(19) United States
(12) Patent Application Publication
(10) Pub. No.: US 2024/0046394 A1
(43) Pub. Date: Feb. 8, 2024

(54) EMPLOYEE GROWTH ACCELERATION SYSTEM

(71) Applicant: Degree, Inc., San Francisco, CA (US)

(72) Inventors: Aleksandr Mistratov, San Francisco, CA (US); Srilakshmi Manikantan, San Francisco, CA (US); Joan Roig Arderiu, Seattle, WA (US); Jared Erondu, New York, NY (US); Ricky Rizal Zein, Brooklyn, NY (US); Teresa Do, San Diego, CA (US); Chuen Yan Lau, Brooklyn, NY (US); Scott Dennis Lindley, Beacon, NY (US); Neil Phillip Steiner, Ann Arbor, MI (US); Angeles Arena, San Francisco, CA (US); Sergio Minutoli, San Francisco, CA (US); Colin VanLang, Long Island City, NY (US); Benjamin Ki, San Francisco, CA (US); Hari Vignesh Ganesan, Jersey City, NJ (US); Samuel John Brian Coxon, New York, NY (US); Sarah Zhao, Brooklyn, NY (US); Harmony Merva Geauvreau-Dashut, Brooklyn, NY (US); Thomas Chang, New York, NY (US); Jeffrey Cheung, New York, NY (US); Emily Marshall, Livingston, MT (US); Adam Romel David, Manhattan, NY (US); Lance Allen Laughlin, JR., Somerville, MA (US); Carrie Jo Noonan, Wheat Ridge, CO (US); Nayana Srivastava, San Francisco, CA (US); Jaclyn Anh Tu Tran, San Francisco, CA (US); Kevin Cook, San Francisco, CA (US); Dina Deng, New York, NY (US); Audrey Chou, Brooklyn, NY (US); Jay Ashish Mahabal, New York, NY (US)

(21) Appl. No.: 18/361,418

(22) Filed: Jul. 28, 2023

Related U.S. Application Data
(60) Provisional application No. 63/369,872, filed on Jul. 29, 2022.

(51) Int. Cl. G06Q 50/20; G06Q 10/105; G06Q 10/0631; G06Q 10/0639

(52) U.S. Cl. CPC G06Q 50/2057; G06Q 10/105; G06Q 10/063112; G06Q 10/06398

(57) ABSTRACT

A method and system for accelerating employee growth is disclosed. A growth track is created. The growth track is associated with one or more competencies. The growth track is associated with one or more track levels. The growth track is aligned with a job architecture. The job architecture includes a job function, a job type, and one or more job tracks. The one or more job levels are mapped to the one or more track levels. A growth area is created. The growth area relates to one or more competencies. A user interface is caused to be presented on a device of a user based on the user being associated with the job function and the job type. The user interface allows the user to share an update pertaining to a progress of the user within the growth area.

### CROSS-REFERENCE TO RELATED APPLICATIONS

This application claims the benefit of U.S. Provisional Application No. 63/369,872, filed Jul. 29, 2022, which is incorporated by reference herein in its entirety.

### TECHNICAL FIELD

The present application relates generally to the technical field of data analytics and, in one specific example, to collecting and analyzing data pertaining to growth of employees or other individuals associated with an entity and facilitating implementation of actionable suggestions for accelerating that growth based on the analysis.

### BACKGROUND

When it comes to hiring and retaining employees—especially in a competitive labor market organizations that offer a robust employee development program can have a major advantage. It's a win-win: Ambitious and engaged employees want opportunities to stretch their skills, and companies that can provide these opportunities reap the rewards in the form of dedicated, innovative workers.

While FIR professionals have a number of options when it comes to bringing development programs to life, individual development plans (IDPs) have become some of the most ubiquitous. The co-written plans, shaped by managers and employees together, let employees define their career goals and outline the steps they'd need to take to achieve them. These plans can be a powerful tool, and they can set the stage for breakthrough growth for the employee, both in their role and their career. But at many organizations, the traditional IDP process doesn't always live up to its potential.

### BRIEF DESCRIPTION OF THE DRAWINGS

In the drawings, which are not necessarily drawn to scale, like numerals may describe similar components in different views.

The drawings illustrate generally, by way of example, but not by way of limitation, various embodiments discussed in the present document.

FIG. 1 is a network diagram displaying a system within which various example embodiments may be deployed.

FIG. 2 is a block diagram illustrating example modules of growth service(s) 120.

FIG. 3 is a schematic of a user interface displaying matrix of competencies.

FIG. 4 is a schematic of a user interface displaying an individual development plan.

FIG. 5 is a schematic of a user interface displaying career track templates.

FIG. 6 is a schematic of a user interface displaying career conversations for a specific employee.

FIG. 7 is a schematic of a user interface displaying an employee's career goals and growth areas.

FIG. 8 is a schematic of a user interface displaying an employee's short-term and long-term development planning.

FIG. 9 is a schematic of a user interface displaying a manager's view of a direct report's growth areas.

FIG. 10 is a schematic of a user interface displaying an employee's career vision exercises.

FIG. 11 is a schematic demonstrating how to navigate a user interface to view track groups when no tracks have been assigned.

FIG. 12 is a schematic of a user interface displaying an employee's track groups when no groups have been associated with tracks.

FIG. 13 is a schematic of a user interface displaying growth tracks organized by group.

FIG. 14 is a schematic of a user interface displaying an employee's home page.

FIG. 15 is a schematic highlighting various aspects of a user interface displaying an employee's grow page.

FIG. 16 is a schematic demonstrating how to navigate a user interface to view all tracks.

FIG. 17 is a schematic of a user interface displaying expectations for an employee's track.

FIG. 18 is a schematic demonstrating how to navigate a user interface to add a growth area around a different track.

FIG. 19 is a schematic demonstrating how to navigate a user interface to respond to a career vision exercise.

FIG. 20 is a schematic of a user interface displaying a text box for receiving a response to a career vision exercise.

FIG. 21 is a schematic demonstrating how to navigate a user interface to view a user's career vision responses.

FIG. 22 is a schematic demonstrating how to navigate a user interface to view a user's inactive career vision responses.

FIG. 23 is a schematic of a user interface displaying a user's inactive career vision responses.

FIG. 24 is a schematic demonstrating how to navigate a user interface to edit a user's career vision response.

FIG. 25 is a schematic demonstrating how to navigate a user interface to update a user's growth areas.

FIG. 26 is a schematic of a user interface displaying a pop-up window containing a text box for receiving an update to a growth area.

FIG. 27 is a schematic demonstrating how to navigate a user interface to edit or delete a user's growth area.

FIG. 28 is a schematic of a user interface displaying a pop-up window containing a text box for receiving an edit to an update for a growth area.

FIG. 29 is a schematic of a user interface displaying the option to delete a growth area.

FIG. 30 is a schematic demonstrating how to navigate a user interface to edit a growth area.

FIG. 31 is a schematic demonstrating how to navigate a user interface to change a growth area competency while editing a growth area.

FIG. 32 is a schematic demonstrating how to navigate a user interface to mark a growth area as complete.

FIG. 33 is a schematic demonstrating how to navigate a user interface to view completed growth areas.

FIG. 34 is a schematic demonstrating how to navigate a user interface to link a competency to a feedback request.

FIG. 35 is a schematic demonstrating how to navigate a user interface to link a competency to a feedback request.

FIG. 36 is a schematic of a user interface displaying a feedback request within the feedback module.

FIG. 37 is a schematic of a user interface displaying a text box within the feedback module to receive feedback in response to a request.

FIG. 38 is a schematic of a user interface displaying an add to growth area button for linking a review response to a growth area.

FIG. 39 is a schematic demonstrating how to navigate a user interface to unlink a review response from a growth area.

FIG. 40 is a schematic demonstrating how to navigate a user interface to create a development 1:1.

FIG. 41 is a schematic demonstrating how to navigate a user interface to apply a template to a development 1:1.

FIG. 42 is a schematic of a user interface displaying an option to add or remove talking points and action items from a development 1:1 agenda.

FIG. 43 is a schematic demonstrating how to navigate a user interface to create a growth area for a direct report.

FIG. 44 is a schematic of a user interface displaying an option to add additional information to a growth area for a direct report.

FIG. 45 is a schematic of a user interface displaying a selection of competencies to add to a growth area.

FIG. 46 is a schematic demonstrating how to navigate a user interface to view a direct report's growth areas.

FIG. 47 is a schematic of a user interface displaying a growth plan for a growth area.

FIG. 48 is a schematic demonstrating how to navigate a user interface to select an organization from the home page.

FIG. 49 is a schematic demonstrating how to navigate a user interface to search for an indirect report from the employees tab.

FIG. 50 is a schematic demonstrating how to navigate a user interface to locate an indirect report from a direct report's profile.

FIG. 51 is a schematic demonstrating how to navigate a user interface to view growth areas for an indirect report.

FIG. 52 is a schematic demonstrating how to navigate a user interface to view a direct report's track and level.

FIG. 53 is a schematic demonstrating how to navigate a user interface to view a direct report's career visions.

FIG. 54 is a schematic demonstrating how to navigate a user interface to view career vision tips.

FIG. 55 is a schematic demonstrating how to navigate a user interface to add career vision tips.

FIG. 56 is a schematic of a user interface displaying a direct report's view of the career vision tips.

FIG. 57 is a schematic demonstrating how to navigate a user interface to access grow reporting for a team.

FIG. 58 is a schematic demonstrating how to filter growth areas for a team in a user interface.

FIG. 59 is a schematic demonstrating how to navigate a user interface to group growth areas for a team.

FIG. 60 is a schematic of a user interface displaying a bar graph depicting the percentage of direct reports on a team that have created at least one growth area.

FIG. 61 is a schematic of a user interface displaying a bar graph depicting the percentage of direct reports on a team that have shared a progress update to at least one growth area.

FIG. 62 is a schematic of a user interface displaying direct reports' review responses and providing the option to link a review response to that direct report's growth area.

FIG. 63 is a schematic demonstrating how to navigate a user interface to unlink a review response from a direct report's growth area.

FIG. 64 is a schematic demonstrating how to navigate a user interface to access the growth area of an employee.

FIG. 65 is a schematic of a user interface displaying the option to search and select a target employee.

FIG. 66 is a schematic of a user interface displaying an employee's growth areas.

FIG. 67 is a schematic of a user interface displaying visibility preferences for managers of managers.

FIG. 68 is a schematic demonstrating how to navigate a user interface to assign track admins to a job track.

FIG. 69 is a schematic demonstrating how to navigate a user interface to assign track admins to a job track.

FIG. 70 Is a schematic of a user interface displaying tracks assigned to a track admin.

FIG. 71 is a schematic demonstrating how to navigate a user interface to allow or disallow track publishing for a track admin.

FIG. 72 is a schematic of a user interface displaying grow settings, including the option to edit track visibility for employees.

FIG. 73 is a schematic of a user interface displaying grow settings, including the option to edit job level visibility for employees.

FIG. 74 is a schematic of a user interface displaying grow settings, including the option to edit attribute visibility for employees.

FIG. 75 is a schematic of a user interface displaying a track template matrix in the grow tool.

FIG. 76 is a schematic demonstrating how to navigate a user interface to adjust activation settings for the grow.

FIG. 77 is a schematic demonstrating how to navigate a user interface to activate the grow tool for a subset of employees.

FIG. 78 is a schematic of a user interface displaying notification delivery methods for the Grow tool.

FIG. 79 is a schematic of an example notification generated by the Grow tool after a direct report has created a growth tool.

FIG. 80 is a schematic of an example notification generated by the Grow tool after a direct report has updated a growth area.

FIG. 81 is a schematic of an example notification generated by the Grow tool after a manager has created a growth area for their report.

FIG. 82 is a schematic of an example notification generated by the Grow tool after a manager has updated a growth area for their report.

FIG. 83 is a schematic demonstrating how to navigate a user interface to view track templates in the Grow tool.

FIG. 84 is a schematic demonstrating how to navigate a user interface to select a track template in the Grow tool.

FIG. 85 is a schematic of a user interface displaying a matrix of competency themes and associated competencies for a track template.

FIG. 86 is a schematic demonstrating how to navigate a user interface to create a track from scratch in the Grow tool.

FIG. 87 is a schematic of a user interface displaying text boxes for a user to provide a name and description for a track.

FIG. 88 is a schematic demonstrating how to navigate a user interface to add a competency to a newly created track.

FIG. 89 is a schematic of a user interface displaying competencies to be added to a track.

FIG. 90 is a schematic demonstrating how to navigate a user interface to add levels to a competency in a track.

FIG. 91 is a schematic of a user interface displaying expectations for a competency level.

FIG. 92 is a schematic demonstrating how to navigate a user interface to create a track from a CSV.

FIG. 93 is a schematic of a generic CSV template.

FIG. 94 is a schematic of a user interface displaying a CSV template being uploaded to the platform.

FIG. 95 is a schematic demonstrating how to navigate a user interface to create a competency from the competencies auditing page.

FIG. 96 is a schematic of a user interface displaying text boxes to add a name and description to draft tracks.

FIG. 97 is a schematic demonstrating how to navigate a user interface to select a track and create a competency for that track.

FIG. 98 is a schematic demonstrating how to navigate a user interface to add a competency to a track.

FIG. 99 is a schematic of a user interface displaying the option to create a new competency by entering a new name.

FIG. 100 is a schematic demonstrating how to navigate a user interface to reorder competencies.

FIG. 101 is a schematic demonstrating how to navigate a user interface to access the competency library.

FIG. 102 is a schematic of a user interface displaying a competency's levels and expectations.

FIG. 103 is a schematic demonstrating how to navigate a user interface to create a competency theme.

FIG. 104 is a schematic of a user interface displaying text boxes to add a name and description to a competency theme.

FIG. 105 is a schematic demonstrating how to navigate a user interface to add a competency theme to a track.

FIG. 106 is a schematic of a user interface displaying the option to add a competency theme to a track.

FIG. 107 is a schematic of a user interface displaying a drop-down menu and a text box for the user to choose a theme name and add a description.

FIG. 108 is a schematic demonstrating how to navigate a user interface to group competencies under a theme.

FIG. 109 is a schematic demonstrating how to navigate a user interface to assign employees to tracks.

FIG. 110 is a schematic of a user interface displaying the option to add employees to a track.

FIG. 111 is a schematic of a user interface displaying a list of employees to add to a track.

FIG. 112 is a schematic demonstrating how to navigate a user interface to assign each employee a job level.

FIG. 113 is a schematic demonstrating how to navigate a user interface to assign employees to tracks and levels via CSV.

FIG. 114 is a schematic of a pre-filled CSV template.

FIG. 115 is a schematic of a user interface displaying a CSV template being uploaded to the platform.

FIG. 116 is a schematic of a user interface displaying a track and employees' levels after a CSV has been uploaded.

FIG. 117 is a schematic demonstrating how to navigate a user interface to create a track group.

FIG. 118 is a schematic of a user interface displaying a text box and drop-down menu to receive a designation of a track group name and any associated tracks.

FIG. 119 is a schematic of a user interface displaying the option to select departments that a track group is connected to.

FIG. 120 is a schematic of a user interface displaying multiple track groups in alphabetical order.

FIG. 121 is a schematic of a user interface displaying the tracks auditing page with the track group column highlighted.

FIG. 122 is a schematic of a user interface displaying drop-down menus to receive a designation of a job function and job type in order to align job architecture.

FIG. 123 is a schematic of a user interface displaying drop-down menus to receive designations of job levels to be aligned with the listed track levels.

FIG. 124 is a schematic of a user interface displaying a matrix of job architecture alignment.

FIG. 125 is a schematic of a user interface displaying a grow auditing page listing each track's job function and job type.

FIG. 126 is a schematic of a user interface displaying drop-down menus to receive designations of job levels to be aligned with the listed track levels.

FIG. 127 is a schematic demonstrating how to navigate a user interface to access grow reporting.

FIG. 128 is a schematic demonstrating how to navigate a user interface to filter growth areas in the participation page.

FIG. 129 is a schematic of a user interface displaying growth areas on the participation page filtered by a specific manager.

FIG. 130 is a schematic demonstrating how to navigate a user interface to group growth areas by individuals, manager, department, or track.

FIG. 131 is a schematic of a user interface displaying a bar graph depicting the percentage of direct reports which have created at least one growth area.

FIG. 132 is a schematic of a user interface displaying a bar graph depicting the percentage of direct reports who have shared a progress update to at least one growth area.

FIG. 133 is a schematic of a user interface displaying track auditing in the Status column.

FIG. 134 is a schematic of a user interface displaying track auditing in the Last Updated column.

FIG. 135 is a schematic demonstrating how to navigate a user interface to duplicate a track.

FIG. 136 is a schematic of a user interface displaying the duplicated track.

FIG. 137 is a schematic demonstrating how to navigate a user interface to delete a competency.

FIG. 138 is a schematic of a user interface displaying a pop-up window requesting confirmation of the selected competency to be deleted.

FIG. 139 is a schematic demonstrating how to navigate a user interface to unpublish a track from the auditing page.

FIG. 140 is a schematic of a user interface displaying the competency matrix view.

FIG. 141 is a schematic demonstrating how to navigate a user interface to delete a track group.

FIG. 142 is a schematic demonstrating how to navigate a user interface to rename a track.

FIG. 143 is a schematic of a user interface displaying an edit track page containing text boxes to receive a track name and description.

FIG. 144 is a schematic demonstrating how to navigate a user interface to edit competencies in a track.

FIG. 145 is a schematic of a user interface displaying a matrix of competencies available to be edited.

FIG. 146 is a schematic of a user interface displaying an edit competency page containing a list of linked tracks and text boxes to receive a competency name and description.

FIG. 147 is a schematic demonstrating how to navigate a user interface to remove a competency.

FIG. 148 is a schematic demonstrating how to navigate a user interface to edit a level in a track.

FIG. 149 is a schematic of a user interface displaying additional details for a particular competency in a list of competencies.

FIG. 150 is a schematic demonstrating how to navigate a user interface to reorder a level within a track.

FIG. 151 is a schematic of a user interface displaying a pop-up window containing a list of job levels that may be reordered by dragging and dropping.

FIG. 152 is a schematic demonstrating how to navigate a user interface to replace competencies in a track.

FIG. 153 is a schematic of a user interface displaying a matrix of competencies available to be replaced.

FIG. 154 is a schematic of a user interface displaying a pop-up window containing a list of replacement competencies to select from.

FIG. 155 is a schematic demonstrating how to navigate a user interface to edit track groups.

FIG. 156 is a schematic of a user interface displaying a pop-up window containing a text box and drop-down menus for receiving edits to a track group.

FIG. 157 is a schematic demonstrating how to navigate a user interface to export a track from the Track Auditing page.

FIG. 158 is a schematic of a user interface displaying a track matrix available to be exported as a CSV.

FIG. 159 is a schematic demonstrating how to navigate a user interface to customize a career vision template.

FIG. 160 is a schematic demonstrating how to navigate a user interface to add an exercise to a career vision template.

FIG. 161 is a schematic of a user interface displaying a pop-up window to receive edits to an exercise being added to a career vision template.

FIG. 162 is a schematic of a user interface displaying a pop-up window containing a toggle button for enabling a career vision exercise.

FIG. 163 is a schematic of a user interface displaying a pop-up window to receive edits to an exercise in a career vision template.

FIG. 164 is a schematic of a user interface displaying a pop-up window containing the option to delete an exercise from a career vision template.

FIG. 165 is a schematic of a user interface displaying an individual development plan kickoff notification and a manage notification button.

FIG. 166 is a schematic of a user interface displaying an individual development plan kickoff notification and a cancel scheduled send button.

FIG. 167 is a schematic demonstrating how to navigate a user interface to customize growth area templates.

FIG. 168 is a schematic demonstrating how to navigate a user interface to edit optionality of a specific field or question.

FIG. 169 is a schematic of a user interface displaying growth area template questions and an add another question button.

FIG. 170 is a schematic of a user interface displaying options to edit a new question in a growth area template.

FIG. 171 is a schematic of a user interface displaying options to hide an action or make it optional/required.

FIG. 172 is a schematic of a user interface displaying suggested growth area templates and the option to add questions to the templates.

FIG. 173 is a schematic of a user interface displaying growth area template questions and the option to edit their optionality.

FIG. 174 is a block diagram illustrating a mobile device, according to an example embodiment.

FIG. 175 is a block diagram of an example computer system on which methodologies and operations described herein may be executed, in accordance with an example embodiment.

### DETAILED DESCRIPTION

In the following description, for purposes of explanation, numerous specific details are set forth in order to provide an understanding of various embodiments of the present subject matter. It will be evident, however, to those skilled in the art that various embodiments may be practiced without these specific details.

A method and system for accelerating employee growth is disclosed. A growth track is created. The growth track is associated with one or more competencies. The growth track is associated with one or more track levels. The growth track is aligned with a job architecture. The job architecture includes a job function, a job type, and one or more job tracks. The one or more job levels are mapped to the one or more track levels. A growth area is created. The growth area relates to one or more competencies. A user interface is caused to be presented on a device of a user based on the user being associated with the job function and the job type. The user interface allows the user to share an update pertaining to a progress of the user within the growth area.

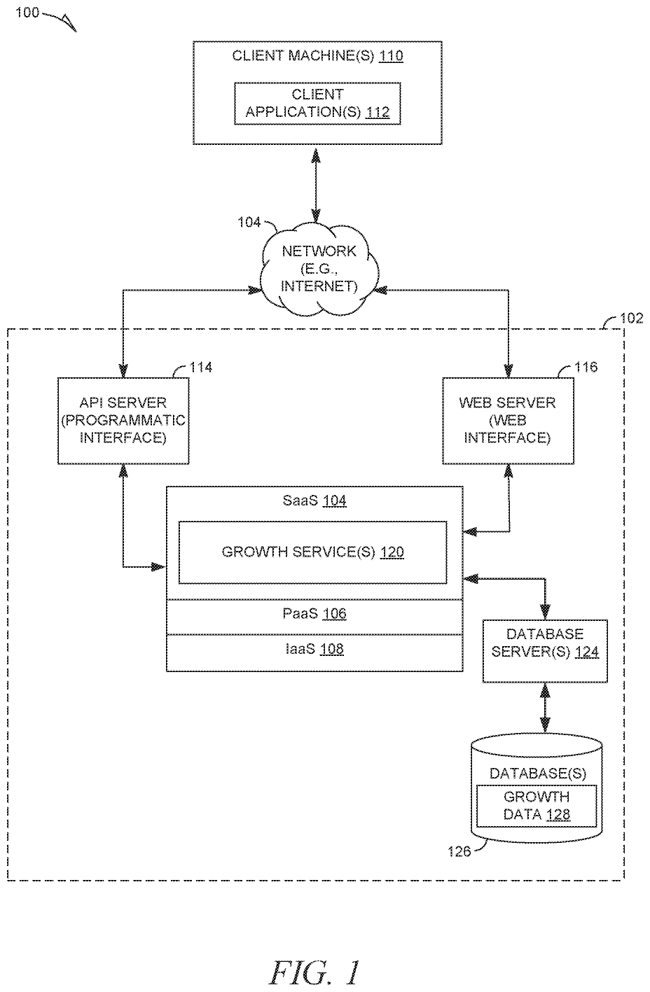

FIG. 1 is a network diagram depicting a system 100 within which various example embodiments may be deployed.

A networked system 102, in the example form of a cloud computing service, such as Microsoft Azure or other cloud service, provides server-side functionality, via a network 104 (e.g., the Internet or Wide Area Network (WAN)) to one or more endpoints (e.g., client machines 110). The networked system 102 is also referred to herein as “Lattice” or “the system” or “the growth acceleration system” or “the employee growth acceleration system.” FIG. 1 illustrates client application(s) 112 on the client machines 110. Examples of client application(s) 112 may include a web browser application, such as the Internet Explorer browser developed by Microsoft Corporation of Redmond, Washington, or other applications supported by an operating system of the device, such as applications supported by Windows, iOS, or Android operating systems. Examples of such applications include e-mail client applications executing natively on the device, such as an Apple Mail client application executing on an iOS device, a Microsoft Outlook client application executing on a Microsoft Windows device, or a Gmail client application executing on an Android device. Examples of other such applications may include calendar applications and file sharing applications. Each of the client application(s) 112 may include a software application module (e.g., a plug-in, add-in, or macro) that adds a specific service or feature to the application.

An API server 114 and a web server 116 are coupled to, and provide programmatic and web interfaces respectively to, one or more software services, which may be hosted on a software-as-a-service (SaaS) layer or platform 104. The SaaS platform 104 may be part of a service-oriented architecture, being stacked upon a platform-as-a-service (PaaS) layer 106 which, may be, in turn, stacked upon a infrastructure-as-a-service (IaaS) layer 108 (e.g., in accordance with standards defined by the National Institute of Standards and Technology (NISI)).

While the applications (e.g., growth (or “Grow”) service(s)) 120 are shown in FIG. 1 to form part of the networked system 102, in alternative embodiments, the applications 120 may form part of a service that is separate and distinct from the networked system 102.

Further, while the system 100 shown in FIG. 1 employs a cloud-based architecture, various embodiments are, of course, not limited to such an architecture, and could equally well find application in a client-server, distributed, or peer-to-peer system, for example. The various server applications 120 could also be implemented as standalone software programs. Additionally, although FIG. 1 depicts machines 110 as being coupled to a single networked system 102, it will be readily apparent to one skilled in the art that client machines 110, as well as client applications 112, may be coupled to multiple networked systems, such as payment applications associated with multiple payment processors or acquiring banks (e.g., PayPal, Visa, MasterCard, and American Express).

Web applications executing on the client machine(s) 110 may access the various applications 120 via the web interface supported by the web server 116. Similarly, native applications executing on the client machine(s) 110 may accesses the various services and functions provided by the applications 120 via the programmatic interface provided by the API server 114. For example, the third-party applications may, utilizing information retrieved from the networked system 102, support one or more features or functions on a website hosted by the third party. The third-party website may, for example, provide one or more promotional, marketplace or payment functions that are integrated into or supported by relevant applications of the networked system 102.

The server applications 120 may be hosted on dedicated or shared server machines (not shown) that are communicatively coupled to enable communications between server machines. The server applications 120 themselves are communicatively coupled (e.g., via appropriate interfaces) to each other and to various data sources, so as to allow information to be passed between the server applications 120 and so as to allow the server applications 120 to share and access common data. The server applications 120 may furthermore access one or more databases 126 via the database servers 124. In example embodiments, various data items are stored in the database(s) 126, such as growth data 128. In example embodiments, the growth data 128 includes one or more data items or metadata items that are viewable and/or editable via one or more user interfaces described herein. In example embodiment, growth data 128 includes data structures encapsulating one or more data items described herein, including, for example, growth areas, growth tracks, competencies, track levels, job tracks, job architectures, job levels, and so on, including fields having names by which they may be referenced and values corresponding to the fields. Thus, for example, a data structure representing a job architecture may be aligned to a data structure representing a growth track and/or a data structure representing a job level may be mapped to a data structure representing a track level, as described herein.

Navigation of the networked system 102 may be facilitated by one or more navigation applications. For example, a search application (as an example of a navigation application) may enable keyword searches of data items included in the one or more database(s) 126 associated with the networked system 102. Various other navigation applications may be provided to supplement the search and browsing applications.

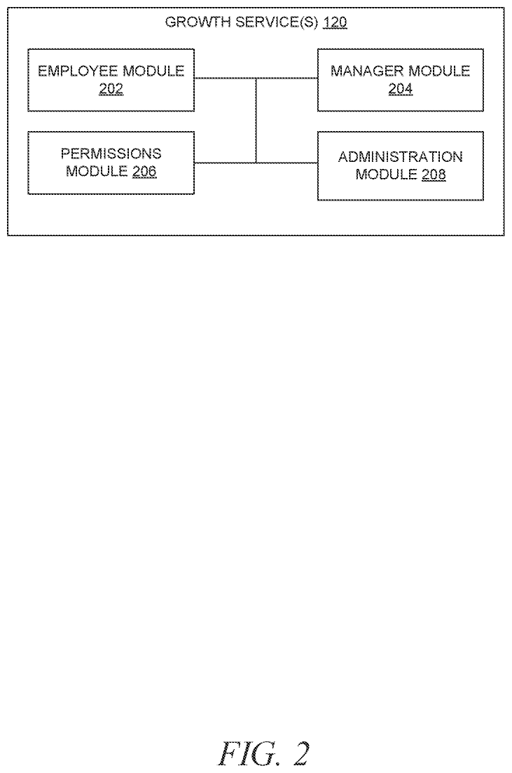

FIG. 2 is a block diagram illustrating example modules of growth service(s) 120.

An employee module 202 is configured to provide access to the growth service(s) 120 from an employee perspective, including viewing track groups, viewing an assigned track and level, creating a growth area, responding to career vision exercises, viewing career vision responses, editing career vision responses, updating growth area progress, editing a growth area, linking competences, and so on, as described herein. A manager module 204 is configured to provide access to the growth service(s) 120 from a manager perspective, including planning a development 1:1 for a report, creating a growth area for a report, viewing growth areas, tracks, and levels for direct and indirect reports, adding a career vision exercise tip, viewing grow reporting for a team, and so on, as described herein. A permissions module 206 is configured to provide for viewing and monitoring of permissions related to the growth service(s) 120, including custom relationship permissions into growth areas, career vision responses, and so on, as described herein. An administration module 208 is configured to provide administrative access to the growth service(s) 120, including creating tracks, managing grow, aligning tracks to job architecture, administering individual development plans, and so on, as described herein.

In example embodiments, the system 102 is a resource management platform that enables leaders to develop engaged, high-performing teams. Because the system 102 combines various features, including continuous performance management, employee engagement, and employee development into one or more unconventional solutions or tools, as described herein, teams get powerful, real-time analytics that lead to actionable insights, turning managers into leaders, employees into high performers, and companies into the best places to work.

Growth is fundamental to the human experience. For us to feel fulfilled, we crave challenges that push us to the next level. We need mountains to climb and goals that we can reach toward and achieve. And we need the sense as individuals that we're progressing in our lives.

The same is true in our professional lives. As employees, we strive for working environments where we constantly look to gain new experiences that will advance our careers. A growth mindset is at the heart of all thriving companies. That's why employee development is critical for long-term business success.

In example embodiments, growth service(s) 120 (also referred to herein as “Grow”) are incorporated into system 102 to help entities (e.g., corporations, partnerships, LLCs, or any entity capable of having employees) and their employees to unlock career meaning in at least two key ways: continuous performance management and employee engagement. And, while the system 102 provides insight into past performance and current engagement, it also takes it at least one step further: addressing the need for employee development in order to make work more meaningful with a focus on the future.

The system redefines talent management as talent acceleration. Grow puts employees in charge of their own development, giving them and their managers a roadmap of actionable steps for continuous discussion and a transparent view of success. Meanwhile, it also gives entities the infrastructure to manage their employees' career growth and align it to broader business goals and success.

Grow incorporates employee-developed growth plans into various key manager touchpoints, like one-on-one meetings, performance reviews, or weekly updates—allowing for organic development conversations that help employees feel supported in their careers while helping companies reduce regrettable attrition.

In example embodiments, the system ensures that each employee is in the driver seat of their developmental journey, and Grow helps make that a reality. Grow gives managers and employees tools to have real dialogue around where they want to go, where they stand, and how to get there.”

The addition of Grow improves the system 102 in at least the following ways:

Creating transparency in expectations and areas for focus as employees look to evolve their careers with integrated Competency Matrices and Career Tracks.

Accelerating careers by offering clear guidance for growth progression in the form of collaborative, easy-to-track Growth Plans.

Driving entity growth as employees focus on key areas of impact that align with larger company needs and values.

Providing guidance for managers to consistently incorporate growth areas and development goals into conversations, rather than in a standalone dust-collecting document.

Grow makes it possible for employees to not just know how they've performed, but also to express how they feel and know what they're working towards. They get to make sure that their manager and their companies are working with them to know their career aspirations. And they can then have clear steps to getting there.

Grow provides the missing piece to holistic talent management. Grow provides transparency to employees' career journeys by surfacing advancement paths and actionable development plans while providing managers with trackable data insights.

Career planning that is only discussed during performance reviews may be ineffective. Grow incorporates competency matrices and career tracks into the Lattice platform so any employee can quickly and easily navigate their career advancement roadmap. Grow offers an intuitive, rounded assessment of employees' current skills and career interests as well as visibility into next growth steps. By providing employees specific areas of focus and direction, managers can help employees develop in the areas their company needs and values to have a positive impact on company growth.

As a manager tool, Grow allows leaders to view, set up, and track development metrics and key growth areas for each member of their team. Bringing career development information into regularly used tools makes conversations around growth happen more consistently and more easily. This transparency is key to empowering employees with the information they need to continue to take the next step and feel supported in their careers and reduce attrition.

Competency matrices in Grow also complement companies' diversity, equity and inclusion (DEI) efforts by establishing objective, observable targets for each level within a role, and making them easy to find and reference by ICs and managers alike. This helps to remove unconscious bias when assessing performance and promotion criteria.

Employees want more than a paycheck. They want to understand how they impact the bigger picture and what they can do to successfully accomplish their career goals.

A growth mindset is often at the heart of thriving organization cultures. With Grow, leadership teams and HR organizations have an opportunity to increase this focus across the individuals in their organization. This idea has been further amplified during the coronavirus pandemic as the normal practices that encourage momentum and continuity have become essential to employees looking for continued structure and growth opportunities in a remote environment.

With the addition of Grow, the system 102 becomes a unified performance management, employee engagement, and career growth platform.

With Competency Matrices, each employee will be clear on their role expectations and understand their path to career advancement.

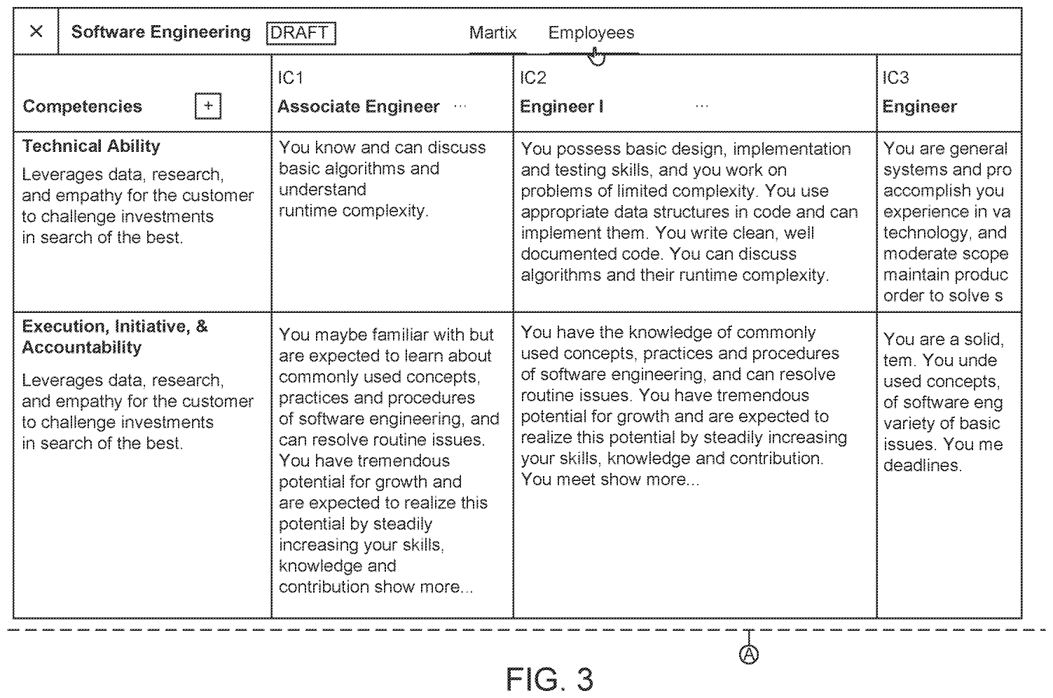

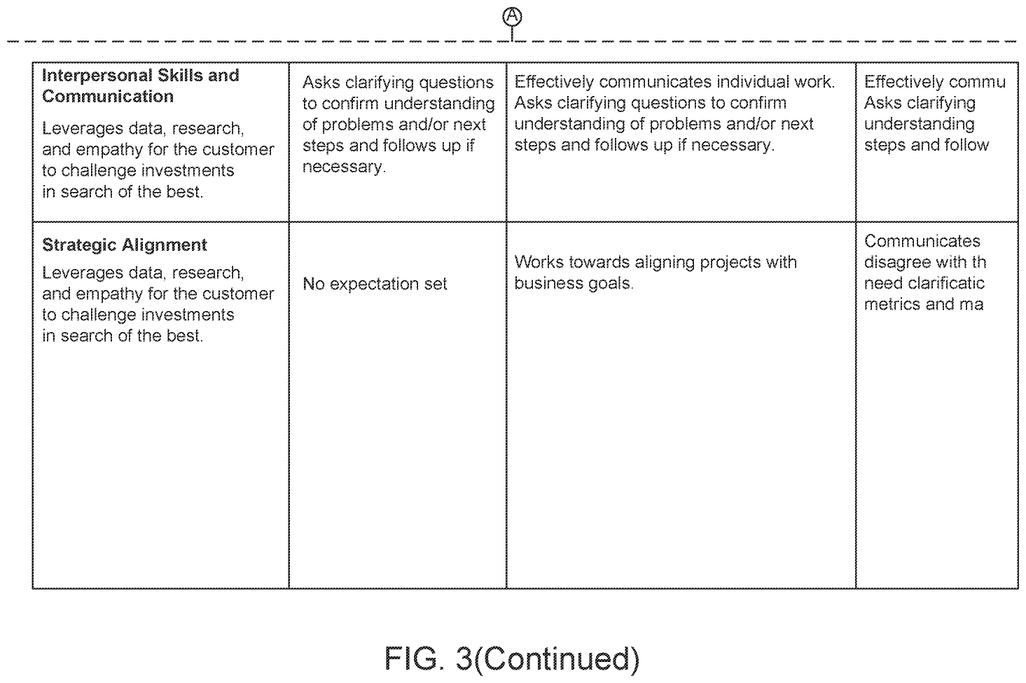

FIG. 3 is a schematic of a user interface displaying matrix of competencies.

Easy-to-launch, next-generation Individual Development Plans help employees achieve meaningful, continuous development from day one.

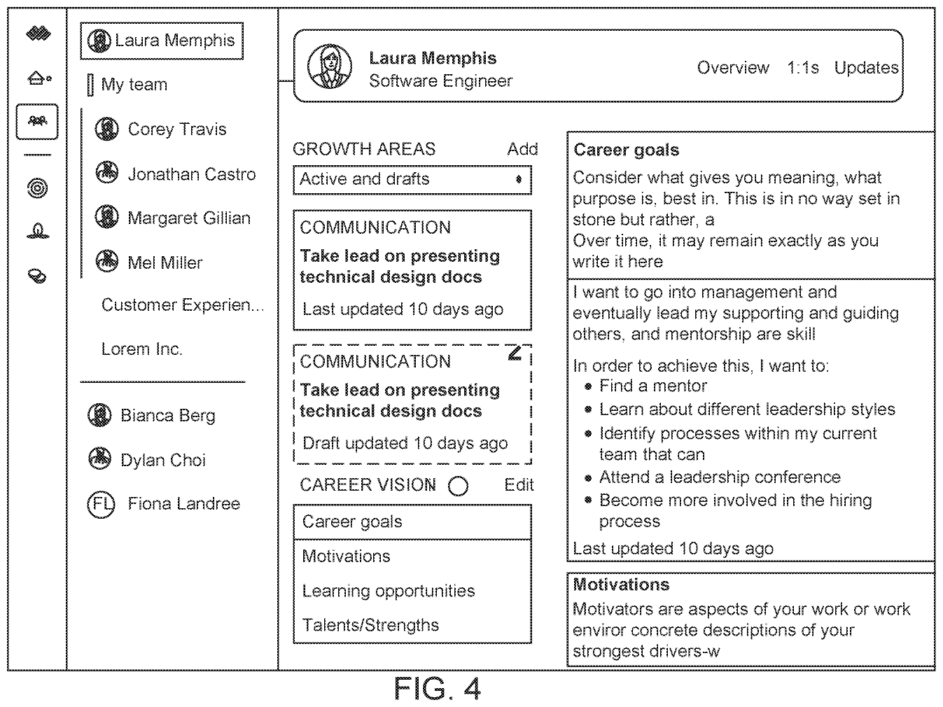

FIG. 4 is a schematic of a user interface displaying an individual development plan.

Career tracks and templates help you effortlessly manage role expectations as your company evolves. As discussed herein, “you” may refer to a user, including a user having one or more specific roles, such as an employee, manager, manager of manager, executive, administrator, super administrator, track administrator, and so on.

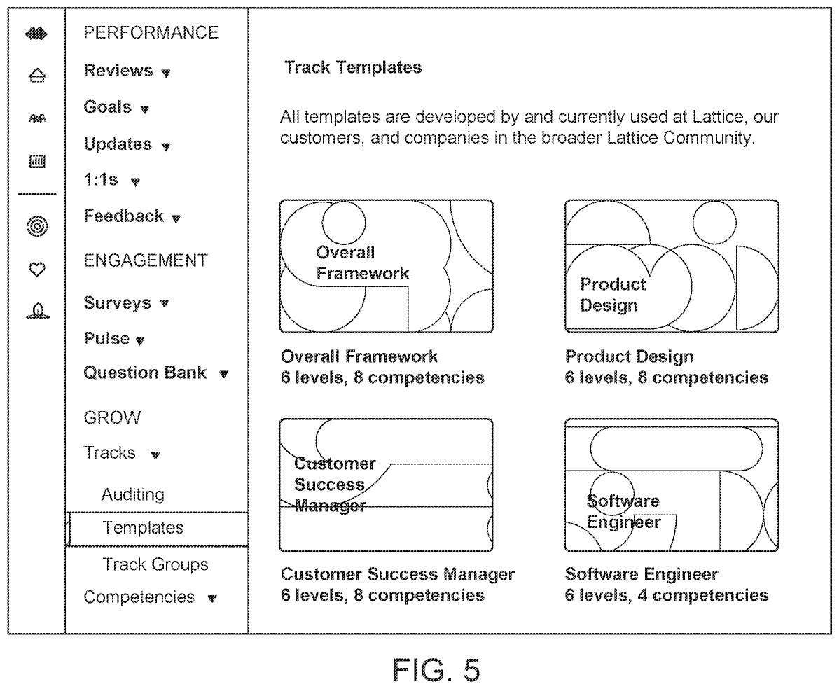

FIG. 5 is a schematic of a user interface displaying career track templates.

Managers may be turned into career coaches, integrating career conversations into everyday work to guide company-wide growth.

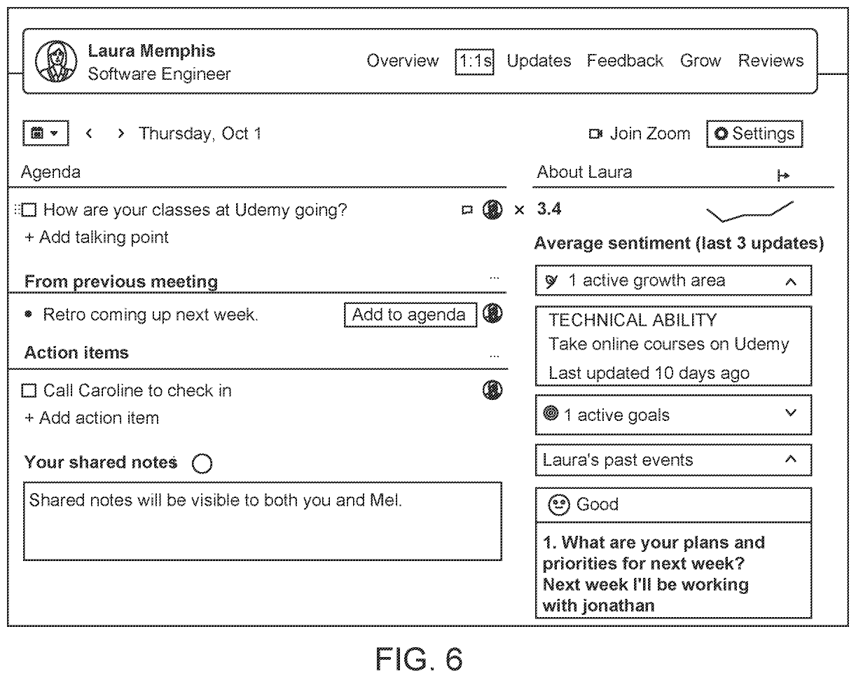

FIG. 6 is a schematic of a user interface displaying career conversations for a specific employee.

The system 102 may make expectations crystal clear and illuminate career advancement opportunities to keep employees engaged and committed.

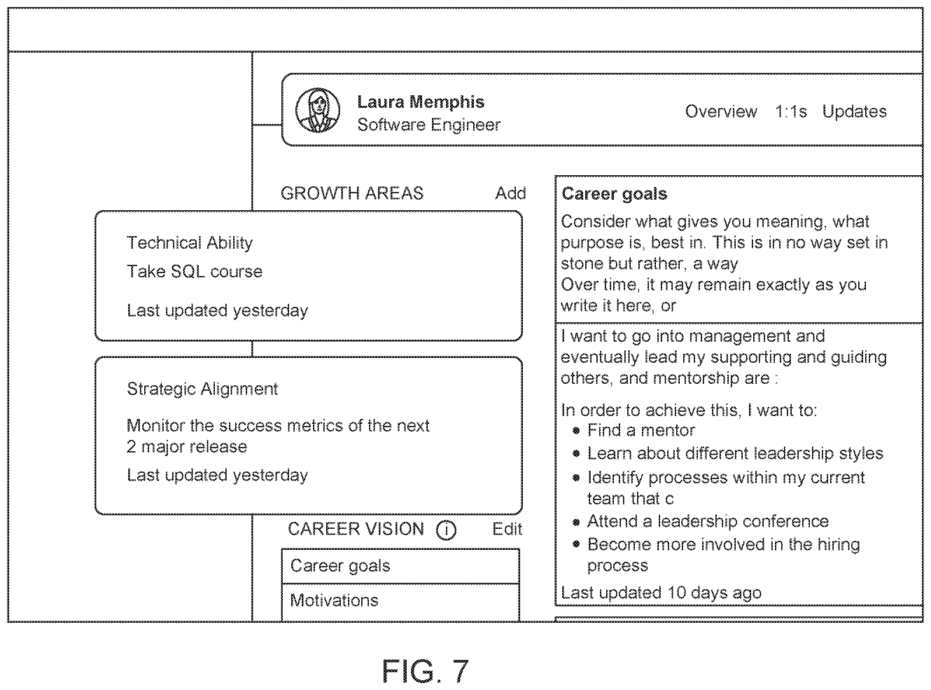

FIG. 7 is a schematic of a user interface displaying an employee's career goals and growth areas.

The system 102 may make short-term and long-term development planning empowering for employees and easy for managers.

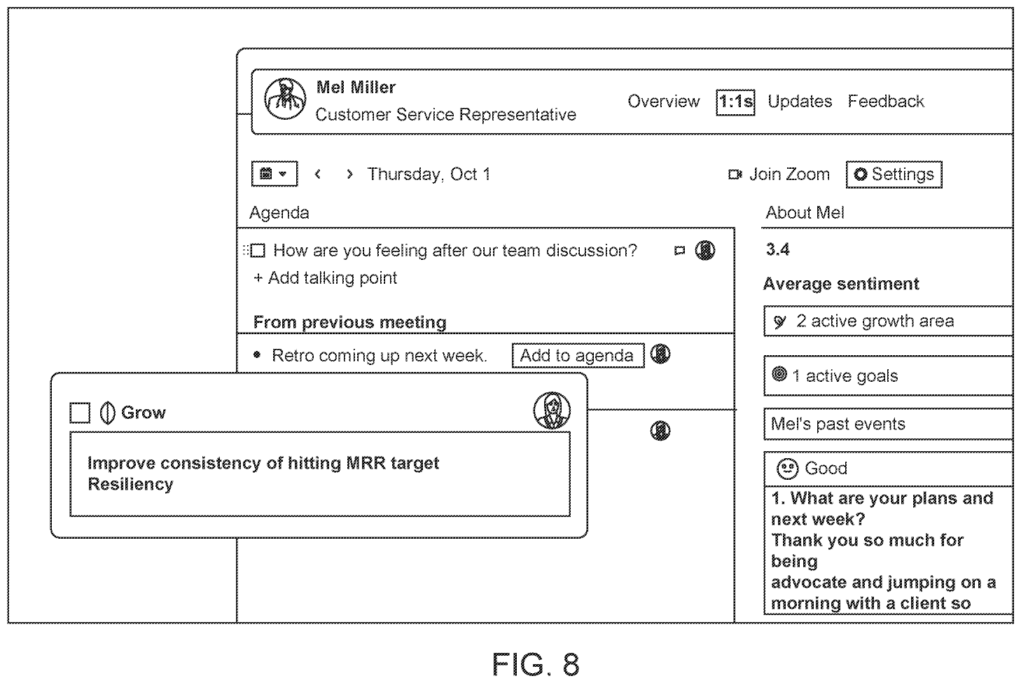

FIG. 8 is a schematic of a user interface displaying an employee's short-term and long-term development planning.

What Is an Individual Development Plan?

Individual development plans are documents created collaboratively between employees and their managers or supervisors that define the employee's short- and long-term career goals. According to the Society for Human Resource Management (SHRM), IDPs also typically lay out the support and educational opportunities the employee would need to achieve those goals, like projects to lead, classes and seminars to enroll in, and opportunities to seek out.

A Career Vision feature of Grow brings robust individual development plan functionality to entities looking to invest in their workforce—and see results.

Notably, IDPs are not evaluations or performance plans, although many firms that use IDPs do so in part because of the performance benefits they see when their employees feel supported and motivated. They're a well-regarded tool in human resource management (for example, many federal agencies require them), and can be a powerful tool for the development of both employees and companies alike.

IDPs may be a key component of an entity's learning and development (L&D) strategy, especially because they are an affordable way to invest in employee growth. But while traditional IDPs may be considered a ubiquitous growth planning tool, they are antiquated. For example, they are just static documents that aren't updated regularly or integrated into the employee's daily flow of work. This lack of scalability and engagement can frustrate people and L&D leaders.

Unlike traditional IDPs, the IDPs supported or implemented by Grow are meant to grow and evolve with the employee, with new goals and opportunities added as the employee grows their career and competencies. IDPs are revisited regularly for optimal benefit.

### Characteristics of Successful IDPs

While every individual development plan should be unique to the objectives and opportunities for each employee, the system provides support for five key components of an effective IDP: strengths, development opportunities, long term career vision, short-term career plan, and immediate growth areas.

The IDPs supported by Grow establish a metric, or measurable way that the employee can know they've improved or succeeded. Specificity is key: If there are new skills an employee wants to develop or that are required to reach a target milestone, they are spelled out. If there is a particular training that will be a prerequisite for achieving a benchmark, or a specific job shadowing opportunity that would be valuable, it is included.

Unlike traditional IDPS, IDPs supported by Grow are not just a rigid catalog of boxes to tick. While the intention is to set goals, the plan is flexible enough to allow the employee to grow and develop their career path as they learn.

### How IDPs in Grow Support Employees

Working through the IDP process of self-assessment offers employees a chance to both reflect on their skillset and current job performance and envision what career advancement might look like for them personally—and what action steps they'll need to get there. And for workers whose previous interactions with supervisors have been limited to feedback on their current job performance, the actual act of career planning and setting professional goals can be a huge plus.

IDPs may be more valuable when the employee and their manager have a high degree of trust between them. They can enable an open dialogue between the manager and their direct reports about how the person can be their best, rather than focus on what they are ‘doing wrong,’ and provide a roadmap with a manageable but meaningful mix of on-the-job experiences, formal learning, and coaching and mentoring.

Employee development plans can be illuminating for both the employee and the manager—and going through the self-assessment and career planning process can help employees envision professional growth at their firm.

Individual development plans may show employees that their supervisors are invested in their long-term growth.

### How Grow Brings IDPs to Life

With its Growth Plans feature, Grow enables employees and managers to continuously track progress on short-term goals. With the addition of the IDP feature, managers can go one step further in supporting long-term employee development.

When used in conjunction, growth plans and IDPs have the power to turn managers into career coaches equipped with the tools and framework needed to drive fruitful development conversations.

Grow's Individual Development Plans enable long-term and short-term career development and integrate it into the daily workflow By empowering employees to progress towards their career aspirations, entities will engage and retain talent, not to mention cultivate stronger performance.

### What do Individual Development Plans (IDP) Look Like in Grow?

In example embodiments, an employee's IDP consists of two features: growth areas and career vision.

The growth areas provide a space for employees to track progress towards their short-term development through documentation and action items. The career vision allows employees to engage in longer-term career planning through exercise prompts.

Growth areas allow employees, alongside their manager, to identify development opportunities and track progress. Key points include the following: record short-term goals, skill development, and progress; tied to growth track and competencies; repeated exercise; updated on an ongoing basis.

Career vision allows employees to complete long-term career planning exercises alongside their manager. Key points include the following: record long term goals, aspirations, and strengths; not directly tied to growth track and competencies, one-time exercise; not updated on an ongoing basis.

Individual Development Plans are shared documents between managers and employees that help employees determine their long-term and short-term career development goals. A key point includes the following: Career vision combined with existing growth area capabilities and visibility into career tracks.

In combination, career vision and growth areas provide an aligned, consistent development process that enables continuous professional growth.

### Growth Area

Growth areas allow employees to identify development opportunities and track progress against them alongside their manager. These are areas of focus that an employee works on for a duration of time to assist their career development and provide updates to the area.

Often growth areas are associated with a specific competency in a job role, but they do not have to be. A growth area can be created even if a track has not been assigned.

Managers have visibility into the growth areas of their direct reports and can create growth areas on behalf of their team.

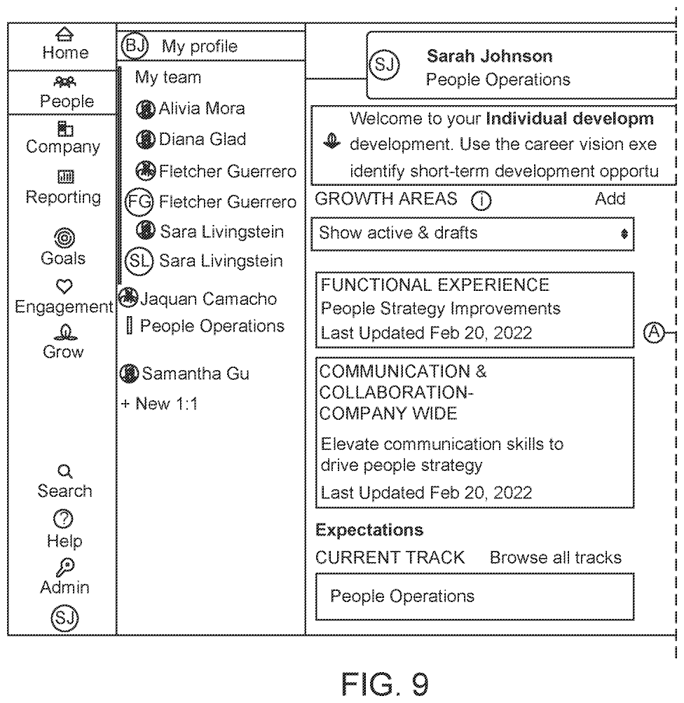

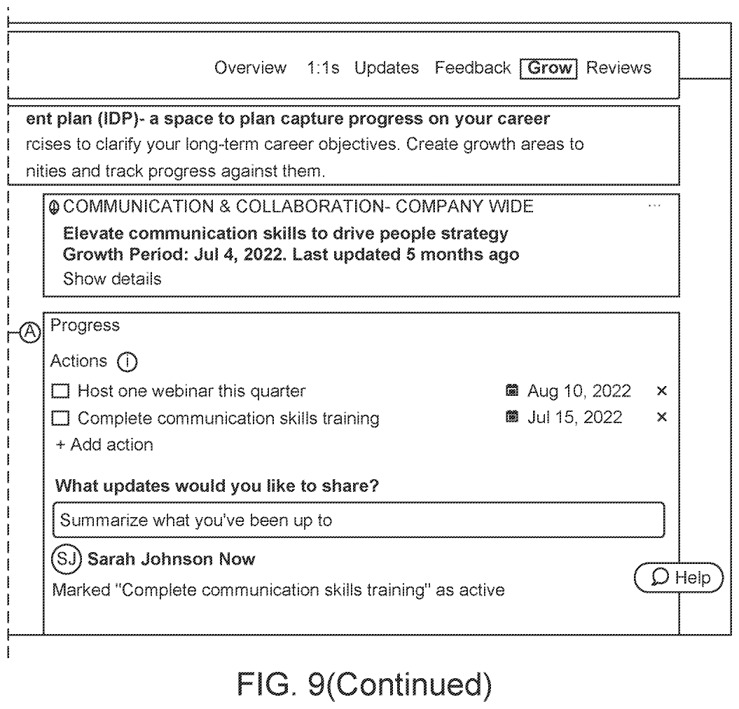

FIG. 9 is a schematic of a user interface displaying a manager's view of a direct report's growth areas.

### Career Vision

Career vision exercises help capture an employee's long-term career aspirations via exercise responses that they can share with their managers. Managers can then work with their direct reports to help support the employee's development based on their responses.

Career visions are not tied to track level or competencies and are only completed once.

The career vision template is customizable by admins to help fit their organization.

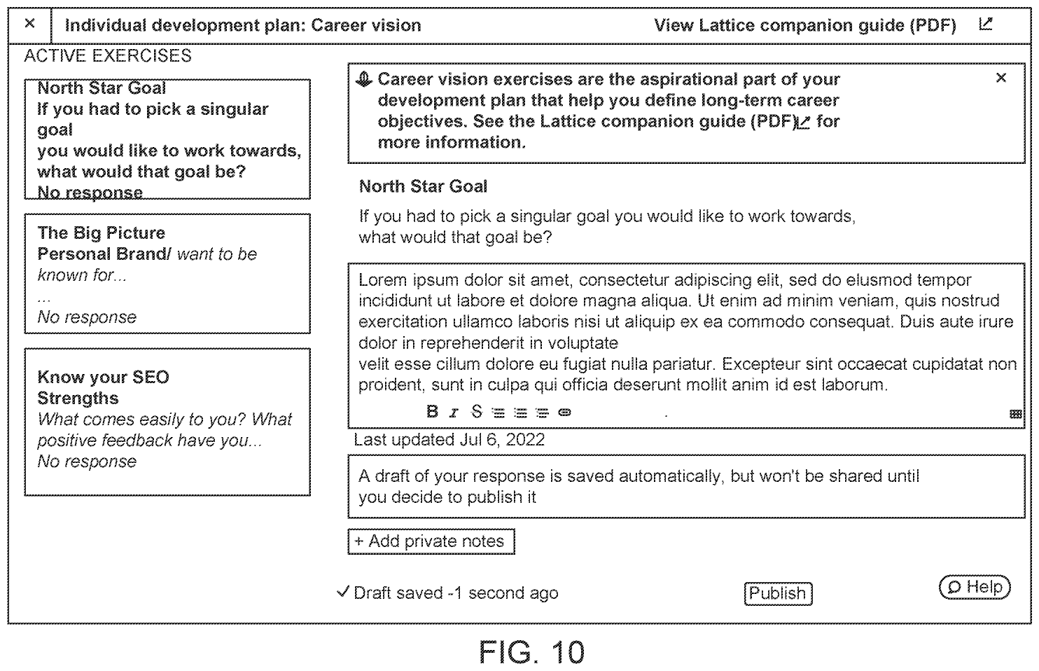

FIG. 10 is a schematic of a user interface displaying an employee's career vision exercises.

Features of Grow discussed below are organized into separate sections for Employee, Manager, Permissions, and Administering Grow. In example embodiments, these features may be implemented by one or more of the modules of FIG. 2.

### Employee

### TRACK Groups

What are track groups?

Track groups help organize related tracks and associate departments. Groups allow you to visualize the relationships between tracks to better understand your career pathing.

### Before You Start

When accessing the Grow page in the discovery navigation, your assigned track will be displayed and highlighted. Within the secondary navigation, if visibility settings configured by the admin allow, employees will be able to view: any groups associated with their track; all other published tracks, if configured.

Track groups are visible to all users as long as at least one associated track within the group is not their own.

### View Track Groups

Navigate to the Grow page on your discovery navigation bar.

No tracks assigned

If you have not been assigned to a track, the first track beneath the first group will be highlighted. Groups will be ordered alphabetically.

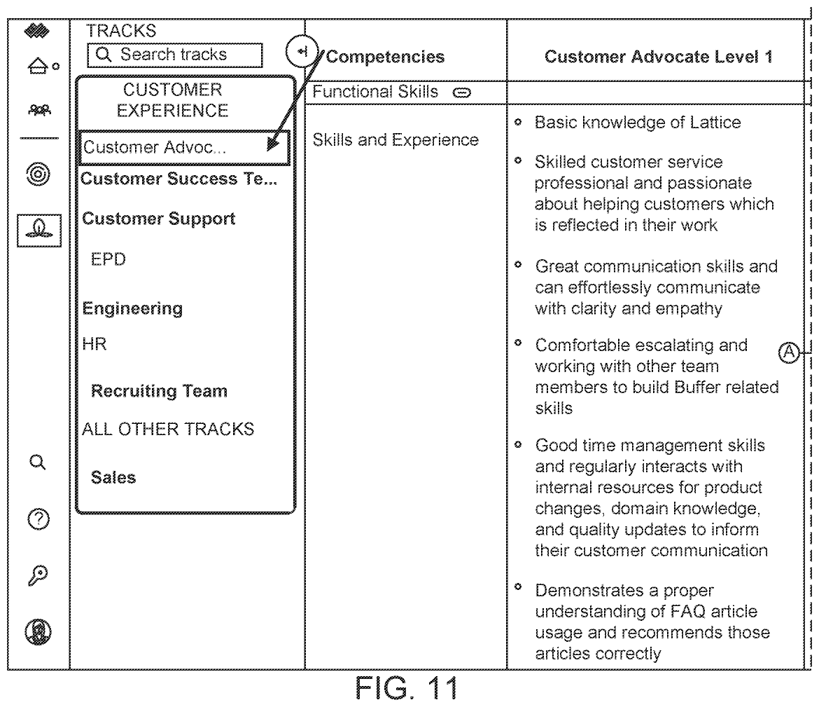

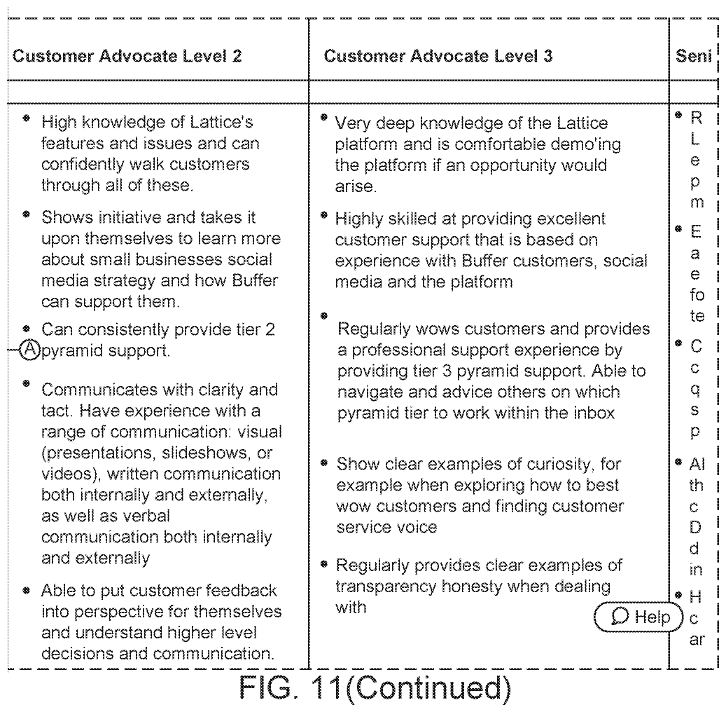

FIG. 11 is a schematic demonstrating how to navigate a user interface to view track groups when no tracks have been assigned.

Any tracks that are not associated with a group will appear beneath the All Other Tracks heading.

No track groups

If no groups have been associated with tracks, tracks will appear alphabetically with no grouping.

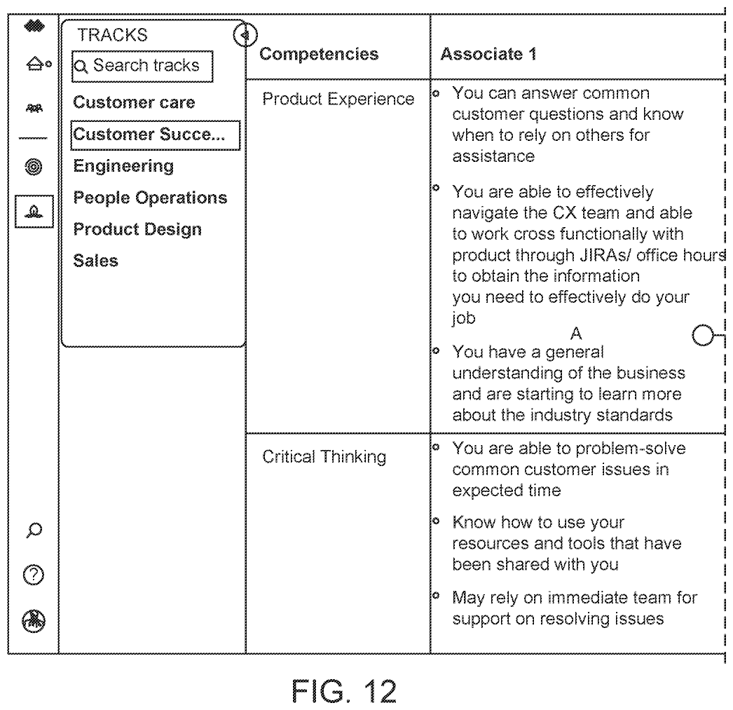

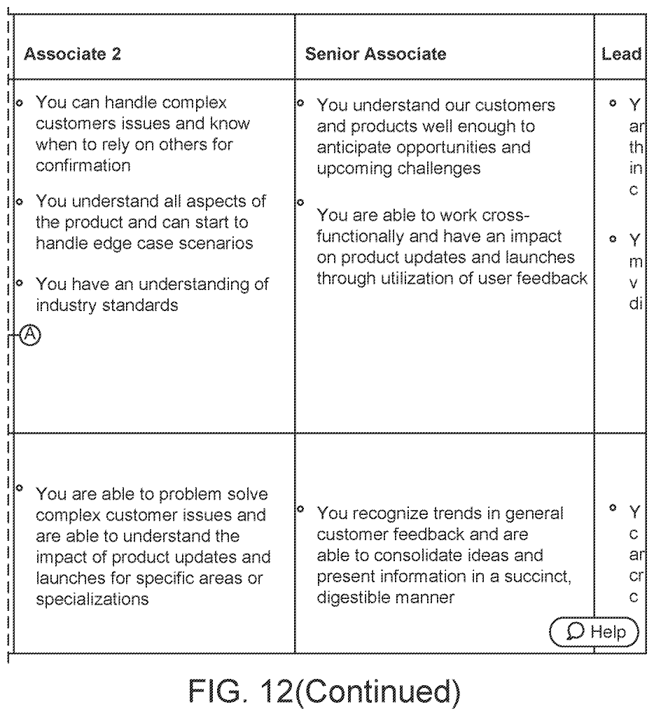

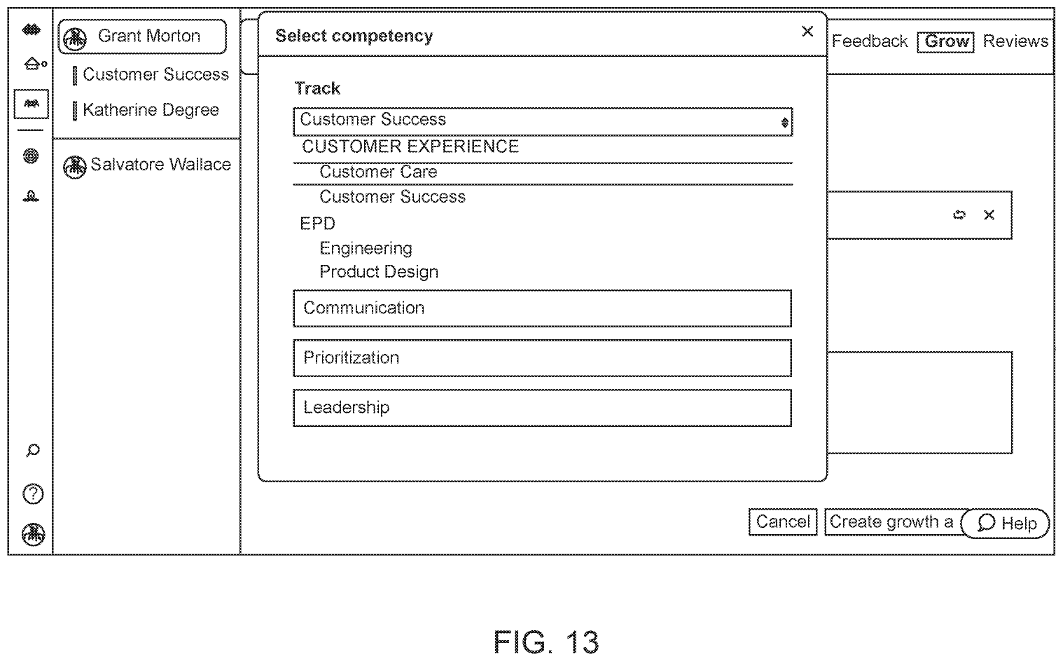

FIG. 12 is a schematic of a user interface displaying an employee's track groups when no groups have been associated with tracks.

### Track Groups in Growth Plans

When creating a growth plan, you will see growth tracks organized by the same grouping when selecting your competencies.

FIG. 13 is a schematic of a user interface displaying growth tracks organized by group.

Otherwise, if the tracks have not been associated with a group, all tracks will appear in alphabetical order within the dropdown.

How to View Your Track and Level

Once you have been assigned a track and level by your account admin, you will be able to access your track from your home page.

Step 1: Enter your Home page and select the Grow page from your discovery navigation.

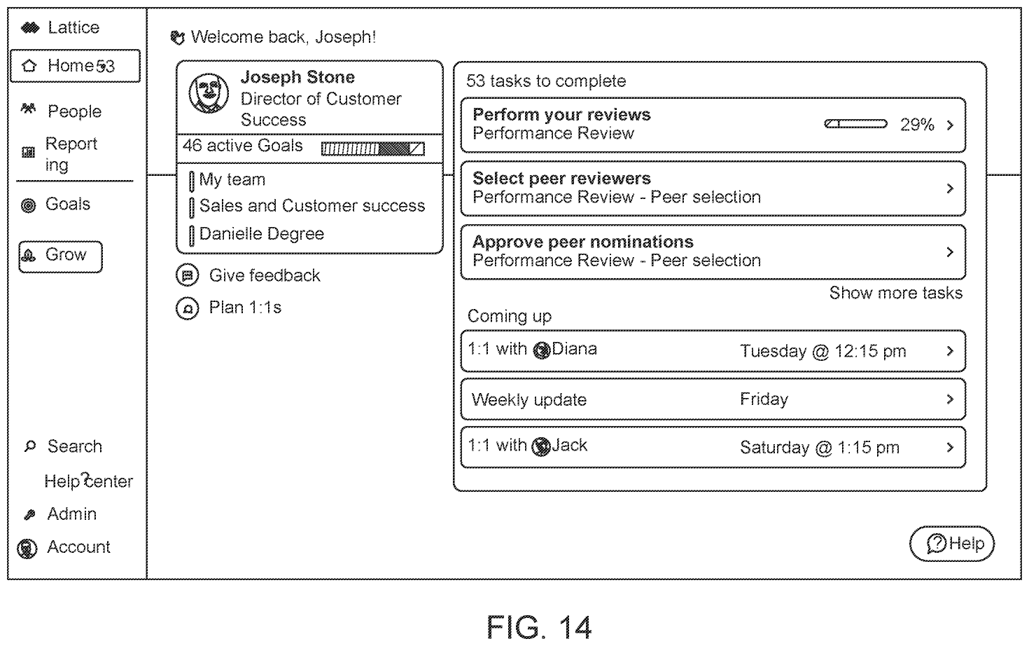

FIG. 14 is a schematic of a user interface displaying an employee's home page.

The Grow page includes the following:
1. Track: contains all the levels that are relevant for progression.
2. Level: sometimes called job classification, the expectations around each competency, depending on where you are along a track. Your assigned level will be highlighted in blue.
3. Expectation: the expectations you must meet for each competency for your role.
4. Competencies: skills or characteristics needed to succeed in a role.
5. Competency theme: grouping of competencies based on similar characteristics.
6. All published company tracks, if visible, along with the associated track group.

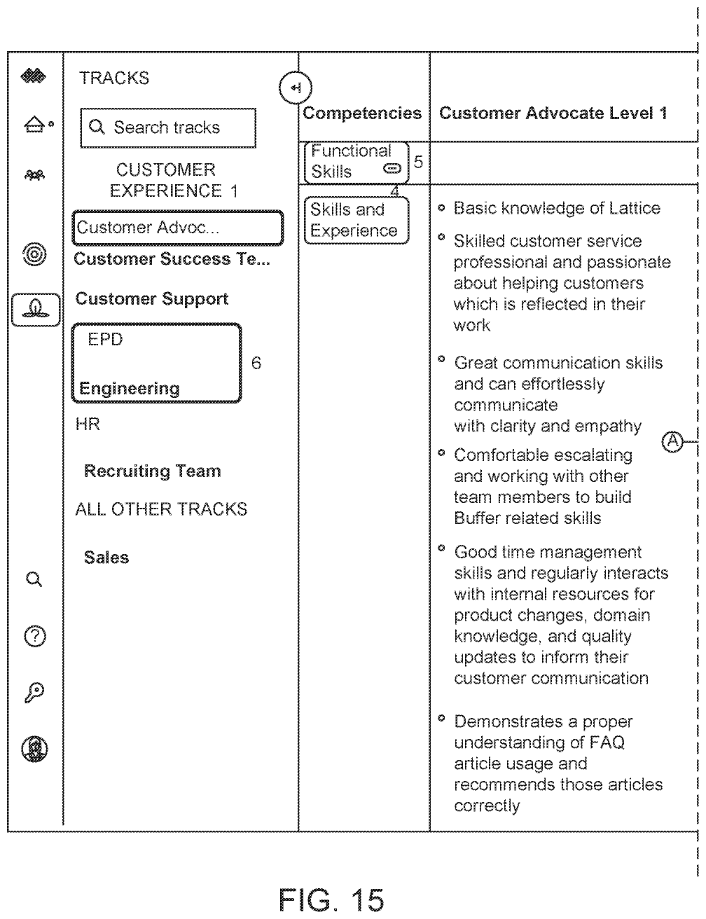

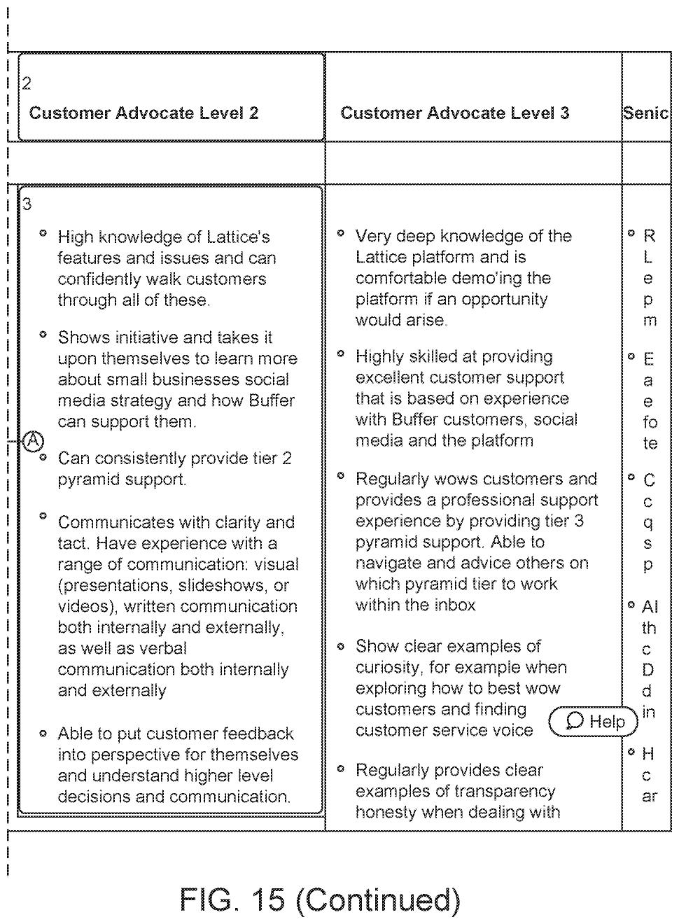

FIG. 15 is a schematic highlighting various aspects of a user interface displaying an employee's grow page.

### How to View All Tracks at a Company

Employees can view all published tracks for their company directly from the Grow page. Please note that although all employees have visibility to their own tracks, visibility to all published company tracks must be enabled by the account admin.

### View All Tracks

Step 1: Navigate to the Grow page on your discovery navigation bar.

Step 2: Click on the desired published track from the left-hand panel. You can search for a specific track or scroll down to view all other tracks.

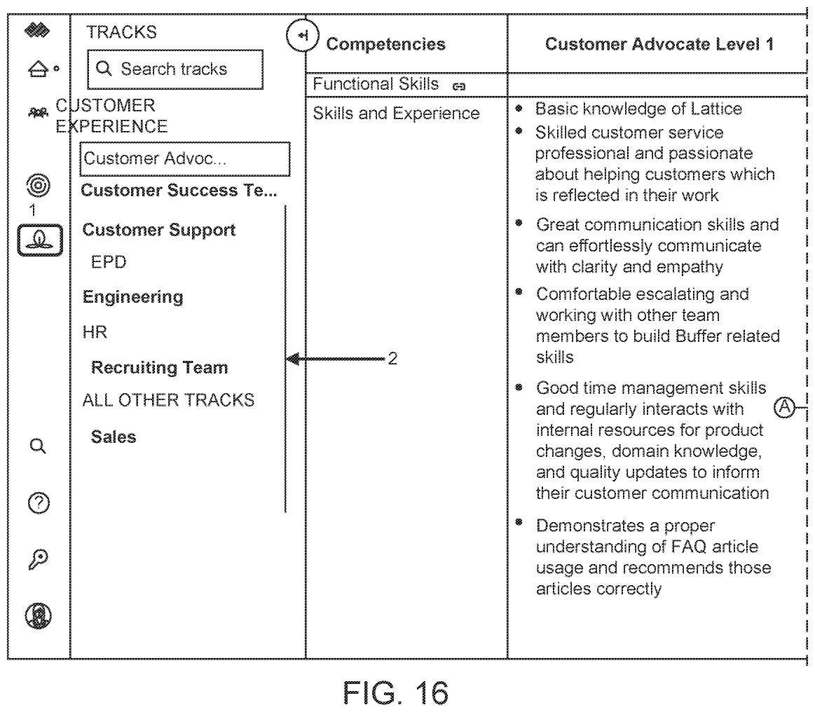

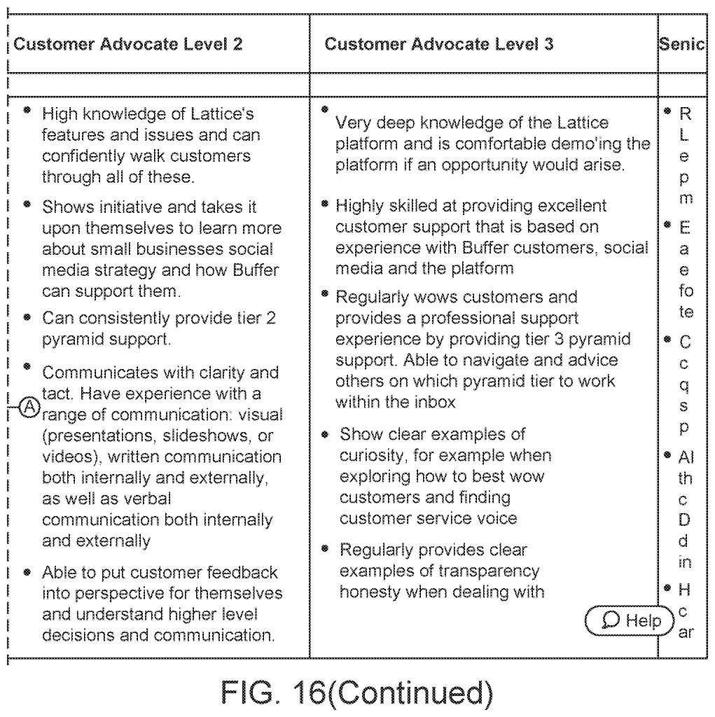

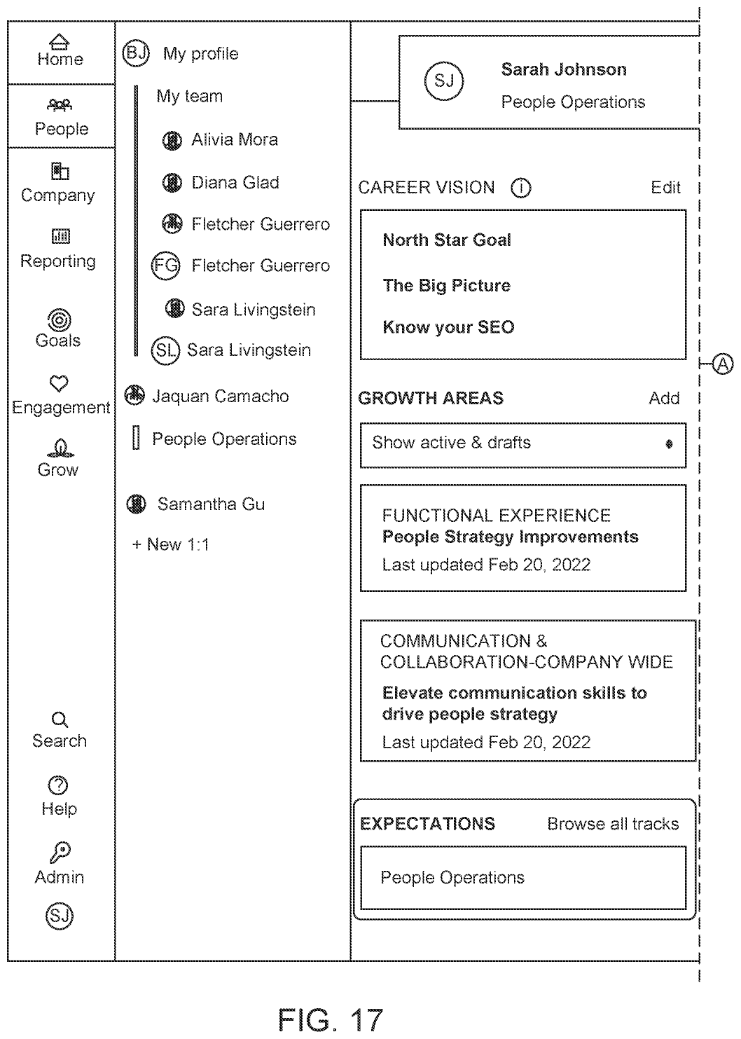

FIG. 16 is a schematic demonstrating how to navigate a user interface to view all tracks.

You will have visibility into the different levels, competencies, and expectations for each published track.

Who Can See My Assigned Track and Level?

Who has visibility into my assigned growth track and level?

By default, Lattice admins, employees, and their direct manager will have access to individual track information.

Depending on your organization's Grow Visibility Settings, the following roles may also be able to view your assigned track and level:
Track Admins
Managers
Manager of managers

### Create a Growth Area

### Creating a Growth Area as an Employee

Growth areas help monitor and document your progress while improving on your assigned competencies. Lattice allows you to create areas of focus called growth areas that you can work on for a duration of time to assist your career development.

Before you start

You can create a growth area even if you have not been assigned to a track.

Managers can also create actions for a direct report.

Growth areas are auto-saved and marked as a draft if not published. Drafted growth areas will not be visible to anyone until they are published.

Here are some relevant tasks.
Create a growth area
Create a growth area with competencies in your track
Create a growth area with competencies from a different track

Create a Growth Area

On the Home page, click on Create growth area—OR—Navigate to the People>My Profile>Grow.

Next to Growth areas, click Add.

Give your growth area a title and include a description of what you need to accomplish to improve upon your growth area.

Under Growth period, select the duration of focus for your area.

Add actions and due dates needed to complete or improve upon the growth area.

Add a competency to your growth area by selecting a competency within your own or another published track.

Select Publish.

Note: The growth period is not a hard deadline but a target dale for focus.

Create a growth area with competencies in your track

If you have been assigned a track, Lattice will show you the expectation for your current level and the next level up on your track by selecting the track under Expectations.

Under Expectations, select the name of your job track.

Navigate to the competency of interest and select Add as a growth area.

Repeat the relevant steps to finish creating the growth area.

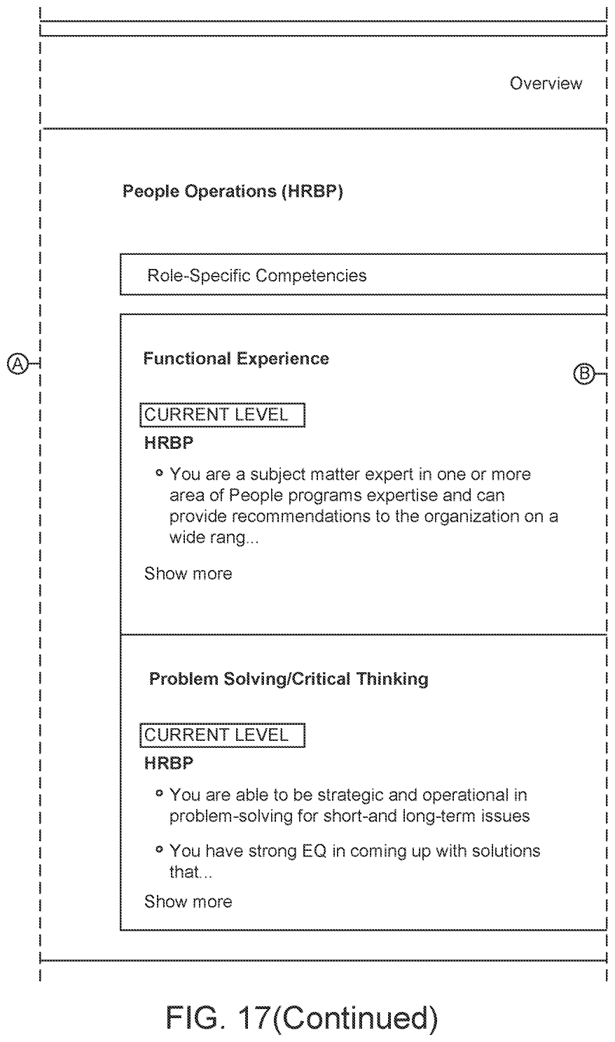

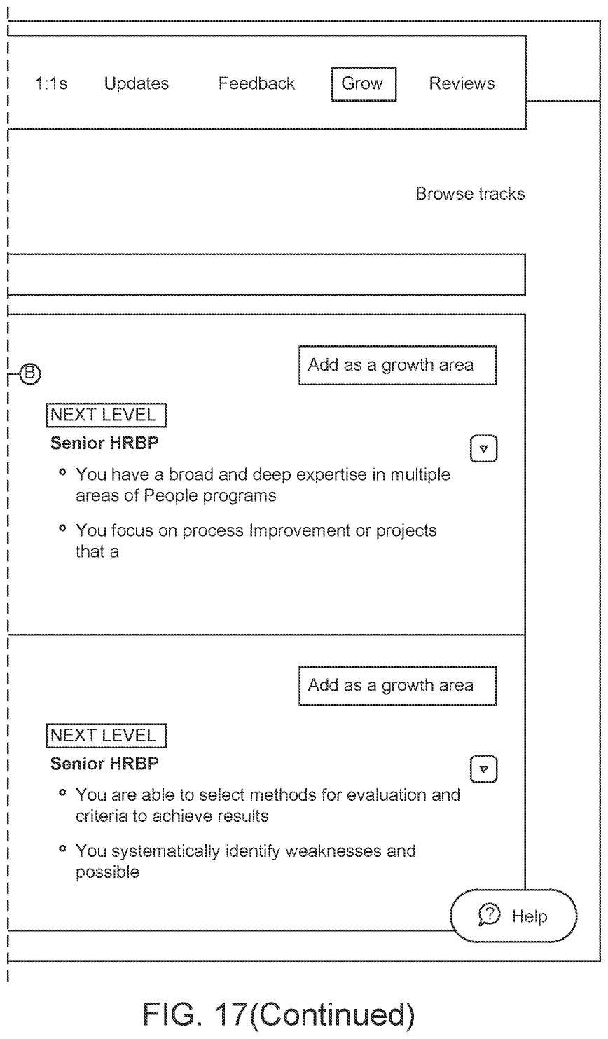

FIG. 17 is a schematic of a user interface displaying expectations for an employee's track.

Create a growth area with competencies from a different track

If given visibility by an account admin, you may have access to all published tracks within the company. Creating a growth area around a different track allows you to create your own career path that does not necessarily involve moving from one level to another within your same track.

Under Expectations, select the name of your job track.

Select Browse tracks.

Navigate to the desired job track and click the eye icon in the right-hand corner of the role of interest.

Navigate to the competency of interest and select Add as a growth area.

Repeat the relevant steps above to finish creating the growth area.

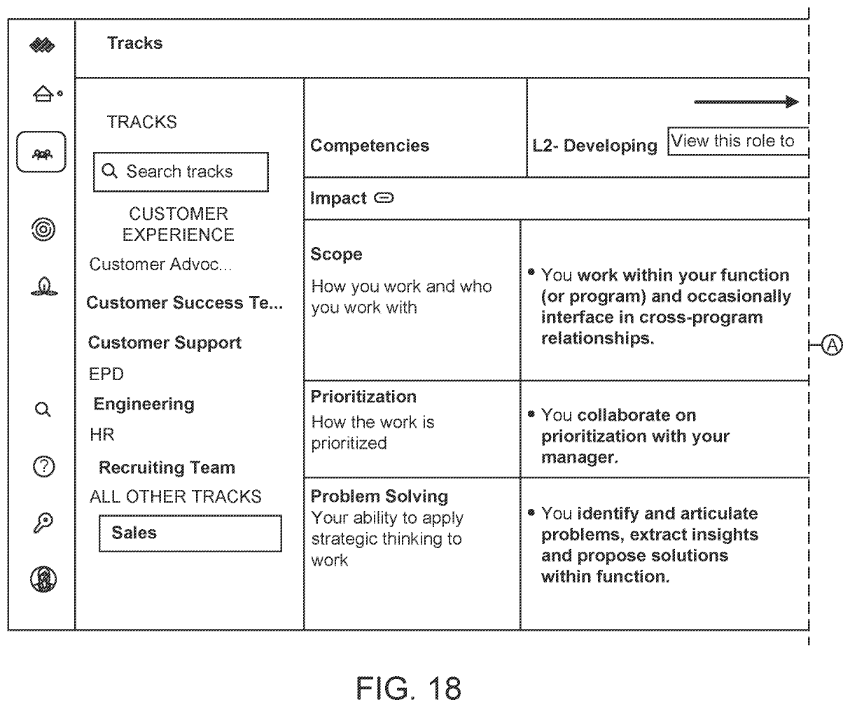

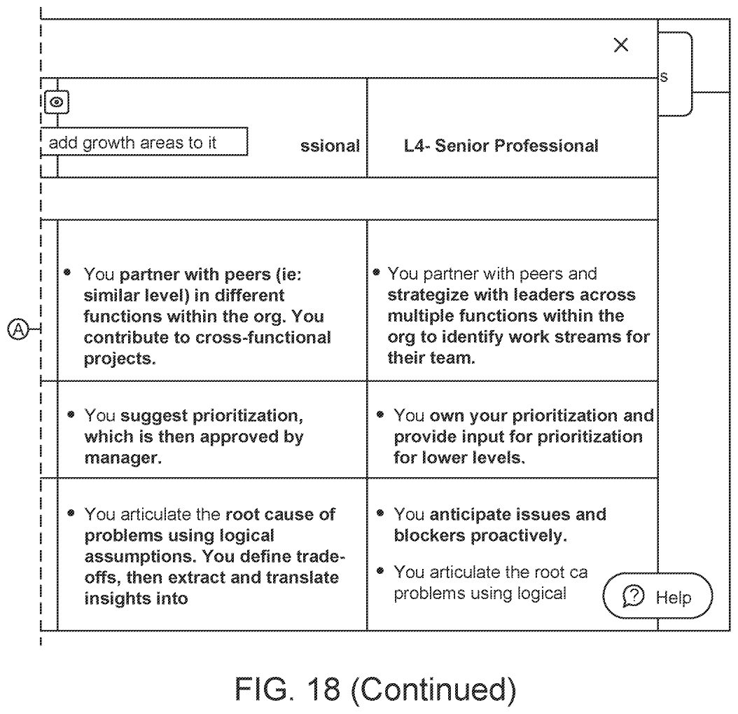

FIG. 18 is a schematic demonstrating how to navigate a user interface to add a growth area around a different track

Depending on your organization's Grow Visibility Settings, the following roles may also be able to view your assigned track and level:
Track Admins
Managers
Manager of managers

For additional questions on who has visibility into your growth areas, we recommend reaching out to your Admin or HR team directly.

### How to Respond to Career Vision Exercises

Career vision exercises allow employees to engage in longer-term career planning exercises alongside their manager. Your account admin will create and assign your organization vision exercises that you can respond to, and you can work with your manager to define your career aspirations. Your manager may also create additional exercises just for your team.

Before you start

Note that managers will not be notified that an exercise has been responded to and published. Once your career vision exercise is published, your manager will be able to view your response.

Respond to a career vision exercise

Step 1: Navigate to People>My profile>Grow.

Step 2: Under Career vision, select a prompt and select Add response.

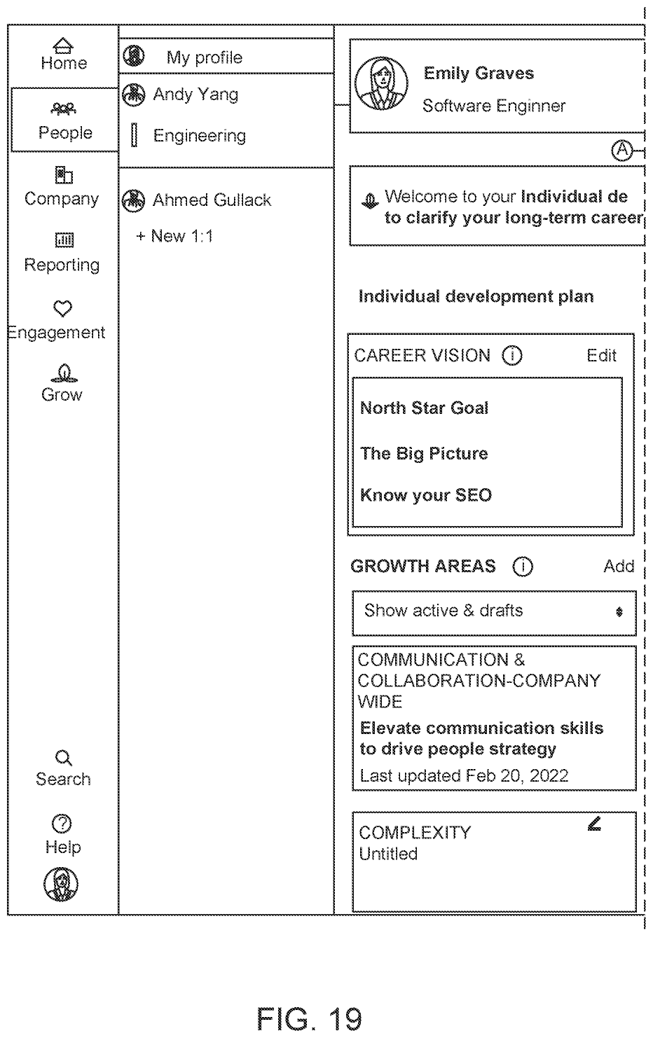

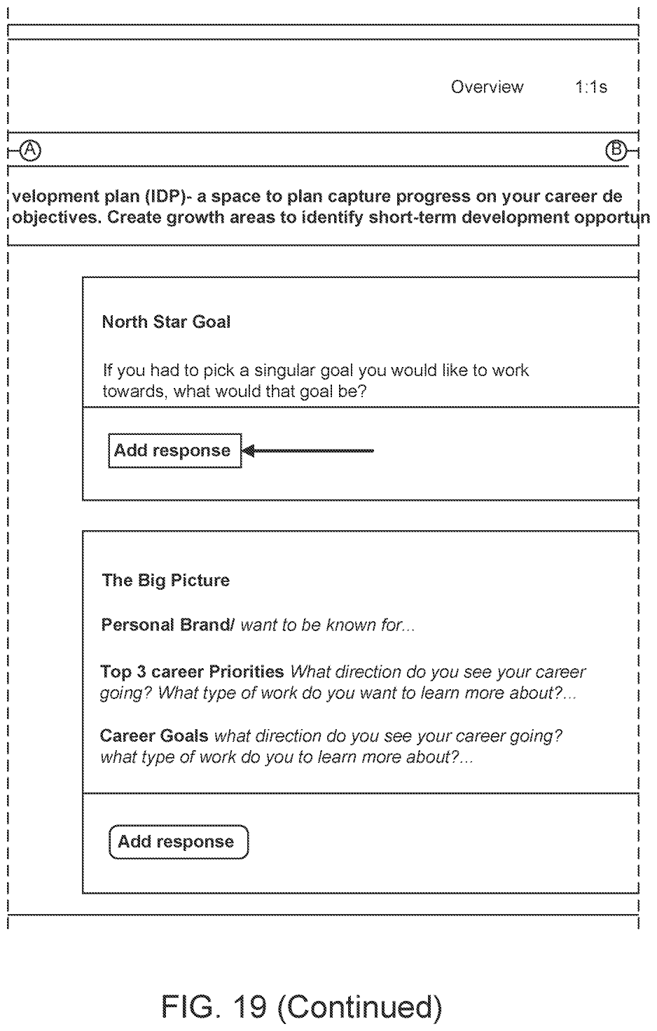

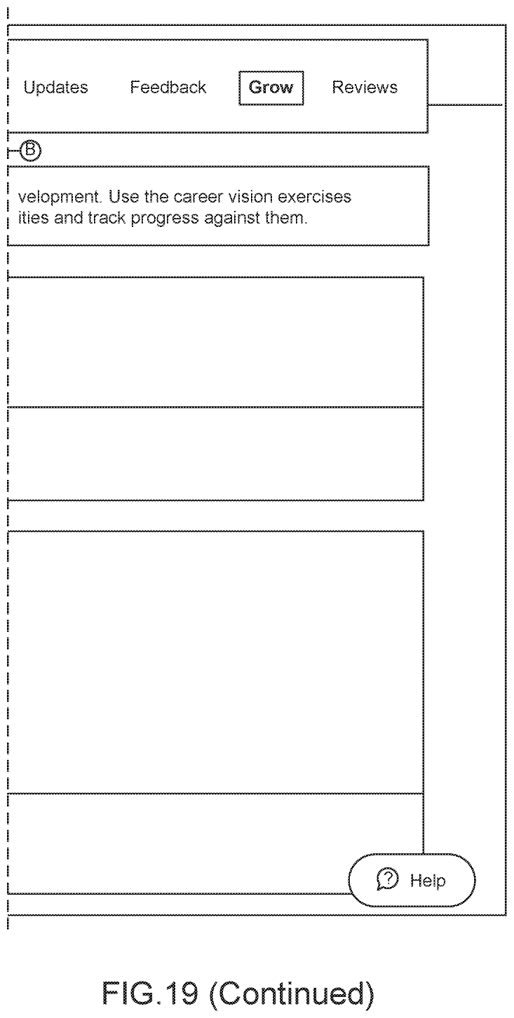

FIG. 19 is a schematic demonstrating how to navigate a user interface to respond to a career vision exercise.

Step 3: Within the textbox, add your response. Text will save automatically and will not be visible until you decide to publish.

Step 4 (optional): Add a private note by selecting+Add private notes. Private notes are only visible to you and not your manager or admins.

Step 5: Select Publish.

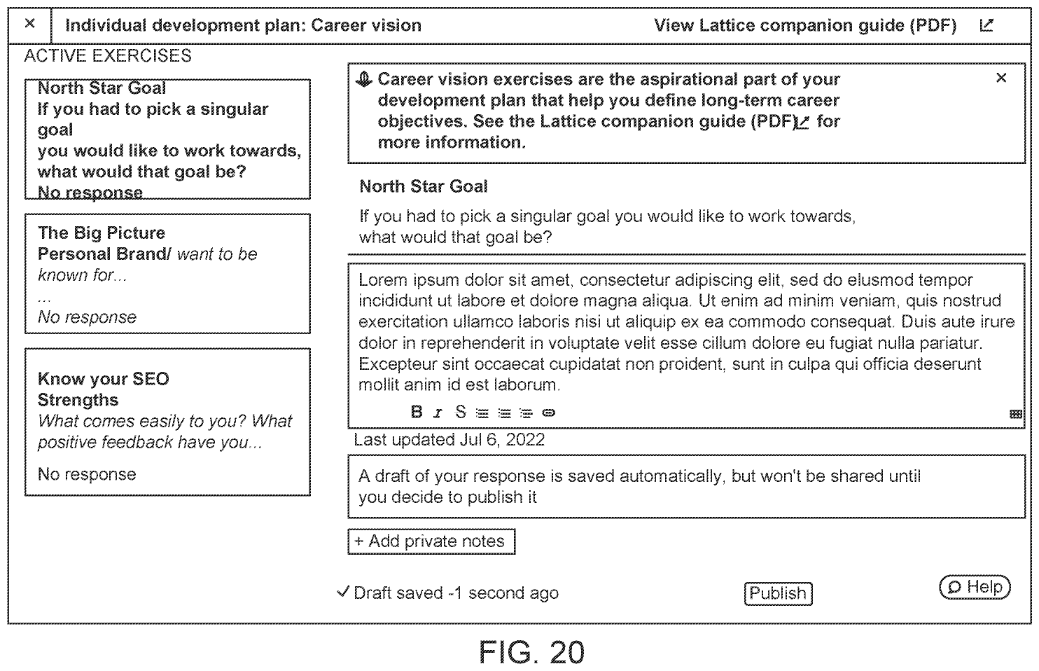

FIG. 20 is a schematic of a user interface displaying a text box for receiving a response to a career vision exercise.

### How to View Your Career Vision Responses

Career vision exercises help capture your long-term career goals via exercise responses you can share with your managers. Lattice allows you to access your active and inactive exercise responses any time once published.

Before you start

Career vision responses can be viewed by the responder, their direct manager, admins, and Grow custom role owners.

View your career vision responses

Step 1: Navigate to People>My profile>Grow.

Step 2: Under Career vision, select a prompt to access your response.

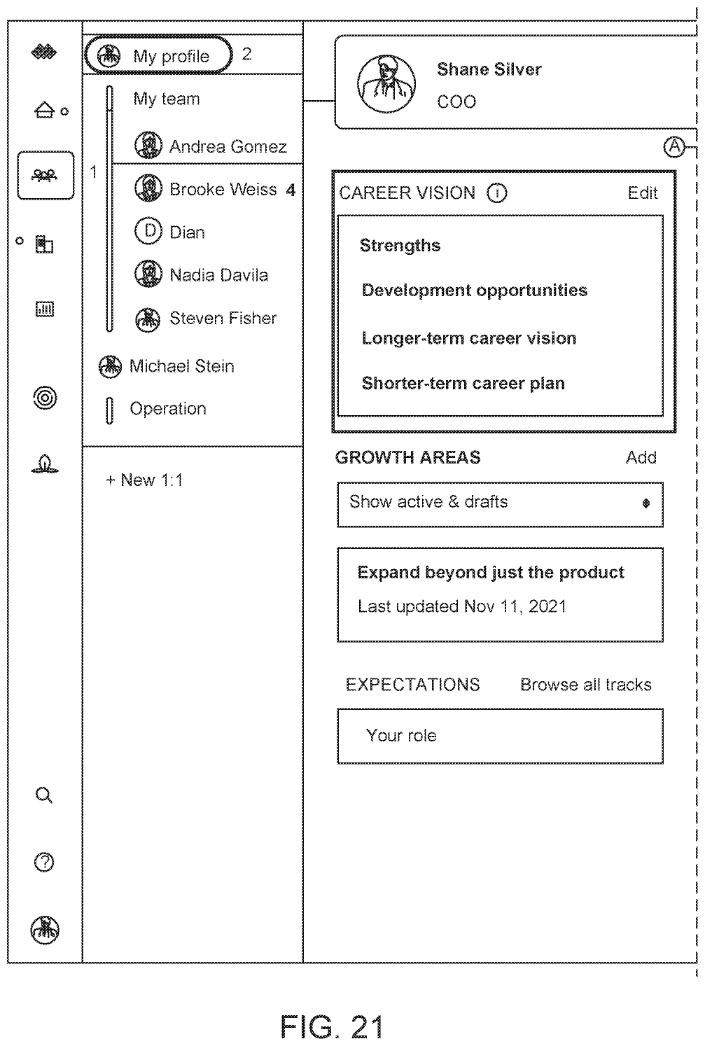

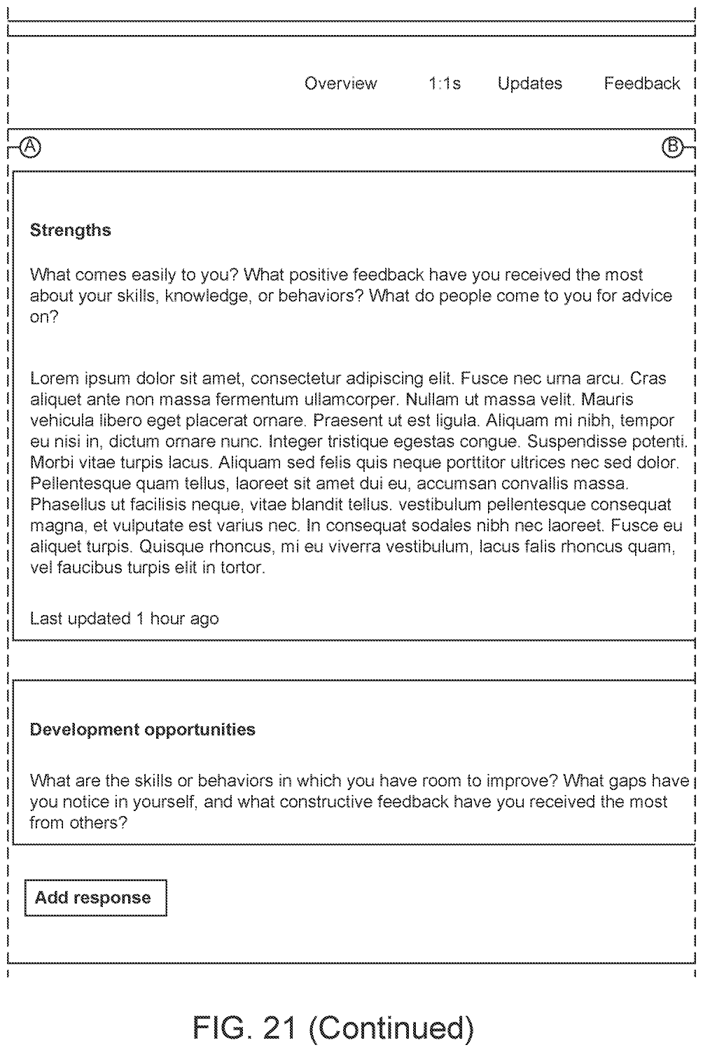

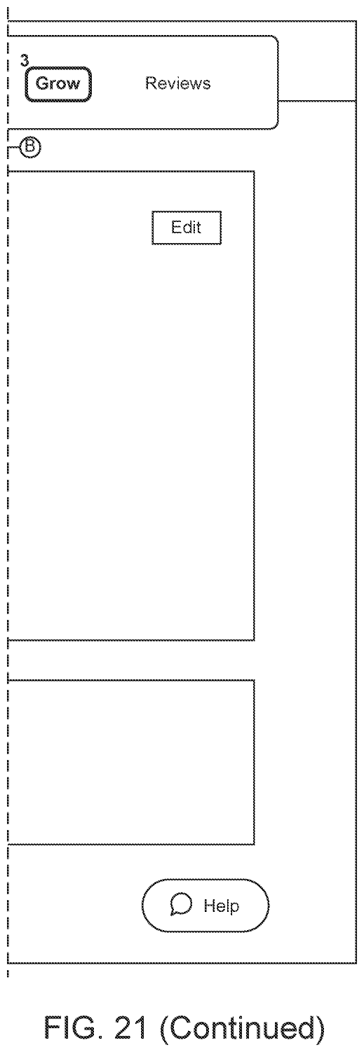

FIG. 21 is a schematic demonstrating how to navigate a user interface to view a user's career vision responses.

How to View Your Inactive Career Vision Responses

Career vision exercises help capture your long-term career goals via exercise responses you can share with your managers. Lattice allows you to access your active and inactive career vision responses at any time once published.

Before you start

Inactive exercises have been disabled and hidden by your account admin. Managers can also disable and hide team-specific exercises they have created. However, if you have already published a response, the exercise and your response will stay visible to you.

Inactive exercises are only visible within the takeover view and not within the Grow tab. You will be unable to edit inactive career vision responses.

View your inactive career vision responses

Step 1: Navigate to People>My profile>Grow.

Step 2: Under Career vision, select Edit or Add response next to any prompt to open the takeover view.

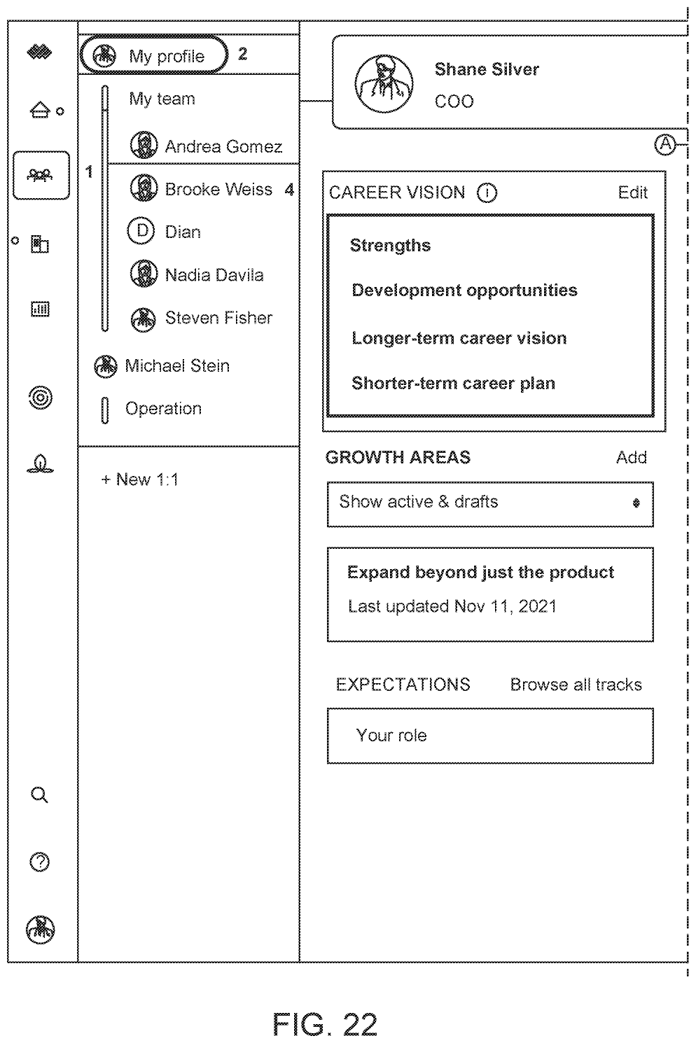

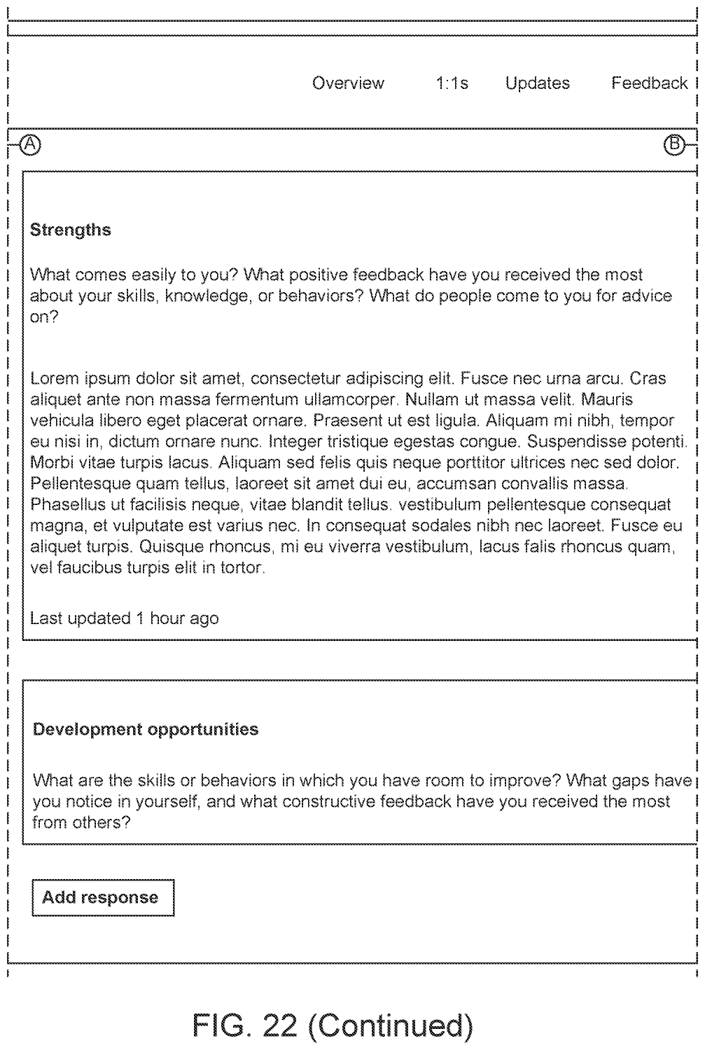

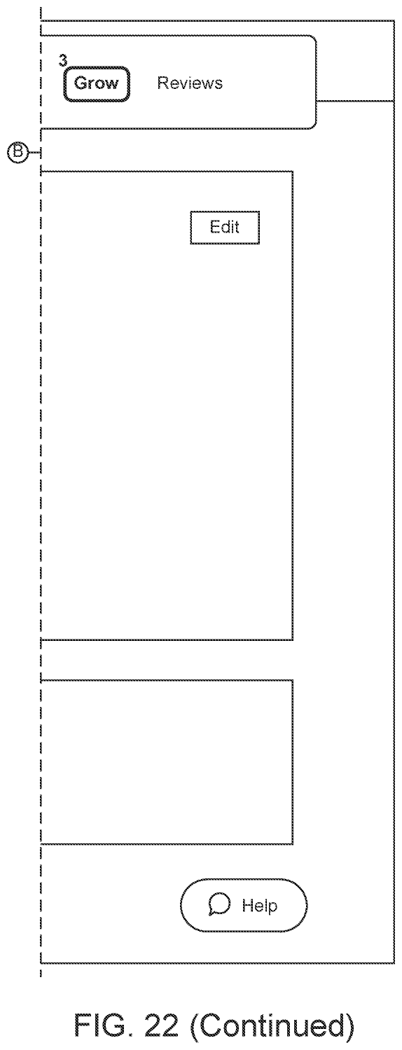

FIG. 22 is a schematic demonstrating how to navigate a user interface to view a user's inactive career vision responses.

Step 3: Within the takeover view, select your inactive exercise prompt under Inactive exercises.

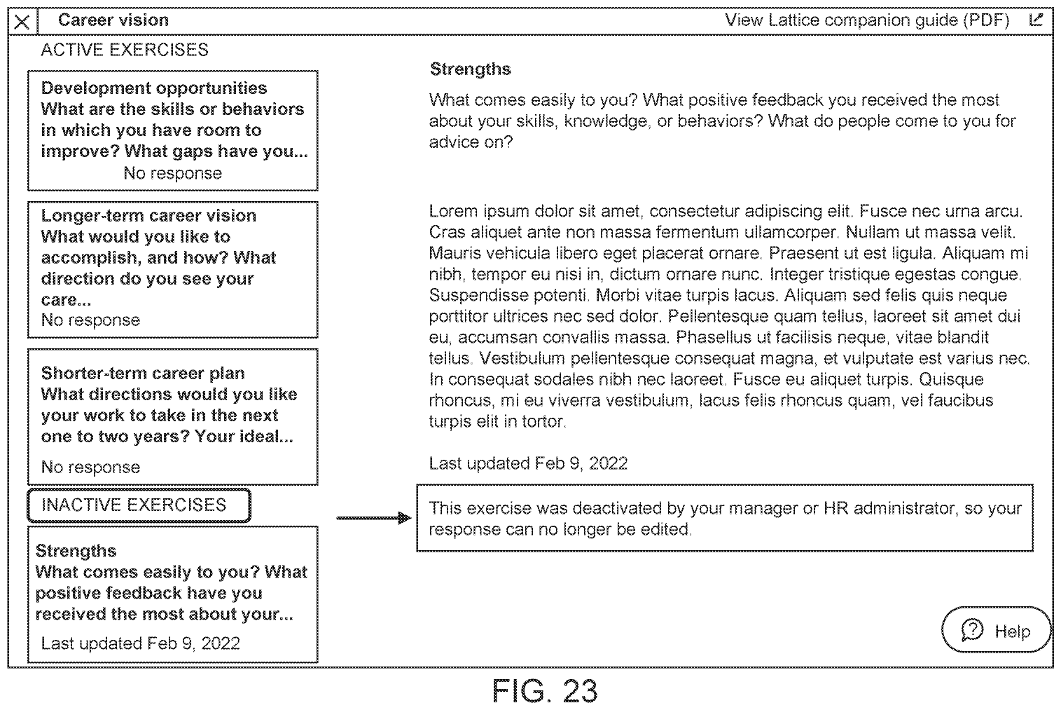

FIG. 23 is a schematic of a user interface displaying a user's inactive career vision responses.

How to Edit Your Career Vision Response

Career vision exercises allow you to engage in longer-term career planning exercises alongside your manager. After publishing a response, you will always have the opportunity to edit your responses within active exercises.

Before you start

Inactive career vision exercises cannot be edited.

Note that managers will not be notified that an exercise has been published. Once your career vision exercise is published, your manager will be able to view your response.

Edit a career response

Step 1: Navigate to People>My profile>Grow.

Step 2: Under Career vision, navigate to the exercise you wish to edit and select Edit.

Step 3: Within the exercise response text box, update your response and select Publish.

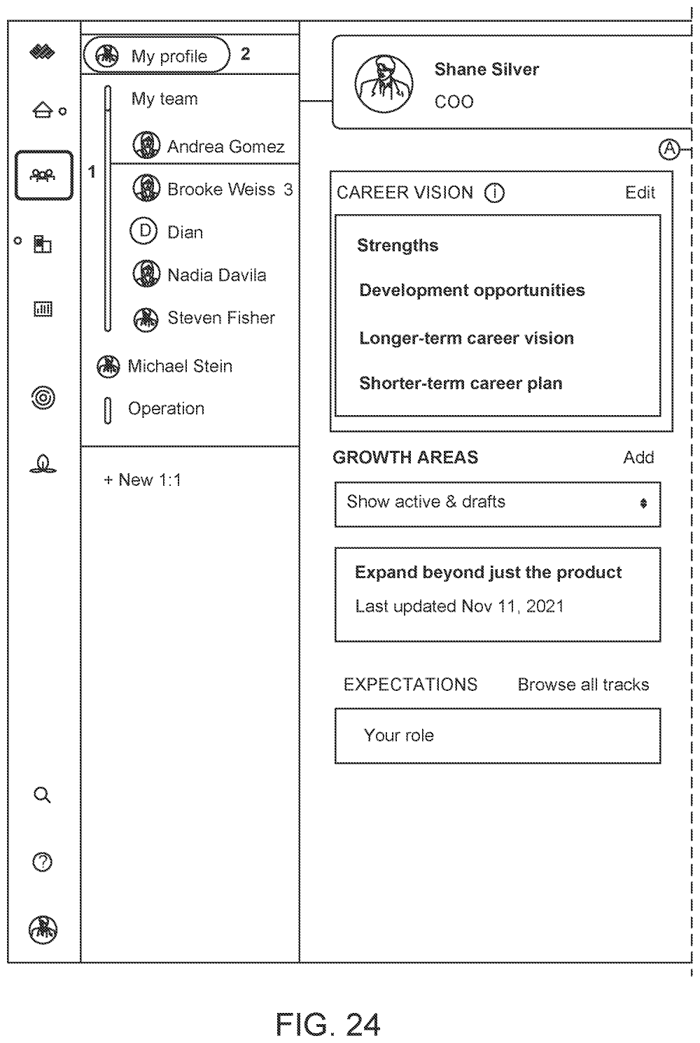

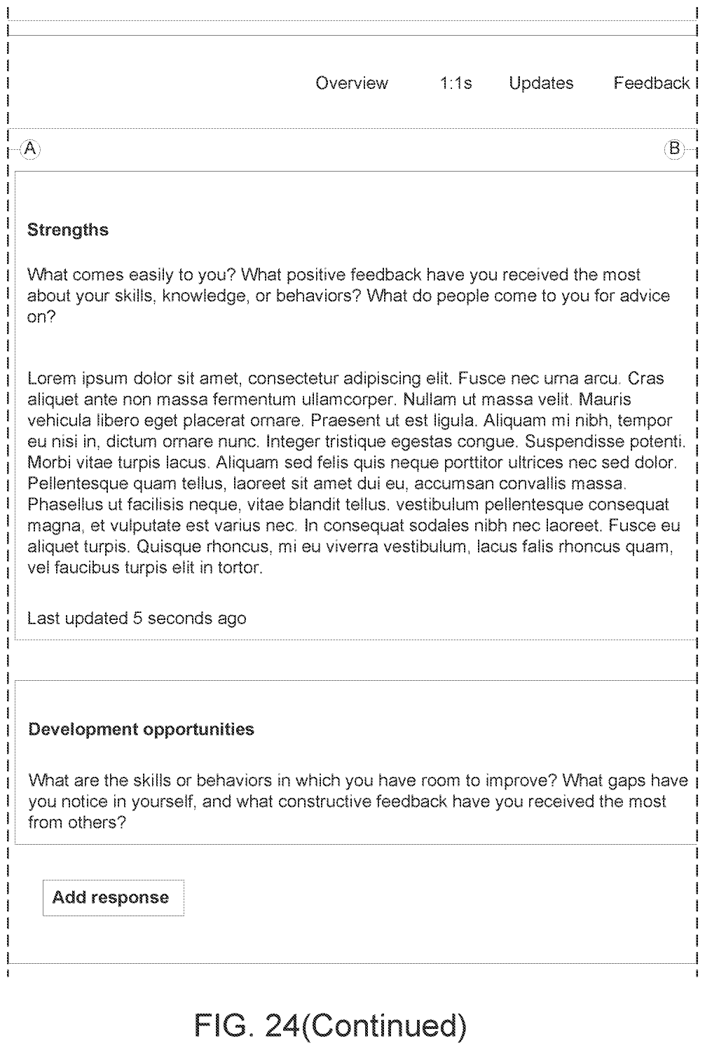

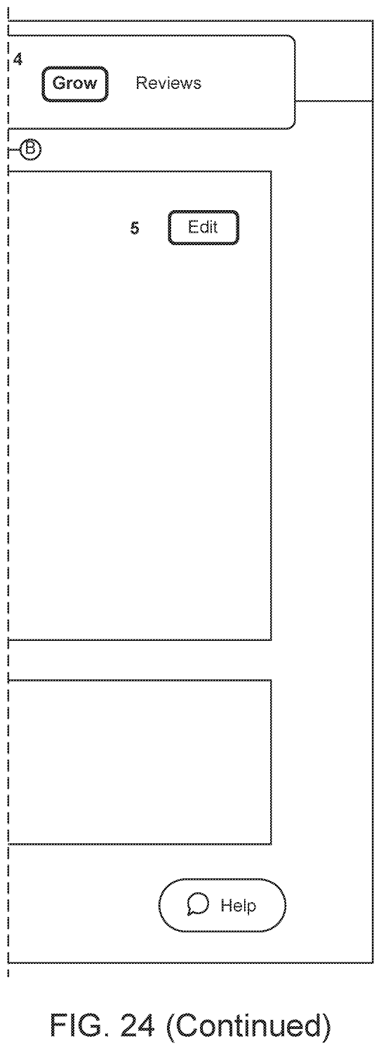

FIG. 24 is a schematic demonstrating how to navigate a user interface to edit a user's career vision response.

How to Update growth area Progress

Once you have created a growth area, it is essential to continue to update it with any progress you have made. Your updates will be visible to your manager in one-on-ones and during review cycles.

Update Growth Areas

Step 1: Navigate to the People page>your Profile>Grow.

Step 2: Under growth areas, select the growth area you would like to update.

Step 3: Select Update growth area.

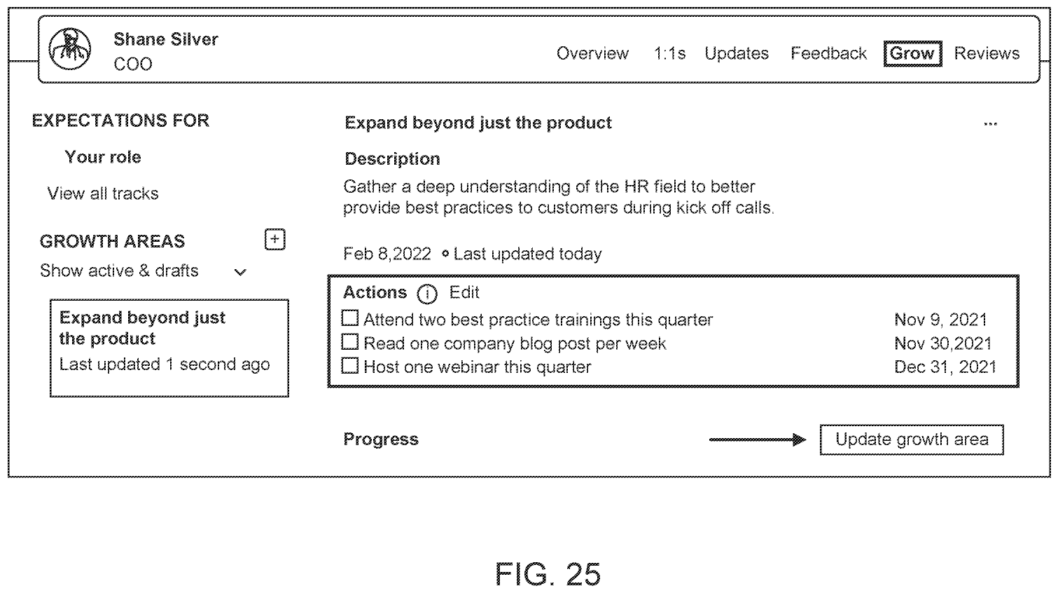

FIG. 25 is a schematic demonstrating how to navigate a user interface to update a user's growth areas.

Step 3: Check off any action items completed and add your update by clicking Update growth area.

Note: There are no notifications lied to actions at this time.

Step 4: Add an update to the text box and select Post update.

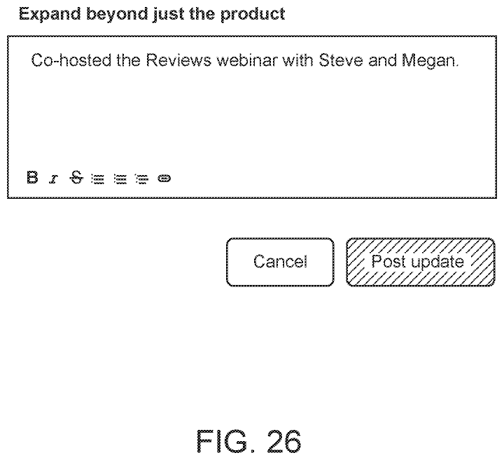

FIG. 26 is a schematic of a user interface displaying a pop-up window containing a text box for receiving an update to a growth area.

To learn how to update your growth plan within a 1:1, check out How to Update Your growth areas within a 1:1.

How to Edit or Delete a growth area update

Once you have updated a growth area, Lattice provides you the option to edit or delete these updates. Growth area updates will be visible to your manager in 1:1s and during review cycles.

Before you start

Growth area updates can only be edited or deleted by the individual who submitted them.

Edit or Delete Growth Areas

Step 1: Navigate to your active growth areas directly from your Profile Card on the Home page.

Step 2: Select your growth area and click the ellipsis ( . . . ) next to the update you wish to edit or delete.

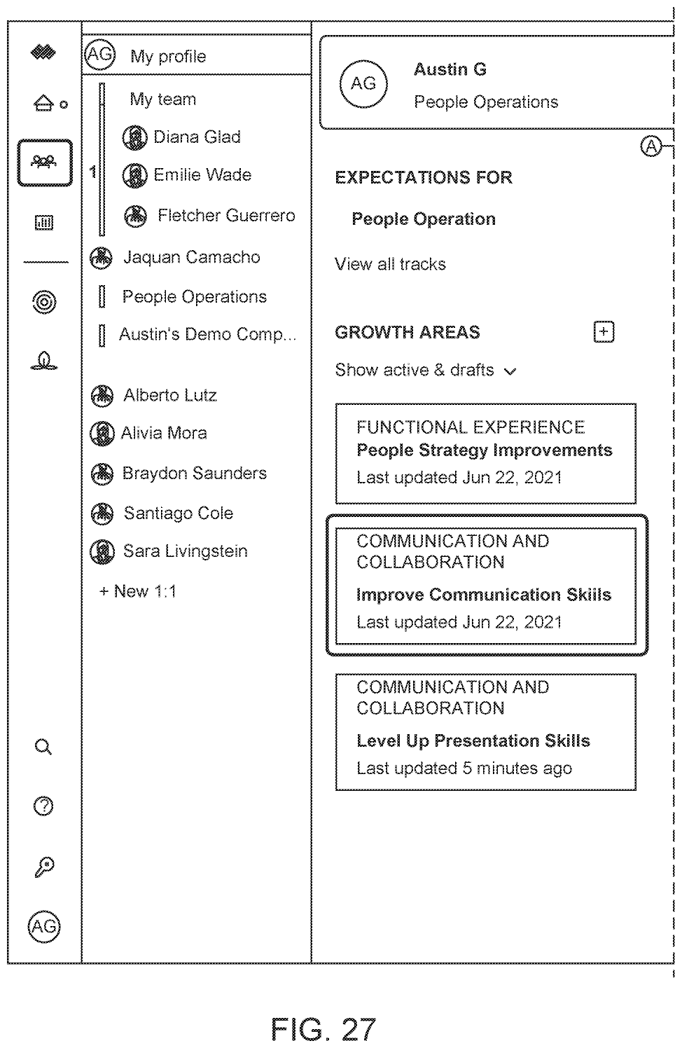

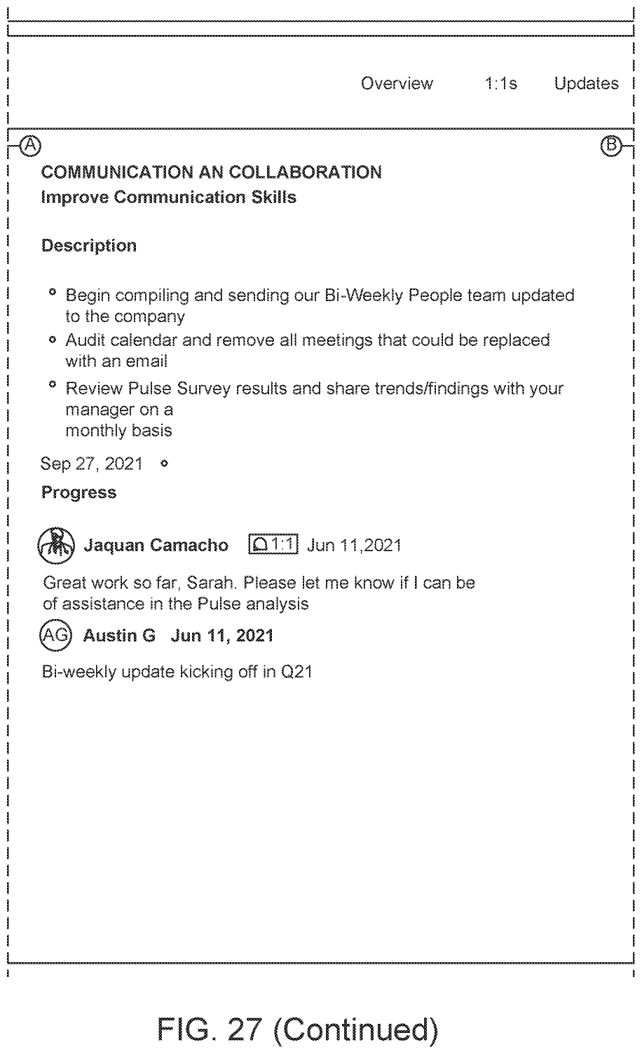

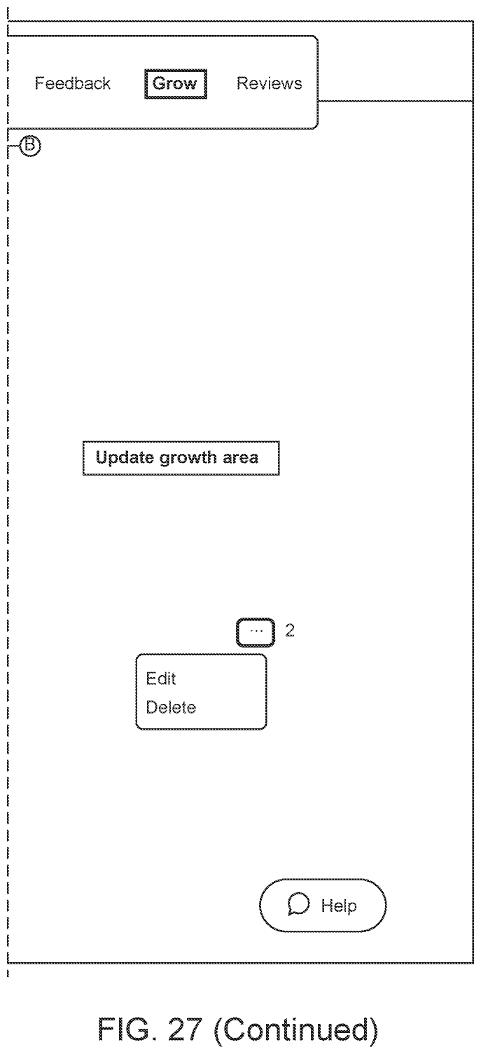

FIG. 27 is a schematic demonstrating how to navigate a user interface to edit or delete a user's growth area.

Step 3: In both scenarios, you will be presented with a pop-up modal to confirm your selection.

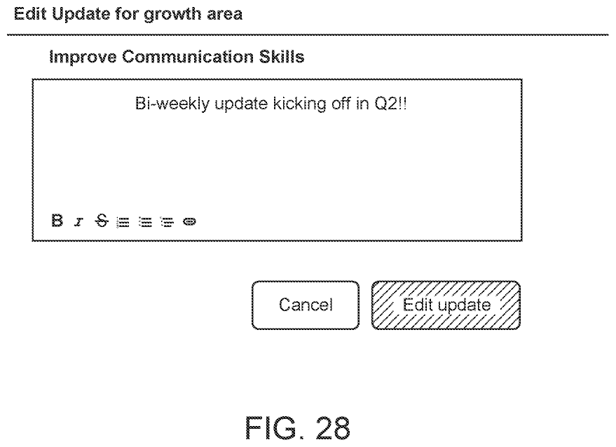

FIG. 28 is a schematic of a user interface displaying a pop-up window containing a text box for receiving an edit to an update for a growth area.

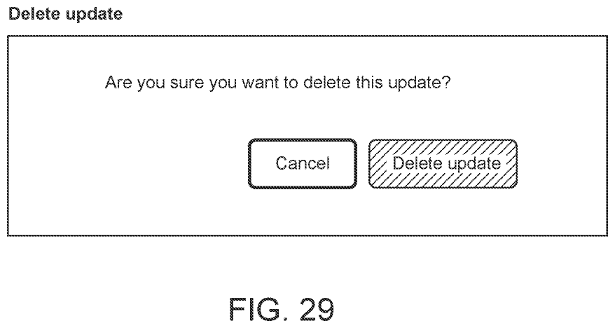

FIG. 29 is a schematic of a user interface displaying the option to delete a growth area.

How to Edit a Growth Area

Once you have created or been assigned a growth area, you will be able to edit the name, description, growth period, and competency associated with this growth area. Please note, managers do not receive a notification when a direct report has edited their growth areas.

Edit a Growth Area

Step 1: Navigate to your active growth areas directly from your Profile Card on the Home page.

Step 2: Select your growth area>ellipsis ( . . . )>Edit.

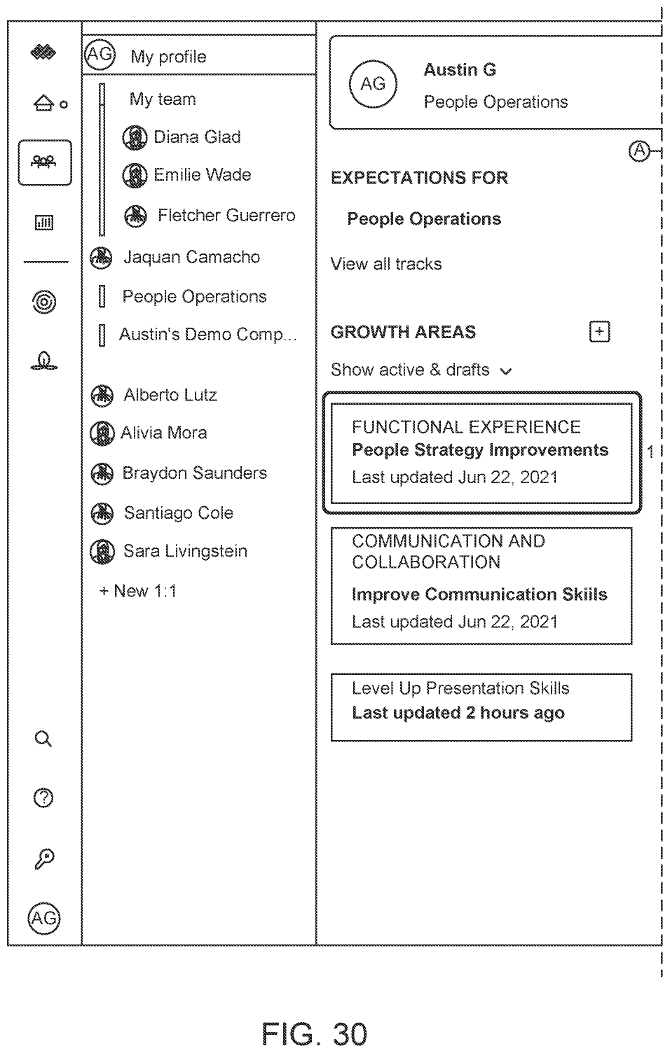

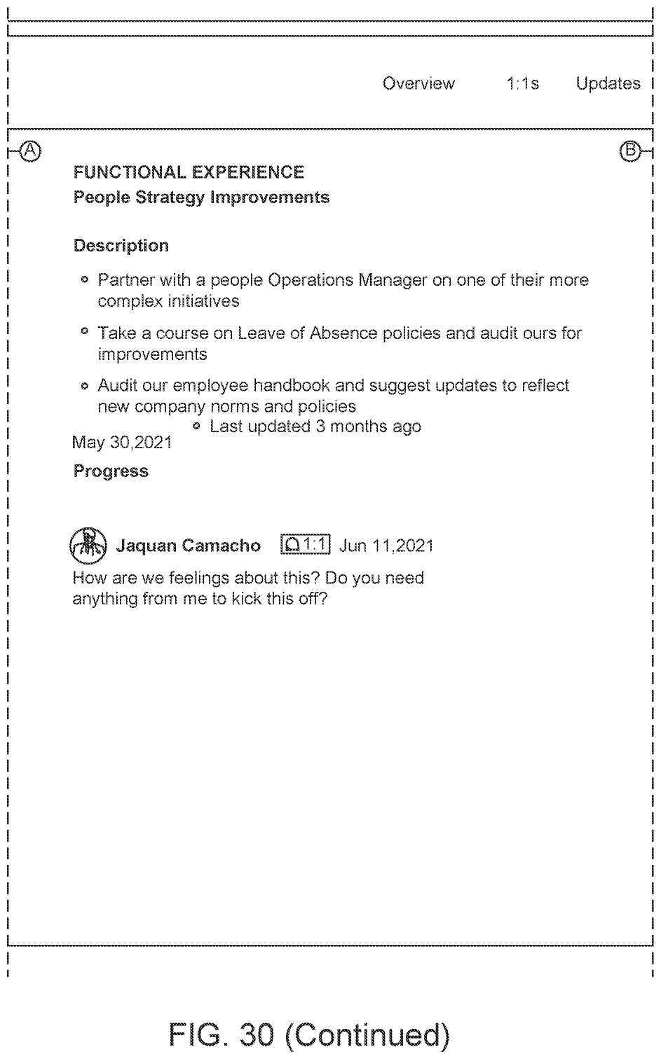

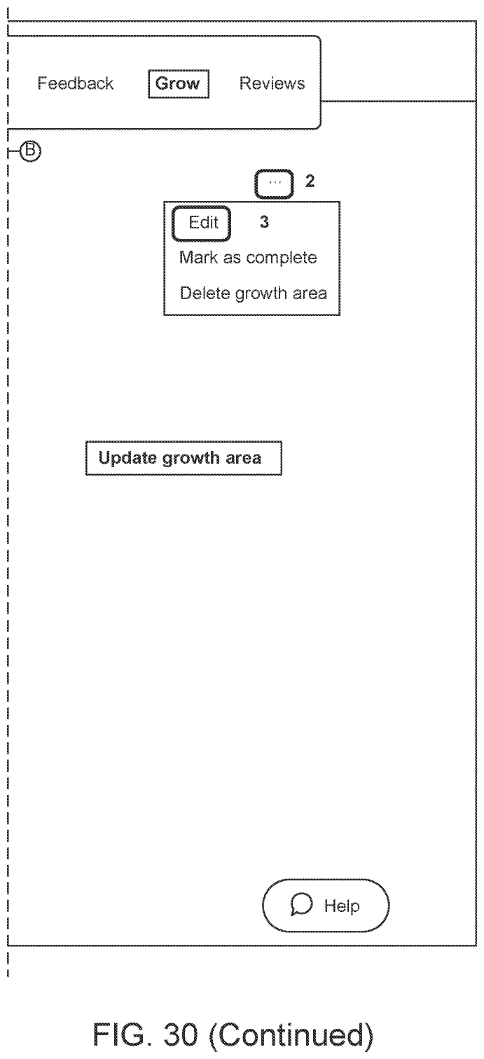

FIG. 30 is a schematic demonstrating how to navigate a user interface to edit a growth area.

Step 3: From here, you will be able to edit the title, description, and growth period for your growth area.

Change Linked Competency in a Growth Area

Step 1: When editing a growth area, click the change icon [symbol] to adjust the linked competency.

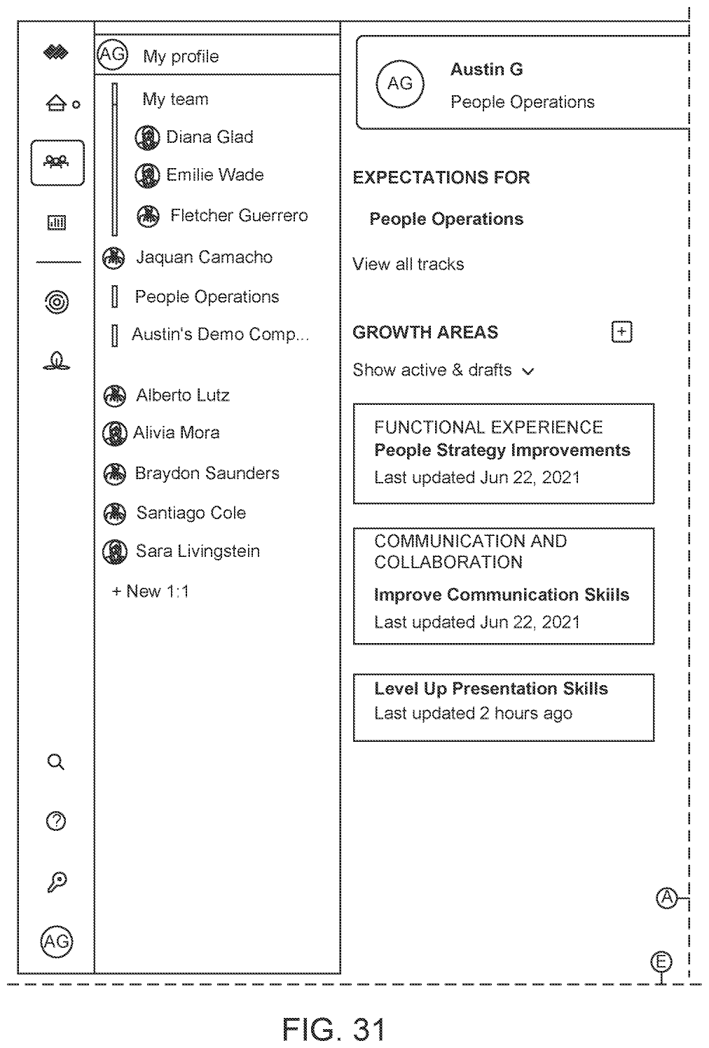

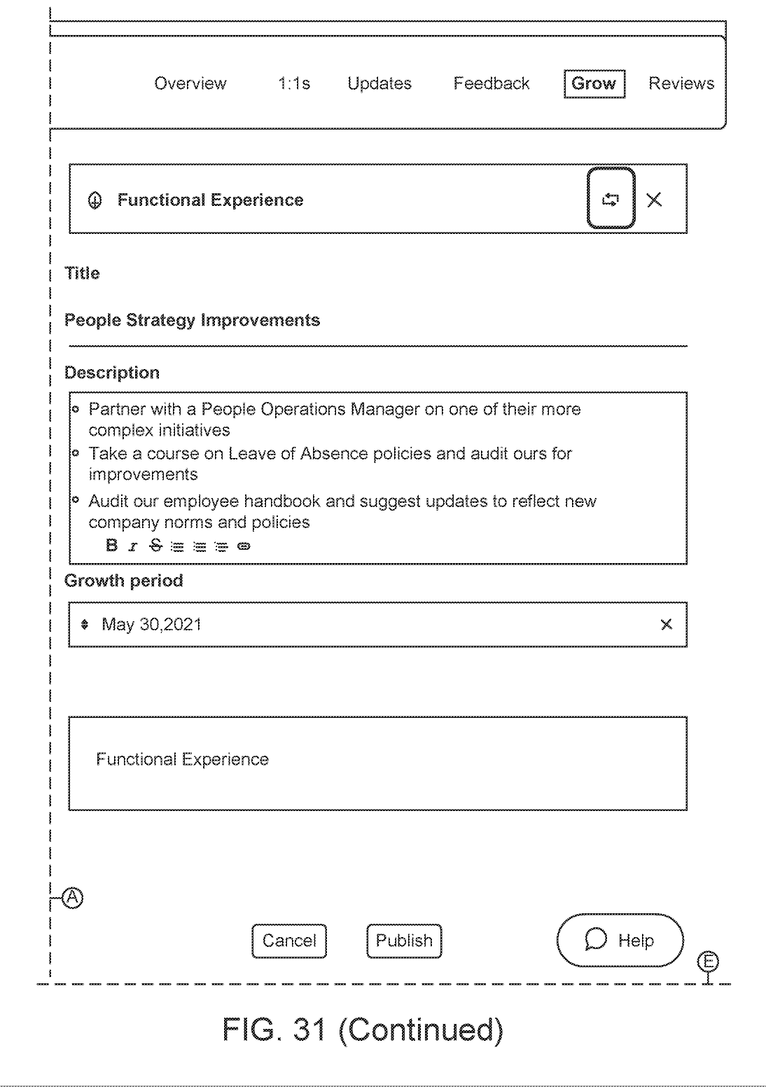

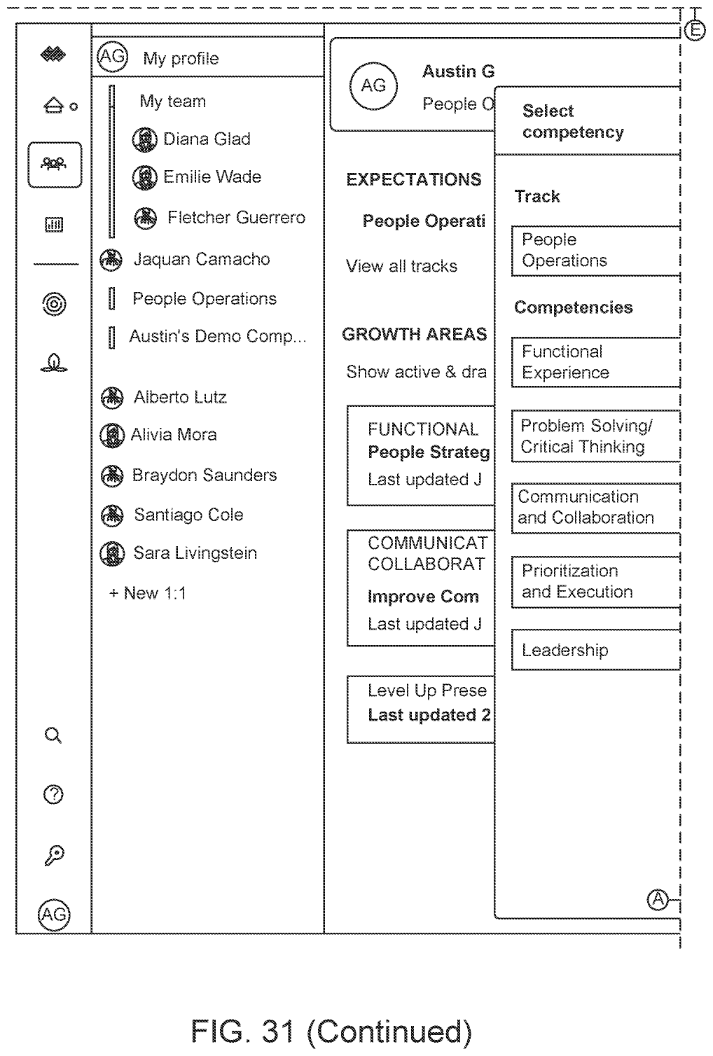

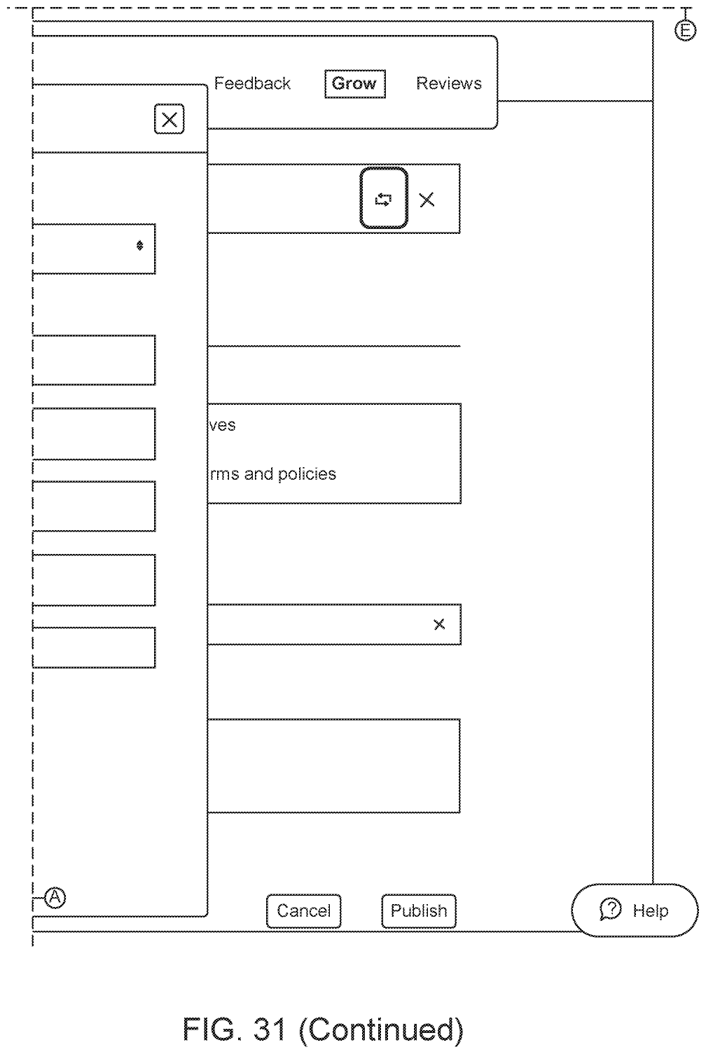

FIG. 31 is a schematic demonstrating how to navigate a user interface to change a growth area competency while editing a growth area. How to Mark a Growth Area as Complete

Once you have made the desired progress on your growth area, you may want to mark the growth area as complete. Marking the area as complete allows you to keep your plan updated so you and your manager can focus on areas you are currently working on concerning your growth.

Before you start

Notifications will not be sent to your manager when a growth area is marked as complete.

Mark a growth area as complete

Step 1: Navigate to your active growth areas directly from your Profile Card on the Home page.

Step 2: Select your growth area>ellipsis ( . . . )>Mark as complete.

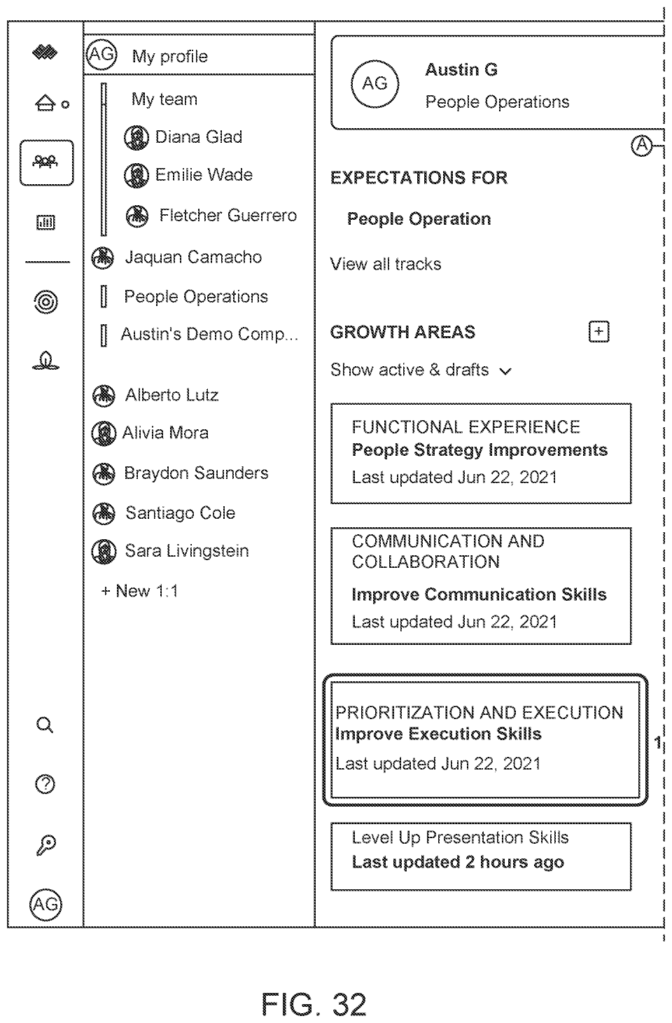

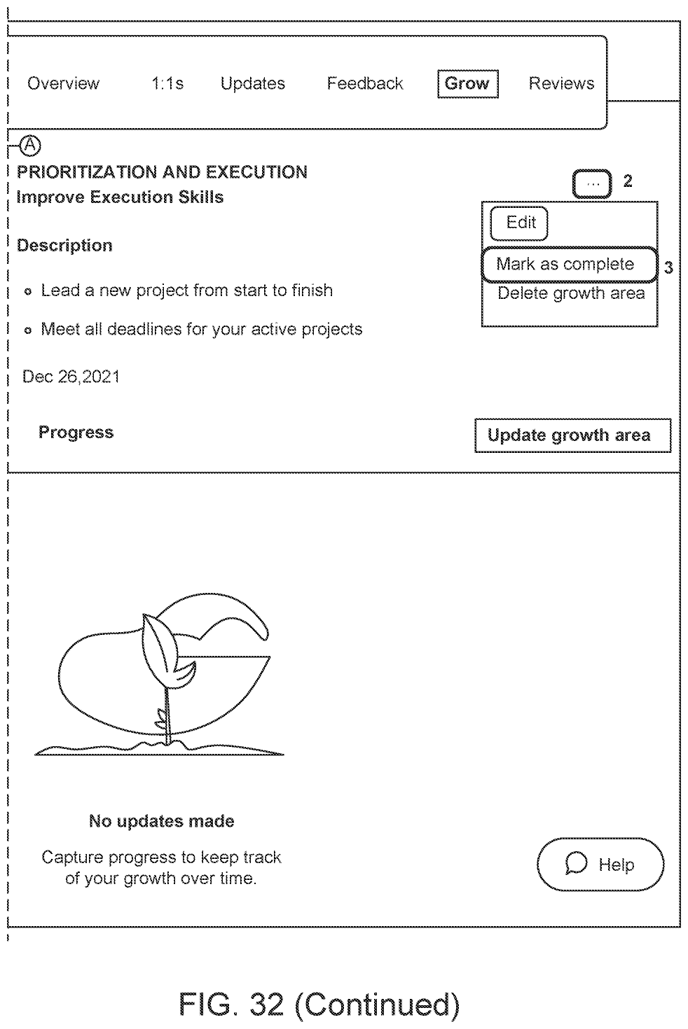

FIG. 32 is a schematic demonstrating how to navigate a user interface to mark a growth area as complete.

Note: You can reactivate a previously completed growth area by following the same steps above on a growth area that's already been marked complete.

View completed growth areas

To view growth areas marked as complete, click Show completed filter underneath the growth areas dropdown.

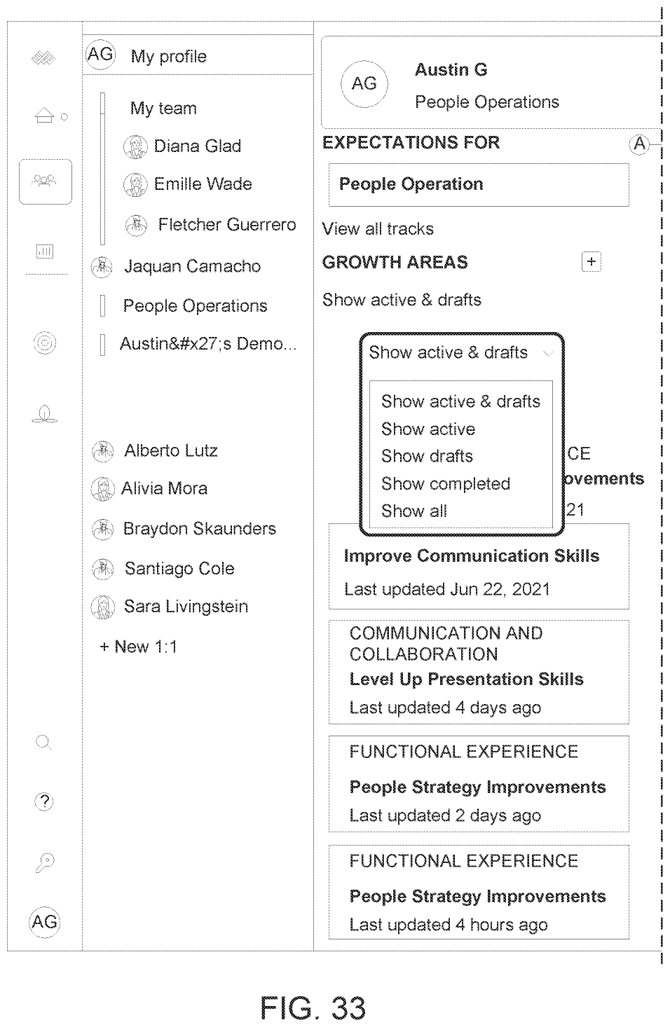

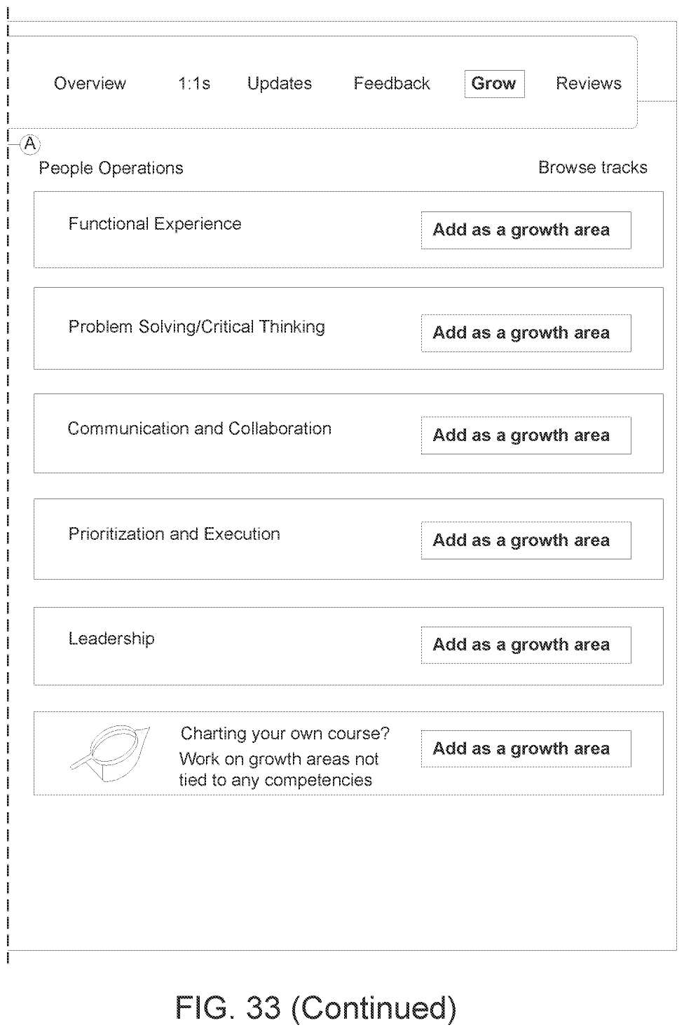

FIG. 33 is a schematic demonstrating how to navigate a user interface to view completed growth areas.

### How to Link Competencies to Feedback Requests

Anyone who requests feedback for themselves or a direct report can tie their feedback to a particular competency in their assigned growth track. Linking to a competency allows the feedback writer to refer to the competency by viewing the expectations when responding to the request.

Before you start

You can link a maximum of one competency to each feedback request. Only competencies within the employee's assigned track will be available to attach.

Link a competency to a feedback request

Step 1: Navigate Home page>Give Feedback.

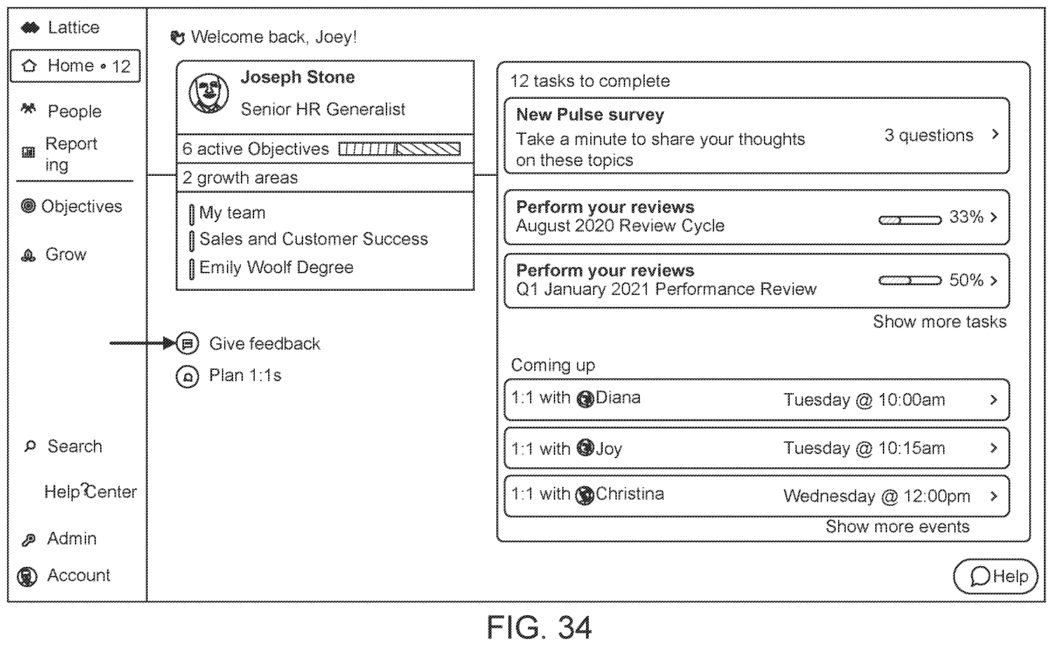

FIG. 34 is a schematic demonstrating how to navigate a user interface to link a competency to a feedback request.

Step 2: The Feedback modal will appear—Enter the Request Feedback tab.

Step 3: Input the request recipients, visibility, and what you want feedback on.

Step 4: Under Which competency is this related to?, select the competency related to your request. This field will only appear after selecting the recipient of the feedback.

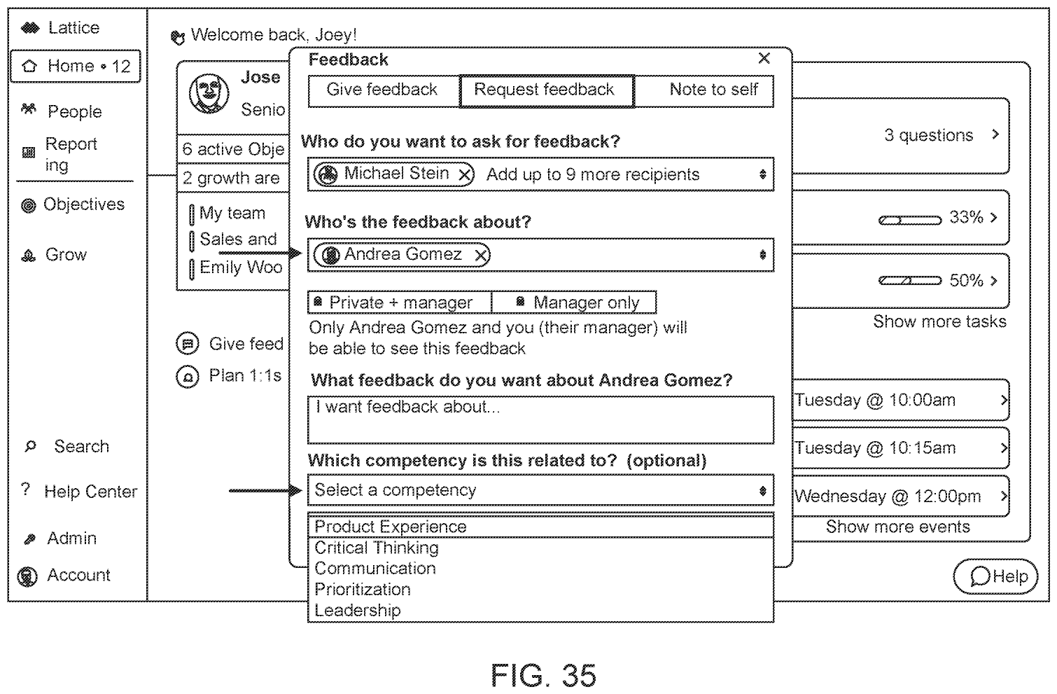

FIG. 35 is a schematic demonstrating how to navigate a user interface to link a competency to a feedback request.

View from feedback request recipient

Once feedback is requested, the user will see the feedback request via email and within the Feedback module:

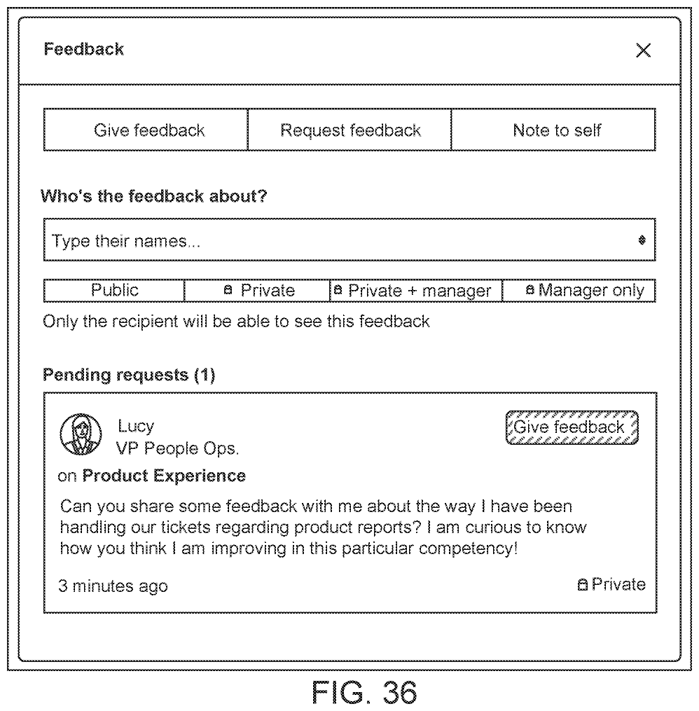

FIG. 36 is a schematic of a user interface displaying a feedback request within the feedback module.

When the recipient clicks on Give feedback, they will be able to assess the employee's competencies on the right-hand context panel as they provide their feedback.

FIG. 37 is a schematic of a user interface displaying a text box within the feedback module to receive feedback in response to a request.

Link a Review Response to Your Growth Area

Employees can link review responses to their growth area directly from their review cycle. Note that responses can be added to multiple growth areas.

Navigate to People>My profile>Reviews.

Select View review packet next to the desired review cycle to be taken to your review packet.

Select+Add to Growth Area under the desired response.

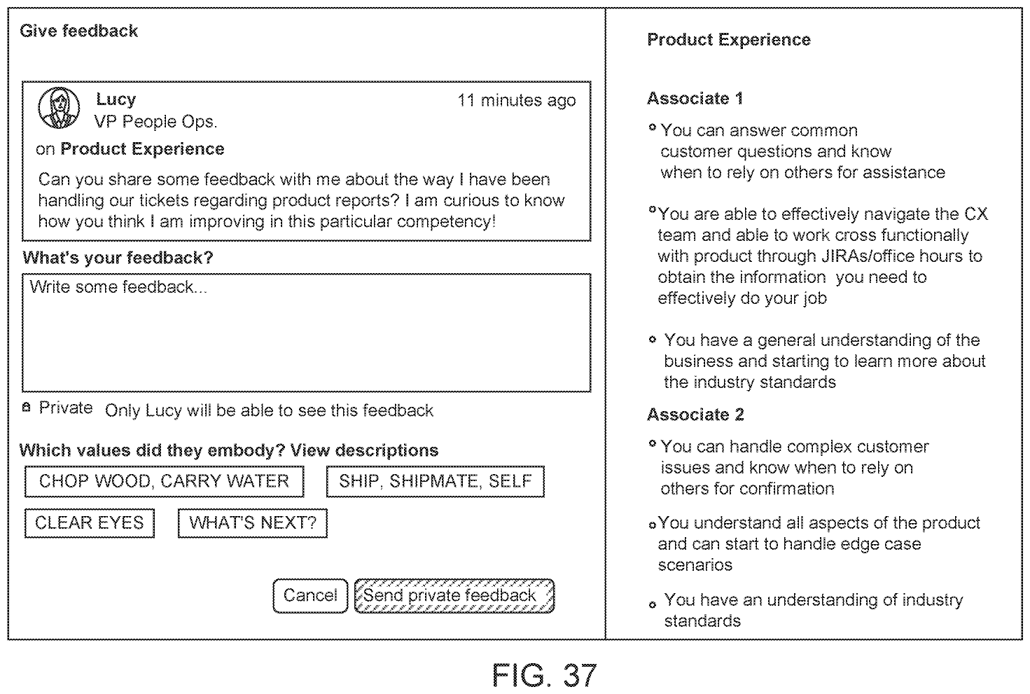

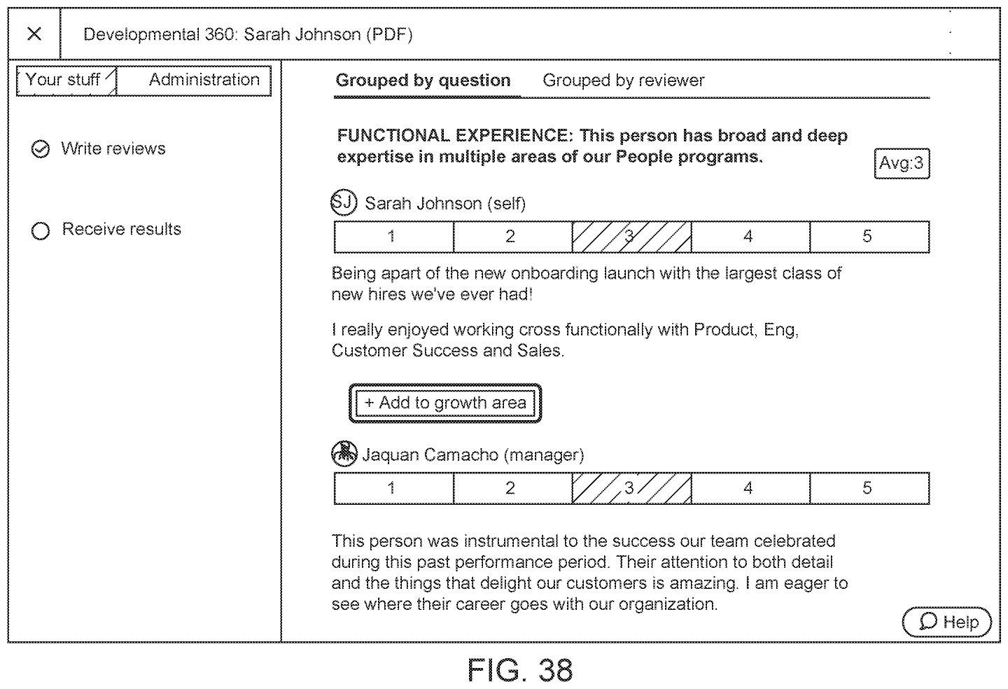

FIG. 38 is a schematic of a user interface displaying an add to growth area button for linking a review response to a growth area.

The growth area panel will appear—Select a growth area to attach or create a new growth area draft.

Select Add to growth area.

Create or edit your growth area and select Publish.

Unlink Review Responses from Your Growth Area

Employees can unlink review responses they or their manager have added to their growth areas.

Navigate to People>My profile>Grow.

Under growth areas, select the desired growth area.

Within the title card, select the ellipsis ( . . . )>Edit.

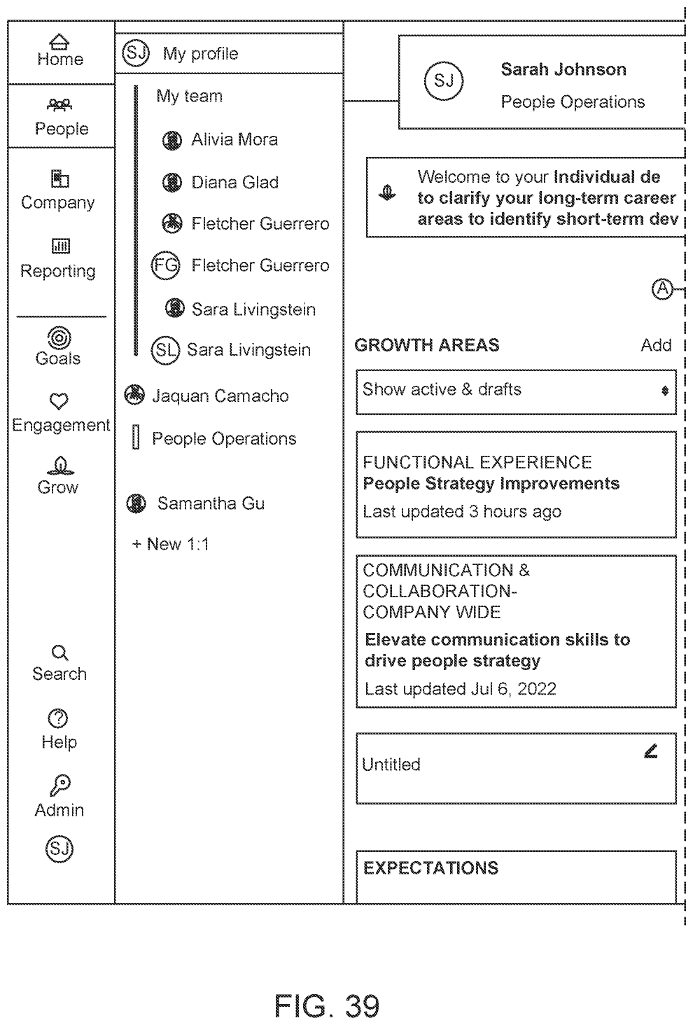

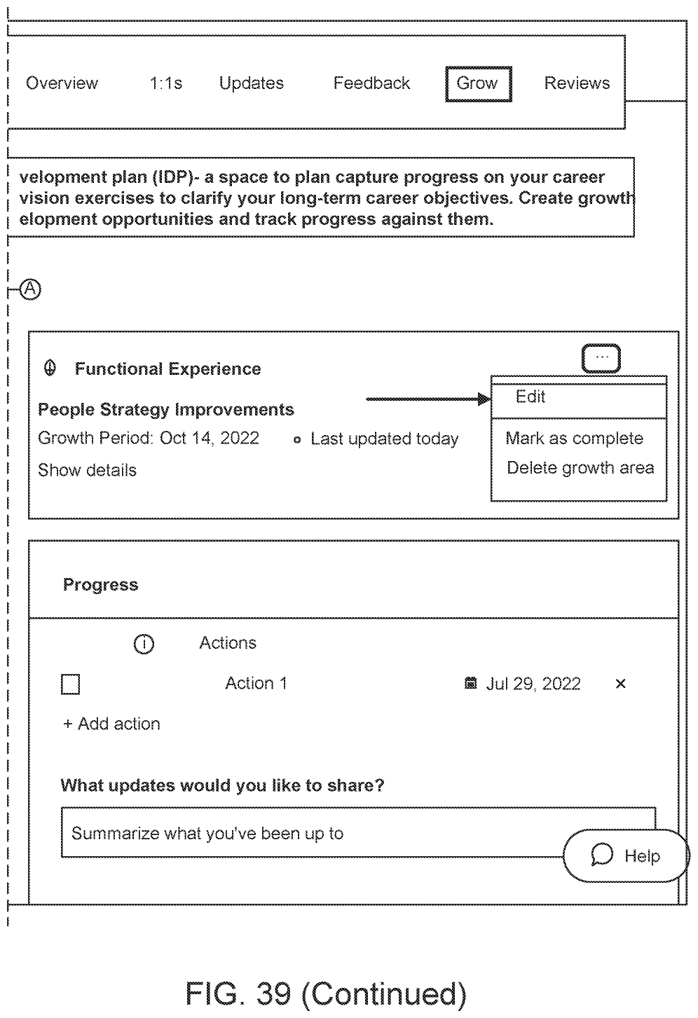

FIG. 39 is a schematic demonstrating how to navigate a user interface to unlink a review response from a growth area.

Under Reviews, navigate to the desired review response and select Remove from growth area.

Confirm by selecting Remove review.

Manager

How to Plan a Development 1:1 with Your Direct Report

Development 1:1s enable managers to facilitate developmental conversations with their direct reports. If enabled, managers can apply a 1:1 development template to make these conversations more impactful.

Note: Development 1:1s is only available for accounts that have purchased the Grow product. Please reach out to your account admin to confirm which products you have available.

Create a development 1:1

Step 1: Navigate to People>My team>Grow.

Step 2: Under Individual development plans, navigate to the desired direct report and select Plan development 1:1.

Note: If you do not have a 1:1 relationship with the direct report, Lattice will prompt you to set up a 1:1 via the 1:1 set up modal.

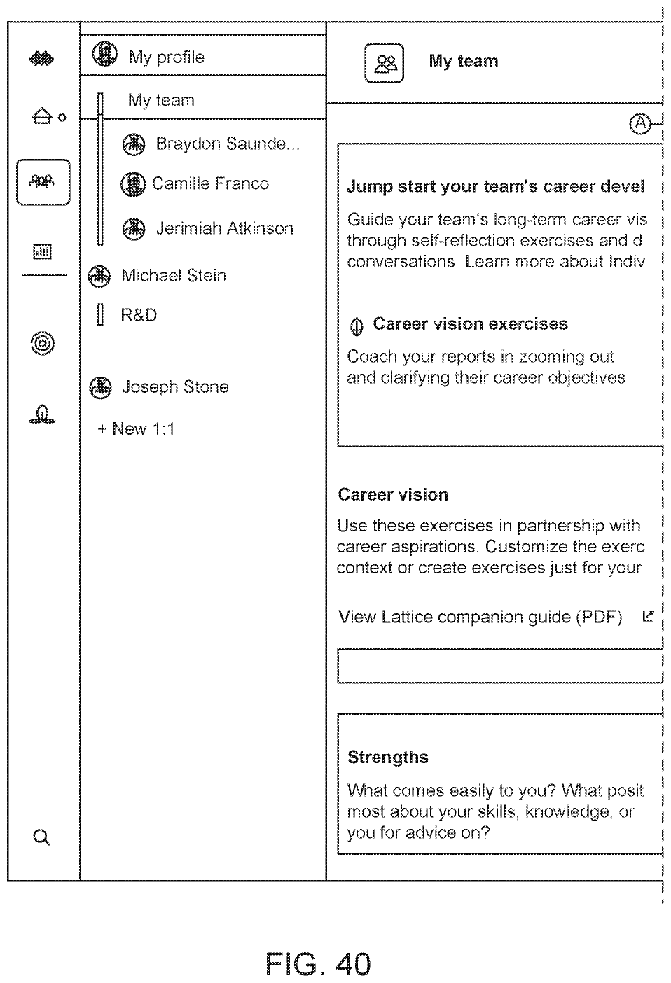

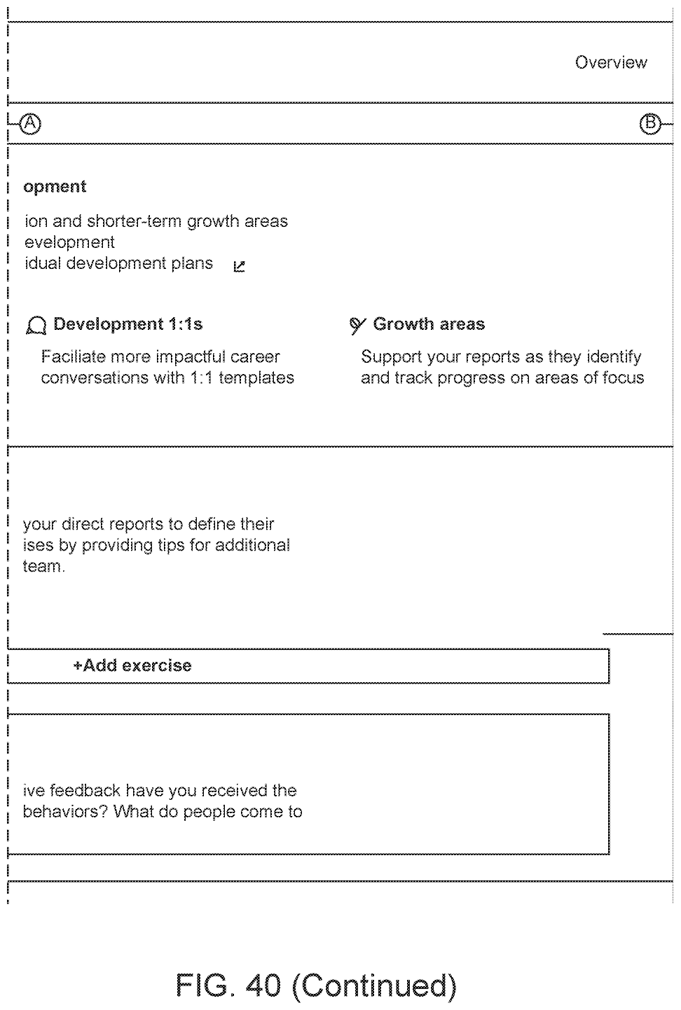

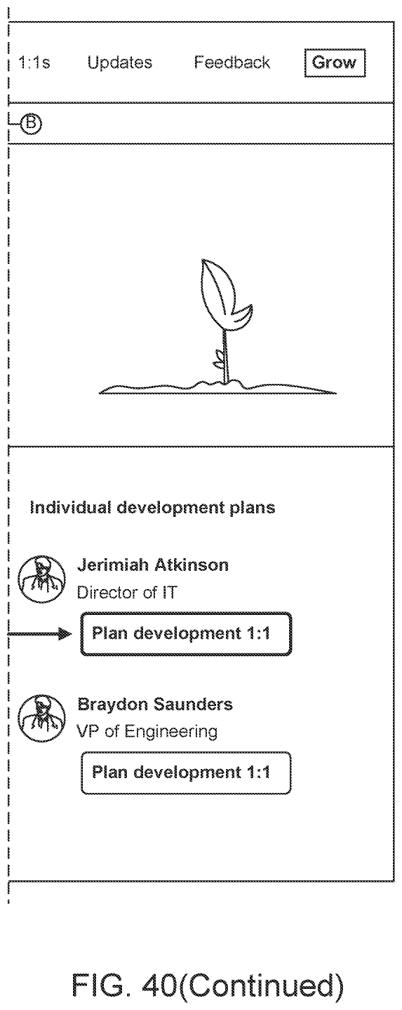

FIG. 40 is a schematic demonstrating how to navigate a user interface to create a development 1:1.

Apply a 1:1 development template to the 1:1

If your account admin has activated 1:1 company templates, you will have the option to apply a development template that includes agenda and action items to help drive the career development conversation with your direct report.

Note: Managers can only apply development templates. Unlike agenda templates, 1:1 development templates are not recurring. However, adding a development template will not override any recurring talking points.

Step 1: Within the development 1:1 agenda, navigate to the blue banner to view a preview of the available templates. Select Browse templates to view all templates.

Step 2: Navigate to the desired template and select Apply.

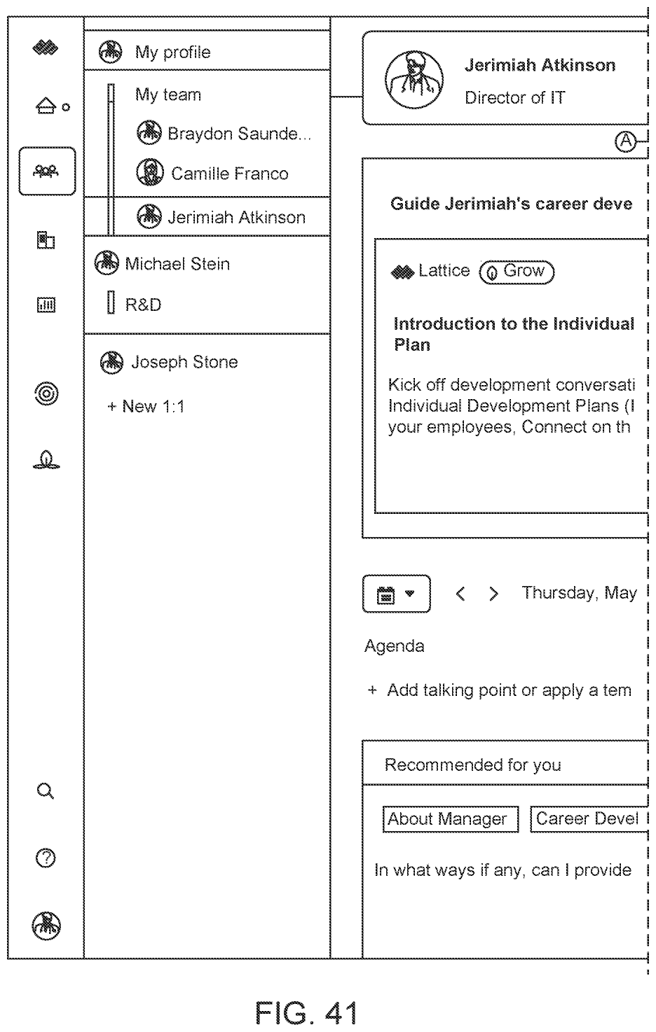

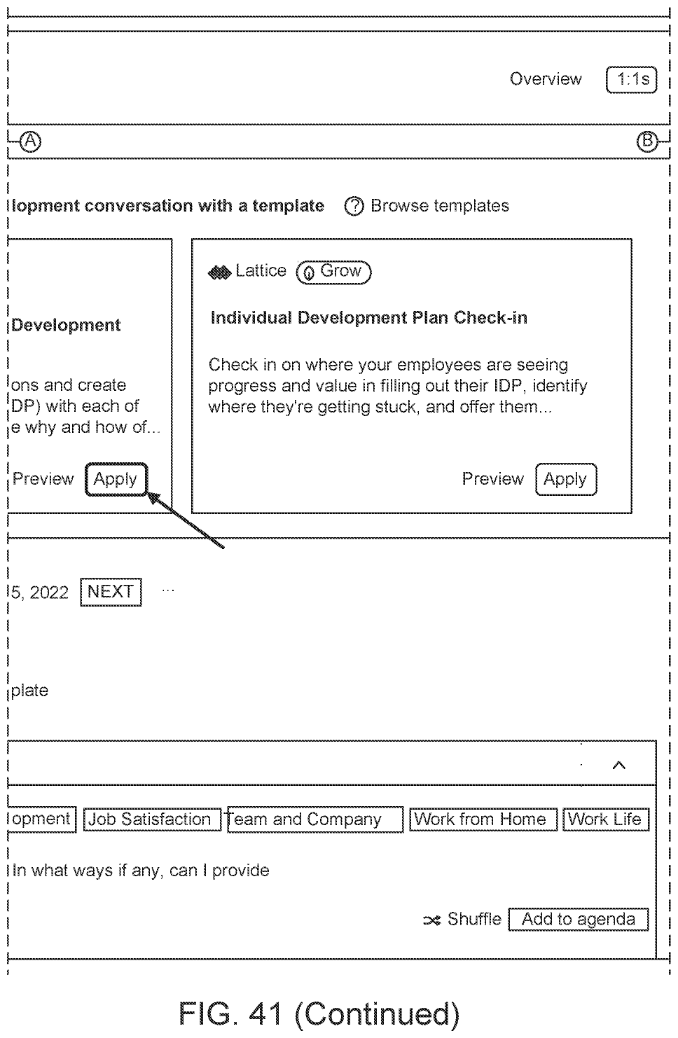

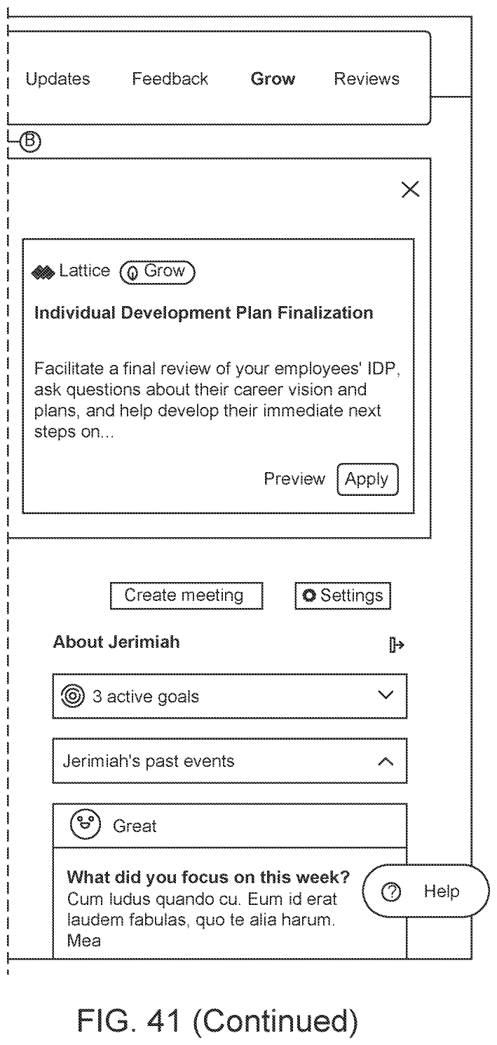

FIG. 41 is a schematic demonstrating how to navigate a user interface to apply a template to a development 1:1.

Step 3 (optional): Customize the agenda by adding or removing talking points and action items.

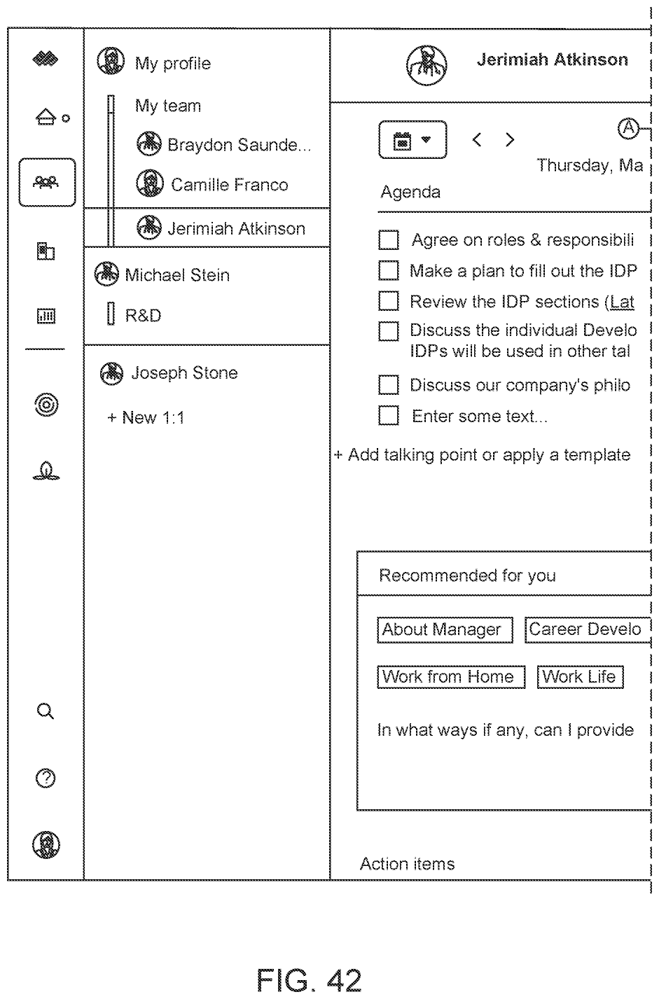

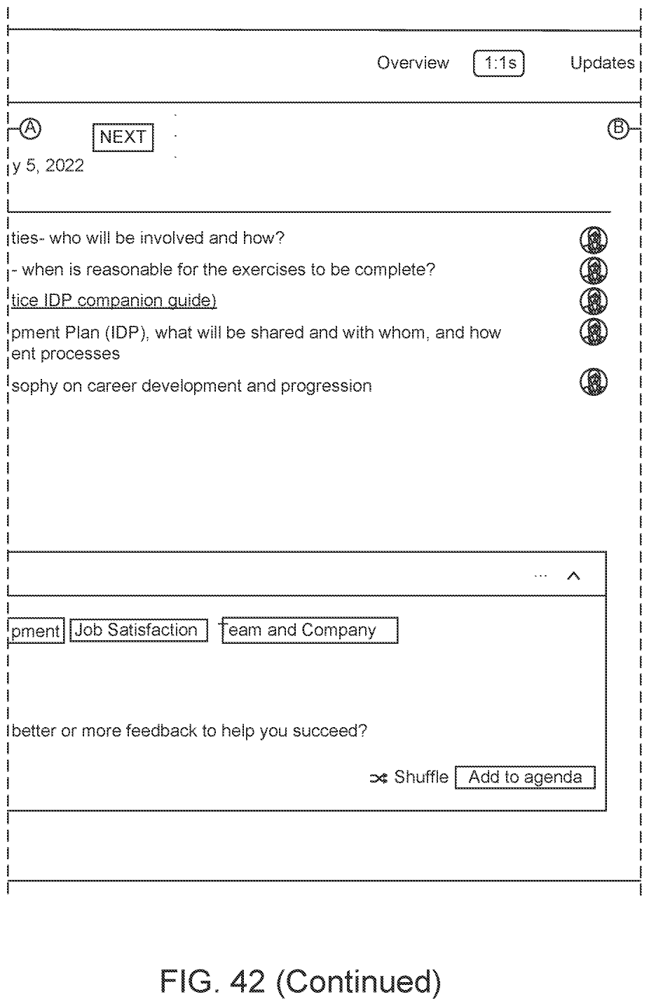

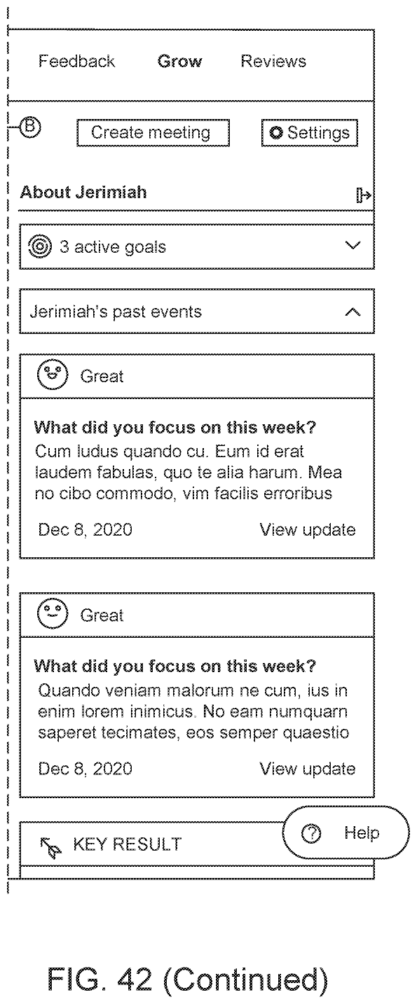

FIG. 42 is a schematic of a user interface displaying an option to add or remove talking points and action items from a development 1:1 agenda.

Create a Growth Area for a Direct Report

How managers can create, view, edit, or update a growth area

As a manager, you can create or view a direct report's growth areas.

Before you start

Growth areas are the skills an employee is developing to reach the next step in their career. Often these are associated with a specific competency in a job role, but they do not have to be. You can create a growth area even if direct reports have not been assigned to a track.

Create a growth area for a direct report.

Step 1: Navigate to the People page on the discovery navigation.

Step 2: Under the My team section, select the direct report's name to be taken to their profile.

Step 3: Enter the Grow tab within the toolkit.

Step 4: Next to growth areas, click Add.

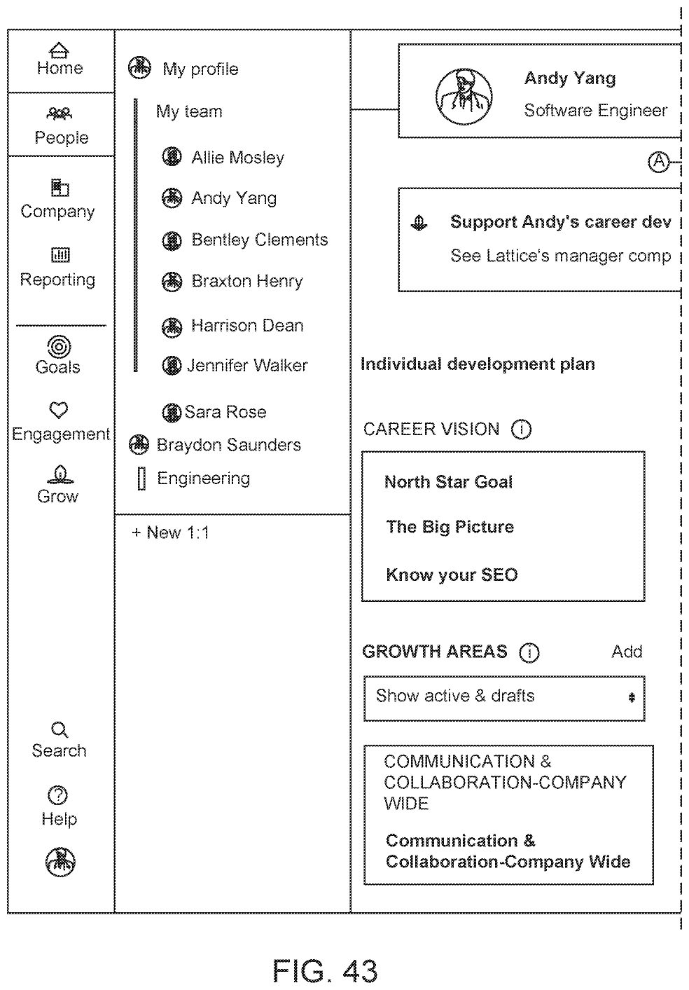

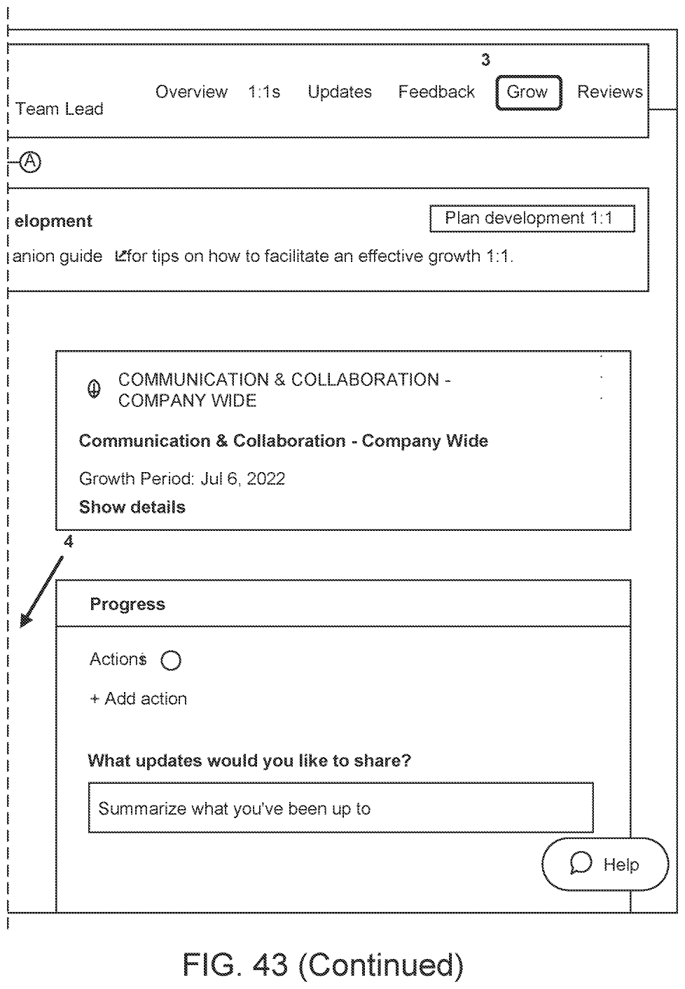

FIG. 43 is a schematic demonstrating how to navigate a user interface to create a growth area for a direct report.

Step 5: Give the growth area a title and include a description of what the report needs to accomplish to improve upon the growth area.

Step 6: Select the duration of focus for the area under the Growth period.

Note: The growth period is not a hard deadline but a target date for focus.

Step 7: Add actions with due dates that the direct report should complete to help improve upon their growth area.

Note: There are no notifications tied to actions at this time.

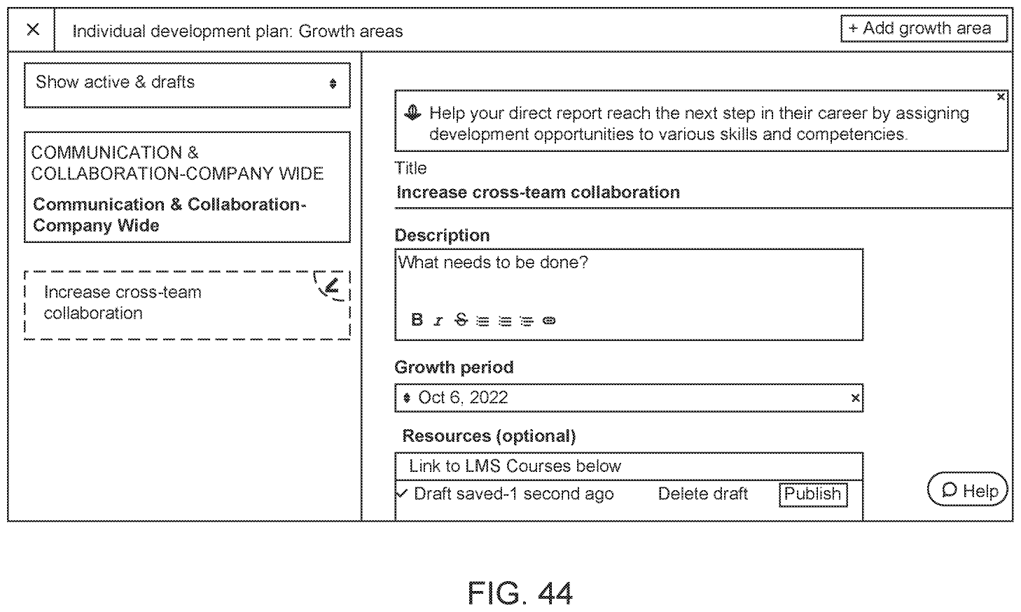

FIG. 44 is a schematic of a user interface displaying an option to add additional information to a growth area for a direct report.

Step 8 (optional): Add competency to the growth area by selecting a competency within the report's track or another published track.

Please note: If given the visibility, you can view other tracks within your company.

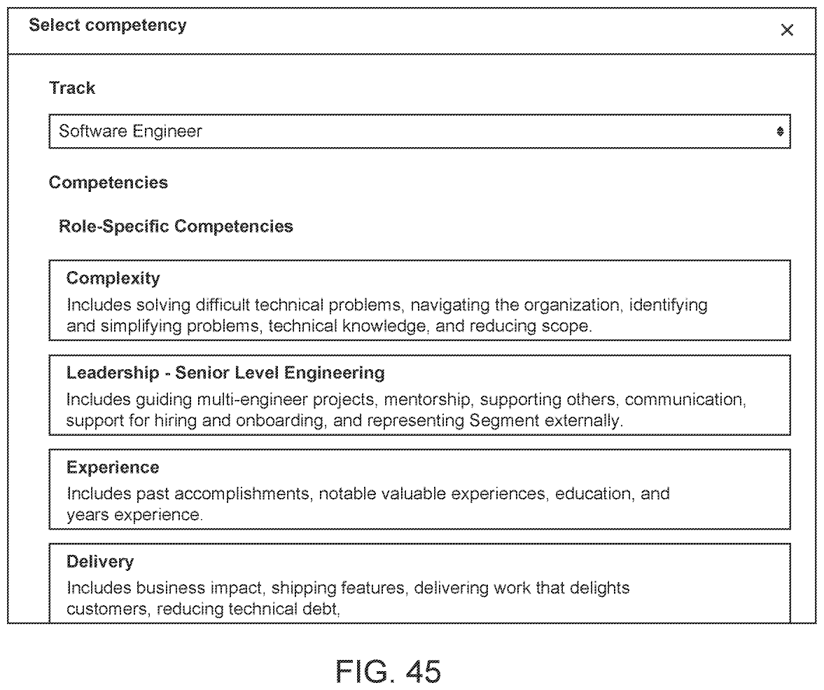

FIG. 45 is a schematic of a user interface displaying a selection of competencies to add to a growth area.

Step 9: Select Publish.

If you are not ready to publish, all inputted information will be auto-saved and marked as a draft. Drafted growth areas will not be visible to anyone until that growth area is published.

How to View a Direct Report's Growth Areas

As a manager, you can access your direct reports' growth areas to help monitor and measure employee progress.

View a Direct Report's Growth Area

Step 1: Navigate to the People page on the discovery navigation.

Step 2: Under the My team section, select the direct report's name to be taken to their profile.

Step 3: Under Growth areas, select the area you would like to view for your direct report.

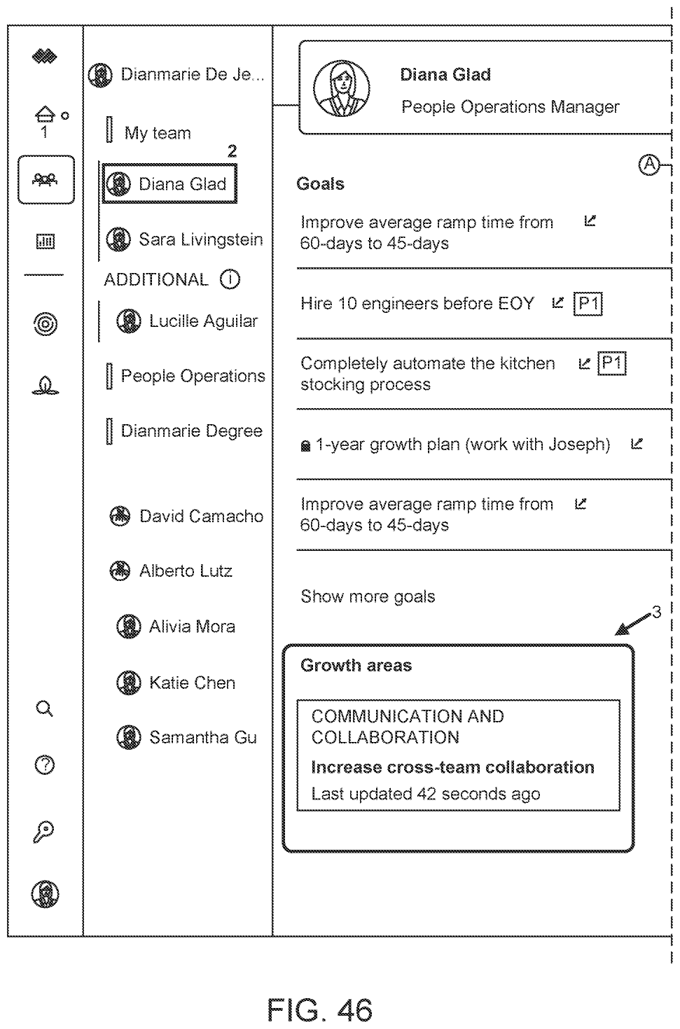

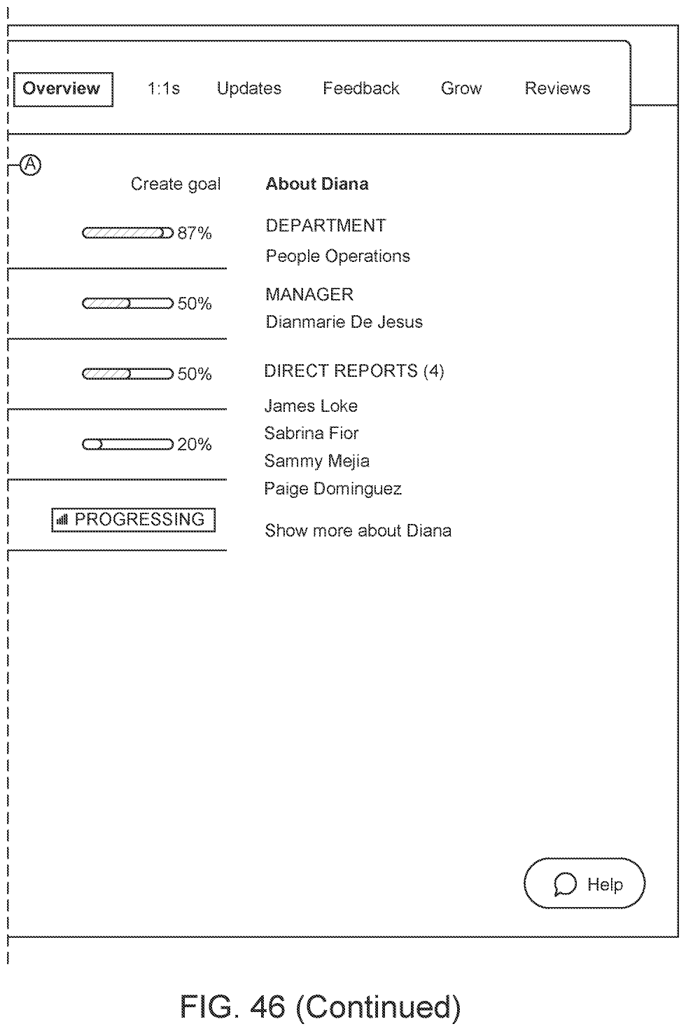

FIG. 46 is a schematic demonstrating how to navigate a user interface to view a direct report's growth areas.

Within the growth plan, you can . . .
Add a new growth area
Edit a growth area
Mark as complete
Delete a growth area
Update a growth area

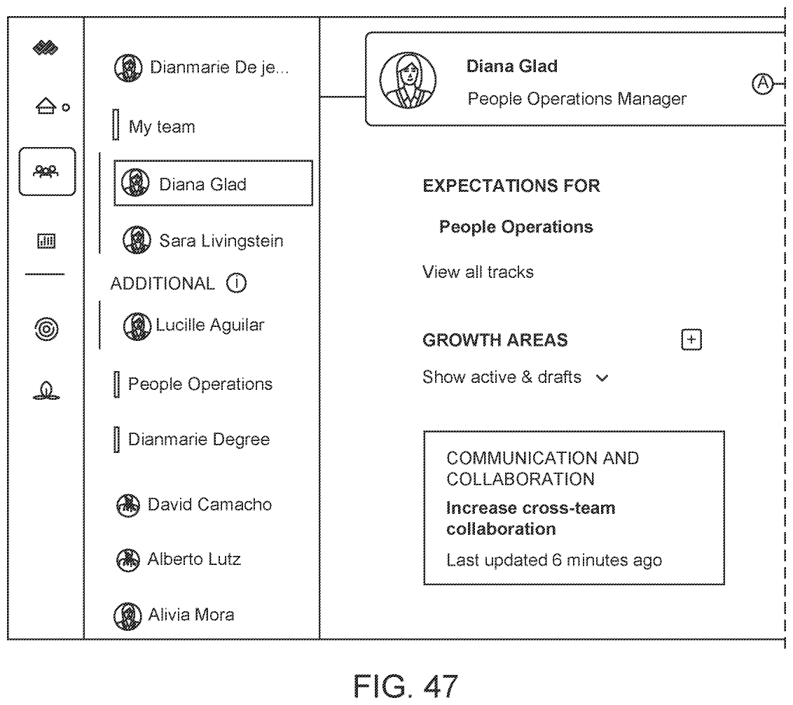

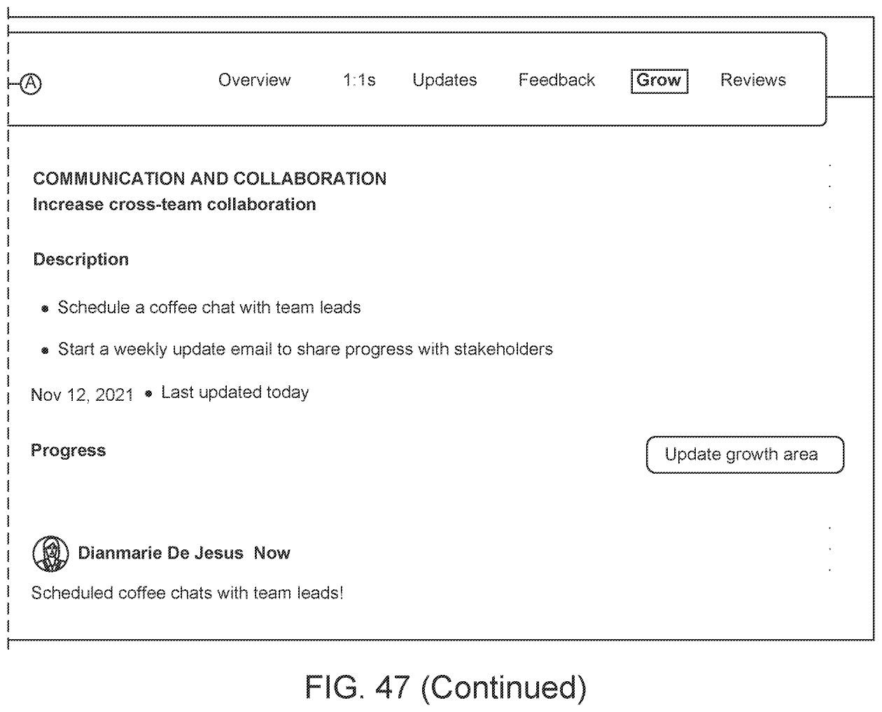

FIG. 47 is a schematic of a user interface displaying a growth plan for a growth area.

### How to View the Growth Areas for My Indirect Reports

Before you Start

In order to view growth areas for indirect reports, manager of managers visibility for Grow must first be enabled. With manager of managers visibility enabled, you will be able to view growth areas of indirect reports directly from their profile page.

Step 1: Enter your Home page and select your organization from the discovery navigation.

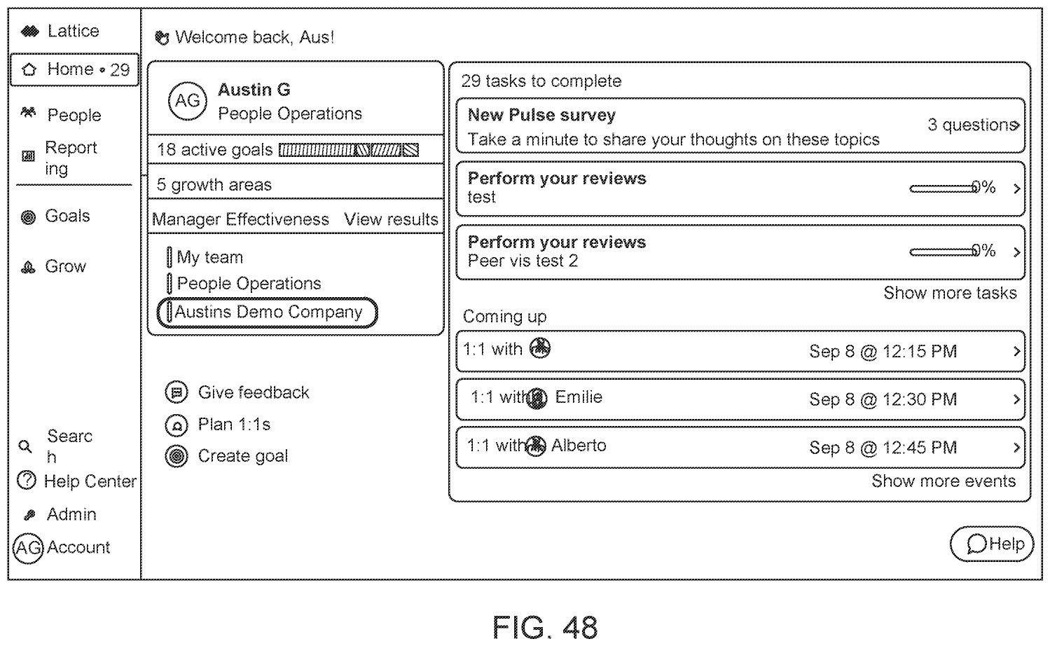

FIG. 48 is a schematic demonstrating how to navigate a user interface to select an organization from the home page.

Step 2: Navigate to the Employees tab, search for your indirect report to enter their profile.

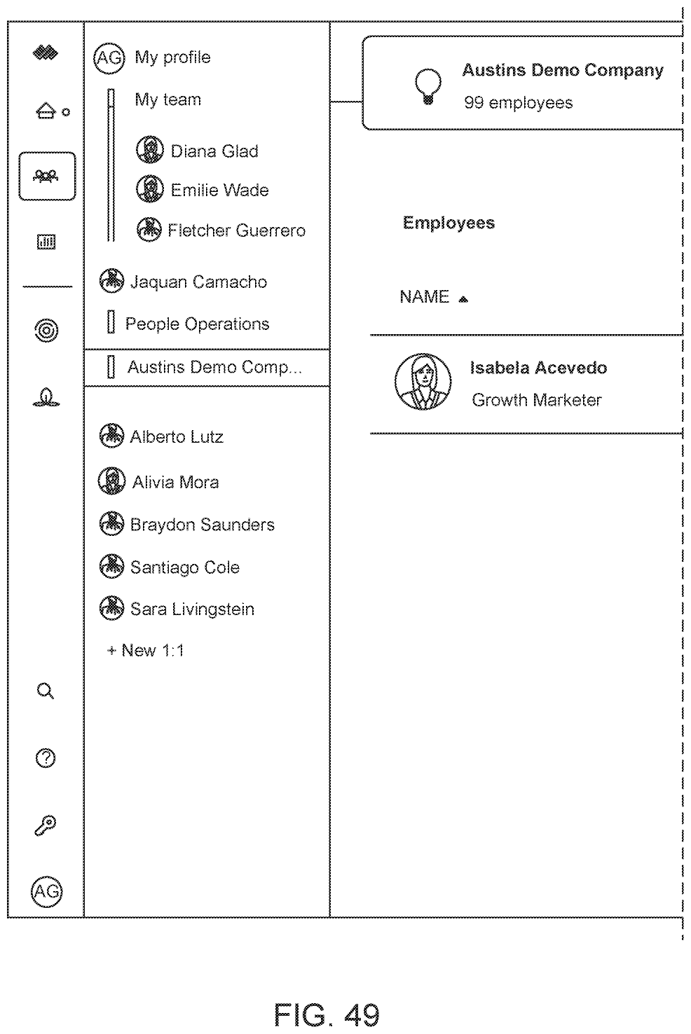

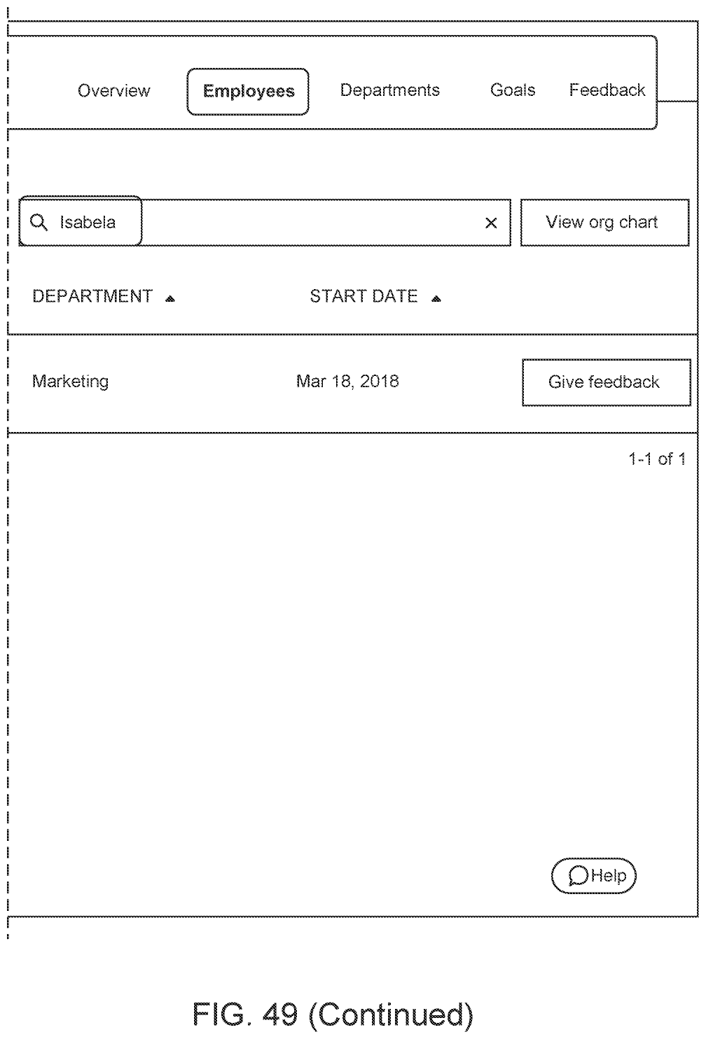

FIG. 49 is a schematic demonstrating how to navigate a user interface to search for an indirect report from the employees tab.

Alternate: Within your direct report's profile, click on your indirect report via the direct reports subheader.

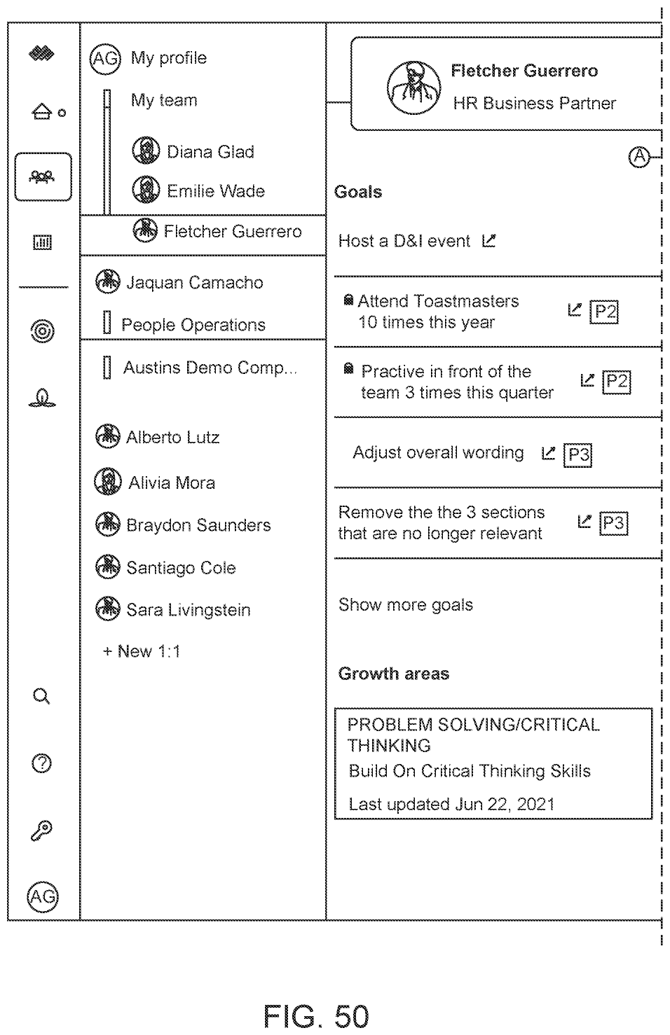

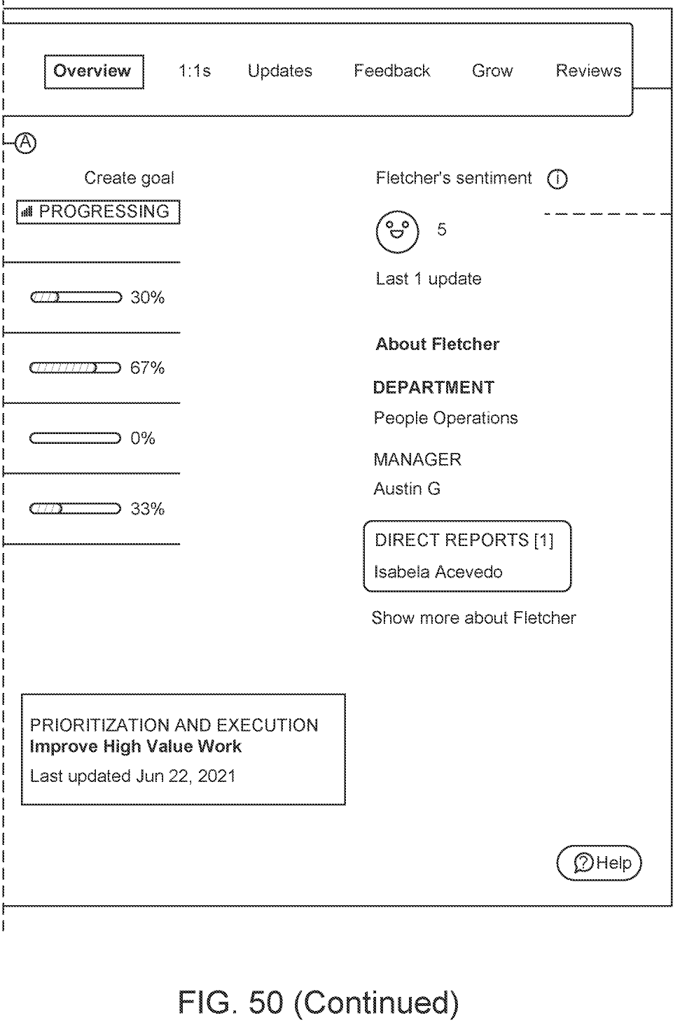

FIG. 50 is a schematic demonstrating how to navigate a user interface to locate an indirect report from a direct report's profile.

Step 3: Click on the Grow tab to view your indirect report's growth areas.

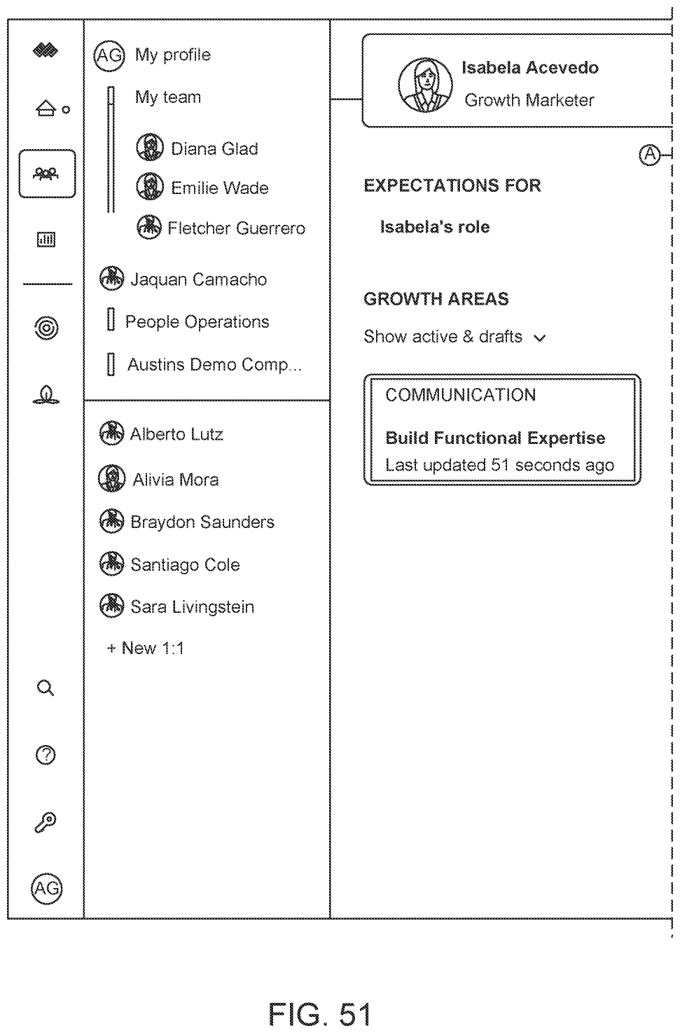

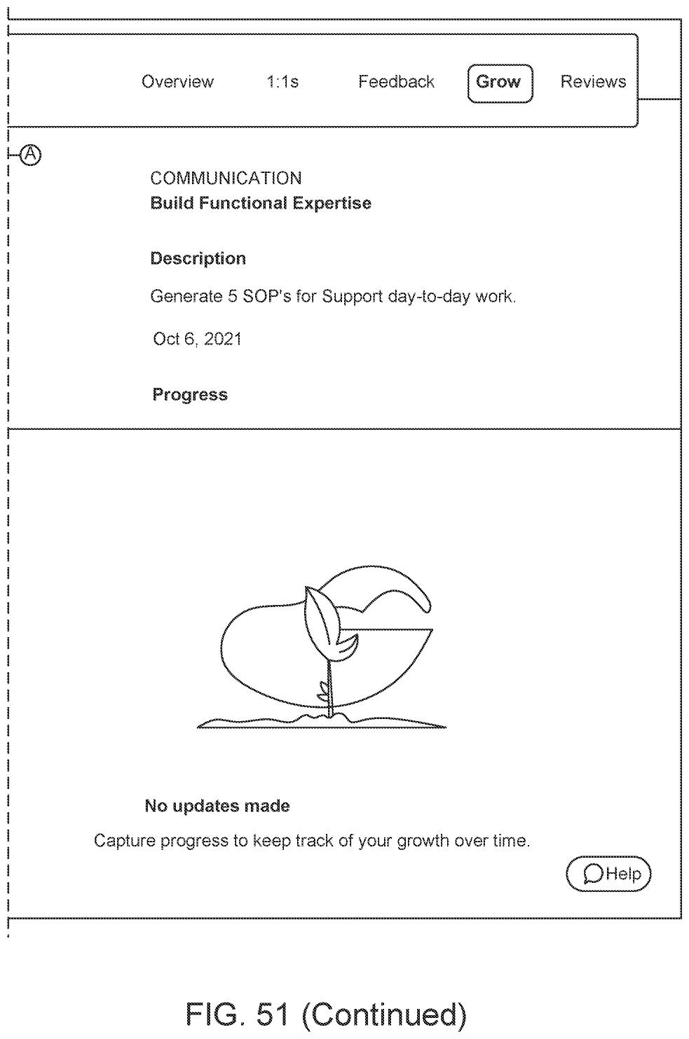

FIG. 51 is a schematic demonstrating how to navigate a user interface to view growth areas for an indirect report.

Note: Managers of managers will NOT be able to update growth areas for indirect reports.

How to view a Direct Report's Track and Level

Once your direct reports have been assigned a track and level by your account admin, you will be able to view their track alongside the associated competencies and level expectations from their profile page.

Step 1: Enter your Home page and select the People page from your discovery navigation.

Step 2: Under My Team, select your direct report to enter their profile and enter their Grow tab.

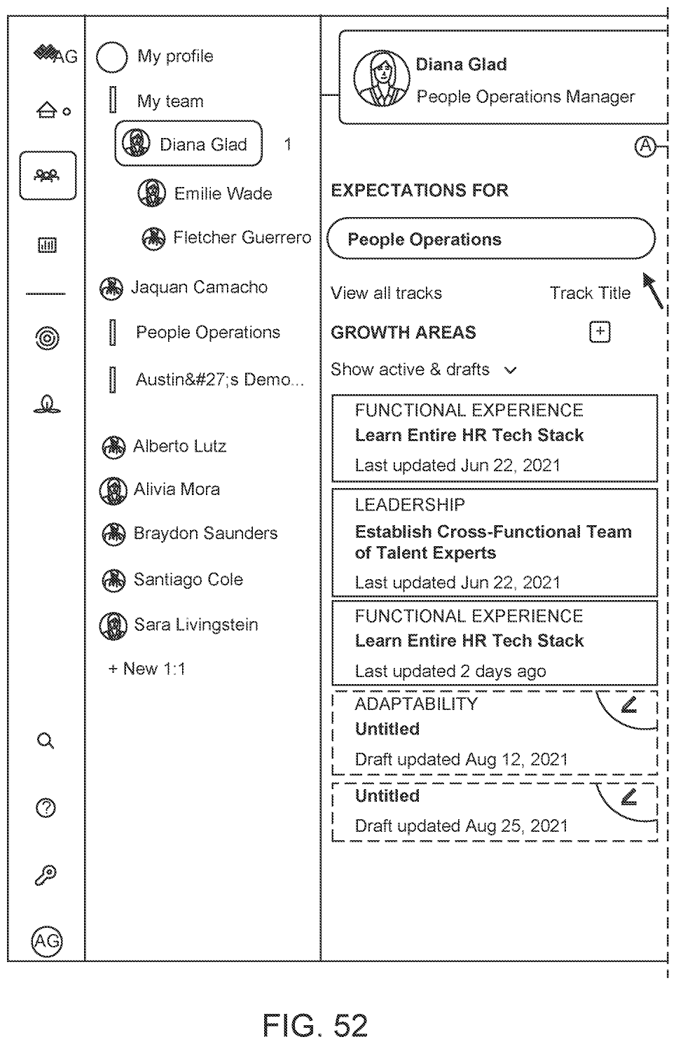

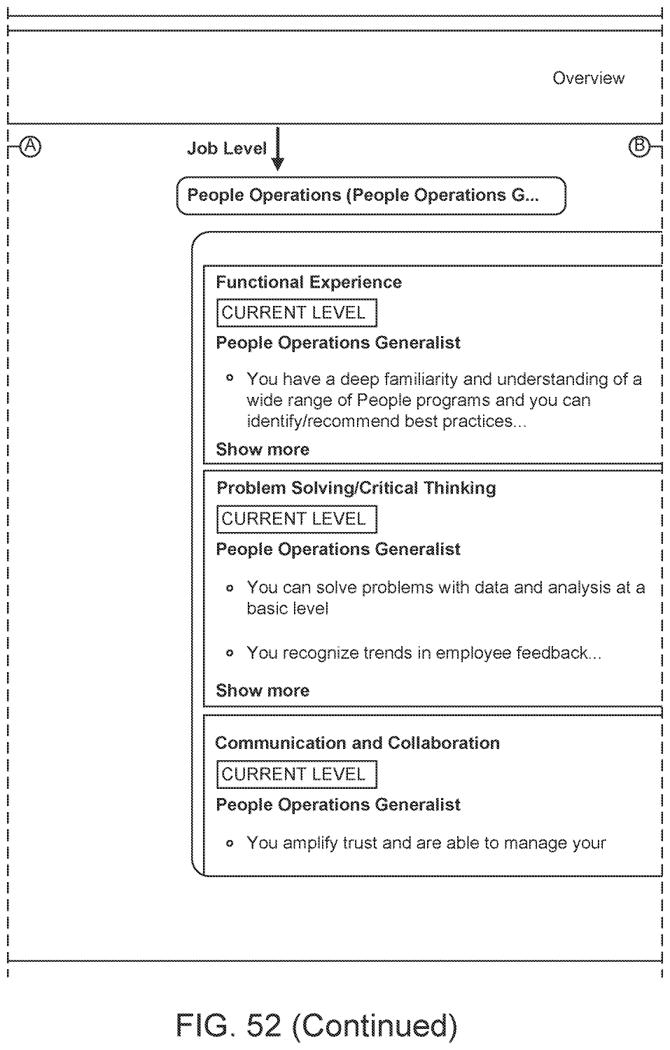

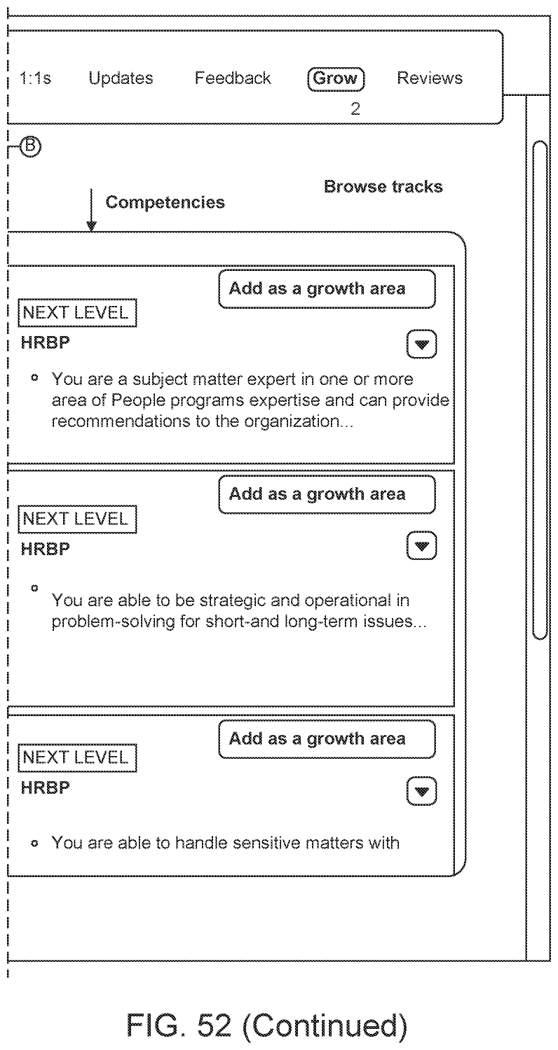

FIG. 52 is a schematic demonstrating how to navigate a user interface to view a direct report's track and level.

From here, you will enter the direct report's Growth Plan, where you can view their level, competencies, and expectations. As a manager, you can also create a growth area for your direct report by clicking the plus icon (+) next to growth areas.

How to View a Direct Report's Career Vision Responses

Career vision exercises help capture an employee's long-term career goals via exercise responses that they can share with their managers. Reading through their responses and working closely with your direct reports will help them to define their career aspirations and allow you to support their employee development.

Before you start

Managers will not be notified when a direct report has published a career vision exercise response; however, managers will have visibility to all direct report responses within the employee's profile.

Note that managers of managers (MoMs) do not have visibility into the responses for their indirect reports.

View your direct report's career visions

Step 1: Navigate to People and select a direct report to enter their profile.

Step 2: Navigate to the Grow tab.

Step 3: Under Career vision, select an exercise to view.

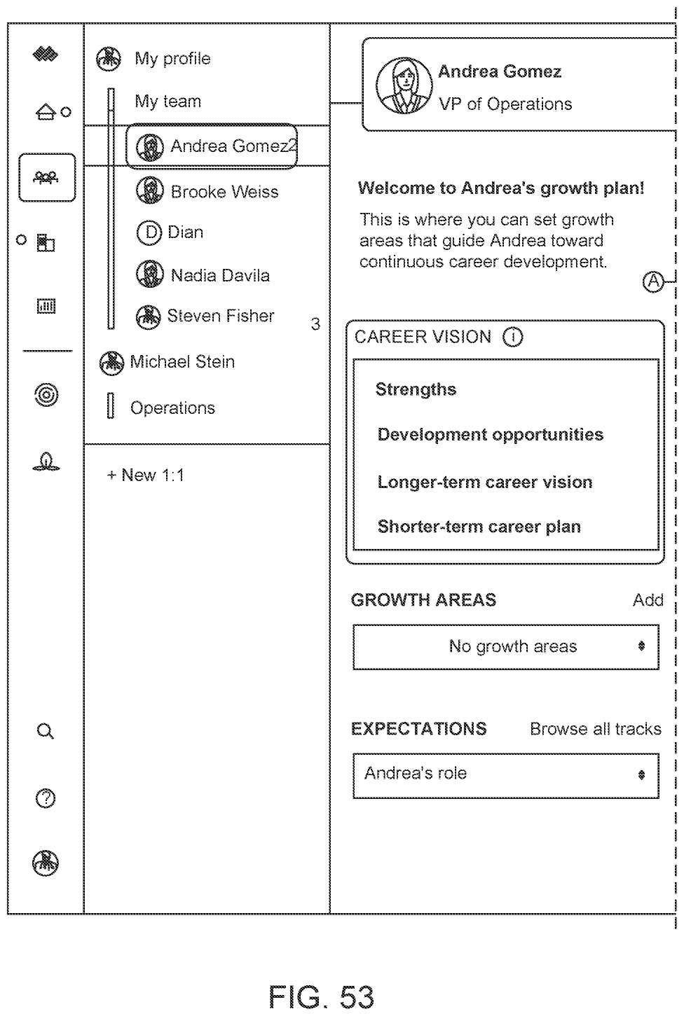

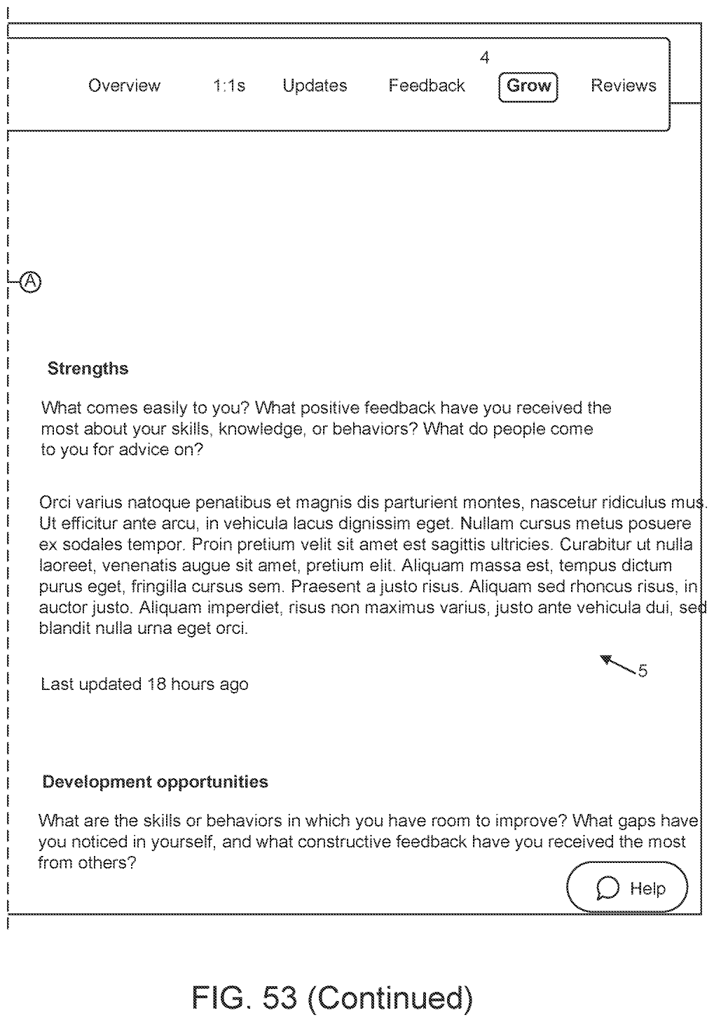

FIG. 53 is a schematic demonstrating how to navigate a user interface to view a direct report's career visions.

How to Add a Career Vision Exercise Tip for Direct Reports

Career vision exercises help capture an employee's long-term career goals via exercise responses that they can share with their managers.

The career vision template is customizable by admins to help fit their organization. However, managers can help provide additional context, thought prompts, or instructions by adding a tip for direct reports to see when completing the exercise. Managers can also create team-specific exercises for further customization.

Before you start

Only direct reports will have visibility to exercise tips.

Managers will not be notified when a direct report has published a career vision exercise response; however, managers will have visibility to all direct report responses within the employee's profile.

Note that managers of managers (MoMs) do not have visibility into the responses for their indirect reports.

Add a career vision tip

Step 1: Navigate to People>My team>Grow.

Step 2: Under Career vision, navigate to the desired exercise and select View.

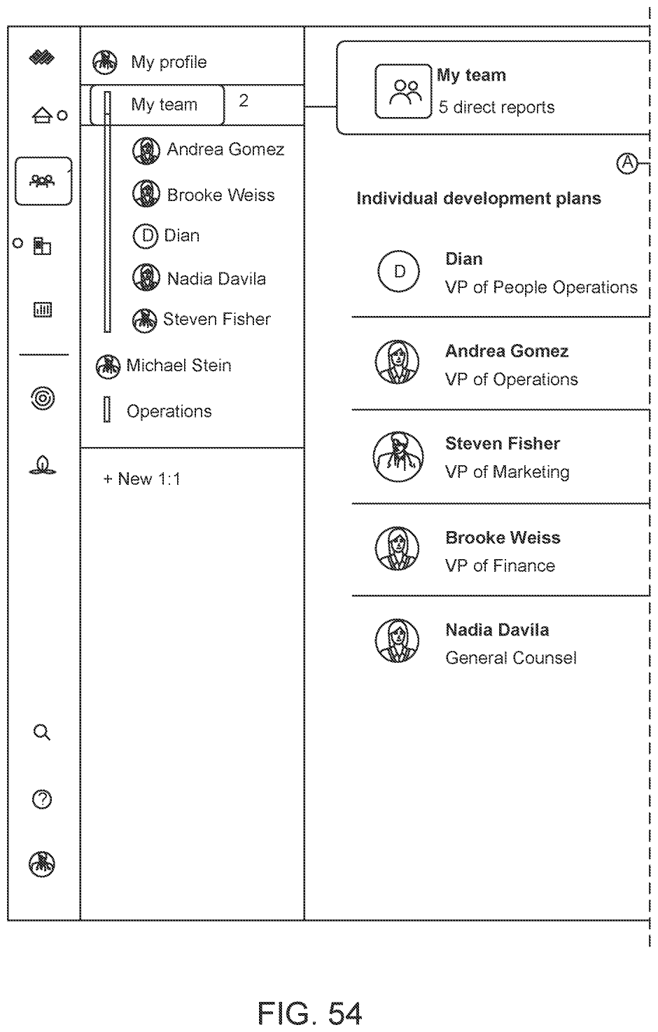

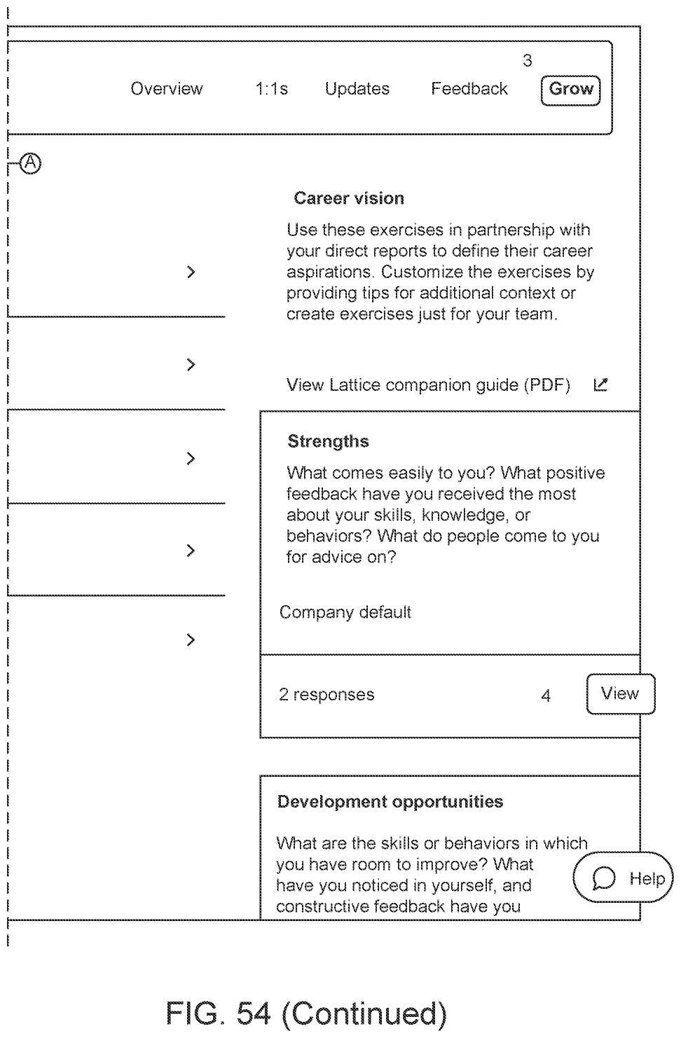

FIG. 54 is a schematic demonstrating how to navigate a user interface to view career vision tips.

Step 3: Under the exercise prompt, select+Add tips.

Step 4: Select Save.

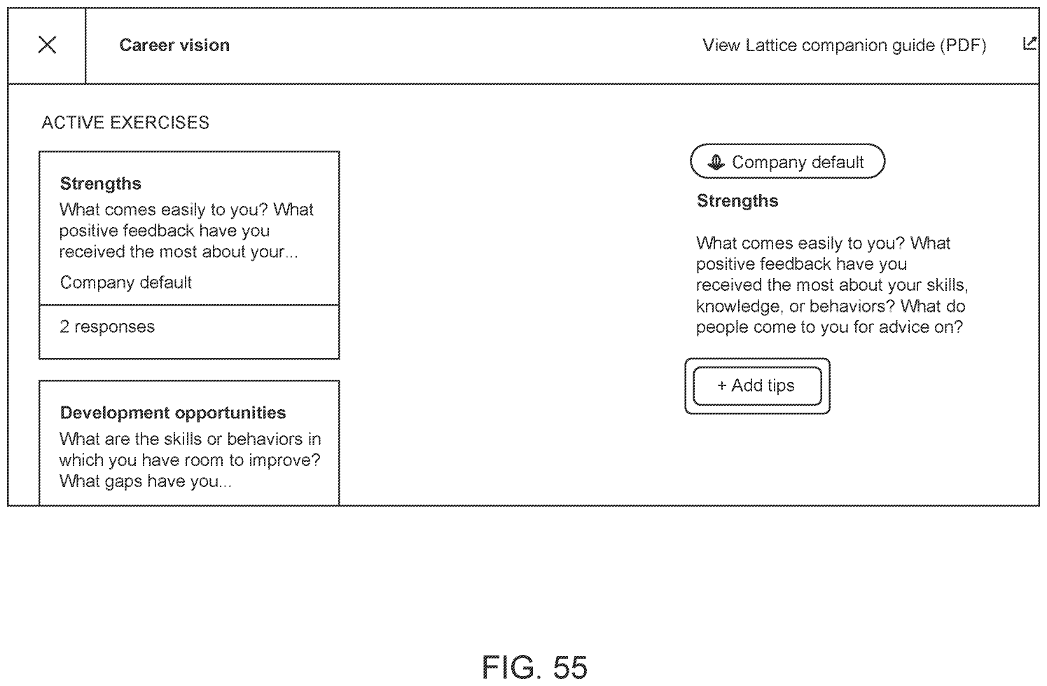

FIG. 55 is a schematic demonstrating how to navigate a user interface to add career vision tips.

How tips appear to direct reports

When completing their exercises, direct reports will be able to view your tip under Tips from your manager.

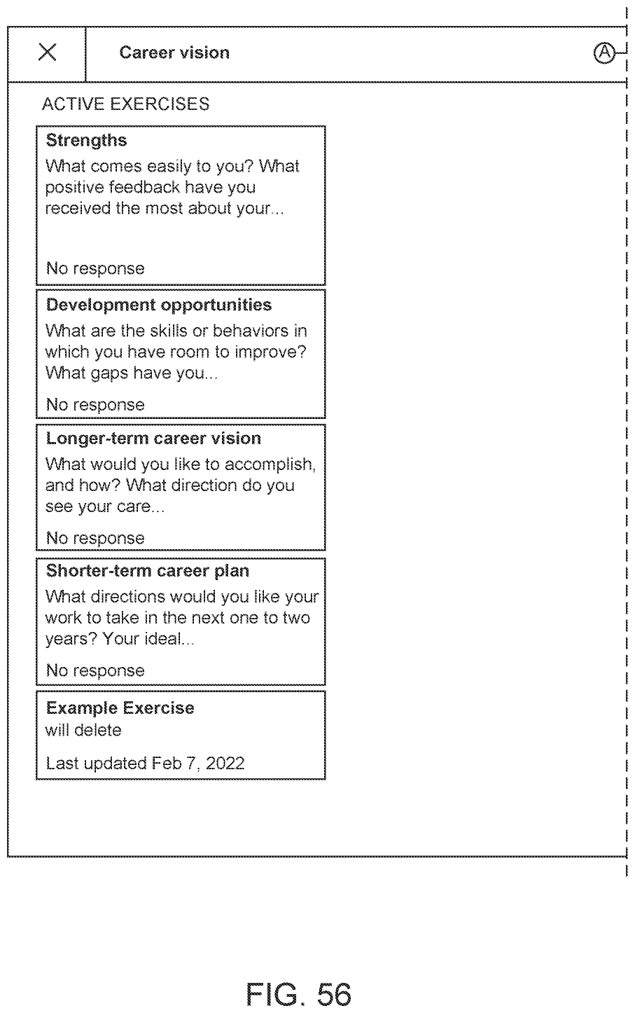

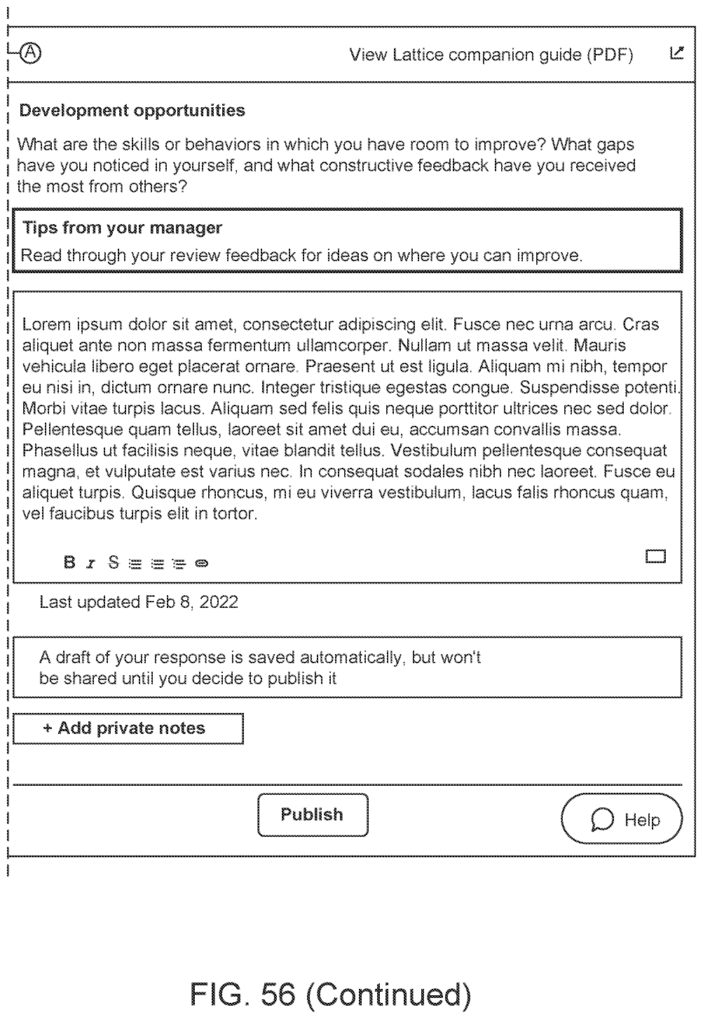

FIG. 56 is a schematic of a user interface displaying a direct report's view of the career vision tips.

View Grow Reporting for Your Team

Understanding how employees are interacting with growth areas

As a manager, you can view which of your direct reports are creating growth areas directly via the reporting page in the discovery navigation.

Accessing Grow Reporting

Step 1: Navigate to Reporting>Grow>Participation.

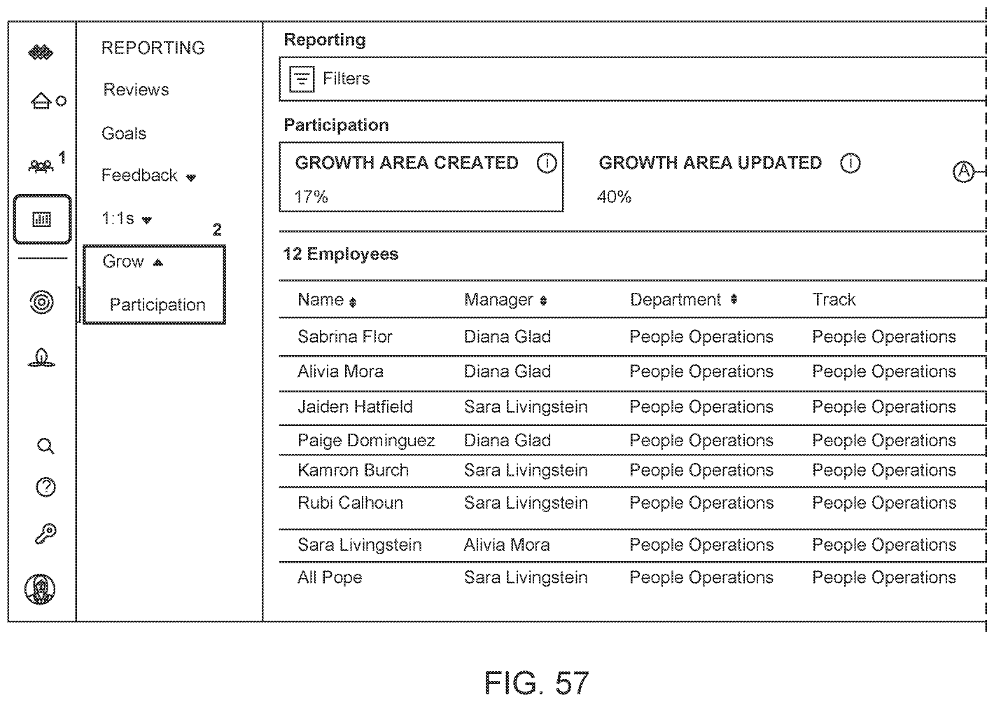

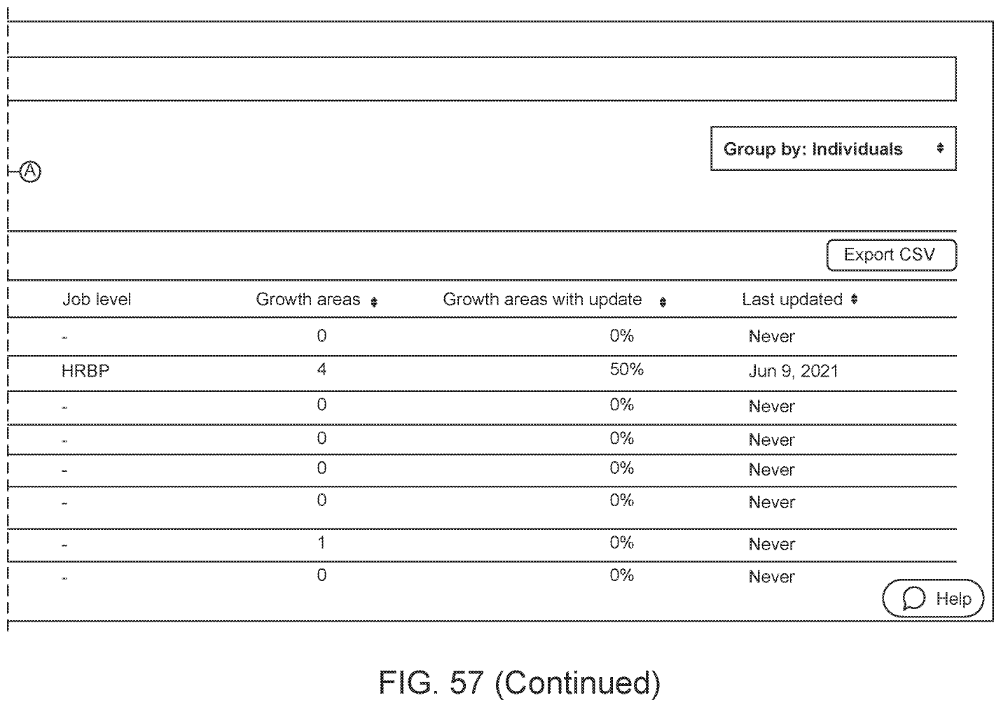

FIG. 57 is a schematic demonstrating how to navigate a user interface to access grow reporting for a team.

Participation

The Participation page includes two metrics:

Growth area created: Measures the percent of direct reports which have created at least one growth area.

Growth area updated: Measures the percent of direct reports which have shared a progress update to at least one growth area.

Filtering Growth Areas

Near the top of the page, you'll see the ability to filter how you are viewing growth areas.

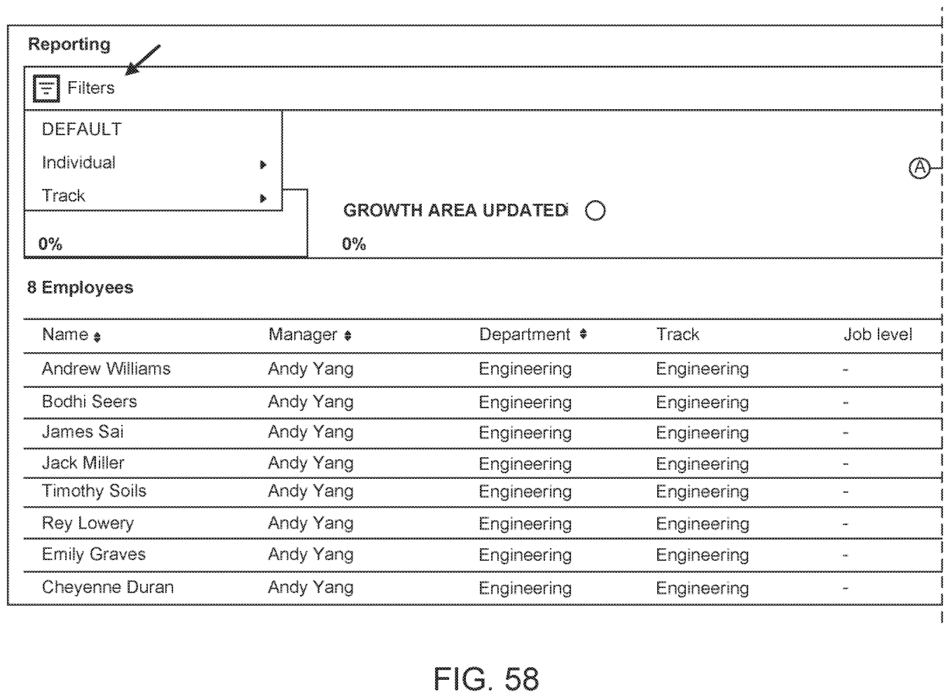

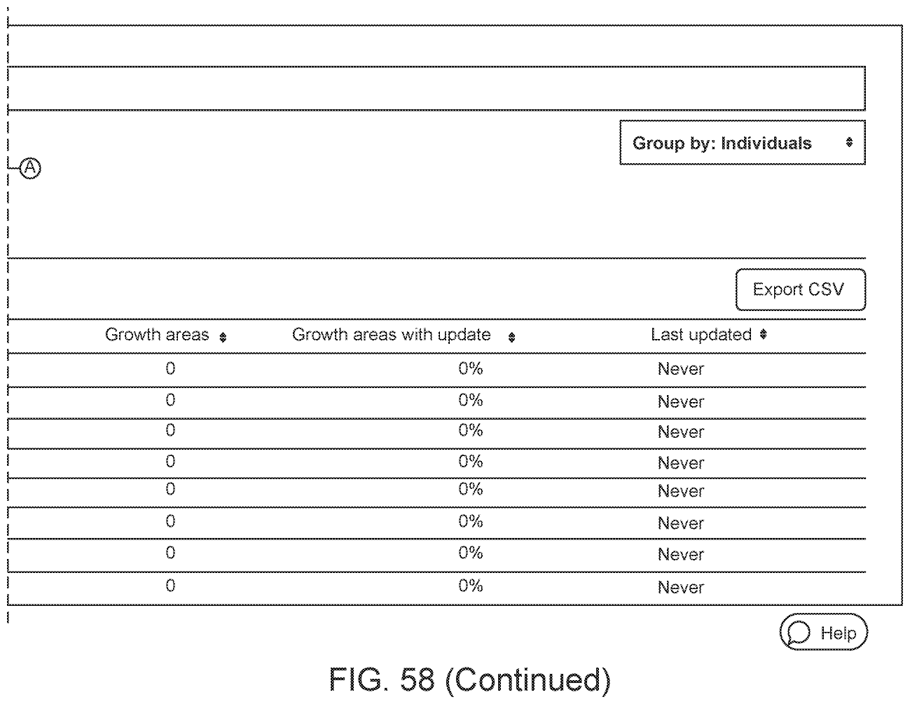

FIG. 58 is a schematic demonstrating how to filter growth areas for a team in a user interface.

For example, you could choose a filter to view only the growth areas by a specific growth track.

Grouping Growth Areas

To group growth areas by individuals, manager, department, or track:
1. Select the Group by dropdown in the top right corner.
2 Choose how you'd like the growth areas to be grouped (Individual, Manager, Department, or Track).

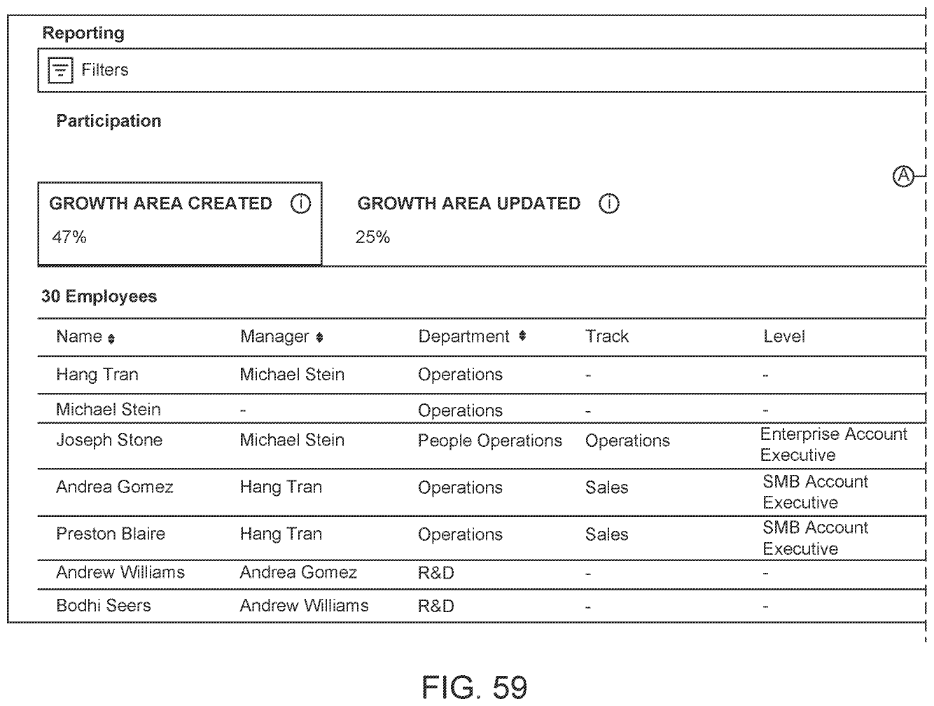

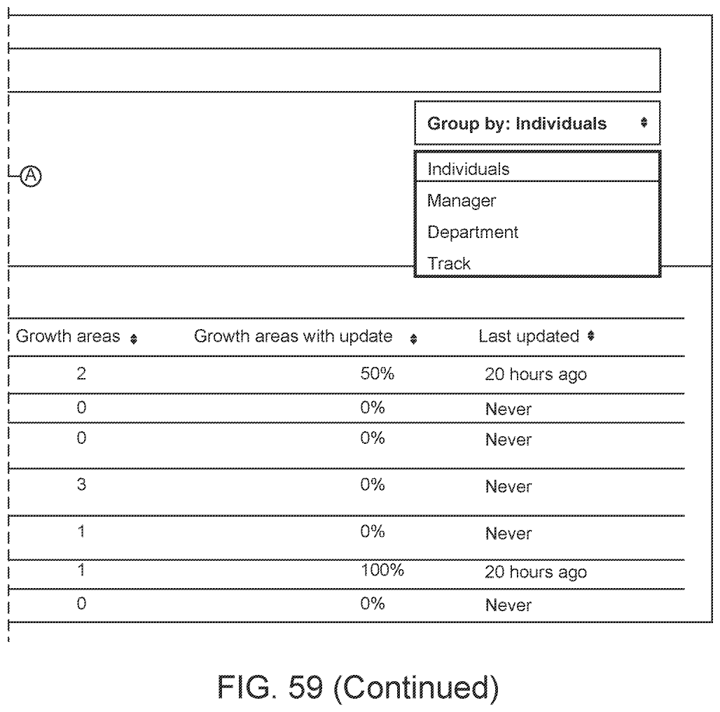

FIG. 59 is a schematic demonstrating how to navigate a user interface to group growth areas for a team.

For example, when you select Group by: Track, you'll see data for your direct reports who have created or have shared a progress update to at least one growth area within their assigned track. This way, you can see which individual tracks tend to utilize growth areas more frequently.

### Bar Graph

Three groups can be seen in a graph view to better visualize the percentage of employees who have created or have shared a progress update to at least one growth area: manager, department, and track.

For example, if grouped by Manager, you can view the percentage of direct reports which have created at least one growth area.

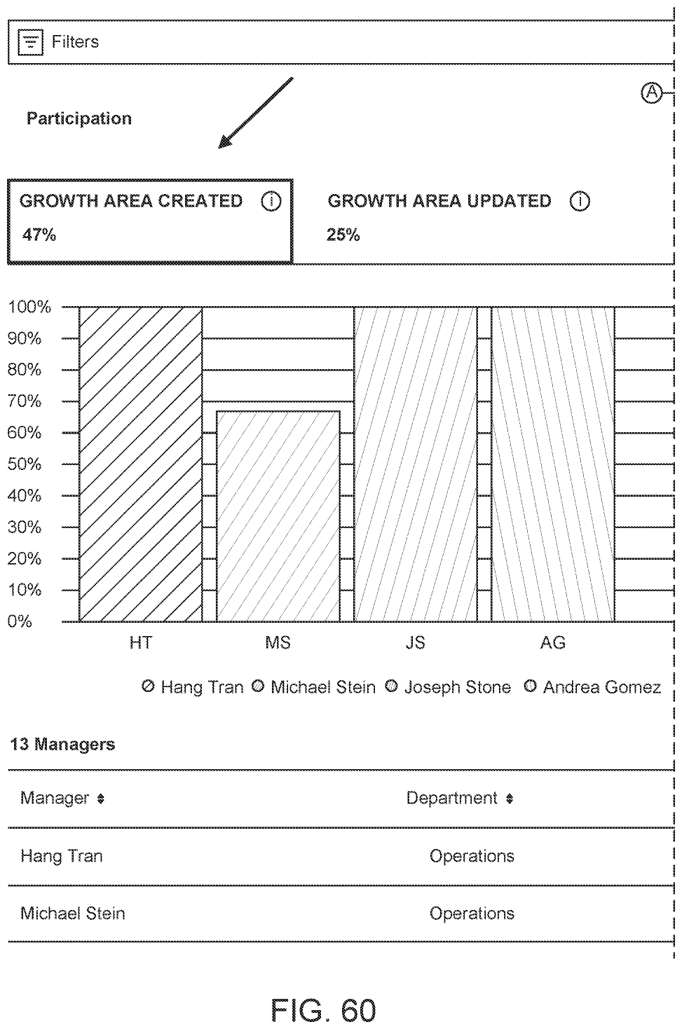

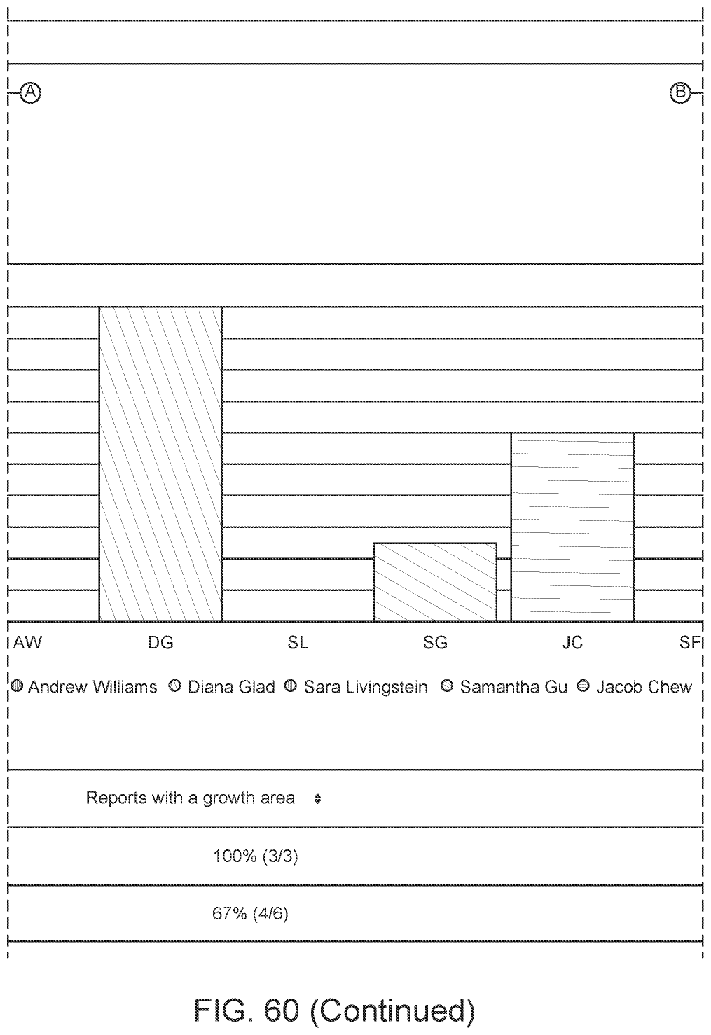

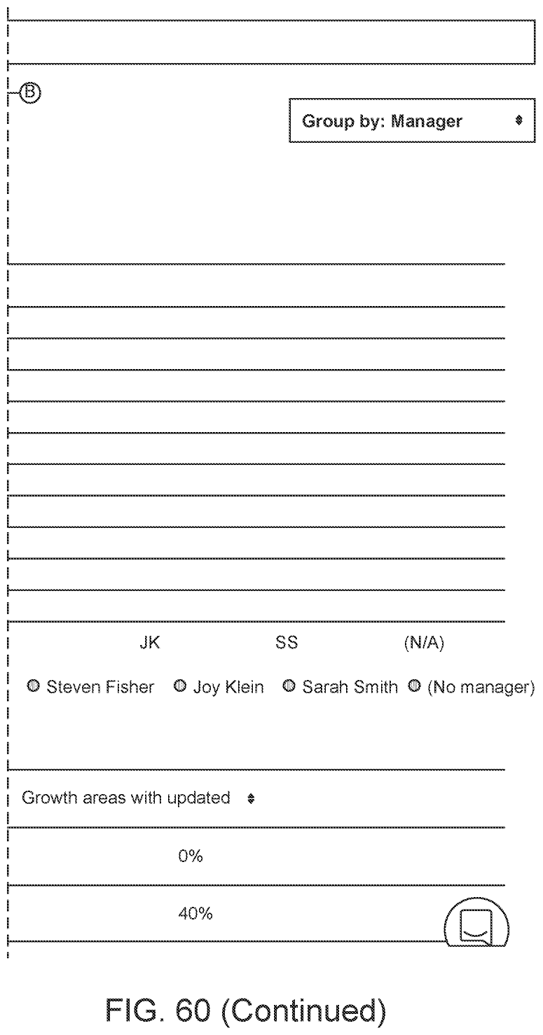

FIG. 60 is a schematic of a user interface displaying a bar graph depicting the percentage of direct reports on a team that have created at least one growth area.

You can also view the percentage of direct reports who have shared a progress update to at least one growth area.

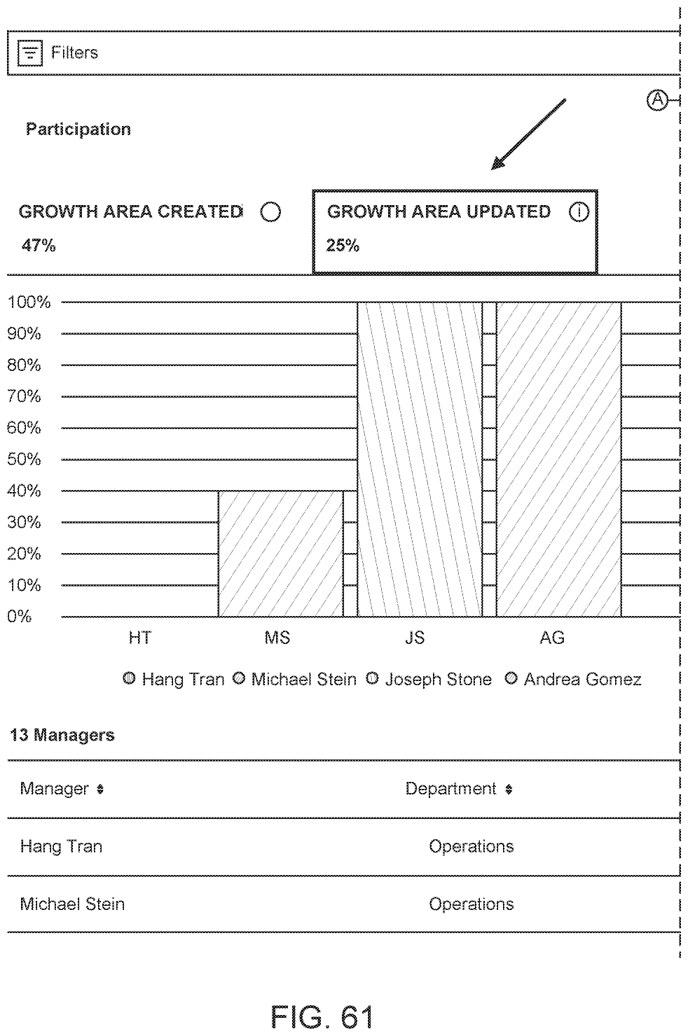

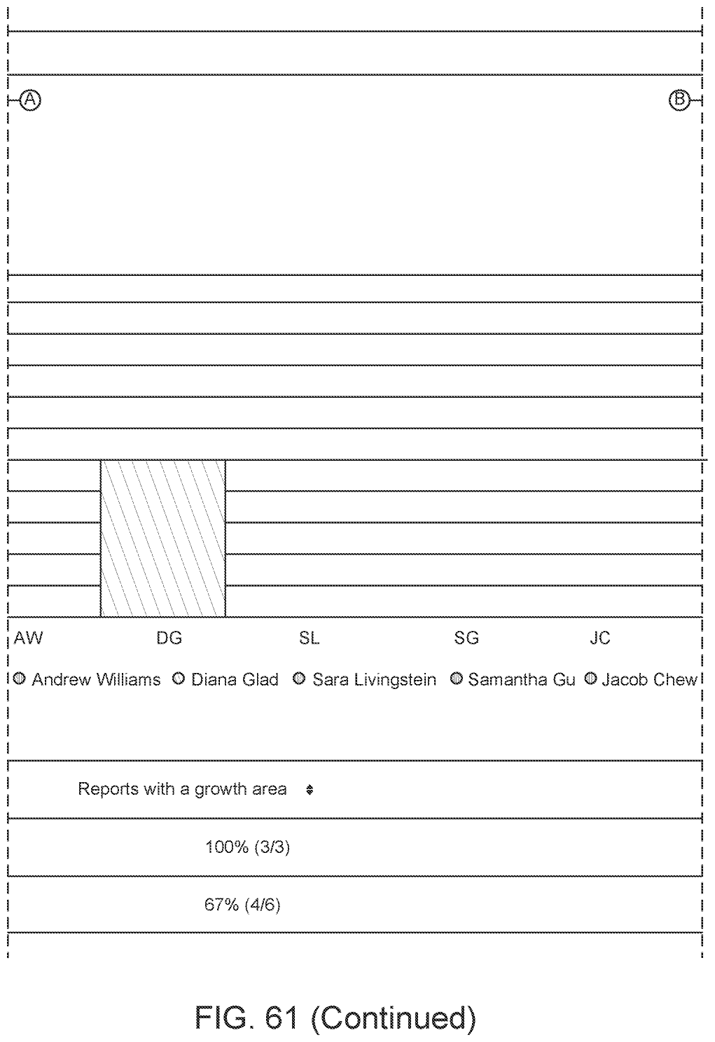

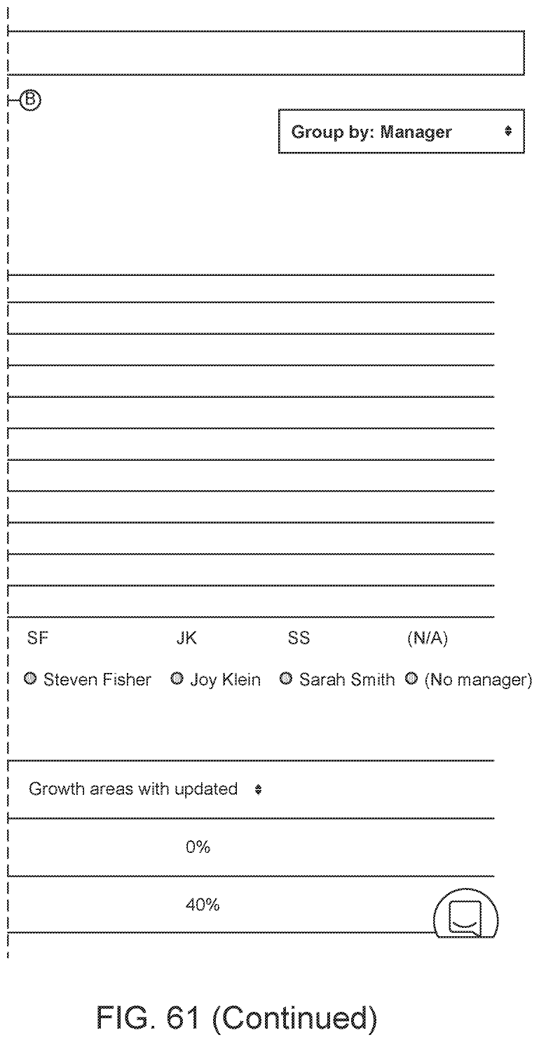

FIG. 61 is a schematic of a user interface displaying a bar graph depicting the percentage of direct reports on a team that have shared a progress update to at least one growth area.

Please note: You may also hover over each bar for further details.

Link a Review Response to a Direct Report's Growth Area

Before you start
Review responses can only be linked to growth areas once the review packet has been shared with the direct report
Private questions cannot be linked to a growth area

Link a review response to a growth area
1. Navigate to the People page.
2. Within the People Navigation, select the desired direct report to enter their profile page.
3. Navigate to the Reviews tab.
4. Next to the review cycle, select View [direct report]'s review packet.
5. Select+Add to growth area under the desired response.

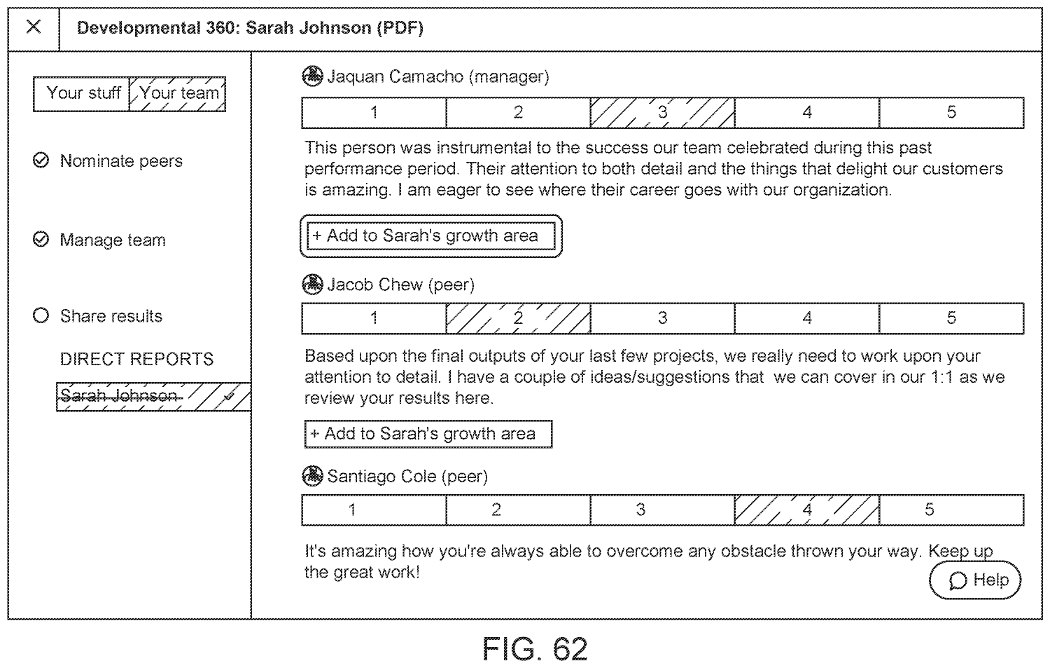

FIG. 62 is a schematic of a user interface displaying direct reports' review responses and providing the option to link a review response to that direct report's growth area.
6. The growth area panel will appear Select a growth area to attach or create a new growth area draft.
7. Select Add to growth area.
8. Create or edit your growth area and select Publish.

Unlink Review Responses from Your Direct Report's Growth Area

Managers can unlink review responses they or their direct reports have added to their growth areas.
1. Navigate to the People page.
2. Within the People Navigation, select the desired direct report to enter their profile page.
3. Navigate to the Grow tab.
4. Under growth areas, select the desired growth area.
5. Within the title card, select the ellipsis ( . . . )>Edit.

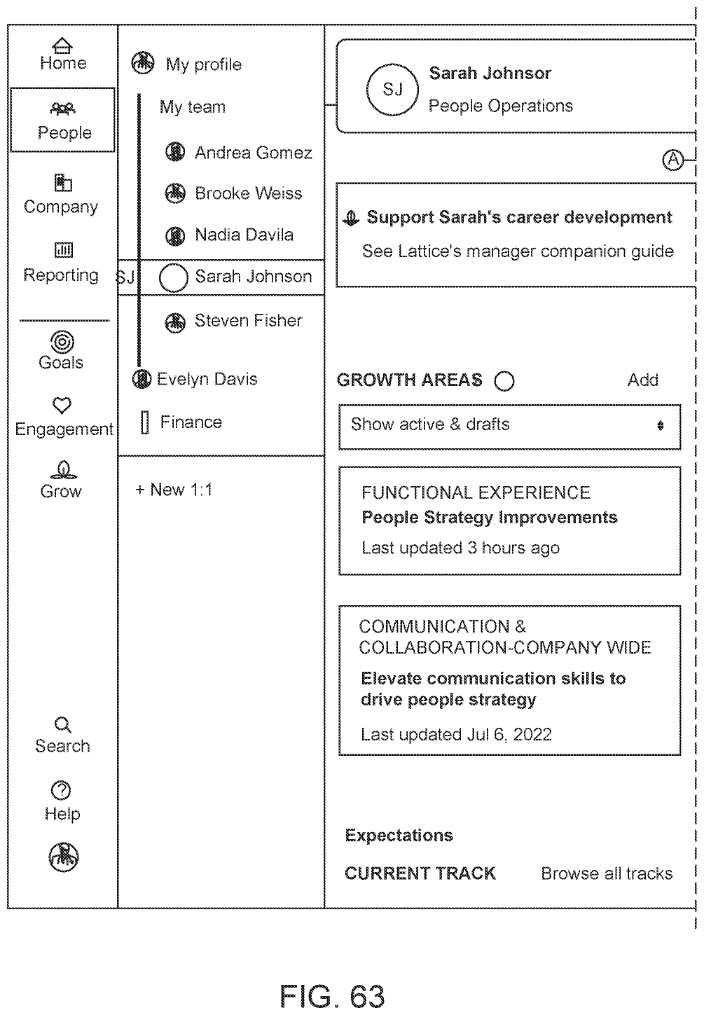

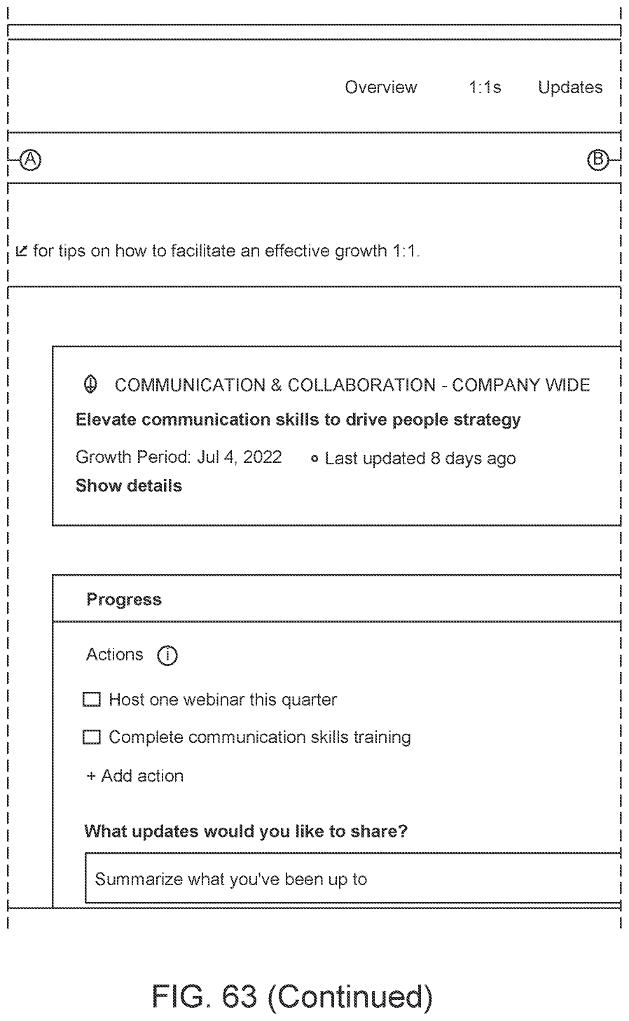

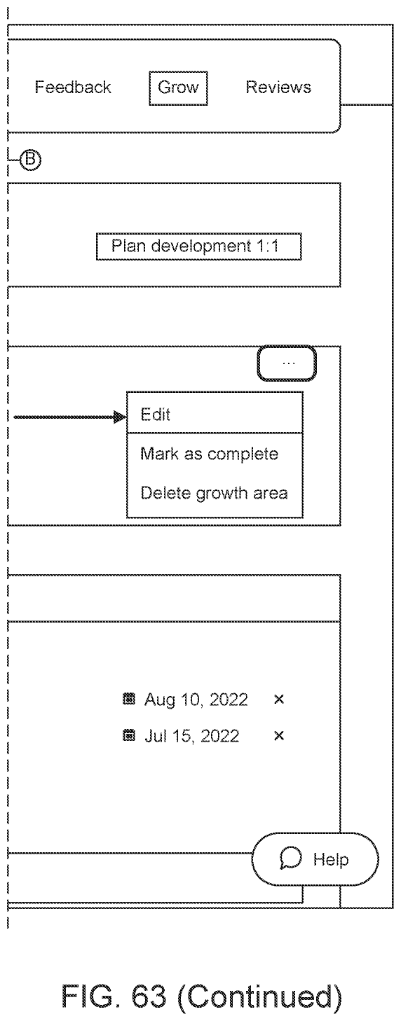

FIG. 63 is a schematic demonstrating how to navigate a user interface to unlink a review response from a direct report's growth area.
6. Under Reviews, navigate to the desired review response and select Remove from growth area.
7. Confirm by selecting Remove review.

Permissions

Question

When viewing grow tracks from the admin page in discovery navigation, I'm unable to edit a track.

Answer

Tracks must be in draft in order to be edited. If your track is published, you will need to unpublish it before making any changes.

Track admins can publish tracks only if given permission by a super admin.

Custom Relationship Permissions into Growth Areas

As an admin, once a custom attribute relationship has been created, you will be able to configure this relationship visibility and editing permissions into the growth areas of the employees they are to oversee.

Before you start

Custom attribute relationships must be configured with the correct permissions after creation via the Permissions page.

Relationship Point of View

To access the growth area of an employee, the relationship owner will follow the following steps:

Navigate to People>Under Additional, select the name of the employee>Grow.

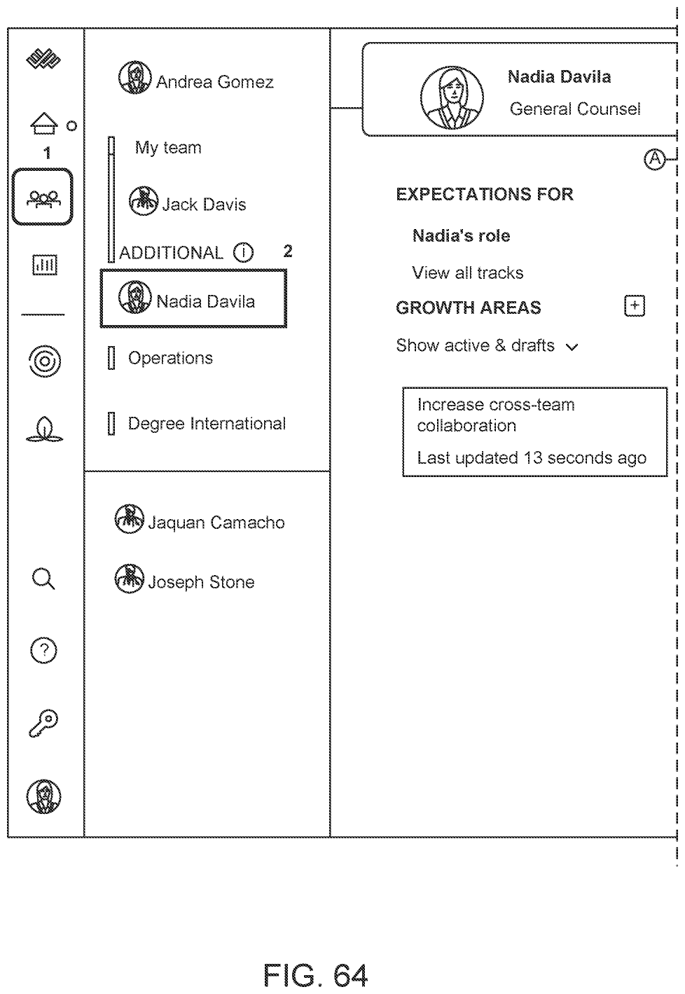

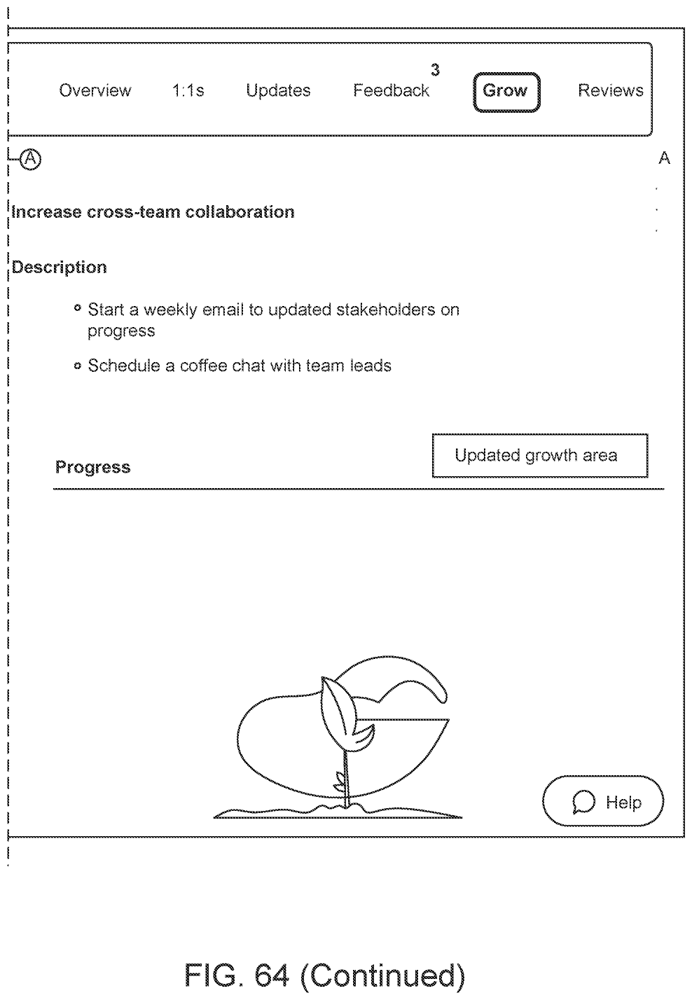

FIG. 64 is a schematic demonstrating how to navigate a user interface to access the growth area of an employee.

From here, relationship owners will be able to . . .
View a growth area
Create a growth area
Edit a growth area

How to View the Growth Areas for a Target Employee Group

Employees can be given additional permissions by their admin to view the growth areas for employees of a specific target group, for example, by department or location. This permission is often given to HRBPs to help manage Grow usage.

Before you start

Custom role owners will need to be given employee-specific Grow permissions by an admin before having visibility to an employee's growth area. The employee's growth areas will be read-only and cannot be edited by a role owner.

Note: Managers and managers of managers (MoMs) automatically have visibility to their direct and indirect report's growth areas.

Navigate to an employee's growth area

Step 1: Navigate to Company>Directory.

Step 2: Search and select a target employee to enter their profile.

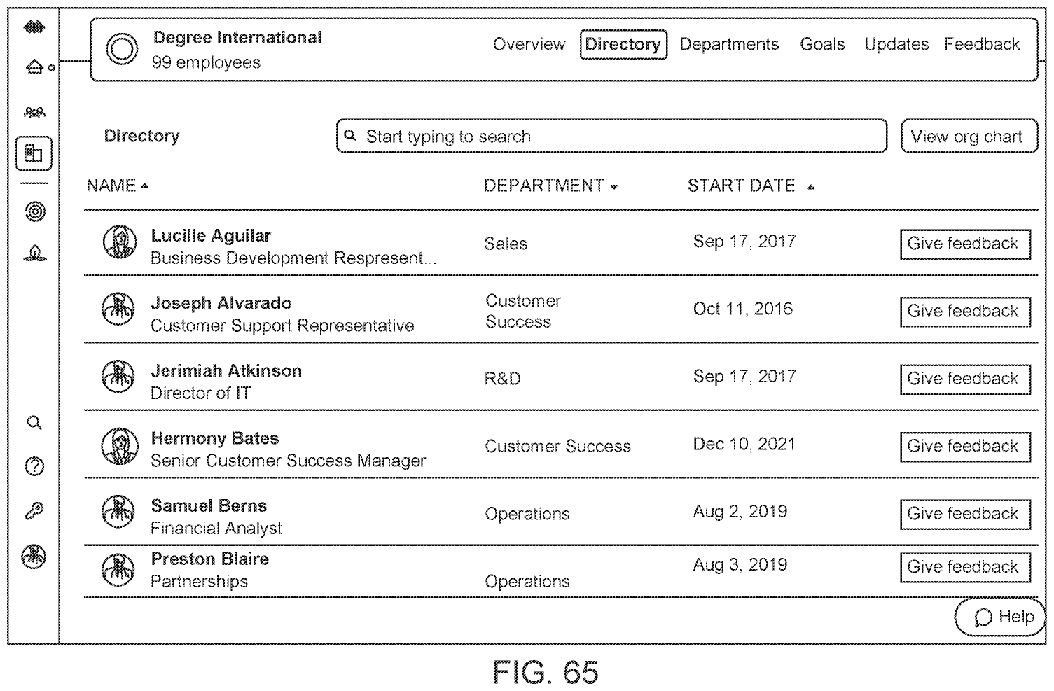

FIG. 65 is a schematic of a user interface displaying the option to search and select a target employee.

Step 3: Enter the Grow tab to view the employee's growth areas.

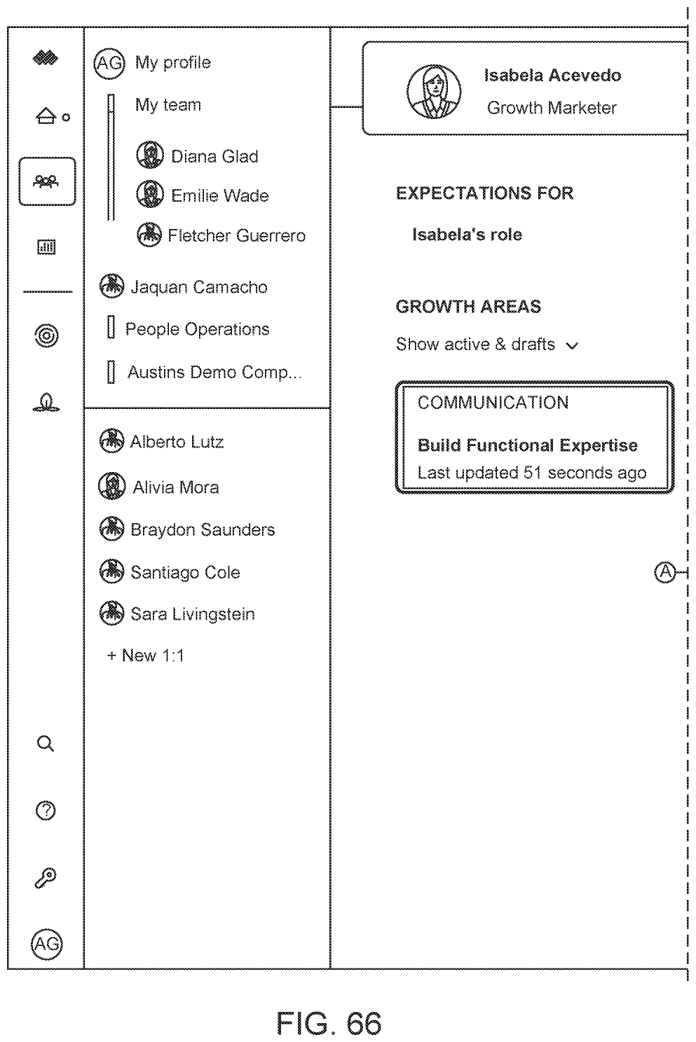

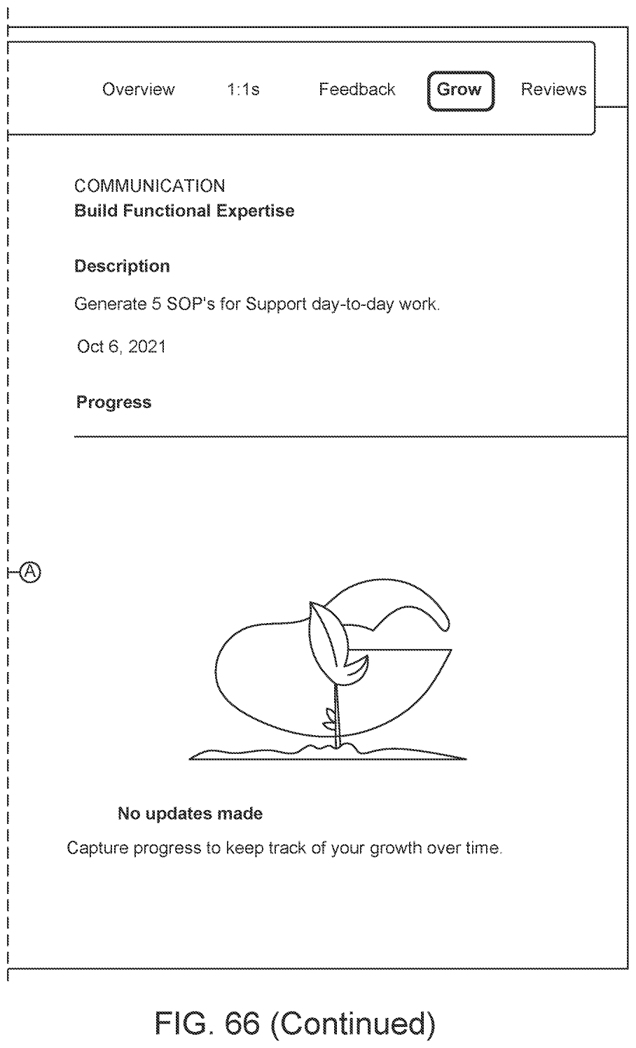

FIG. 66 is a schematic of a user interface displaying an employee's growth areas.

Manager of Managers Visibility for Grow

Learn what visibility you can coq figure for a manager of managers

Depending on the needs of your organization, admins can configure whether managers of managers have additional top-down visibility into growth areas for their indirect reports.

Before you start
Manager of manager visibility must be configured by the account admin before managers of managers can have visibility to their indirect reports' individual development plans (IDP).
Managers of managers will not be able to update growth areas from the 1:1 agenda
Note: an admire can give MoMs it is special custom role permissions for visibility.
By default, the manager of managers can still view reporting for growth areas, even if they cannot view the individual growth areas.

Visibility for a Manager of Managers

If the Grow manager of managers setting is toggled on, managers of managers can view the following:
Growth areas of their indirect reports from the reports profile page
Growth areas in the 1:1 context panel of their indirect reports
Growth areas in the reviews context panel when reviewing their indirect reports
Career vision exercise responses

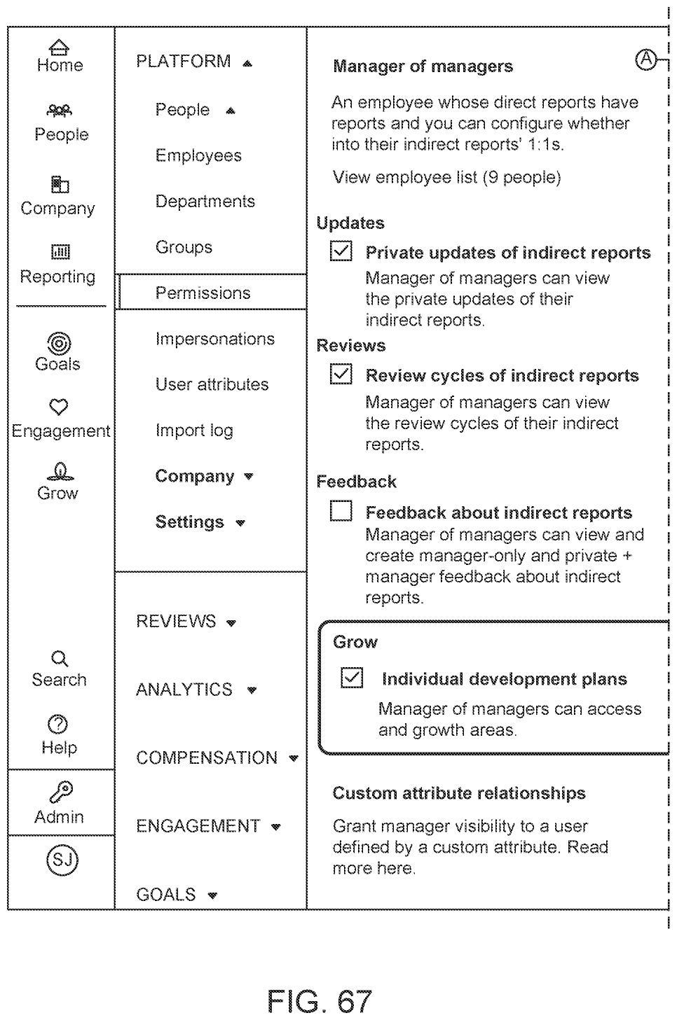

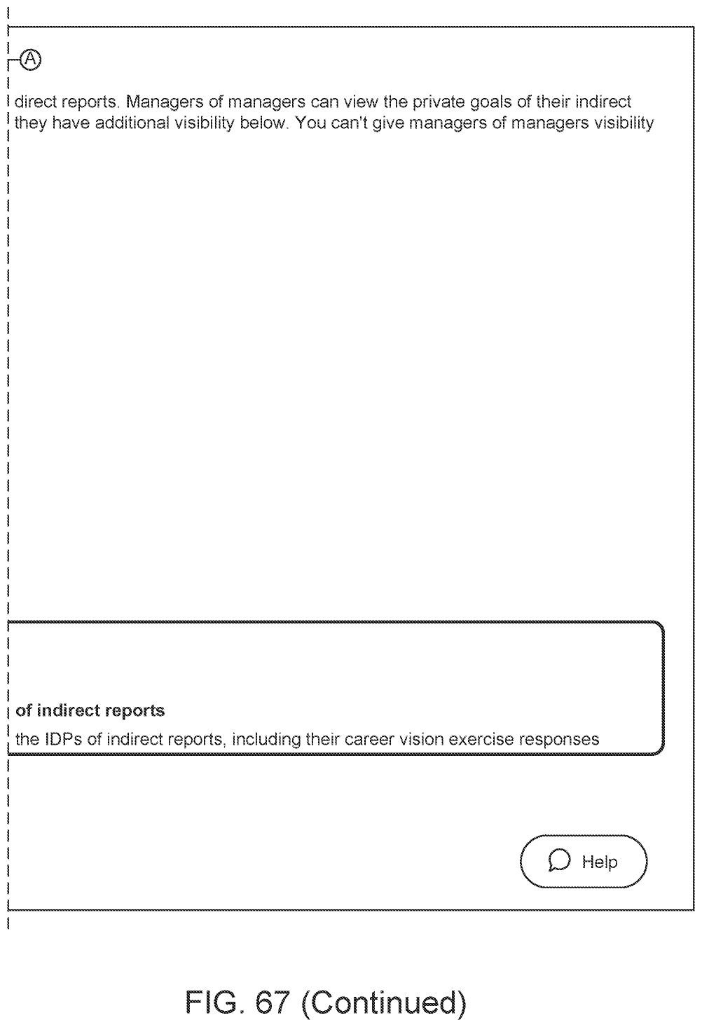

FIG. 67 is a schematic of a user interface displaying visibility preferences for managers of managers.

How to Create a Track Admin

As a Super Admin and Grow Admin, you can give track admins the ability to publish. These track admins will be able to delegate and help build out the track. Track admins can assign a track to employees, create new competencies, and add expectations.

Before you start

Track admins cannot publish or unpublish tracks unless given permission by a Super or Grow Admin.

How to Create a Track Admin

Step 1: Navigate to Admin>Tracks>Auditing.

Step 2: Select a job track to assign a track admin to.

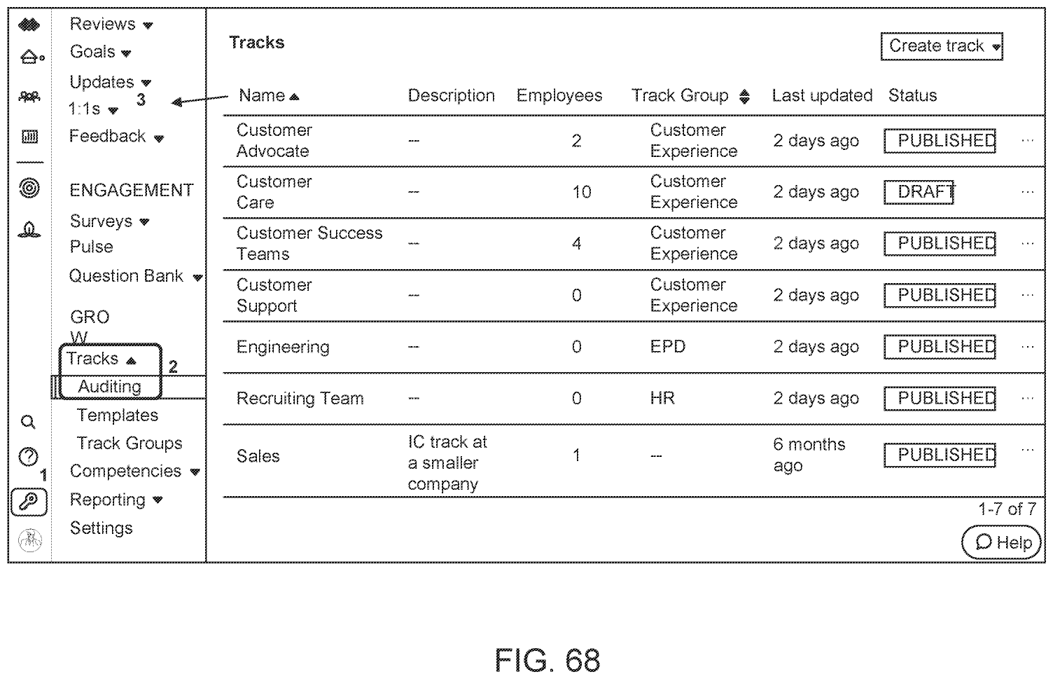

FIG. 68 is a schematic demonstrating how to navigate a user interface to assign track admins to a job track.

Step 3: Select+Track Admins and select the employee(s) you want to add as a track admin.

Step 4: Add Admins and click Done.

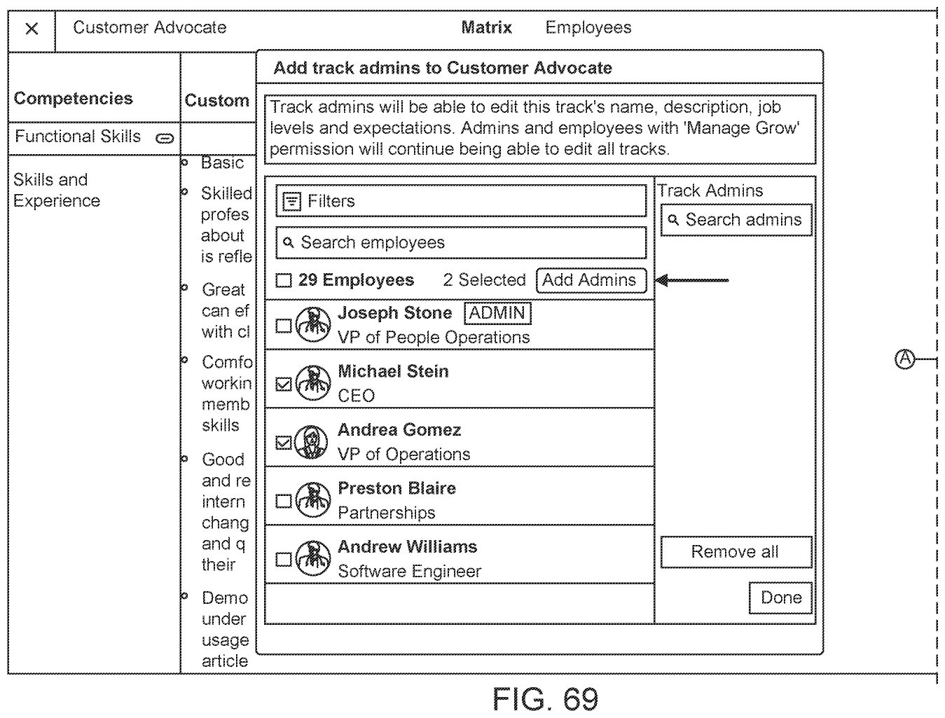

FIG. 69 is a schematic demonstrating how to navigate a user interface to assign track admins to a job track.

Track Admin Visibility

The selected track admin will have an Admin tab with Grow enabled. From here, they will be able to access and manage their assigned track.

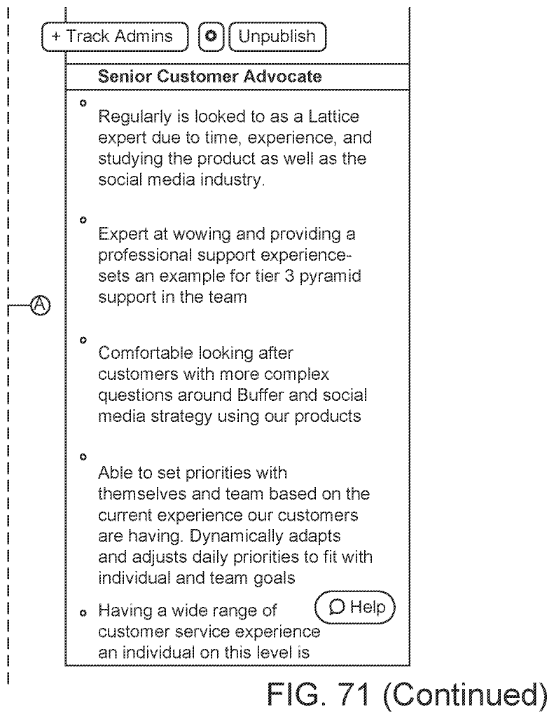

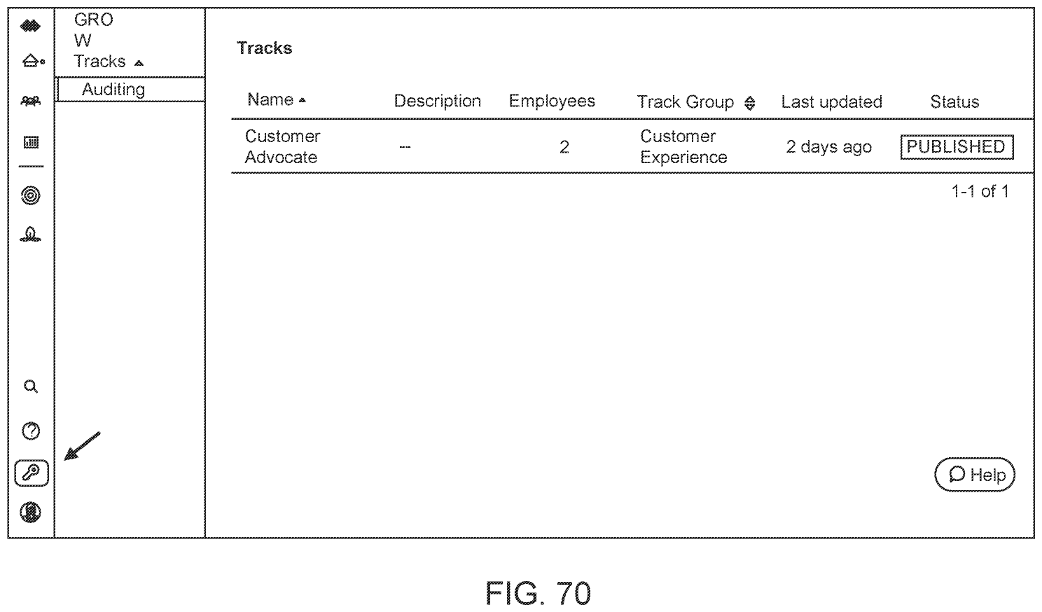

FIG. 70 is a schematic of a user interface displaying tracks assigned to a track admin.

Track admins can:
Assign employees to a track
Create competencies within a track
Add expectations to a track
Access and use Grow Track templates
Publish tracks, if given the permission

How to Allow Track Admins to Publish Tracks

As a Super Admin, you can give track admins the ability to publish. Track admins, by default, are unable to publish the tracks they edit unless given permission.

1. Navigate to Admin>Grow>Settings.

2. Under Track publishing, choose whether track admins can publish their track by selecting either:
Track admins cannot publish tracks
Track admins can publish tracks

3. Select Save.

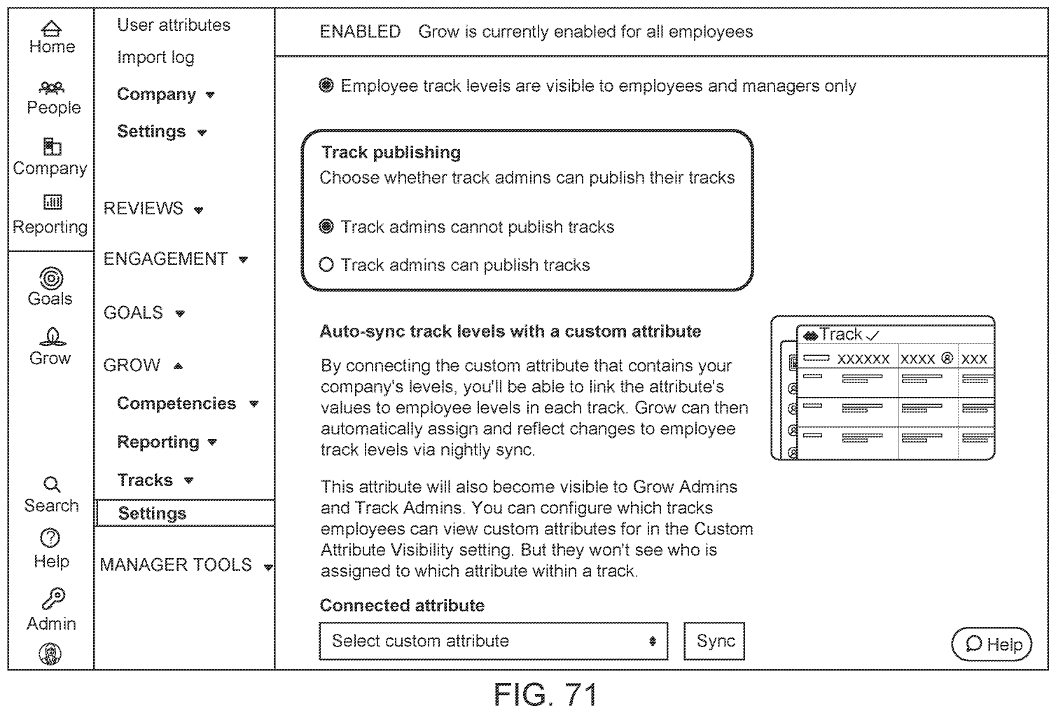

FIG. 71 is a schematic demonstrating how to navigate a user interface to allow or disallow track publishing for a track admin.

Grow Visibility Settings

Should employees see all tracks and everyone's job levels or only their own?

As an admin, you can control the level of transparency for Grow in your company by adjusting track, job level, and track custom attribute visibility.

Navigate to visibility settings

Step 1: Navigate to your Admin page by selecting the key icon found at the bottom of the discovery navigation.

Step 2: Navigate to the Grow tool within the secondary navigation and enter the Settings page.

Track Visibility.

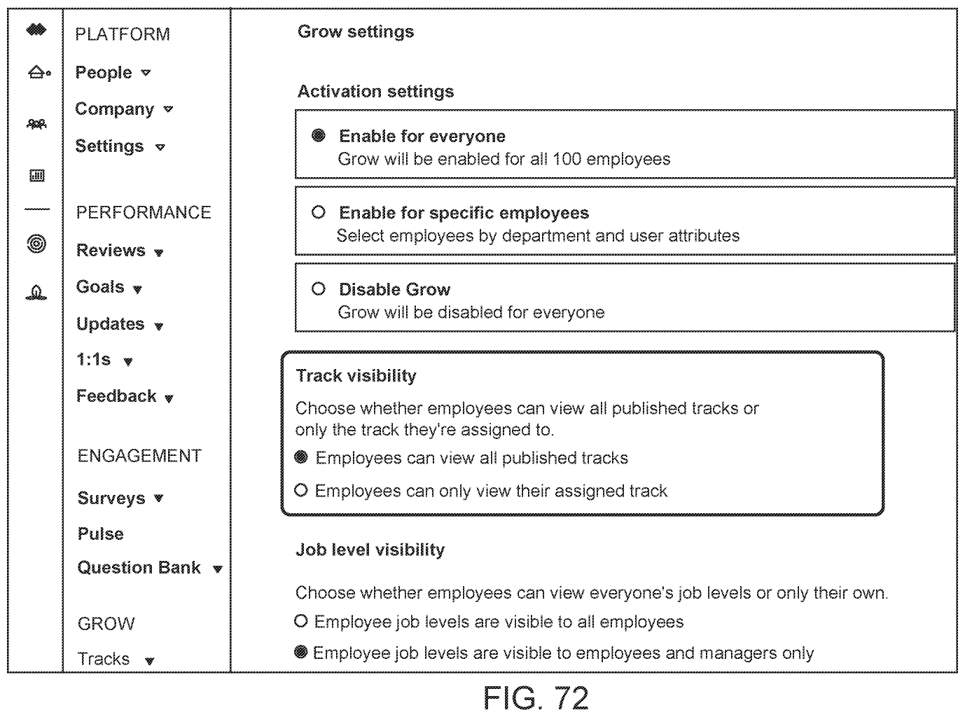

FIG. 72 is a schematic of a user interface displaying grow settings, including the option to edit track visibility for employees.

Track visibility allows you to choose whether employees can view all published tracks in the company or just their own. Wall published tracks are made visible, employees can view them from their Grow page. Otherwise, the Grow page will only show their assigned track and level.

Please note, these settings only apply to published tracks. Only admins can see drafted job tracks.

Job-Level Visibility

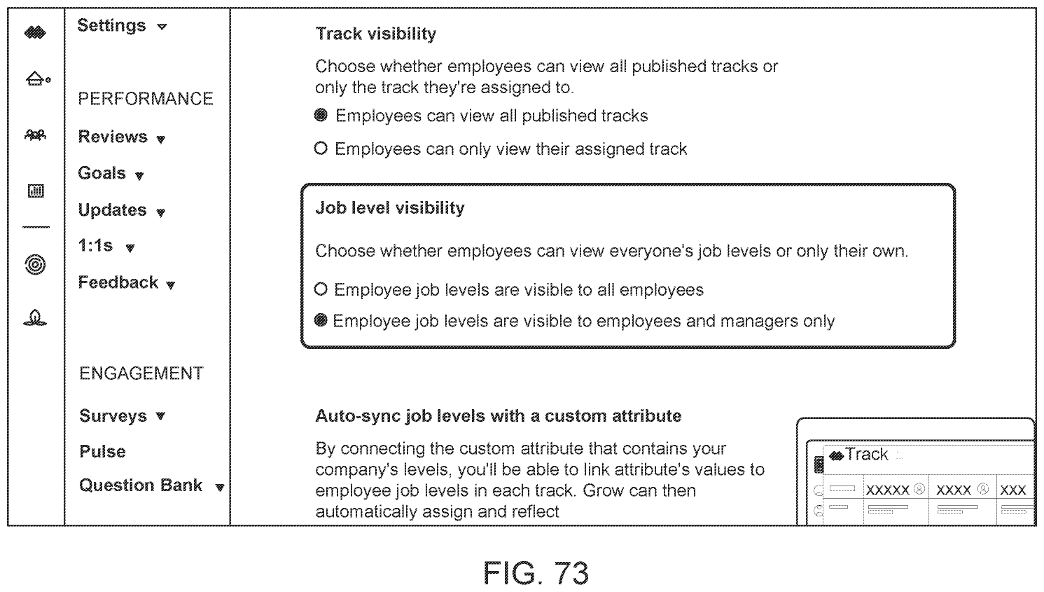

FIG. 73 is a schematic of a user interface displaying grow settings, including the option to edit job level visibility for employees.

Job-level visibility allows you to choose whether employees can view everyone's job levels or only their own. If job level is made visible, employees will be able to view an employee's job level when writing a review or providing feedback based on competencies.

Custom Attribute Visibility

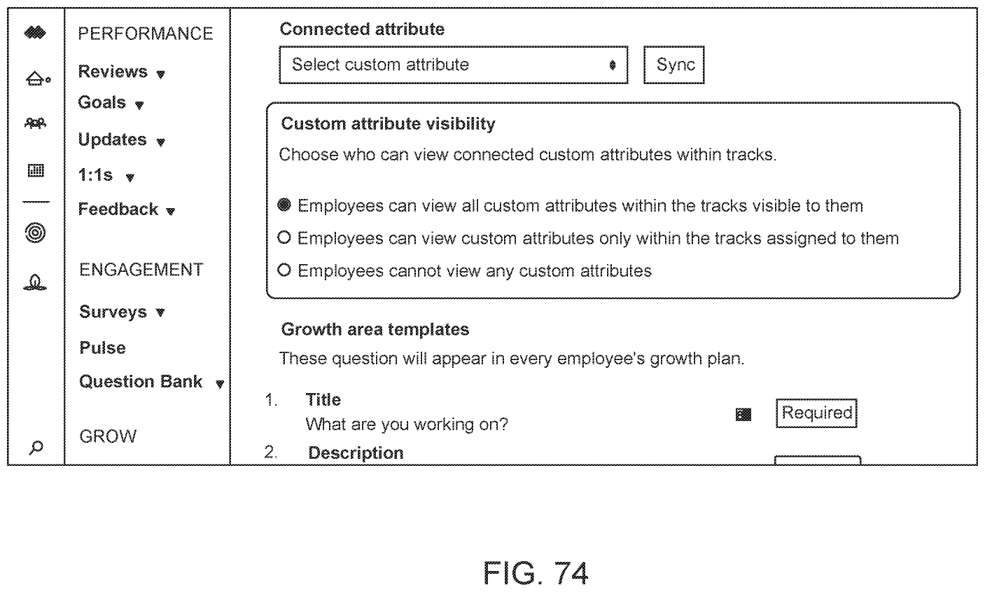

FIG. 74 is a schematic of a user interface displaying grow settings, including the option to edit attribute visibility for employees.

Custom attribute visibility allows you to choose who can view connected custom attributes within tracks. This setting only applies to tracks that have a connected attribute. You can choose whether employees can view, from their Grow page, the connected attribute for their own track, all tracks, or no track.

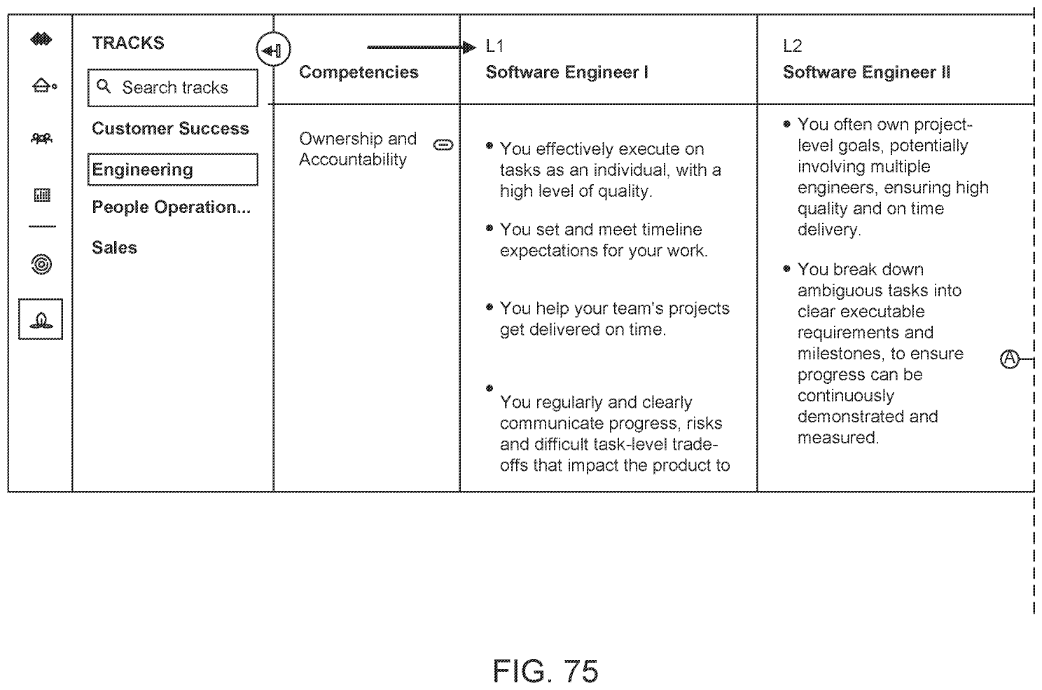

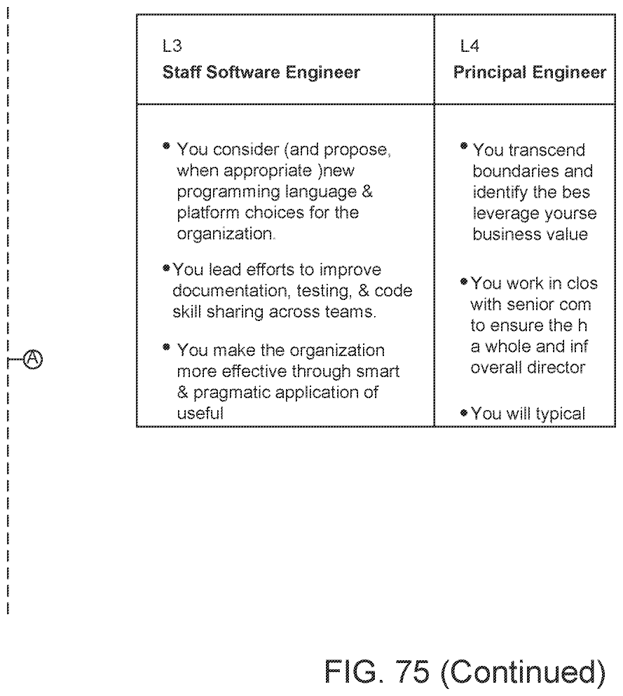

FIG. 75 is a schematic of a user interface displaying a track template matrix in the grow tool.

### Administering Grow

What is Grow?

The Grow tool facilitates employee growth and development. You can evaluate employees' growth throughout time with individualized growth areas, job leveling, and competency enablement. You can customize growth areas to fit individual employees while keeping the focus on your organization leveling structure. These structured pathways help stimulate professional growth and foster high levels of engagement within your organization.

Lattice makes it easier for your organization to get started with Grow by providing track templates directly in the platform that you can use. Track templates, with pre-loaded competencies, levels, and expectations, are a great starting point if your company does not yet have a competency framework in place or if you are looking for best practices to structure a matrix.

Why use Grow?

Grow is ideal for personal objectives that are harder to measure but visible through consistent behaviors. Common examples include: becoming a better public speaker, honing project management skills, or delegating more effectively.

Growth areas align to the competencies required for specific roles or job levels and personal skills. Grow helps answer the question of, “How can I up-level my career and continue to improve as an individual?” Grow gives employees the autonomy to determine and pursue their own development and career aspirations.

From a reporting perspective, Grow allows you to track growth area creation and competency growth—these reports help show which employees are working on themselves and how they're progressing in their careers.

Key Terms for Grow

A glossary of terms for Grow

Many companies use different terms for their job leveling, competencies, and career mapping. Below are key terms used in Lattice to help you build your employee's personal career development roadmap.

### Key Terms

Track: Set clear expectations for each role within your organization and define what it means for an employee to be successful in their role

Track Level: The columns of expectations added to a Grow track. A Grow track must have one or more track levels (i.e., columns in the track). Track levels have a title that describes the role and/or job title (e.g., Software Engineer I, Senior Software Engineer, etc.) and a set of defined expectations per competency for the given level. Each Grow track level can be tied to a job architecture job level by aligning the track to job architecture. When a track is aligned to job architecture, then the first column (track level) will be aligned to the first job level (i.e., IC1).

Competency: Skills or qualities that employees need to embody to succeed in their roles

Competency Theme: Themes that allow you to organize competencies in a track under a single theme

Expectation: A description of what someone in that role needs to do to fulfill each competency

Track groups: Groupings of related tracks, which allow employees to visualize relationships between tracks

Growth area: A process to help employees get from where they are now to where they want to be

Job architecture: An industry term used to refer to the framework or structure that aligns levels, people, and jobs across a company and is used to determine compensation bands and competency frameworks consistently across a company

Job level: The level at which an employee is placed within their job type (e.g., an employee with a job level of IC1 would have a job type of Individual Contributor and be placed at level one of that job type)

Job type: The type of career path that an employee can be on (e.g., Individual Contributor, Management, Professional, Support, etc.)

Job function: The overarching type of work or “job” being done by a group of employees (e.g., a group of employees performs the job functions of Product Design or Software Engineering or Recruiting or People Operations; while employees within these job functions may have a specific title or role which indicates their level or specialty, they are grouped under the umbrella of the overarching job function)

Individual development plan: Individual development plans are created collaboratively between employees and their managers or supervisors that define the employee's short- and long-term career goals and put a plan in place to achieve them

Career vision: Long-term career planning exercises that direct reports share with their managers

### Additional Terms

Job type abbreviation: An abbreviation of the job type (usually 1-3 letters). Prefixed to a number to indicate an employee's job type and job level in tandem (e.g., IC1, IC2, IC3 or M3, M4, M5)

Aligned track: A published or unpublished Grow track that has been aligned to job architecture in Lattice, meaning, an admin has selected both the job type and job function of the track and saved the selection by clicking “Align track”

Unaligned track: A published or unpublished Grow track that has never been or is not currently aligned to job architecture in Lattice, meaning the track has no selected job type or job function

Aligned employee: An employee in Lattice who has an assigned job type and job function and optionally an assigned job level

Unaligned employee: An employee in Lattice who does not have an assigned job type or job function

Grow vs. Goals

When to use Grow versus the Goals tool

If you've been a Lattice customer for a while, you might be using the Goals tool for employee growth and development. Lattice now provides employees with a dedicated space to focus on their own career progression in Grow. We'll break down the factors to consider when deciding which tool to use below.

Goals

The primary use case of the Goals tool is for company operations.

Goals are best for objectives with quantifiable outcomes. Common examples include sales quotas, customer retention rates, or the number of employees hired.

Individual goals align with department and company objectives. Goals help answer the question of, “How can my work help the company?” Typically, individual goals are set within a framework provided by the company, department, or manager.

From a reporting perspective, goals allow you to track participation, alignment, and completion. By focusing on business objectives exclusively, you'll be able to get a much better sense of whether or not employees are accomplishing the essential functions of their roles (and how those individual achievements roll up to the company's success). It can be challenging to take advantage of these reports if your team uses the Goals tool to combine personal and business objectives.

Grow

The primary use case of the Grow tool is for employee growth and development.

Grow is best for personal objectives that are harder to measure but visible through consistent behaviors. Common examples include: becoming a better public speaker, honing project management skills, or delegating more effectively.

Growth areas align to the competencies required for specific roles or job levels and personal skills. Grow helps answer the question of, “How can I up-level my career and continue to improve as an individual?” Grow gives employees the autonomy to determine and pursue their own development and career aspirations.

From a reporting perspective, Grow allows you to track plan creation, growth area creation, and competency growth. These reports help show which employees are working on themselves and how they're progressing in their careers.

How to Enable Grow for your Organization

How to set Grow to be accessible to all or a subset of employees

Lattice allows you to turn on Grow for your entire organization or a smaller group of users. We provide the flexibility you need to help facilitate a phased rollout of the tool if you choose to do so.

Before you start

If enabling the tool for specific employees, employees who are not within the specified attribute will not have visibility to the tracks and growth areas of those who have the tool enabled.

Adjust your activation settings

Step 1: Navigate to Admin>Grow>Settings.

Step 2: Under Activation Settings, select whether you would like the tool turned on for all employees, a specific set of employees, or disabled altogether.

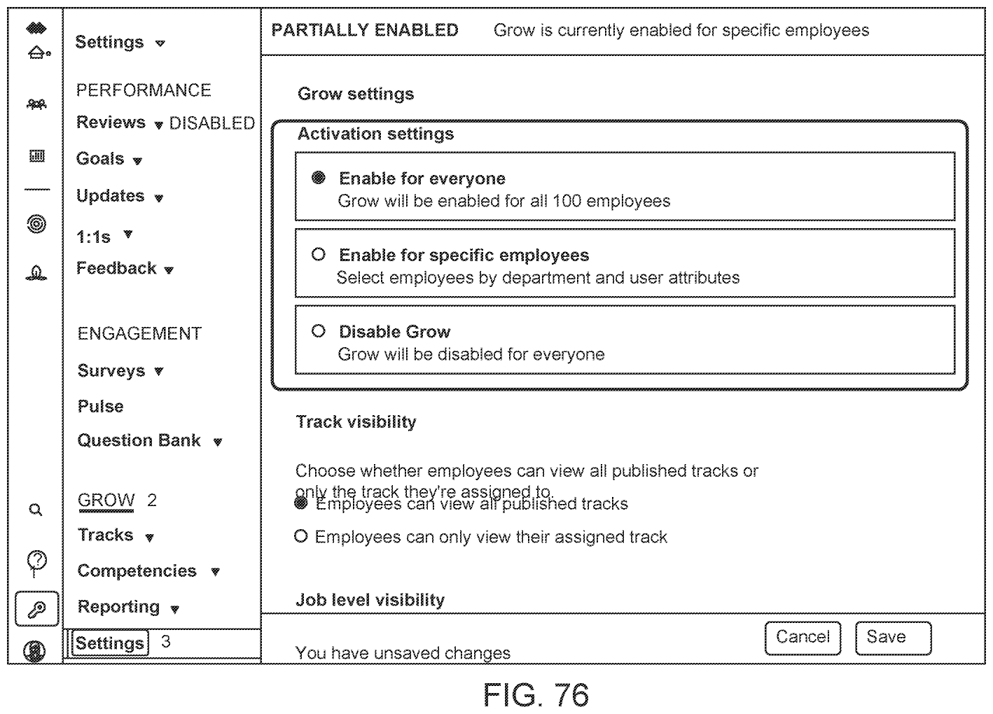

FIG. 76 is a schematic demonstrating how to navigate a user interface to adjust activation settings for the grow.

Step 3: If you choose to turn on Grow for only a subset of employees, you will need to select employees by department or user attributes. This will prevent any user who is not assigned the selected attribute from having visibility into the tool.

Step 4: Save.

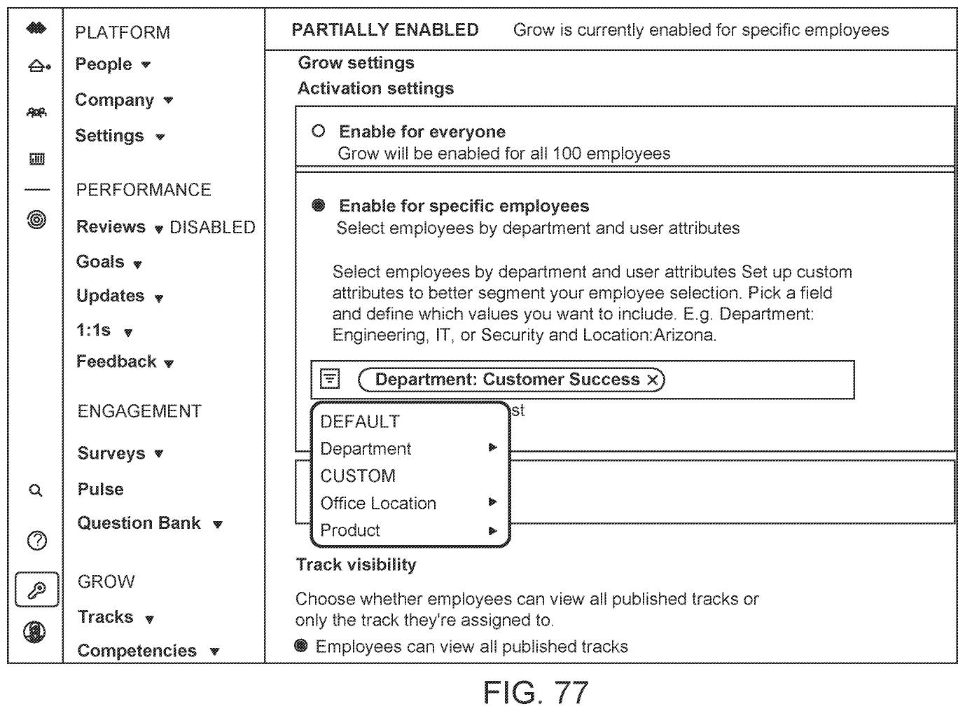

FIG. 77 is a schematic demonstrating how to navigate a user interface to activate the grow tool for a subset of employees.

### A List of Notifications for Grow

A list of notifications for our Grow feature and when you can expect to receive them

Once you have navigated to the Notification Center, there are a few options for how notifications can be sent when it comes to our Grow tool—through Slack/Microsoft Teams and/or through email.

Grow notifications are sent as follows:
When a direct report has created a growth area
When a direct report has updated a growth area
When a manager creates a growth area for a direct report
When a manager updates a growth area for a direct report

To send these through Slack/Microsoft Teams or email, you can check on the boxes to the right of Grow, as shown below.

FIG. 78 is a schematic of a user interface displaying notification delivery methods for the grow tool.

### Direct Report Creates a Growth Area

Once a direct report has created a growth area, the manager will receive the following notification:

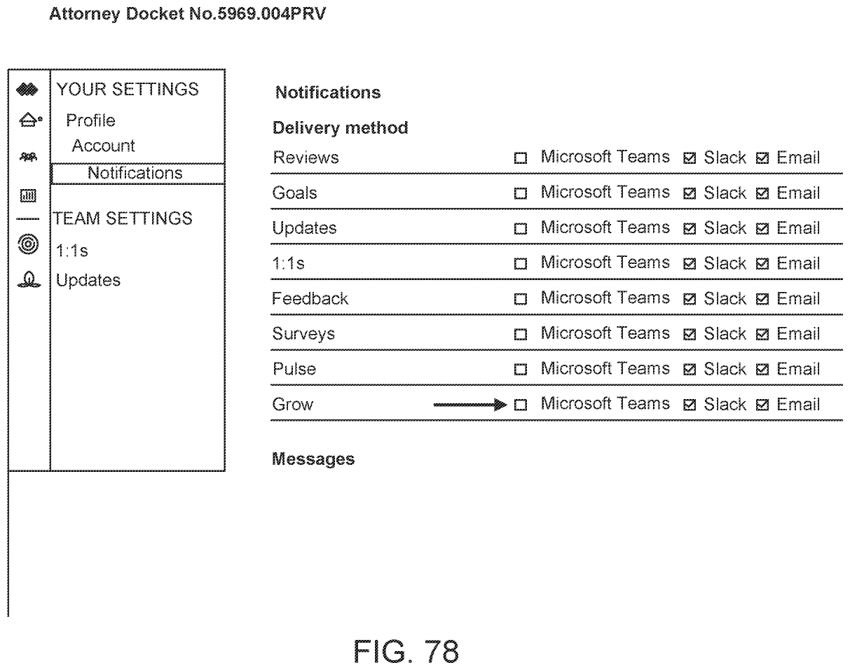

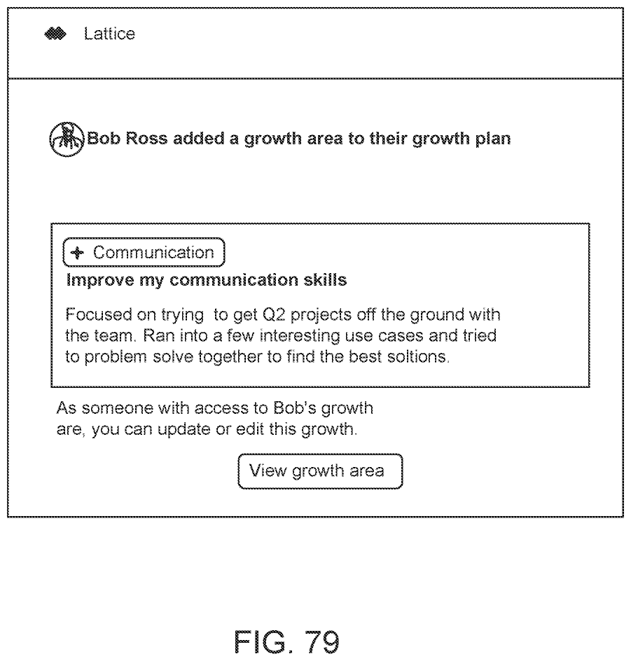

FIG. 79 is a schematic of an example notification generated by the grow tool after a direct report has created a growth tool.

### Direct Report Updates Growth Area

Once a direct report has updated a growth area, the manager will receive the following notification:

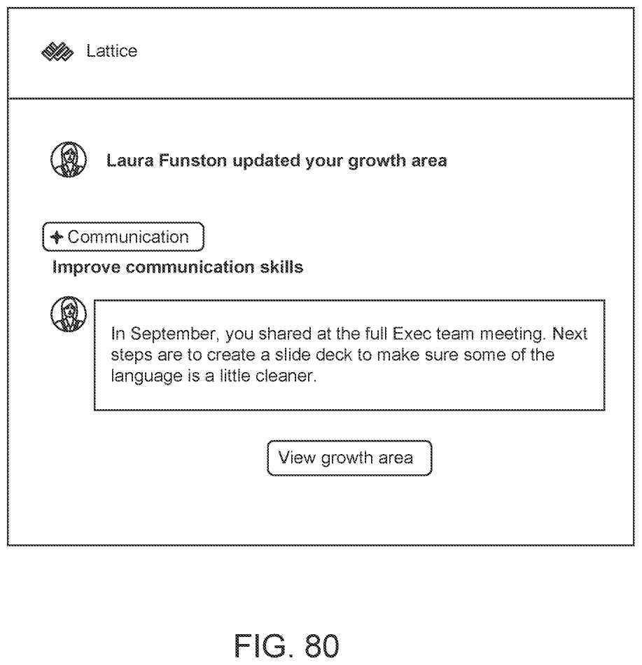

FIG. 80 is a schematic of an example notification generated by the grow tool after a direct report has updated a growth area.

Manager Creates a Growth Area for their Direct Report

Once a manager has created a growth area for their report, the report will receive the following notification:

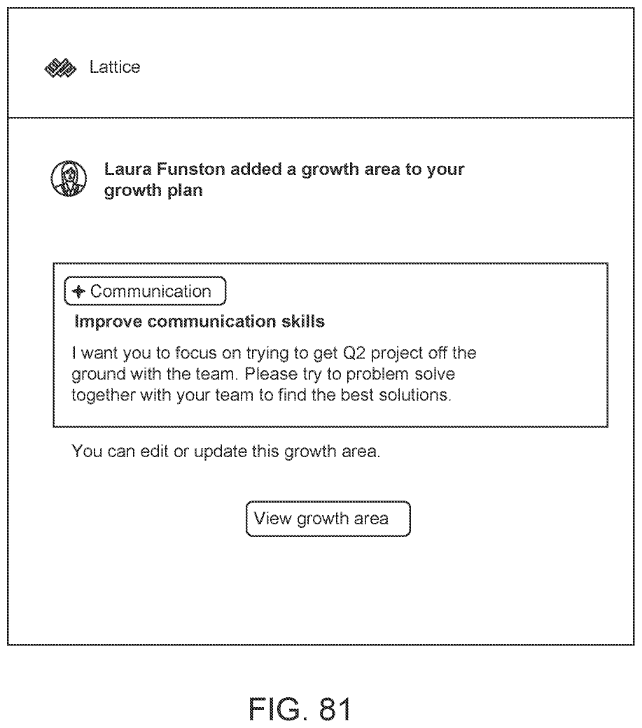

FIG. 81 is a schematic of an example notification generated by the grow tool after a manager has created a growth area for their report.

### Manager Updates Growth Area for a Direct Report

Once a manager has updated a growth area for their report, the report will receive the following notification:

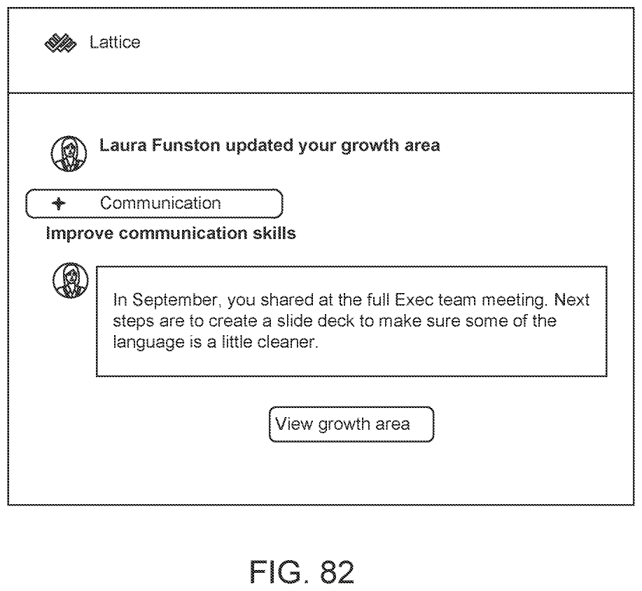

FIG. 82 is a schematic of an example notification generated by the grow tool after a manager has updated a growth area for their report.

### Track Templates

Jumpstart Grow Using a Lattice Rack Template

Lattice makes it easier for your organization to get started with Grow by providing track templates directly in the platform that you can use. Track templates, with pre-loaded competencies, levels, and expectations, are a great starting point if your company does not yet have a competency framework in place or if you are looking for best practices to structure a matrix.

Create a track from a template

Step 1: Navigate to Admin>Grow>Tracks>Templates.

Step 2: Select a specific track template.

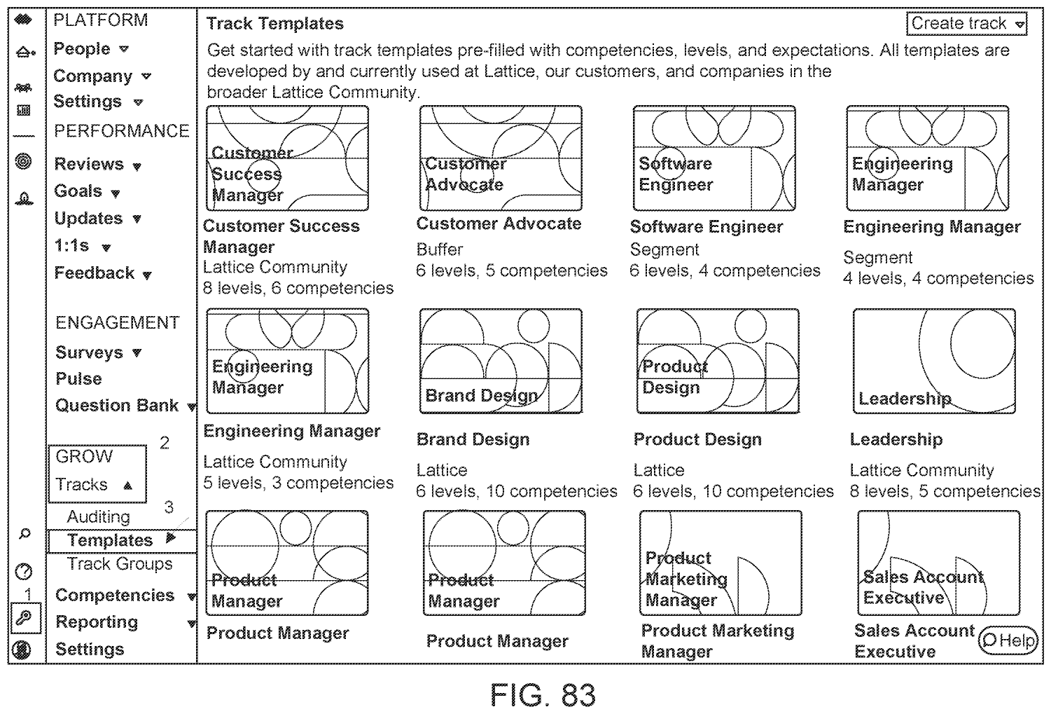

FIG. 83 is a schematic demonstrating how to navigate a user interface to view track templates in the grow tool.

Step 3: Select Use this template.

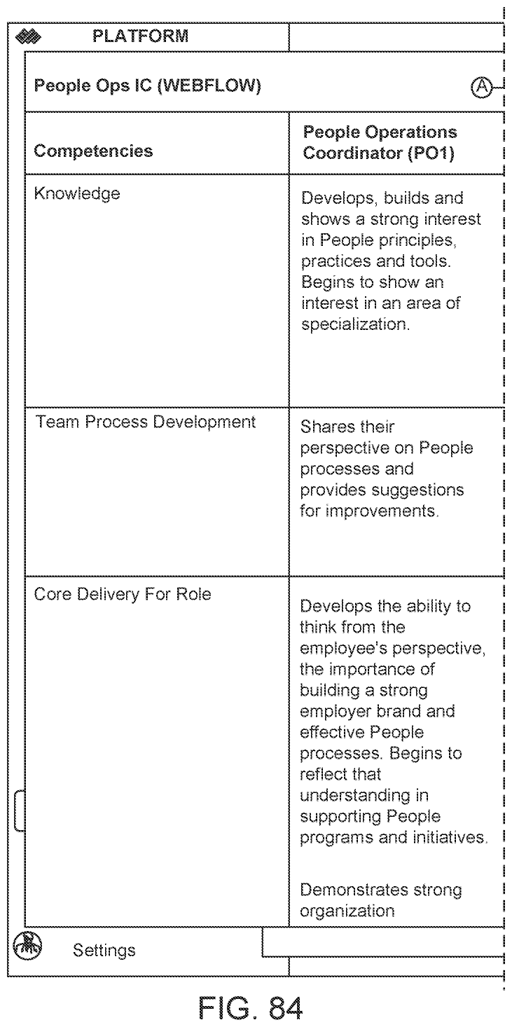

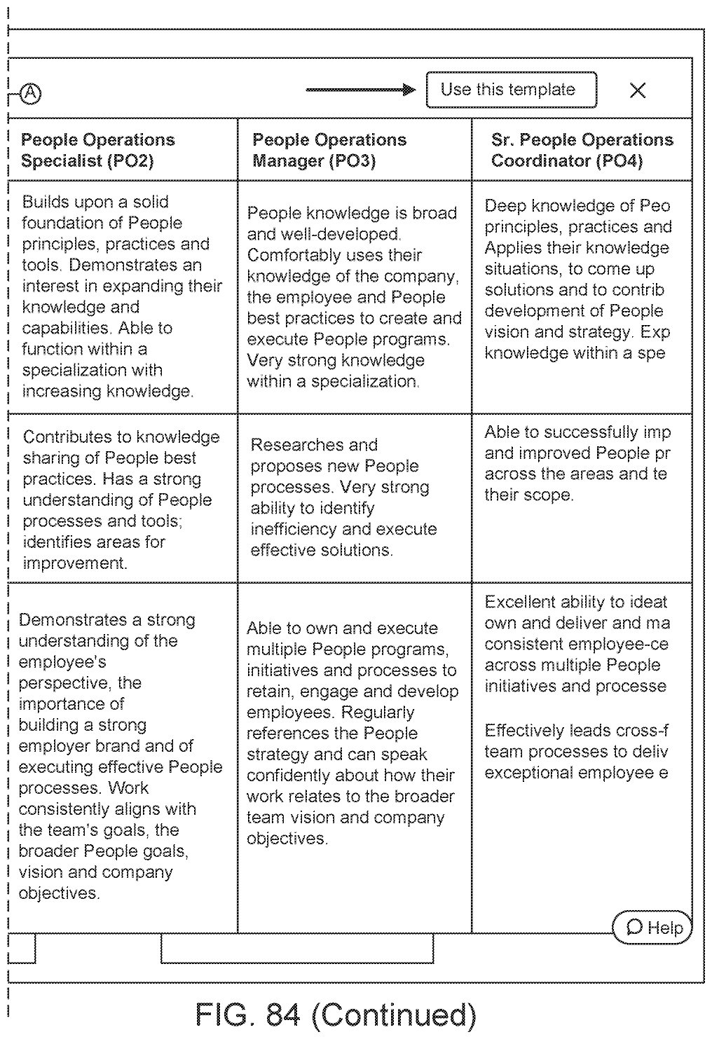

FIG. 84 is a schematic demonstrating how to navigate a user interface to select a track template in the grow tool.

Step 4: Edit the template to include or remove competencies and expectations.

Lattice Individual Contributor and Manager Templates

Along with the numerous templates we provide from our customers and the broader Lattice community, we also provide Individual Contributor and Manager track templates created by our very own Lattice Advisory Services. Template Content

Within both matrices, there are four competency themes; each theme has several competencies within it. The themes are:
Impact: This theme describes what the job is. It's a set of role competencies that articulates the scope and complexity of the role that needs to be done.
Behaviors: This theme describes how the job gets done. It's a set of behavioral competencies that articulates the inherent behaviors that convey the collaboration and communication that an individual in the role should exhibit.
Management (only for managers): This theme describes people management work that the role requires. It's a set of management competencies that articulates the characteristics of effective leaders and translates them into measurable behaviors.
Functional skills: This theme describes what skills and experience are necessary to do the role. It's a set of technical competencies that articulates the application of knowledge and skills needed for success in specialized fields.

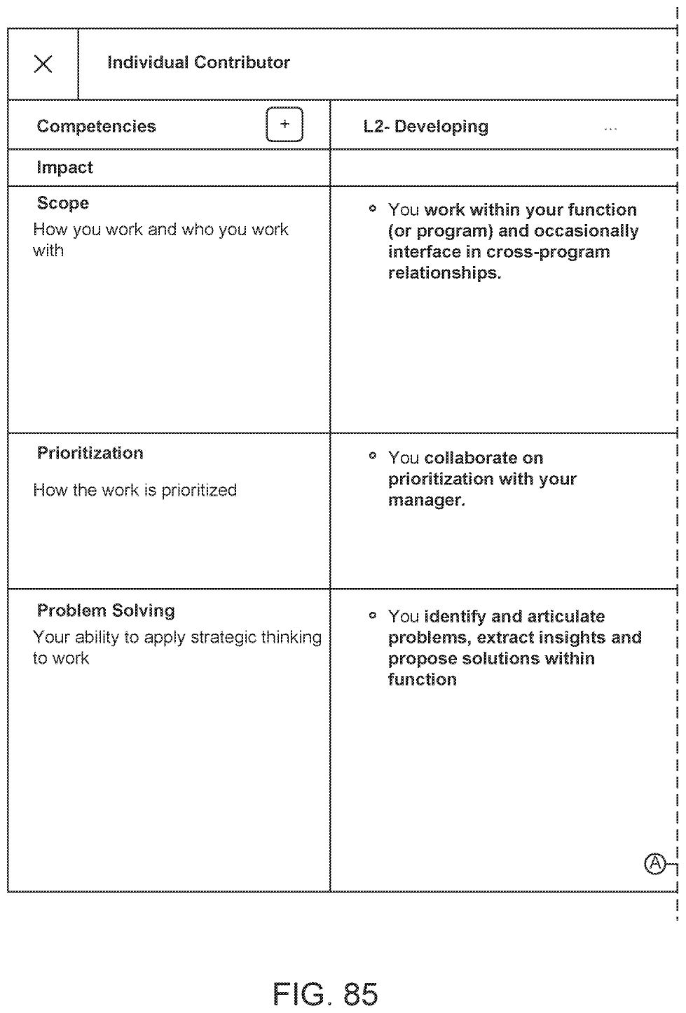

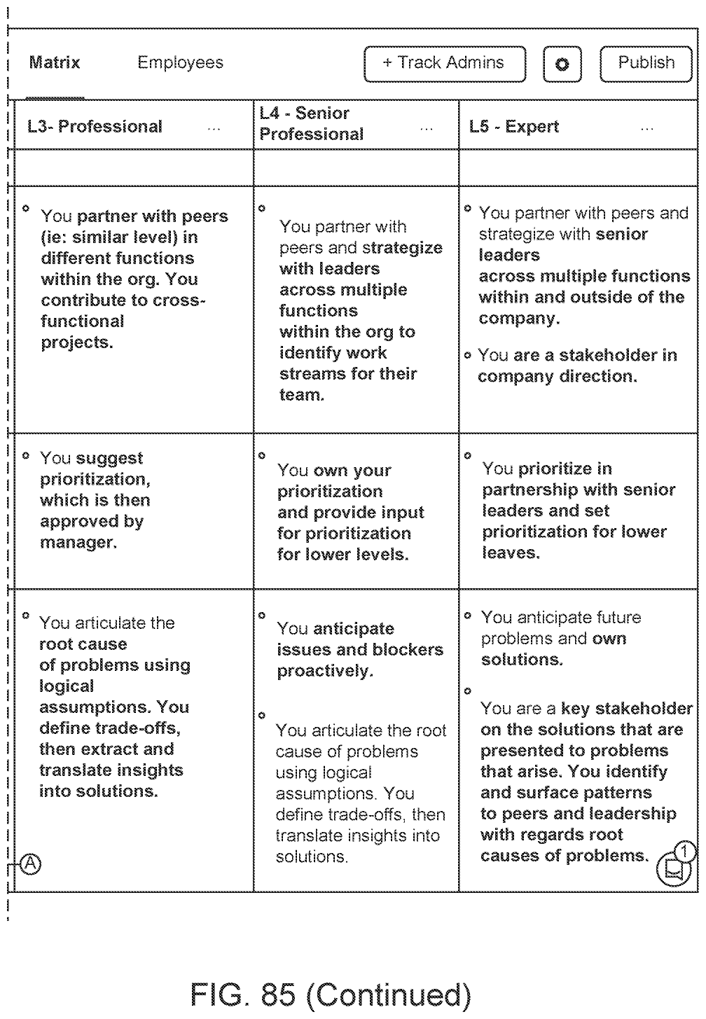

FIG. 85 is a schematic of a user interface displaying a matrix of competency themes and associated competencies for a track template.

### Different Templates for Different Sized Companies

There are two company sizes that have corresponding Grow templates: smaller and larger. Smaller company matrices are automatically included in Lattice for organizations with 150 employees or fewer. Larger companies with more than 150 employees will have a different set of matrices.

The two templates are different in the following ways:
1. The number of competencies. Both template sizes include all four sections defined above: Impact, Behavior, Management, and Functional Skills. However, the larger company template includes the following competencies that the smaller company template does not, given the ever-changing nature of work at growing (smaller) companies:
   Impact: Autonomy
   Behavior: Collaboration
   Management: Supervision
   Functional Skills: Product Knowledge
2. The number of job levels. The smaller company template has four job levels (L2-L5), and the larger company template has six job levels (L1-L6). Once an organization hits a certain size, the expanded specialization requirements merit adding a Level 1 and Level 6 to account for additional junior- and senior-level work.
   Level 1 is added into the larger company template as companies can hire more junior talent, and increased mentorship and management resources are available.
   Level 6 is added to the larger company template as companies mature, and the organization requires more senior-level work and executive presence.
   List of pre-filled track templates available

The following templates are available in Lattice:

| | |
|---|---|
| Customer Success Manager | Customer Advocate (Buffer) |
| (Lattice Community) | |
| Software Engineer (Segment) | Engineering Manager (Segment) |
| Engineering Manager (Lattice | Brand Design (Lattice) |
| Community | |
| Product Design (Lattice) | Leadership (Lattice Community) |
| Product Manager (Buffer) | Product Manager (Segment) |
| Product Marketing Manager | Sales Account Executive |
| (Lattice) | (Lattice Community) |
| Finance (Samsara) | Software Engineer (Lattice |
| | Community) |
| Technical Support Specialist | Overall (VSCO) |
| (Braze) | |
| People Ops IC (Webflow) | People Ops Manager (Webflow) |
| Individual Contributor | Manager (Lattice Advisory |
| (Lattice Advisory Services) | Services) |

### Create a Track

### Creating Tracks for Each Role in Your Organization

Tracks help set clear expectations for each role within your organization and define what it means for an employee to succeed. In turn, tracks set the company up for its own success.

There are three different ways you can create a track in Lattice:
1. Create from scratch
2. Upload from CSV
3. Create from template

In the next section, we will focus on creating a track from scratch.

### Creating a Track

Step 1: Navigate to Admin>Grow>Tracks.

Step 2: Select Create track>Create from scratch.

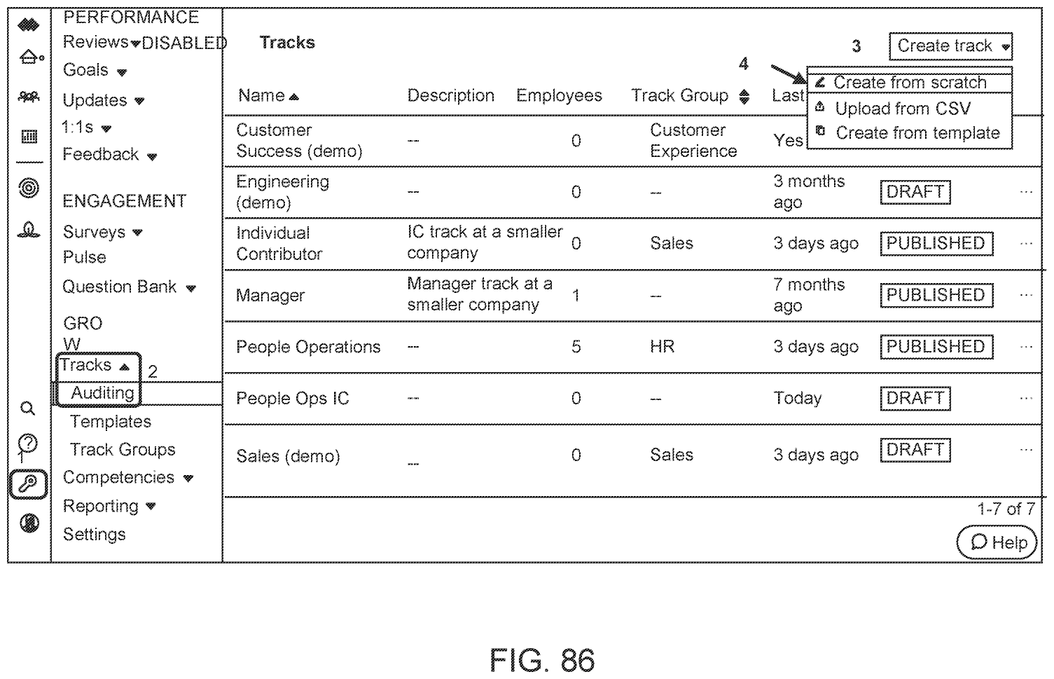

FIG. 86 is a schematic demonstrating how to navigate a user interface to create a track from scratch in the grow tool.

Step 3: Name the track and add a description to give the track additional detail.

Step 4: Select Create track,

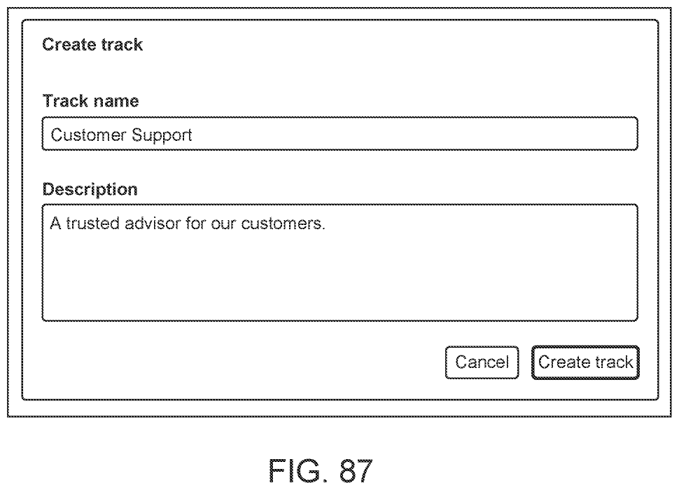

FIG. 87 is a schematic of a user interface displaying text boxes for a user to provide a name and description for a track.

Adding Competencies to Your Track

Once the track has been created, we can now add competencies created beforehand in our Competency Library or create a new competency from scratch within the track itself.

Step 1: Click on the plus (+) next to the Competencies header on the top-left corner.

Step 2: Select Add competency.

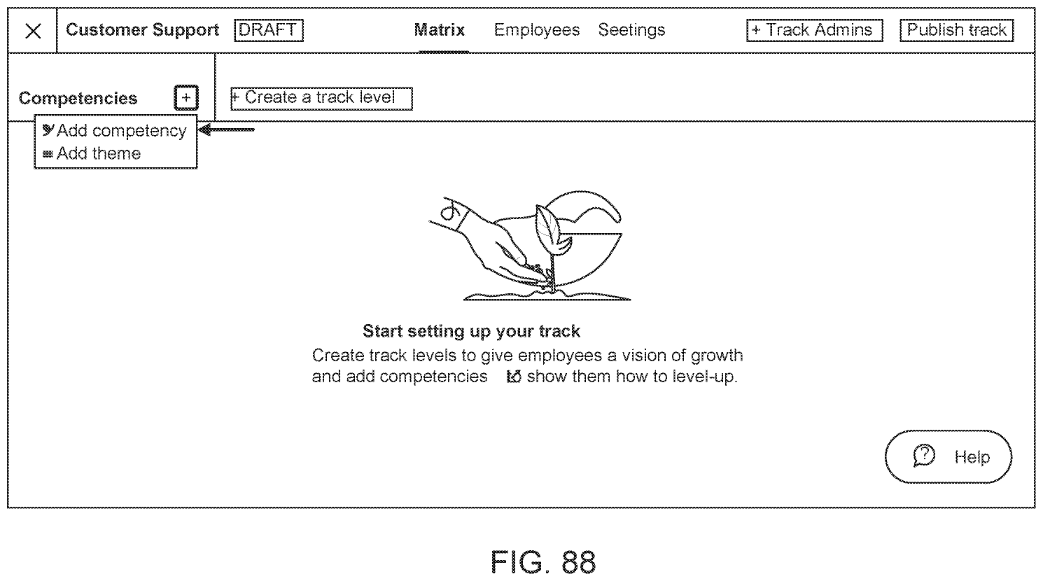

FIG. 88 is a schematic demonstrating how to navigate a user interface to add a competency to a newly created track.

Step 3: If the competency has already been created, select the competency from the dropdown. If you want to use one of our pre-created competencies, select Lattice and choose a competency from the Competency Library.

Otherwise, create a new competency by entering a new name. Add a description for additional detail.

Step 4: Select+Add [Competency] to [Track name] track.

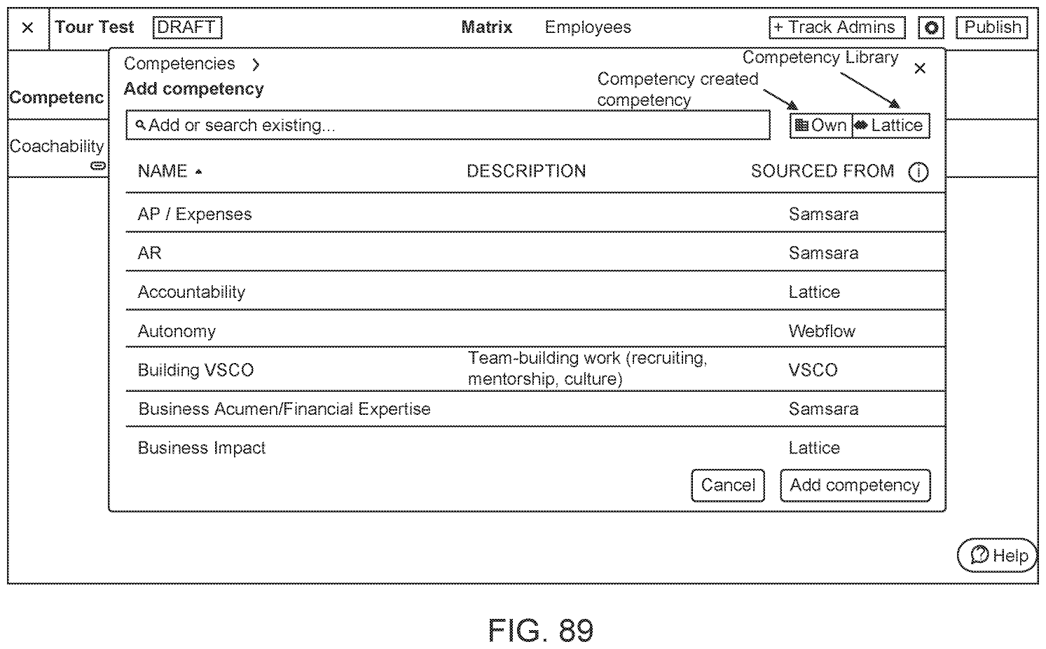

FIG. 89 is a schematic of a user interface displaying competencies to be added to a track.

Step 5 (Optional): Add competency themes to help organize your competencies within related groups in your track.

### Adding Levels to Your Track

Levels help define progress for your employees by helping you set expectations for each competency.

Step 1: Select+Create a track level.

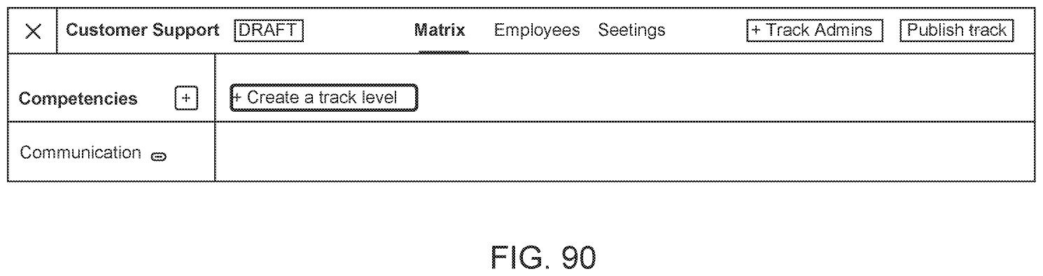

FIG. 90 is a schematic demonstrating how to navigate a user interface to add levels to a competency in a track.

Step 2: Name the level and add a description.

Step 3: Add three to five expectations to each level for all competencies. These can be formatted using bullet points, paragraphs, or a list.

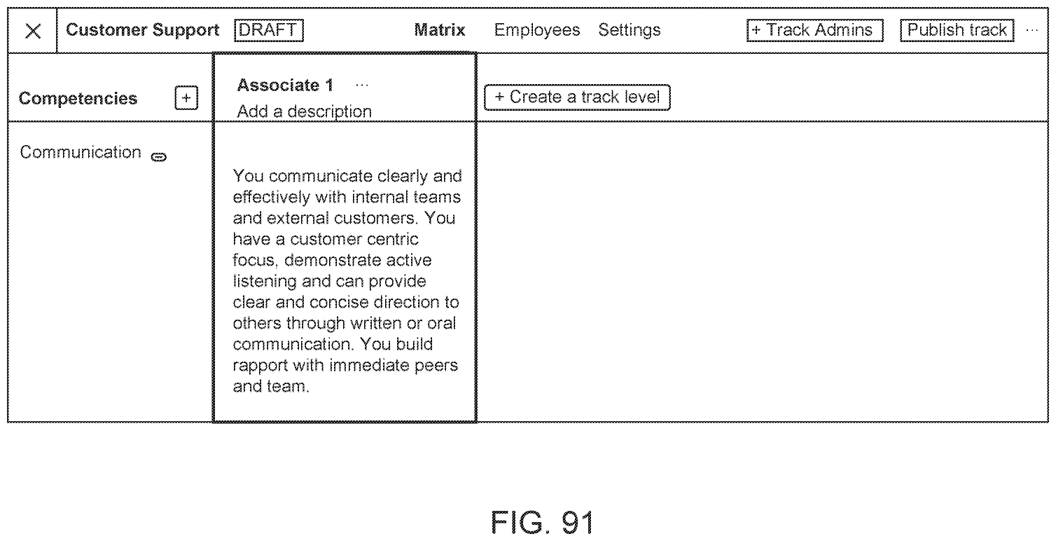

FIG. 91 is a schematic of a user interface displaying expectations for a competency level.

### How to Upload a Track Via CSV

### Create a Track by Importing Your Data Using a CST

Lattice makes it easy to add a track by allowing admins to upload competencies and levels by CSV.

Uploading a Track from a CSV

Step 1: Navigate to Admin>Grow>Tracks>Auditing.

Step 2: Select Create Track and then Upload from CSV.

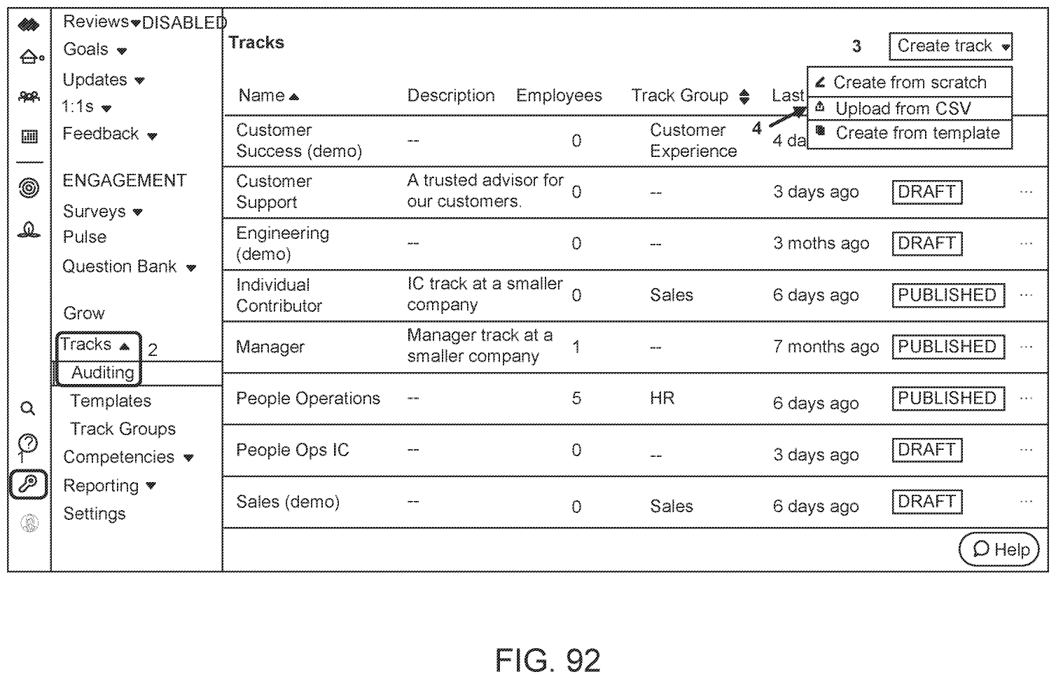

FIG. 92 is a schematic demonstrating how to navigate a user interface to create a track from a CSV.

Step 3: Download our CSV template.

Step 4: Name your track and add any corresponding competencies, levels, and expectations.

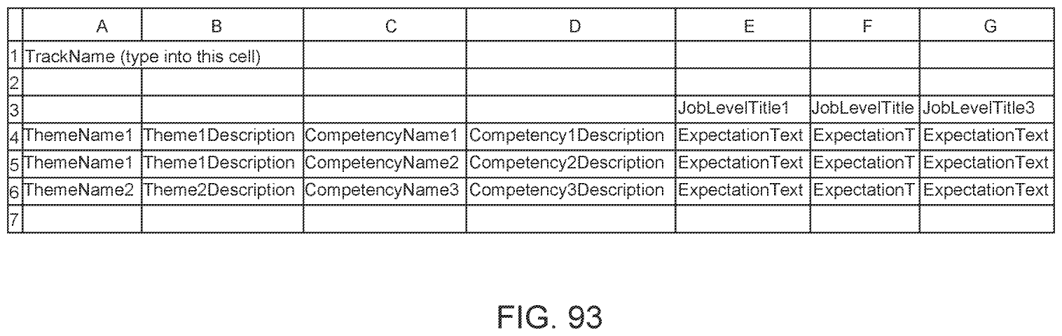

FIG. 93 is a schematic of a generic CSV template.

Please note: Your .csv needs to use commas as separators. Please make sure there are NO empty rows in the matrix.

Step 5: Upload CSV into the platform and select Add to Lattice.

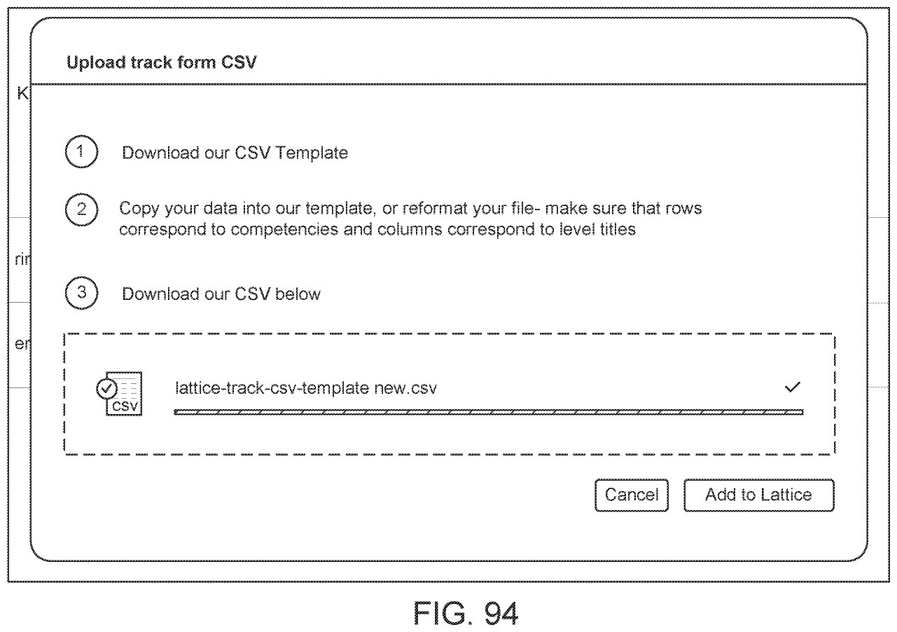

FIG. 94 is a schematic of a user interface displaying a CSV template being uploaded to the platform.

Step 6: If necessary, make any adjustments to your track within the matrix.

### Create a Competency

How to Create Competencies within the Competencies or Track Sections why are Competencies Valuable?

Competencies are an essential way to give employees a clear vision of getting to the next level in their job track and helping your team effectively customize internal training and recruit and assign staff. They are a great way to evaluate performance and identify any skill gaps more efficiently. Lattice allows you to create your own competency or use one of our pre-filled competencies from our Competency Library.

There are at least two ways to create competencies within Lattice:
Create a competency from the Competencies Auditing page
Create a competency in a track

Create a competency from the Competencies Auditing page

Step 1: Navigate to Admin>Grow>Competencies>Auditing.

Step 2: Click Create competency.

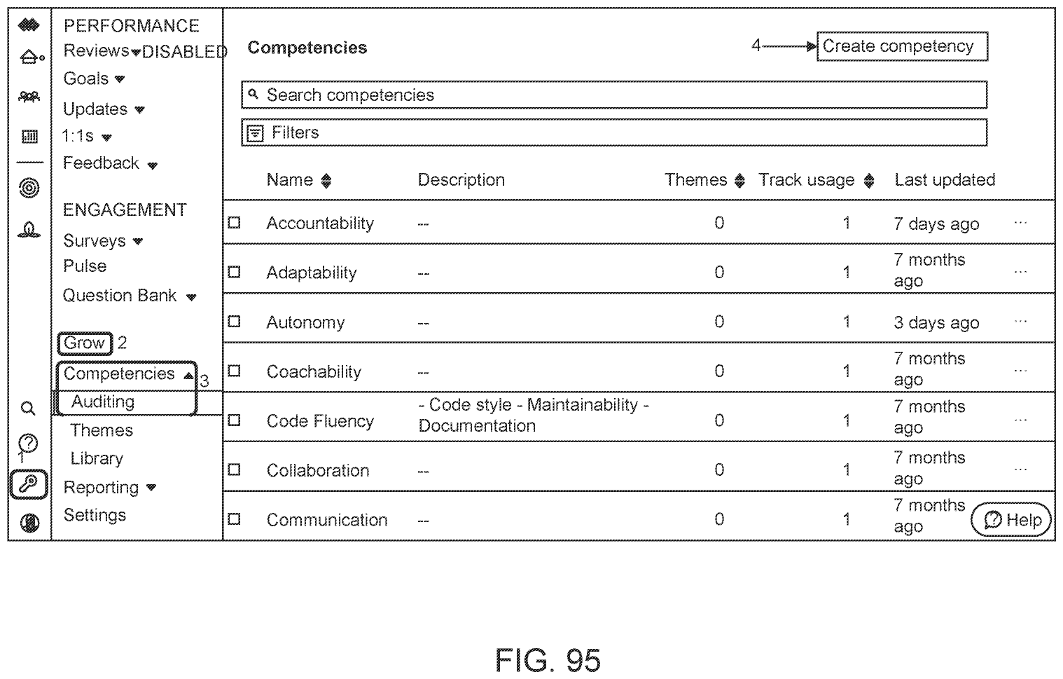

FIG. 95 is a schematic demonstrating how to navigate a user interface to create a competency from the competencies auditing page.

Step 3: The competency modal will appear—Add a name for your competency.

Step 4 (Optional): Include a description of how you will measure your competency and select to add the competency to a particular draft track or all draft tracks.

Step 5: Select Create competency.

FIG. 96 is a schematic of a user interface displaying text boxes to add a name and description to draft tracks.

If you decide to add the competency to track at a later time, you can do so within the track itself.

Create a competency in a track

Step 1: Navigate to Admin>Grow>Tracks>Auditing.

Step 2: Select the desired draft track or create a new track.

Please note: If you would like to edit a published track, you will first need to unpublish the track.

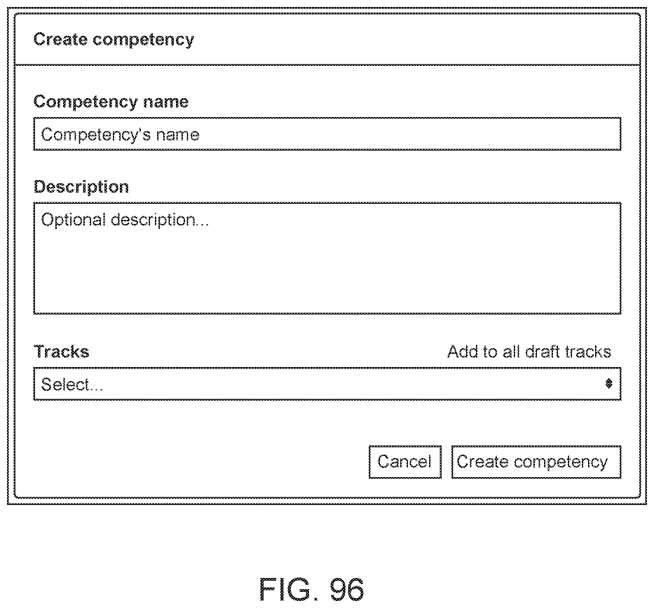

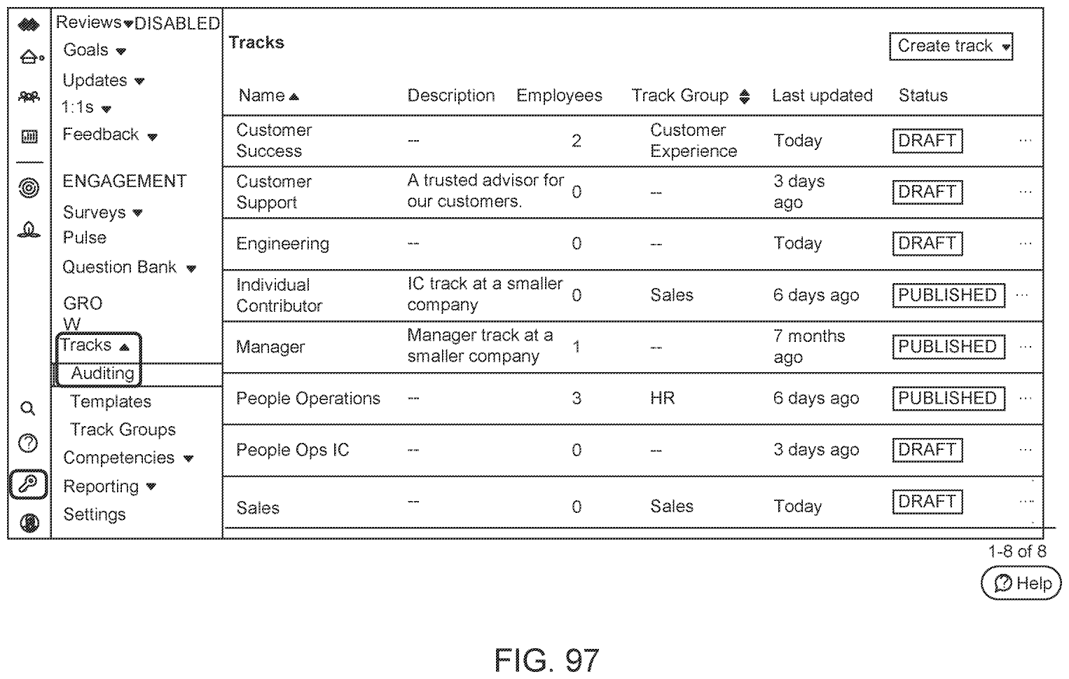

FIG. 97 is a schematic demonstrating how to navigate a user interface to select a track and create a competency for that track.

Step 3: Click on the plus (+) next to the Competencies header on the top-left corner.

Step 4: Select Add competency.

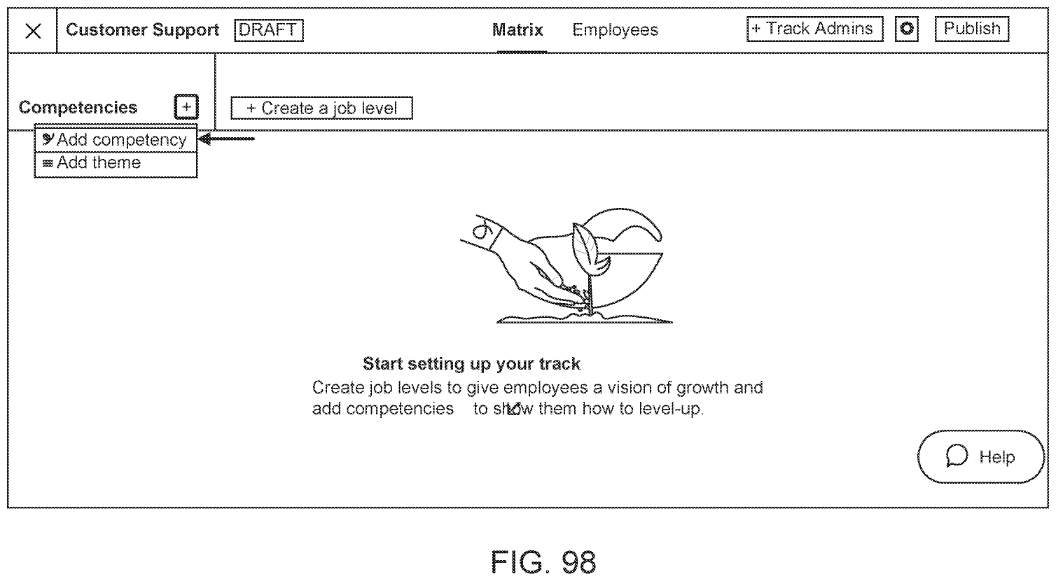

FIG. 98 is a schematic demonstrating how to navigate a user interface to add a competency to a track.

Step 5: Create a new competency by entering a new name. Add a description for additional detail.

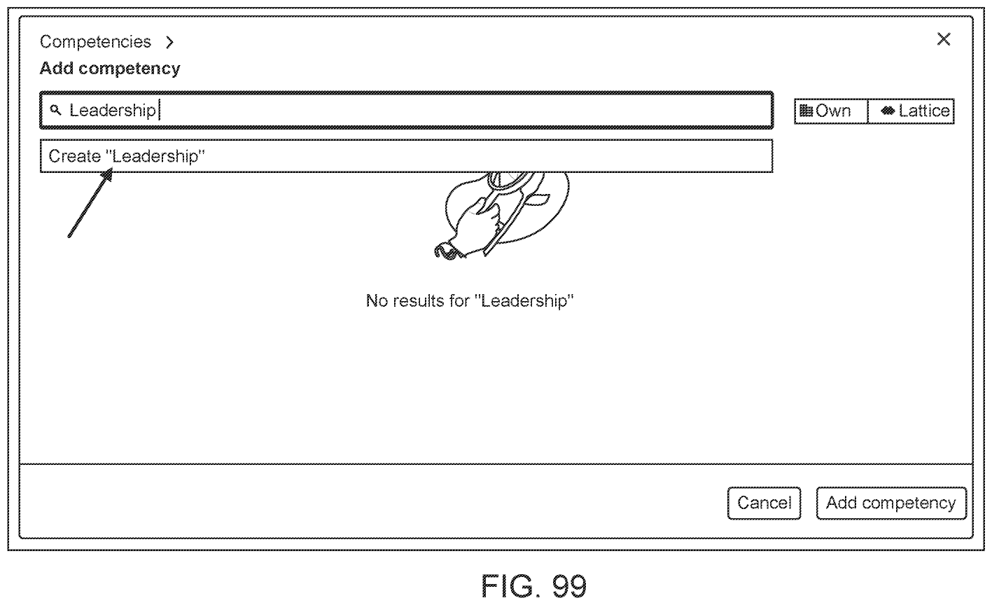

FIG. 99 is a schematic of a user interface displaying the option to create a new competency by entering a new name.

Step 6: Select Add competency.

Step 7 (Optional): To reorder the competencies, select the gear icon in the right-hand corner and click Reorder competencies.

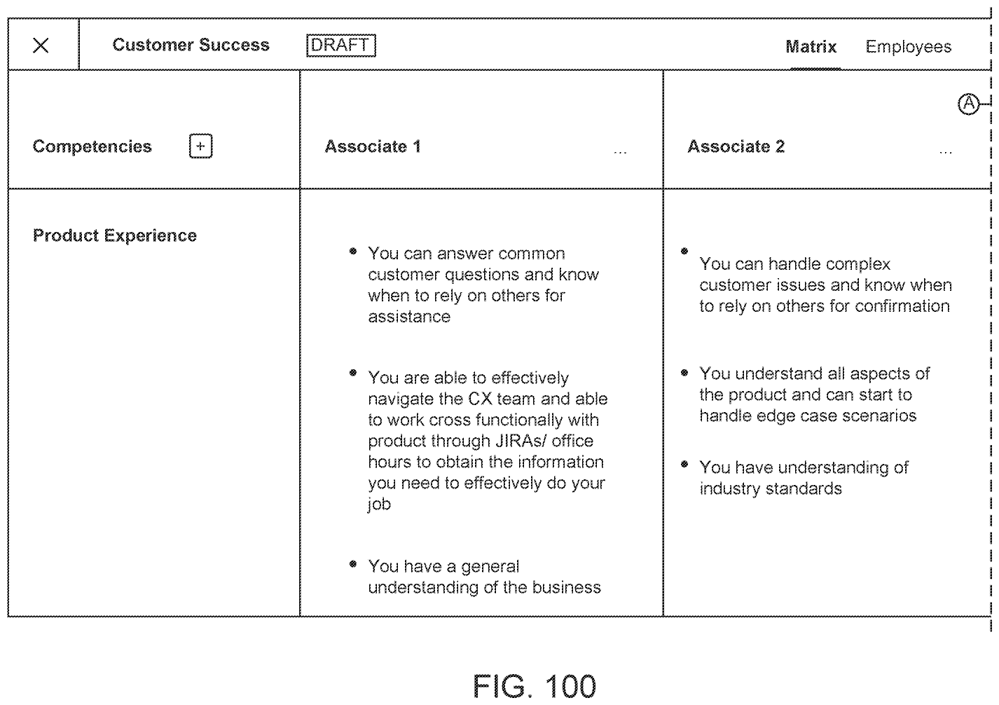

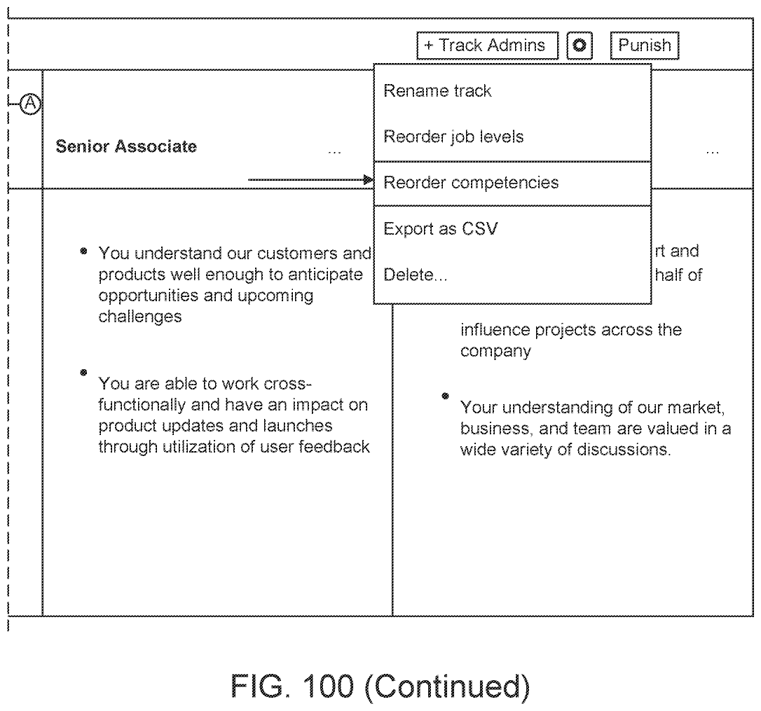

FIG. 100 is a schematic demonstrating how to navigate a user interface to reorder competencies.

### The Competency Library

View all competencies used in track templates in one place

In the Competency Library, admins can quickly explore sourced competency examples from our team, our customers, and anonymous sources within the Lattice community. To help you start developing your career framework, the library includes competencies from our Track Templates that you can use within your own tracks.

Before you start

Competencies can't be added to tracks from the library on this page. However, you can add Library competencies directly within the track.

Accessing the Competency Library

Step 1: Navigate to Admin>Competencies>Library.

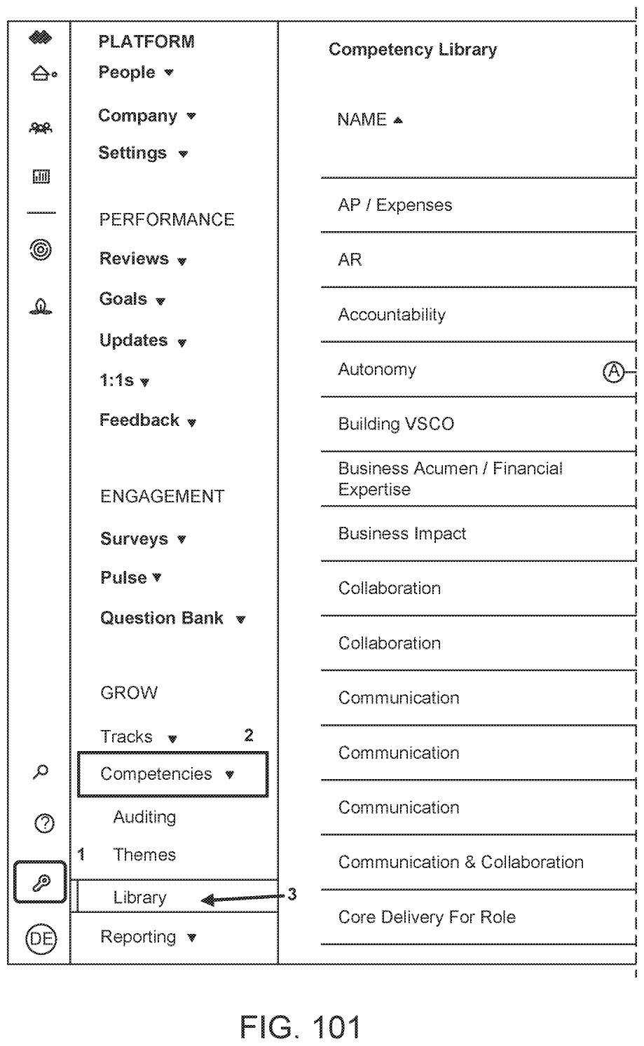

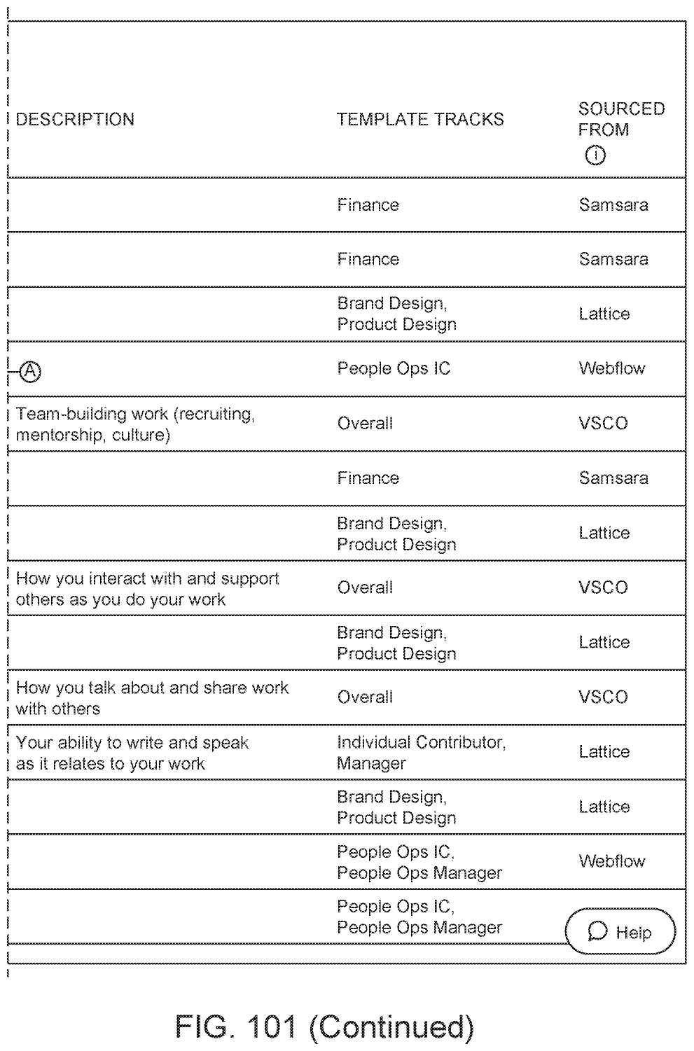

FIG. 101 is a schematic demonstrating how to navigate a user interface to access the competency library.

Step 2: Clicking on a competency will open a window where you can see the competency's levels and expectations.

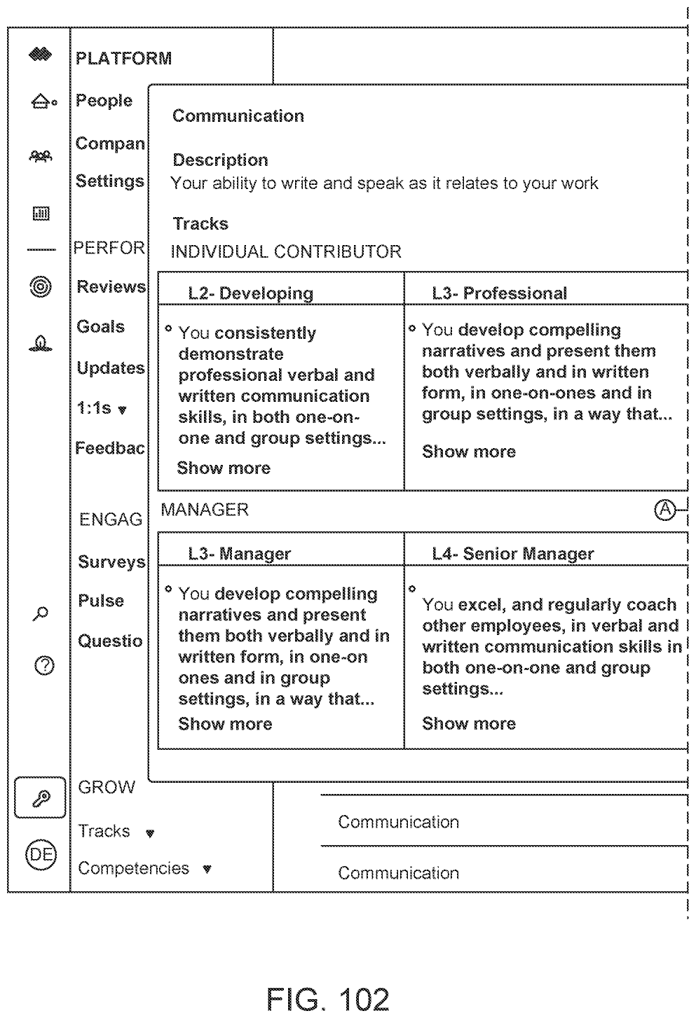

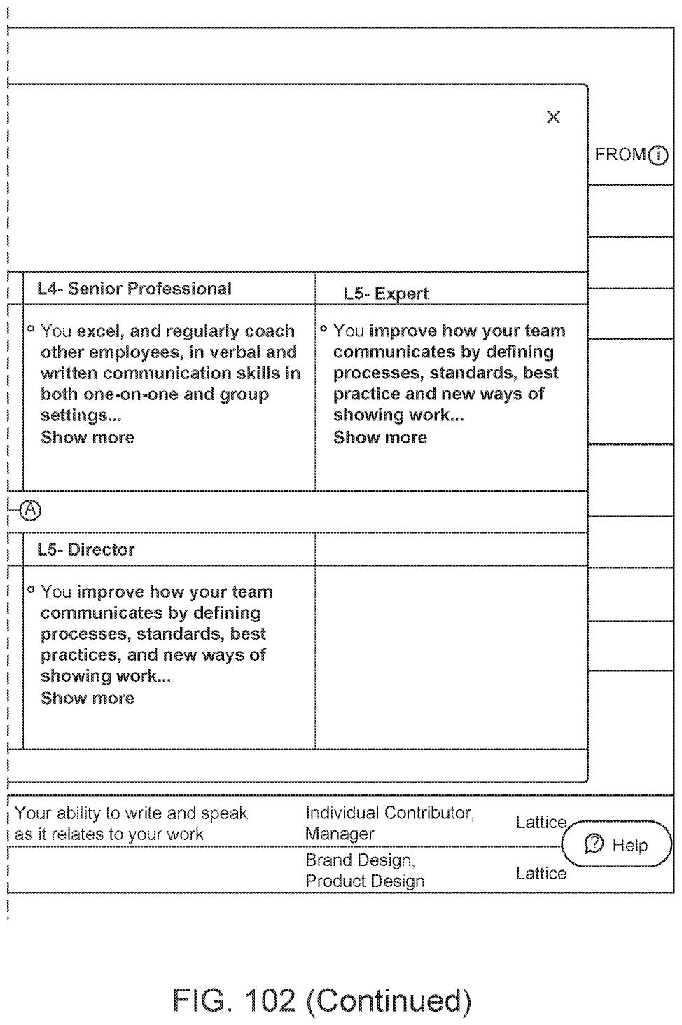

FIG. 102 is a schematic of a user interface displaying a competency's levels and expectations.

The library includes the following information on each competency:
Name
Description
Template tracks the competency belongs to
The Lattice community source

### How to Create Competency Themes

### How to Create Competency Themes and Group Your Competencies Under a Track

Why Use Competency Themes?

Competency themes are a great way to help organize related competencies within a track and group them under a single theme.

Create a Competency Theme

Step 1: Navigate to the Admin>Grow>Competencies>Themes.

Step 2: Select Create theme.

FIG. 103 is a schematic demonstrating how to navigate a user interface to create a competency theme.

Step 3: A popup modal will appear; give the theme a name and description.

Step 4 (optional): Add the theme to a drafted track.

Step 5: Select Create theme.

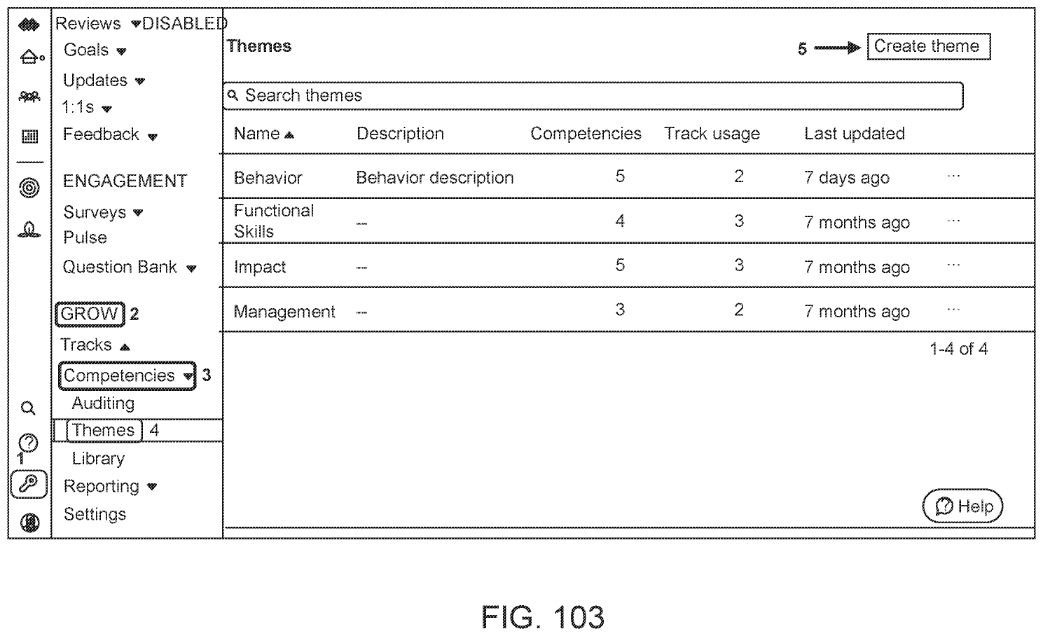

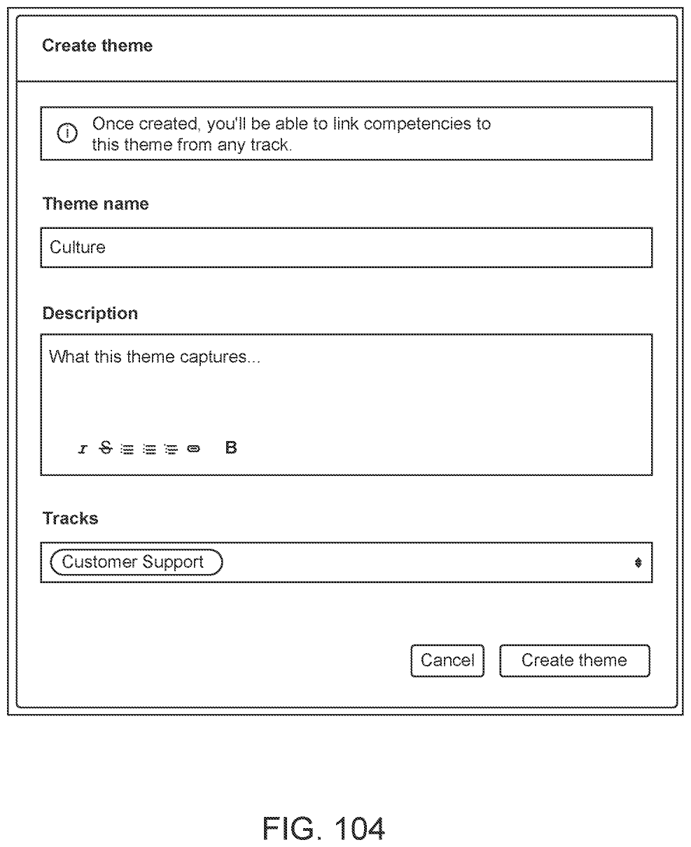

FIG. 104 is a schematic of a user interface displaying text boxes to add a name and description to a competency theme.

### How to Add Competency Themes to a Track

Once you have created a competency theme, you need to add the theme to the track and group the competencies to the theme.

Before you start

Tracks must be in draft to be edited. If your track is published, you will need to unpublish it before making any changes.

Add a competency theme to a track

Step 1: Navigate to Admin>Tracks>Auditing.

Step 2: Enter the desired draft track.

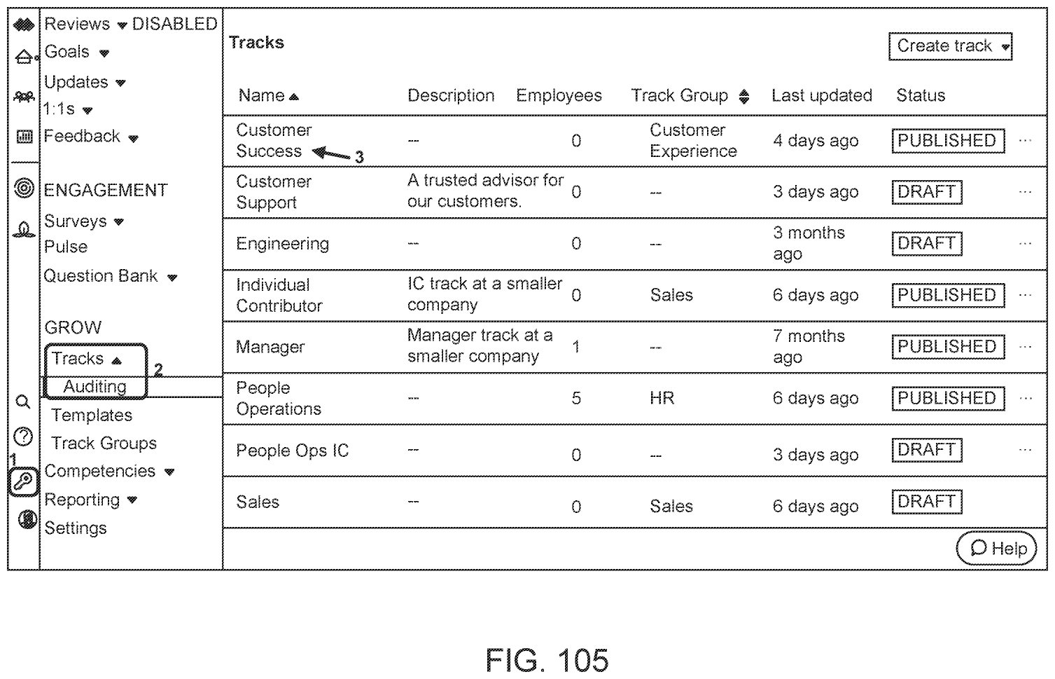

FIG. 105 is a schematic demonstrating how to navigate a user interface to add a competency theme to a track.

Step 2: To the right of Competencies, click on the plus sign (+) and select Add theme.

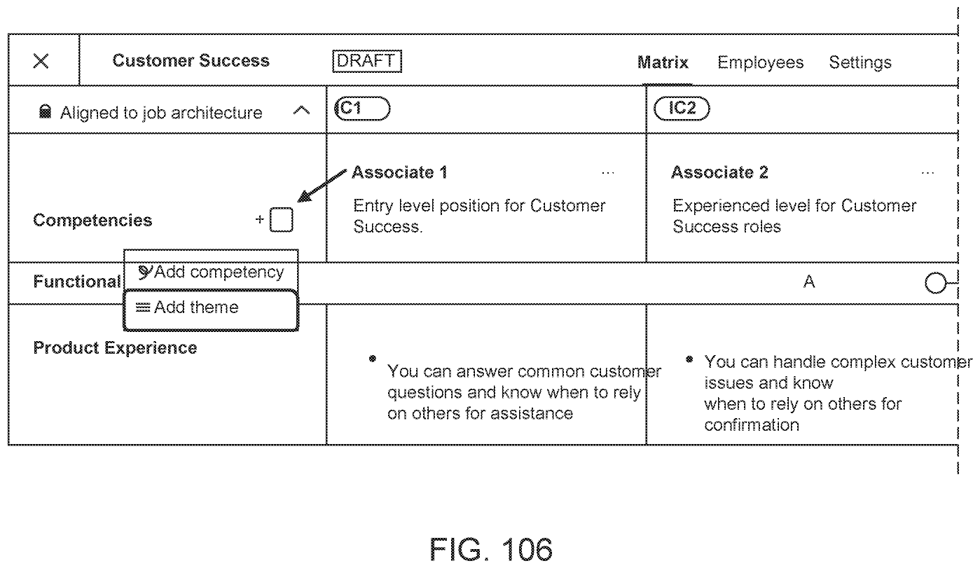

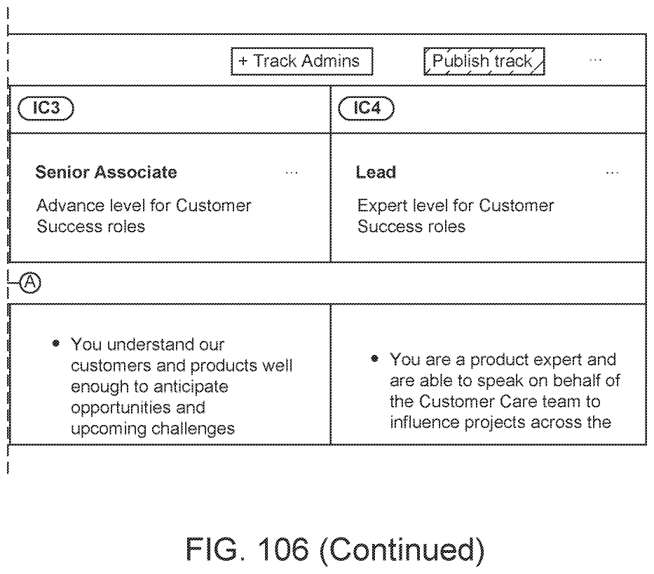

FIG. 106 is a schematic of a user interface displaying the option to add a competency theme to a track.

Step 3: A popup modal will appear; under Theme name, search for the desired theme.

Step 4 (optional): Add a description of what the theme captures.

Step 5: Select Add theme.

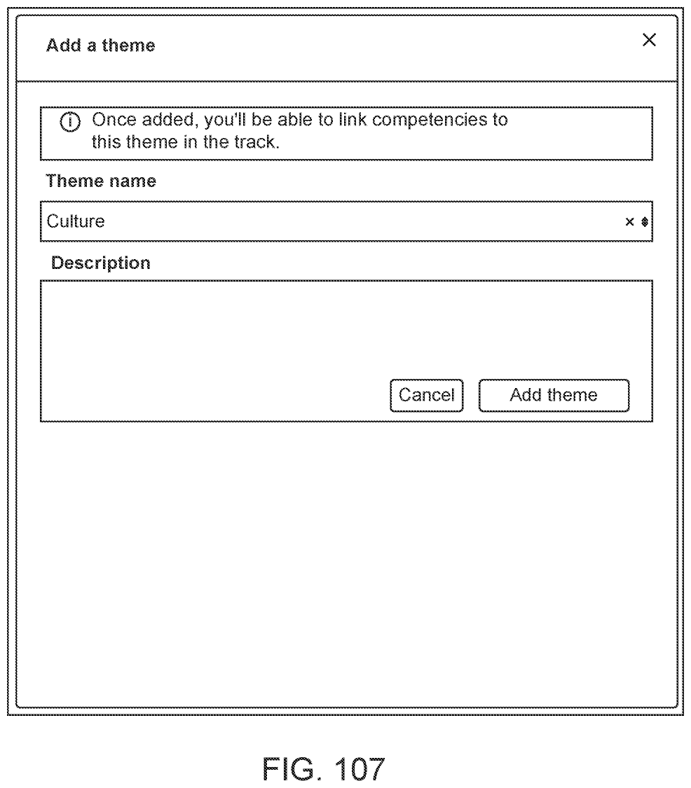

FIG. 107 is a schematic of a user interface displaying a drop-down menu and a text box for the user to choose a theme name and add a description.

Note: Lattice limits themes to 20 per track.

Group competencies under a theme

Step 1: Enter the Settings tab and navigate to Regroup competencies in matrix.

Step 2: Drag and drop the competencies from the Ungrouped section to the recently added competency theme. Lattice will automatically save your changes.

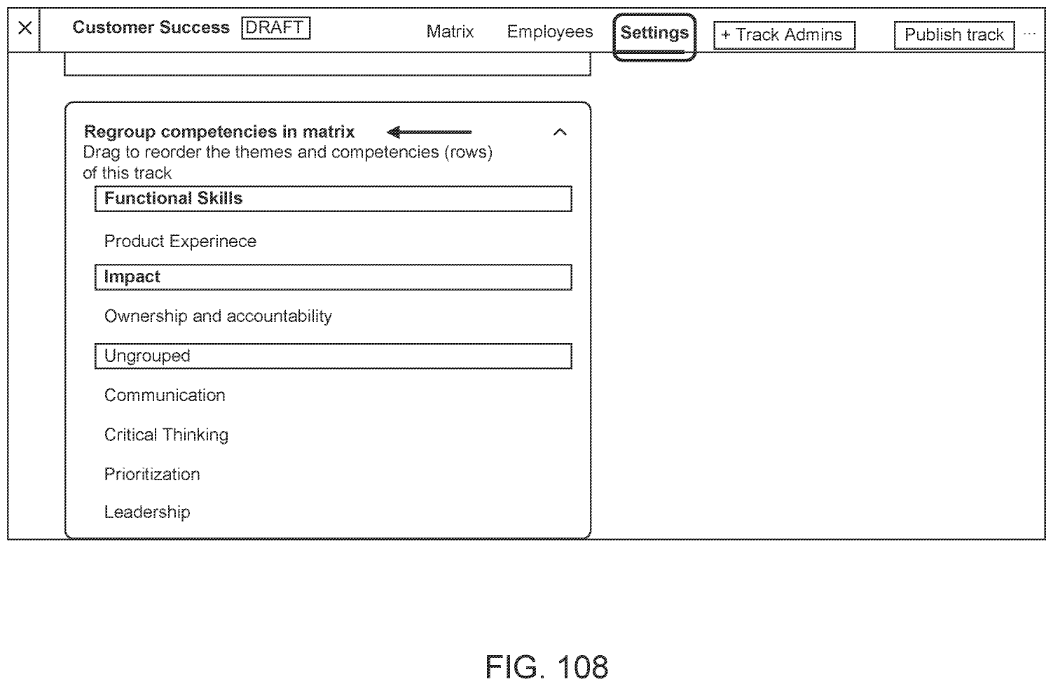

FIG. 108 is a schematic demonstrating how to navigate a user interface to group competencies under a theme.

Once the track is published, assigned employees will be able to view their track, including any competency themes.

### How to Assign Employees to Tracks

Once you have created a track, the next step is to assign the relevant employees to their tracks so they can view the expectations for their role within their Grow page. Tracks help provide a clear understanding of employees' roles and responsibilities and define what it means to succeed.

Before you start

Employees can only be assigned to one track at a time. You can assign employees to both published and drafted tracks; however, tracks will need to be published before assigned employees can view the track.

Assigning employees to tracks

Step 1: Navigate to Admin>Grow>Tracks>Auditing.

Step 2: Select the desired track to which to assign employees.

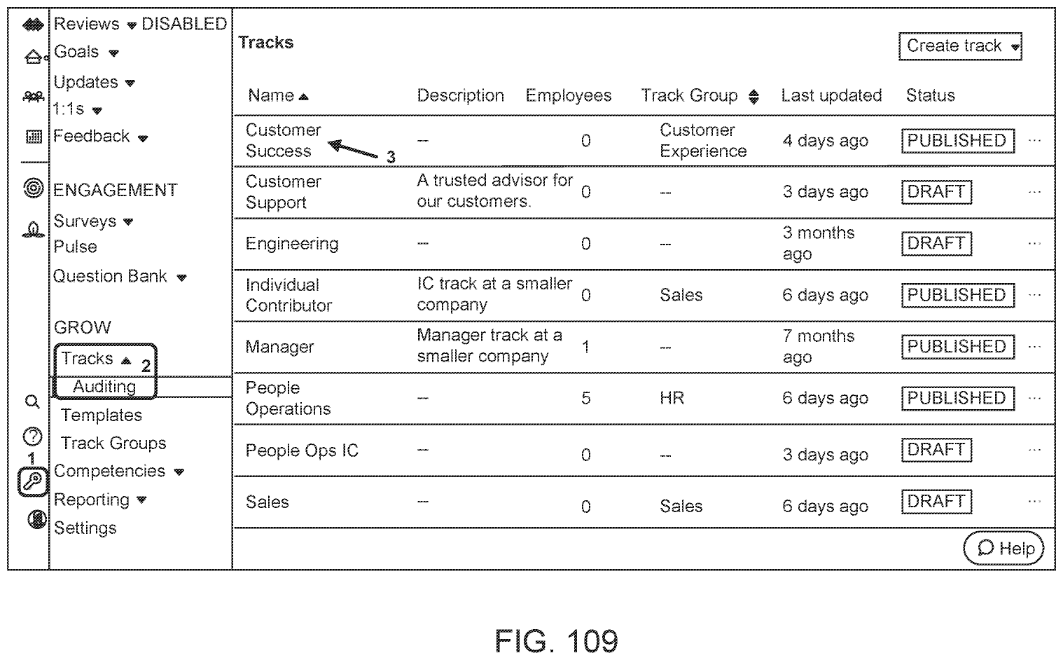

FIG. 109 is a schematic demonstrating how to navigate a user interface to assign employees to tracks.

Step 3: Once you have entered the track, enter the Employees tab and select Add employees.

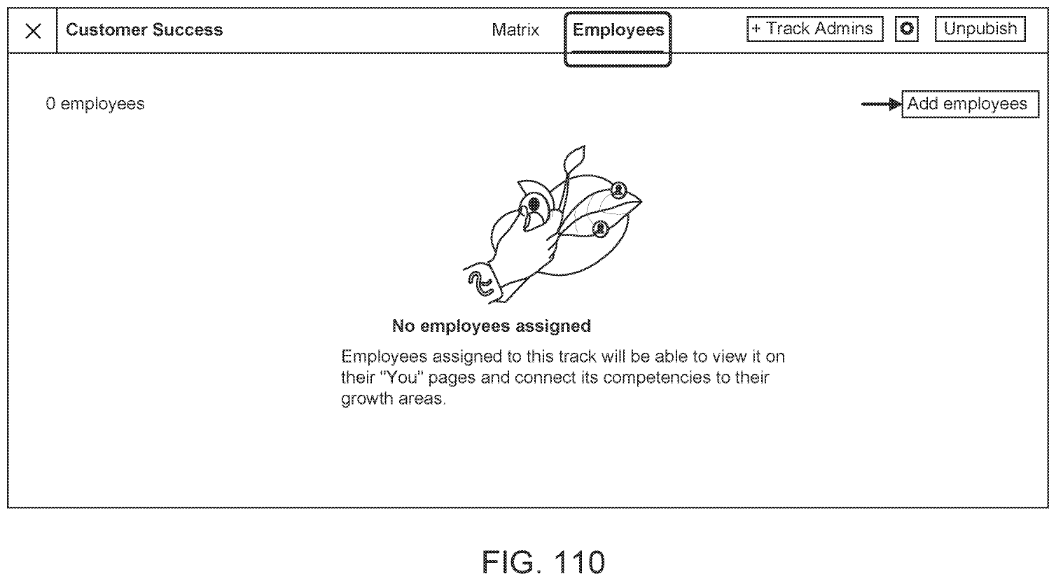

FIG. 110 is a schematic of a user interface displaying the option to add employees to a track.

Step 4: Select employees by filtering by attribute, searching, or manually scrolling through the employee list.

Step 5: Click Add Employees.

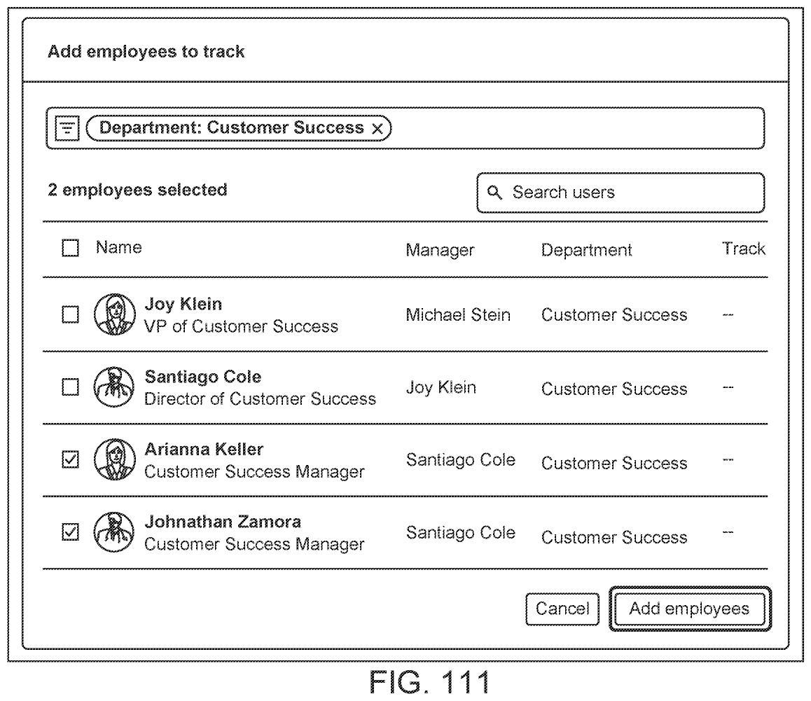

FIG. 111 is a schematic of a user interface displaying a list of employees to add to a track.

Step 6: Assign each employee a Job level.

FIG. 112 is a schematic demonstrating how to navigate a user interface to assign each employee a job level.

Once the employee is assigned and the track is published, the employee can view their track and level from their Grow page.

### How to Bulk Assign Tracks and Levels via CSV

Learn how to assign and update tracks and levels en masse using a CSY

As an admin, you can assign employees to your tracks to provide a clear understanding of their roles and responsibilities. Lattice makes it easy to bulk assign tracks and levels via a CSV.

Before you start

Tracks will need to be created before you can assign levels using a CSV.

The CSV upload will only assign employees to tracks that are not aligned with job architecture.

Bulk assigning tracks and levels using a CSV

Step 1: Navigate to Admin>Grow>Settings.

Step 2: Under Assign employees to tracks and levels via CSV, click Upload CSV.

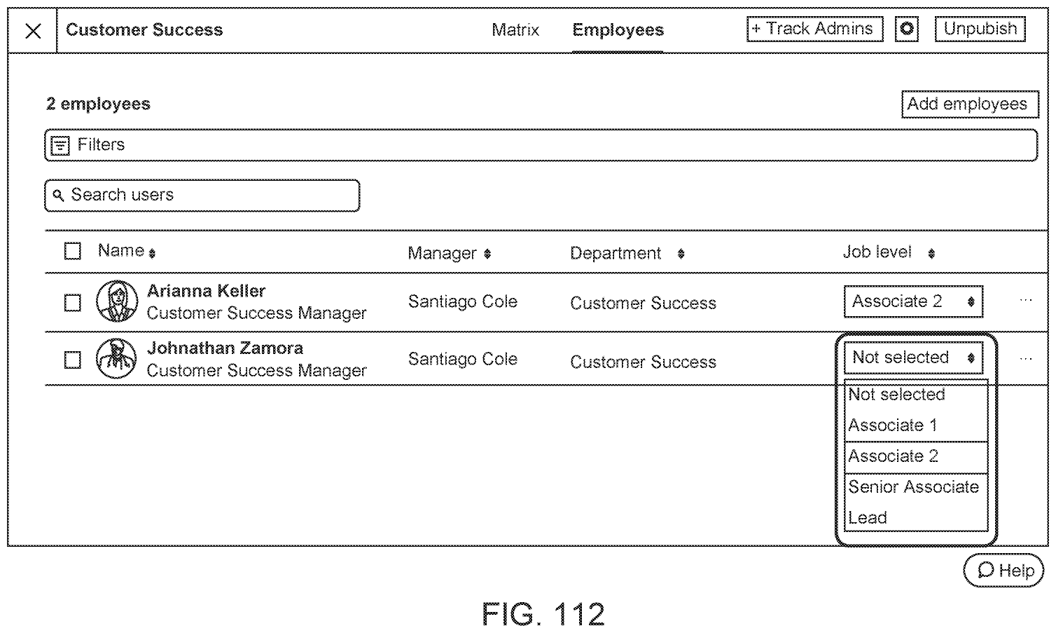

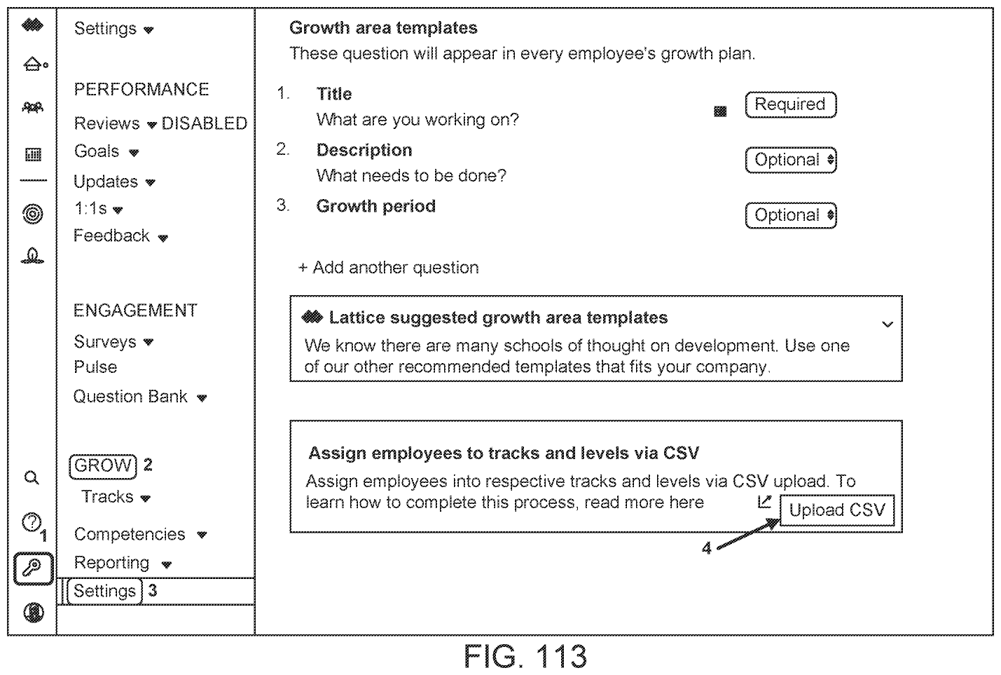

FIG. 113 is a schematic demonstrating how to navigate a user interface to assign employees to tracks and levels via CSV.

Step 3: Download our pre-filled CSV template.

Step 4: Add the name of each employee's track and corresponding level.
If you include an existing track, Lattice will update the employee to be assigned to that track.
If you leave a track field blank and the user is currently assigned to a track, then Lattice will unassign the user from their current track.

Note: There is no limit when adding employees to Grow tracks via CSV upload.

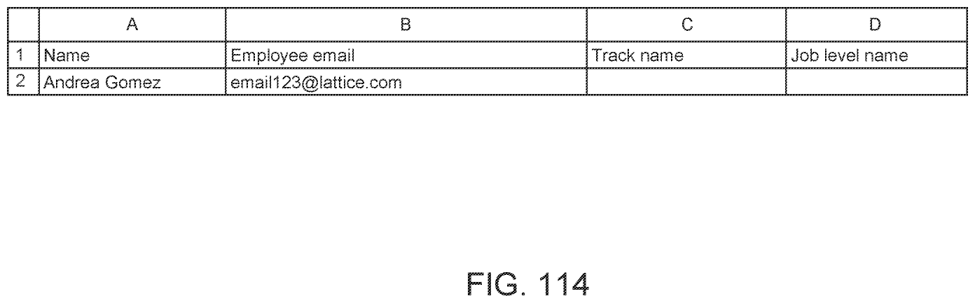

FIG. 114 is a schematic of a pre-filled CSV template.

Step 5: Upload the CSV into Lattice and click Add to Lattice.

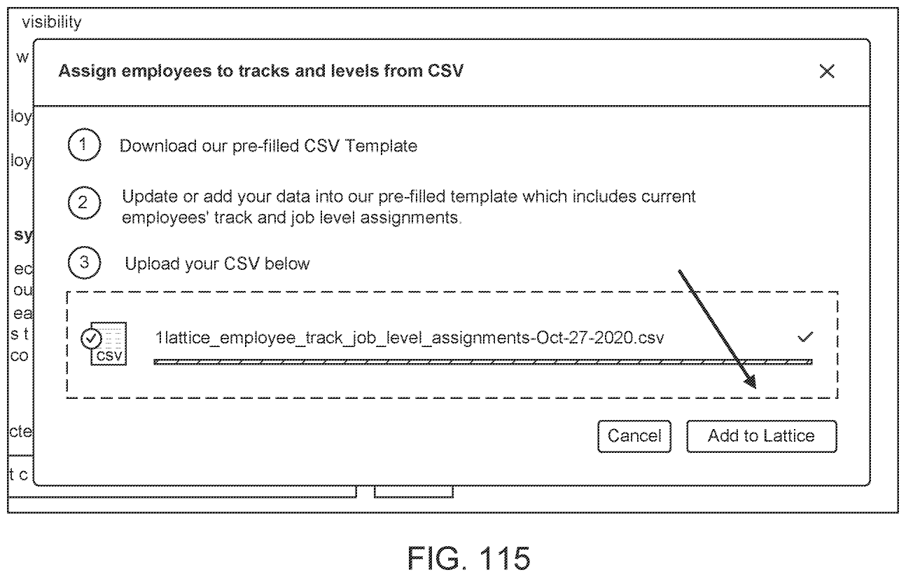

FIG. 115 is a schematic of a user interface displaying a CSV template being uploaded to the platform.

For larger files that may take some time to upload, Lattice will show an In Progress status while the upload completes. You can leave the page and the upload will continue in the background. Once the upload completes, you will see an Added status.

Once you have uploaded your CSV, you can confirm your changes within the assigned track. Once the track is published, the employee can view their track and level from their Grow page.

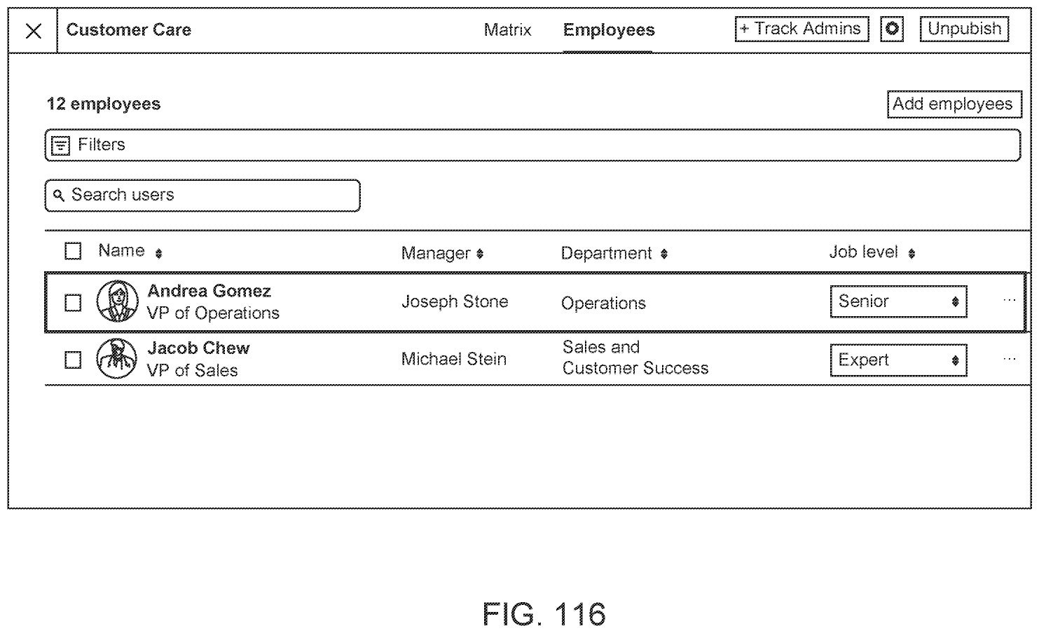

FIG. 116 is a schematic of a user interface displaying a track and employees' levels after a CSV has been uploaded.

### How to Create Track Groups

With Track Groups, admins can organize and map out relationships between tracks so employees can see how different tracks are related. This way, a common pattern between tracks can be presented, especially those within the same department, and illuminate paths of mobility.

Before you start

If given visibility, employees can view all company tracks via the Grow page. Having access to all tracks also gives them visibility to the different track groups created for related tracks.

Creating track groups

Step 1: Navigate to Admin>Grow>Tracks>Track Groups.

Step 2: In the top right-hand corner, select Create track group.

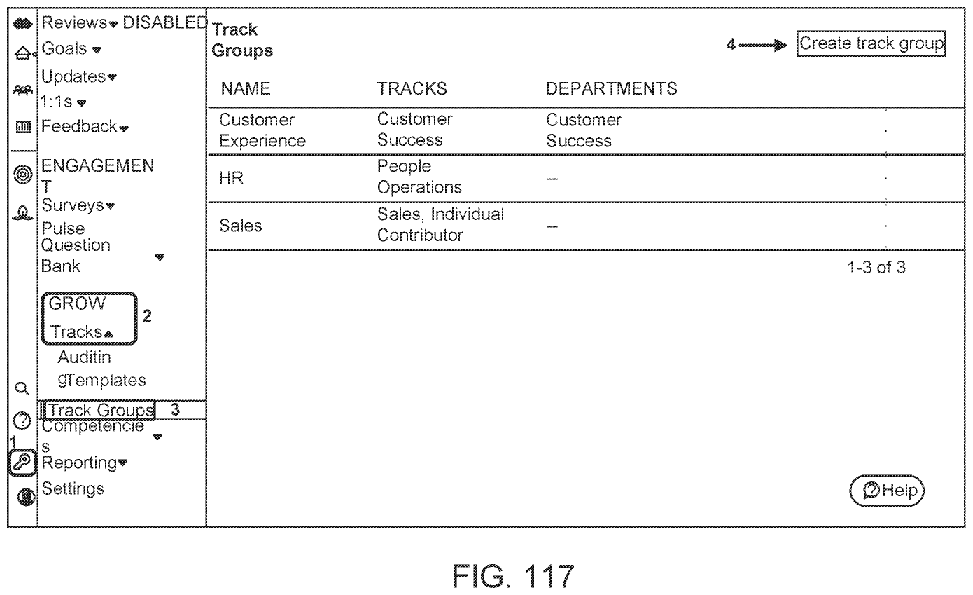

FIG. 117 is a schematic demonstrating how to navigate a user interface to create a track group.

Step 4: A modal will appear; under Track group name, name your track group.

Step 5 (optional): Within the Tracks dropdown, you have the option to select the relevant tracks associated with this group.

Tracks already associated with a group will appear at the bottom. Their checkbox will be disabled, and the group name will be in parentheses.

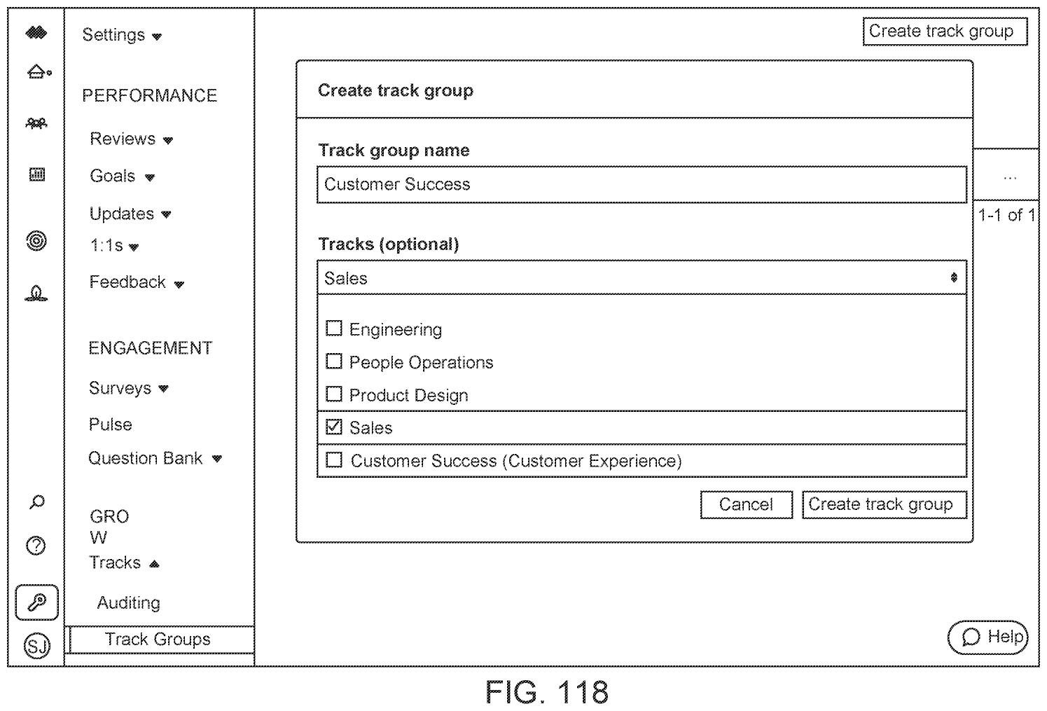

FIG. 118 is a schematic of a user interface displaying a text box and drop-down menu to receive a designation of a track group name and any associated tracks.

Step 6 (optional): Finally, you'll have the option to select departments that this group is connected to.

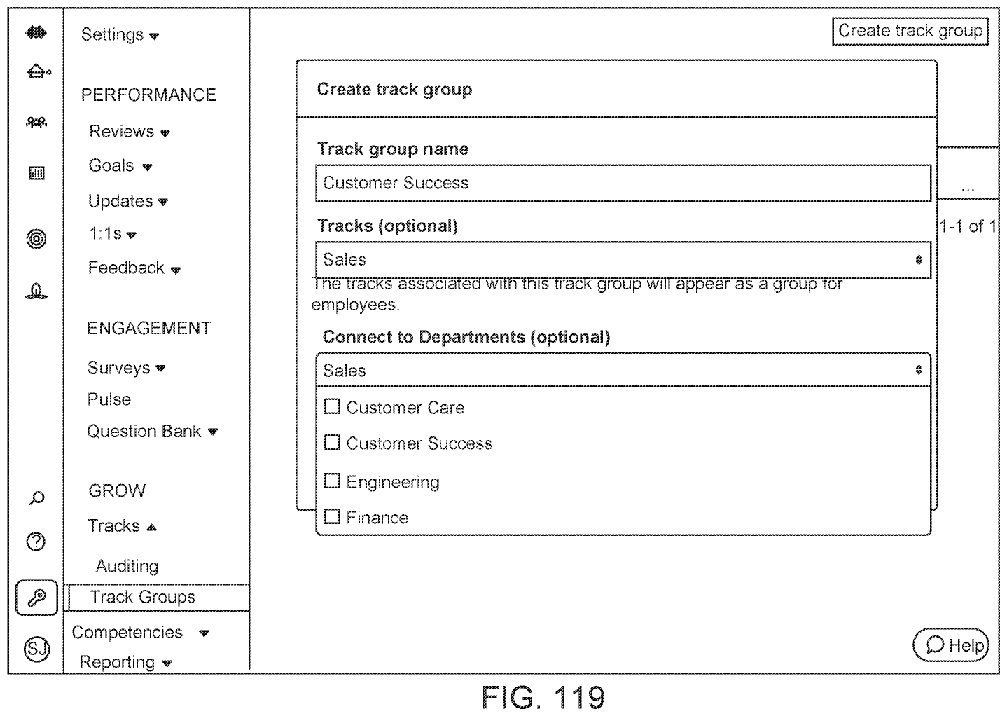

FIG. 119 is a schematic of a user interface displaying the option to select departments that a track group is connected to.

Once multiple groups have been created, they will appear in alphabetical order:

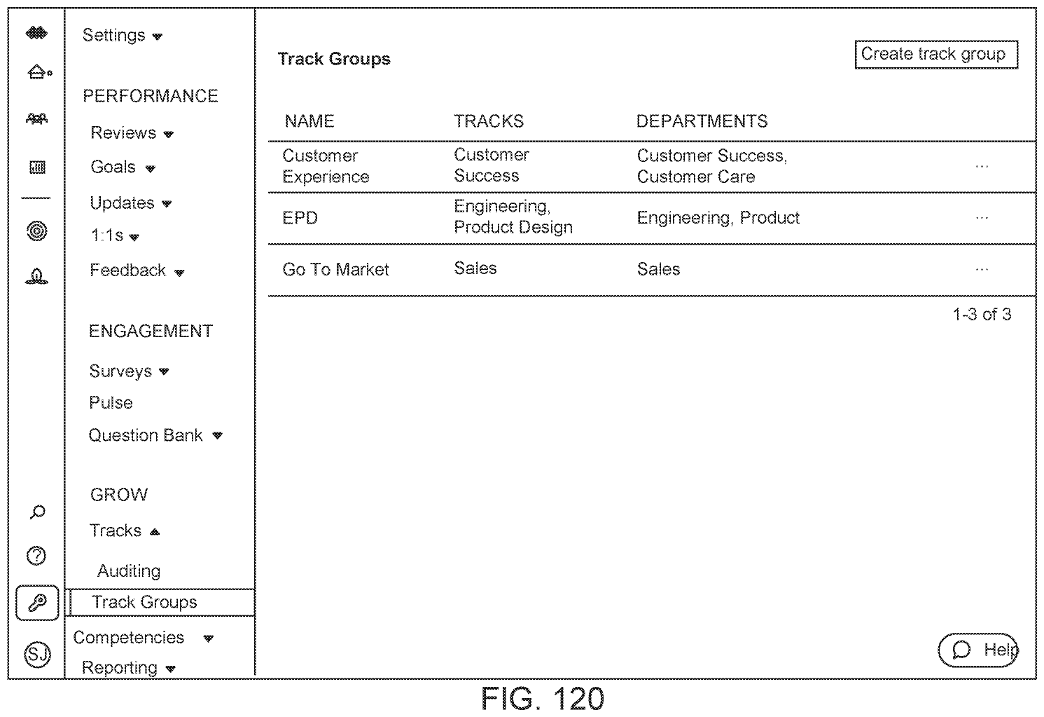

FIG. 120 is a schematic of a user interface displaying multiple track groups in alphabetical order.

In the Tracks Auditing page, you'll be able to see if a track has been linked to a group, and if so, which group it has been linked to beneath the Track Group column:

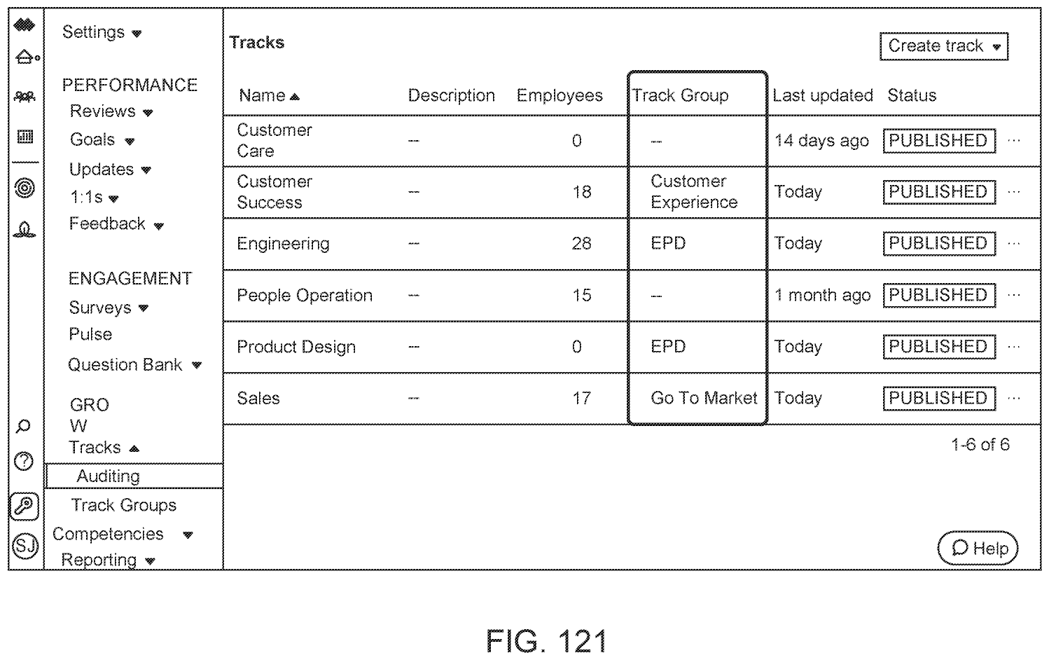

FIG. 121 is a schematic of a user interface displaying the tracks auditing page with the Track Group column highlighted.

### Align Job Architecture Attributes to Grow Tracks

Job architecture is the framework for understanding roles and their hierarchy within a company. In Lattice, job architecture is a combination of user attributes that determine an employee's job track and level in Grow.

Job architecture is available as three default user attributes in Lattice:
Job function
Job type
Job level (not required for auto-assign)

Once job architecture has been imported via HRIS, CSV, or SFTP, the next step is to align job architecture to your tracks to allow employees to be auto-assigned to job tracks.

Before you start
Any employee whose job architecture values match the track will automatically be assigned to the track. If the values do not match, they will be removed from the track.
Although the Compensation suite will require job architecture setup, job architecture will remain completely optional for Grow. Therefore, admins can still manually add and remove employees from a track.

Align job architecture with Grow tracks
1. Bring in job architecture values and assignments into Lattice via HRIS, CSV, or SFTP.
2. Navigate to Admin>Grow>Tracks>Auditing.
3. Enter the desired track and navigate to the Settings tab.
4. Expand the Manage job architecture and job levels section.
5. Under Align track to job architecture, select the Job function dropdown and choose the desired job function for this track.
6. Select the Job type dropdown and choose the desired job type for this track.
7. Select Align track.

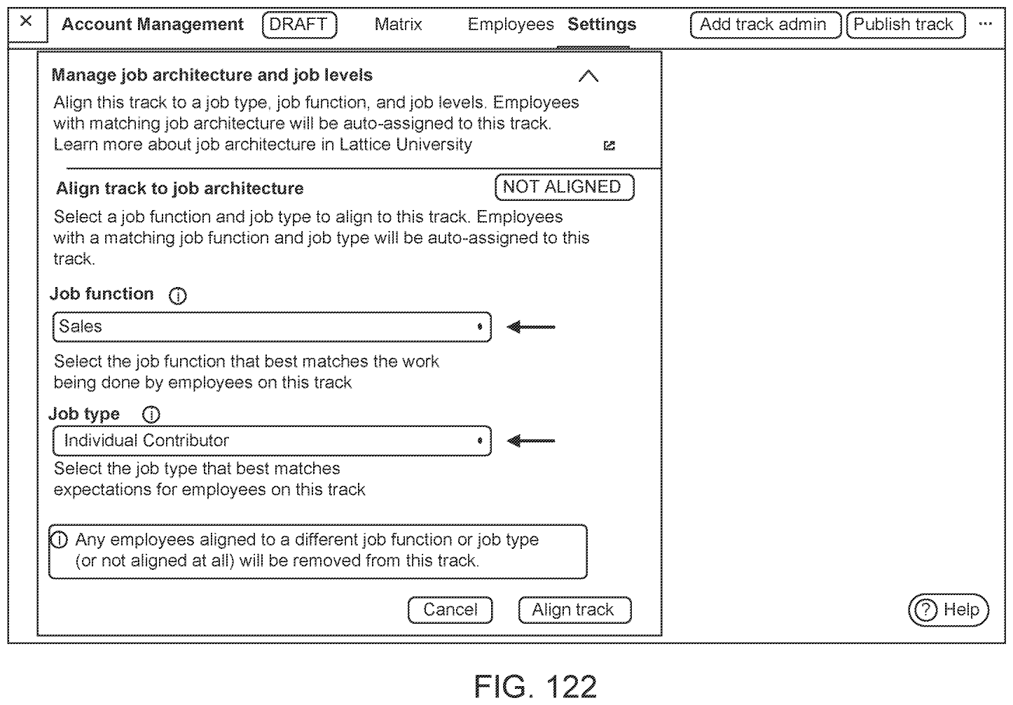

FIG. 122 is a schematic of a user interface displaying drop-down menus to receive a designation of a job function and job type in order to align job architecture.

Align Job Levels

An additional step for Grow alignment to job architecture is to map each job level job architecture value to the levels that exist within the track. Any employee with a job level attribute will automatically be assigned to the corresponding track level.
1. Under Manage job levels, align each track level with the desired job level job architecture attribute by selecting the job level attribute next to the corresponding track level.
2. Select Update Levels.

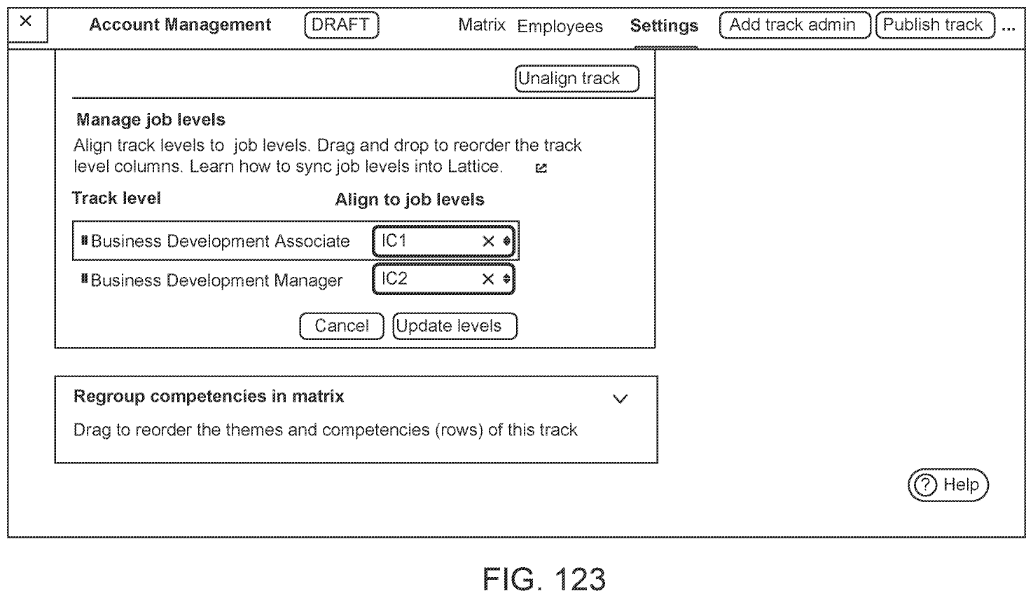

FIG. 123 is a schematic of a user interface displaying drop-down menus to receive designations of job levels to be aligned with the listed track levels.

Grow Tracks with Aligned Job Architecture

Once job architecture has been aligned, you will be able to view the job architecture alignment within the Matrix with an indicator labeled Aligned to job architecture.

You will be able to view the job function and job type that corresponds to the track. If aligned, job levels will also be visible above each track level within the matrix.

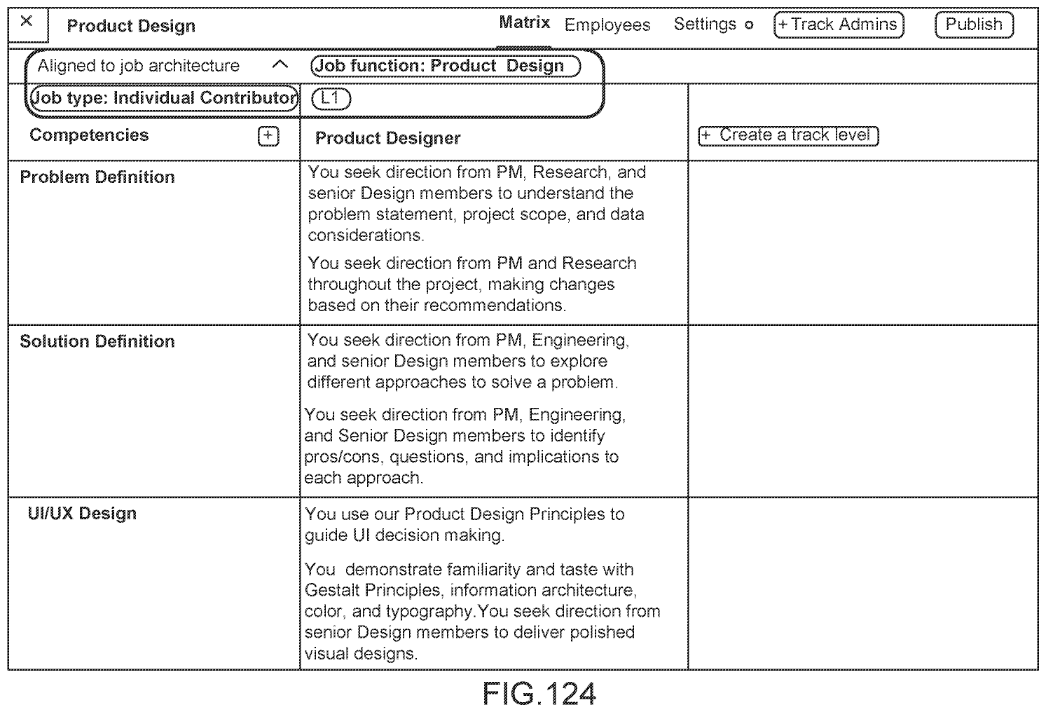

FIG. 124 is a schematic of a user interface displaying a matrix of job architecture alignment.

Job architecture rules

The following rules should be considered when aligning a track to job architecture:
If a Grow track with unaligned employees is aligned to job architecture, the unaligned employees on that track will be removed from the track.
If a Grow track with aligned employees is re-aligned to different job architecture, employees on the track with a different job architecture alignment will be removed to maintain their existing job architecture.
If a Grow track is aligned to job architecture and there are employees in Lattice with a matching job architecture alignment, then those employees will be automatically assigned to that Grow track.
If an admin unaligns a Grow track from job architecture, then the Grow track will no longer be associated with a job type, job function, or job level. The Grow track will keep its existing track levels. Employees assigned to the track will maintain their job architecture alignment and will remain on the track as long as no other Grow tracks match their job architecture alignment.

Bulk Align Tracks to Job Architecture

Job architecture is the framework for understanding roles and their hierarchy within a company. In Lattice, job architecture is a combination of user attributes that determine an employee's job track and level in Grow.

Job architecture is available as three default user attributes in Lattice:
Job function
Job type
Job level (not required for auto-assign)

Once job architecture has been imported via HRIS, CSV, or SFTP, the next step is to align job architecture to your tracks to allow employees to be auto-assigned to job tracks.

Before you start:
Any employee whose job architecture values match the track will automatically be assigned to the track. If the values do not match, they will be removed from the track.
Bulk aligning tracks to job architecture via CSV allows admins to create new job architecture values by inputting those values within the CSV Any new values will be automatically created. Admins can also create new job architecture values via an HRIS sync, SFTP, or CSV employee import.
Although the Compensation suite will require job architecture setup, job architecture will remain completely optional for Grow. Therefore, admins can still manually add and remove employees from a track.

Bulk align tracks to job architecture
1. Navigate to Admin>Grow>Settings.
2. Expand the General section.
3. Next to Bulk align tracks to job architecture via CSV, select Upload CSV.
4. A CSV modal will appear; download the pre-filled CSV template, which will include all existing Grow tracks.
5. Input the Job function and Job type values that should be aligned to each Grow track.
6. Save the CSV and upload it into Lattice.
7. Select Add to Lattice.

### View Aligned Tracks

Once tracks have been aligned with job architecture, the Grow Auditing page will show the associated job function and job type for each track.

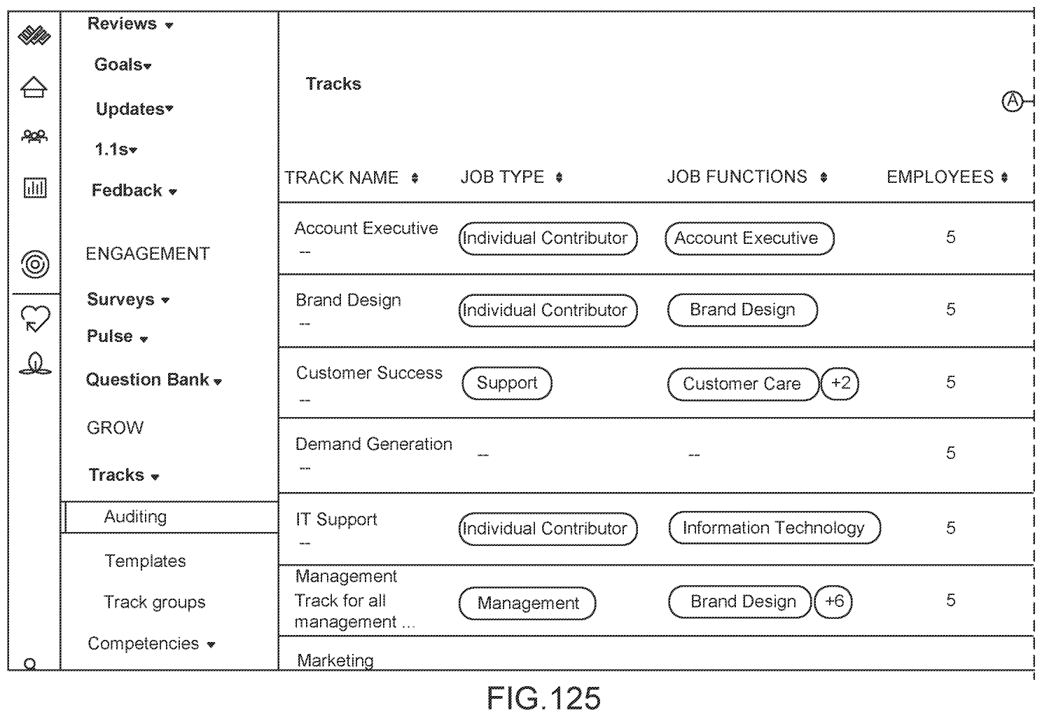

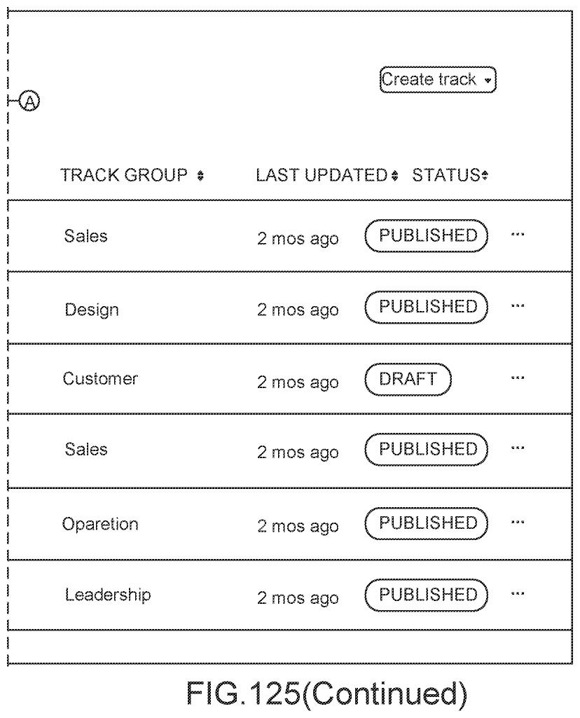

FIG. 125 is a schematic of a user interface displaying a grow auditing page listing each track's job function and job type.

Auto-Sync Job Levels to Grow Tracks

Lattice allows you to sync each employee's level automatically using the job level default attribute. Auto-sync helps remove the duplicative work of manually updating employees when they move into a different level within their job role.

Note: This process replaces the previous custom attribute functionality of connecting an attribute to auto-sync track levels within the Grow Settings page.

Before you start:
Auto-syncing job levels allows employees to move levels within their assigned track automatically. If an employee moves to a different track, the track change will need to be updated manually.
You do not need to input job architecture (job function or job type) fields to align job level in a track.

Auto-Sync Job Levels

Admins can set up and link track levels to the default attribute job level values separately from aligning a track to job function and job type.

Step 1: Sync or import the default job level attribute
1. Navigate to Admin>Platform>People>User attributes.
2. Sync or import your company job levels to the default job architecture attribute Job Level.
Sync the attribute with your job level field within your HR IS
Import job level assignments in bulk via a CSV or SFTP

Step 2: Align Grow track levels to the job level
1. Navigate to Admin>Grow>Tracks>Auditing.
2. Enter the desired track and navigate to the Settings tab.
3. Expand the Manage job architecture and job levels section.
4. Under Manage job levels, align each track level with the desired job level attribute by selecting the job level attribute next to the corresponding track level.
5. Select Update levels.

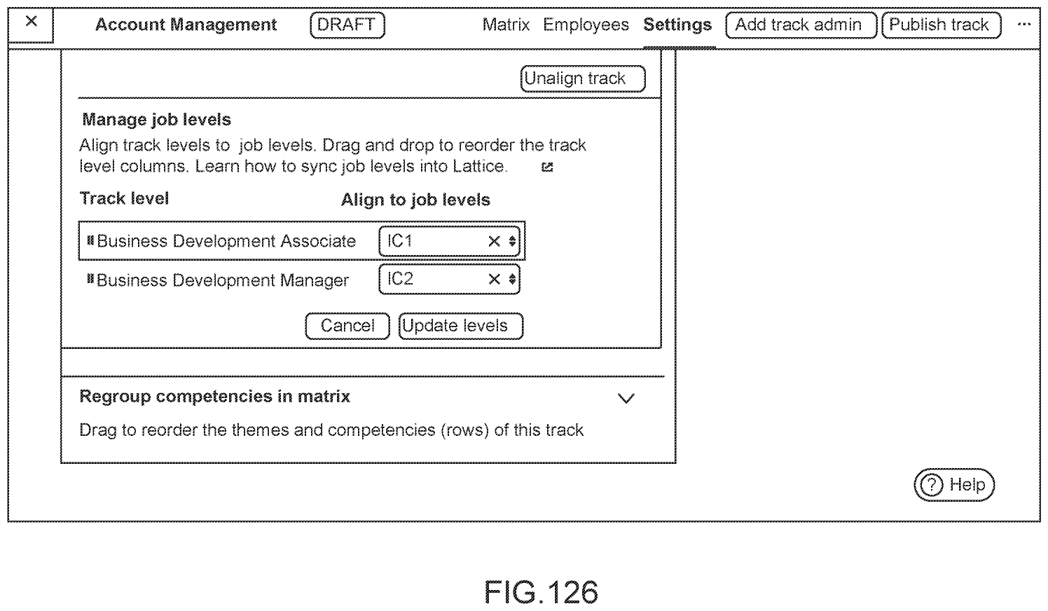

FIG. 126 is a schematic of a user interface displaying drop-down menus to receive designations of job levels to be aligned with the listed track levels.

Question

Why are job architecture attributes (Job function, Job type, Job level) not auto-syncing employees in Grow?

Answer

In Lattice, job architecture is based on default attributes that determine an employee's job track and level in Grow., Ensure that your job architecture setup for Grow is complete by importing job architecture values and aligning each track to the corresponding values.

Another important note is that aligning tracks to a custom attribute will not allow auto-syncing. Tracks must be aligned to the default job architecture fields.

Understand Grow Analytics as an Admin

Understanding how employees are interacting with growth areas

As an admin, you can view which employees, managers, and departments are creating growth areas and which employees are working with their managers to update those growth areas.

Accessing Grow Reporting

Step 1: Navigate to Admin>Grow>Reporting>Participation.

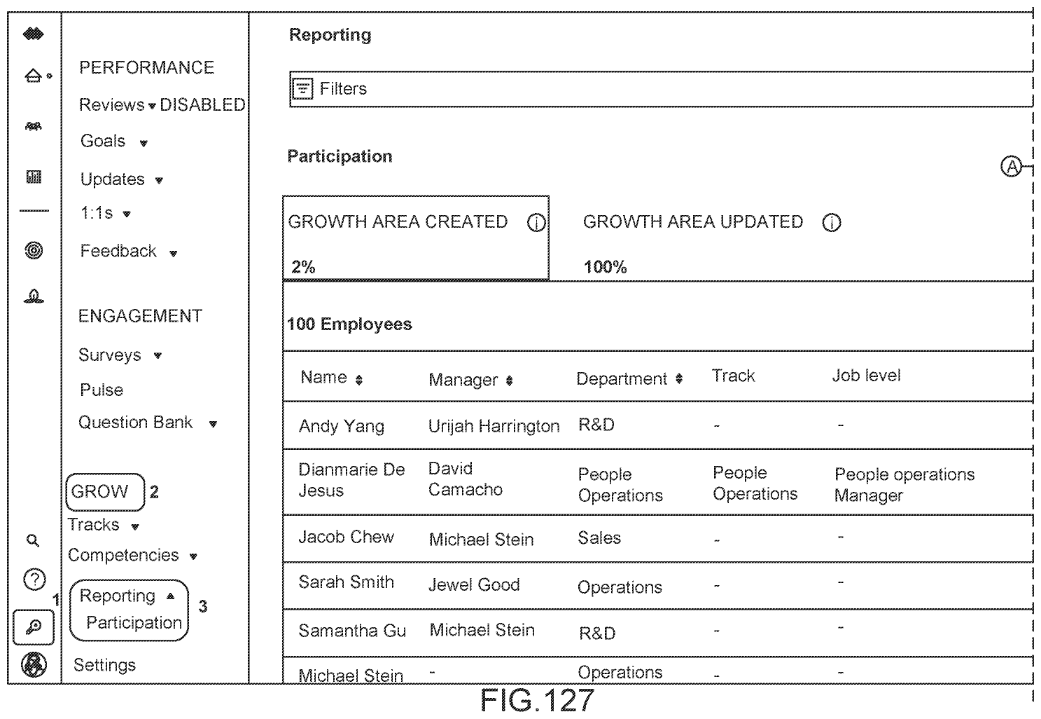

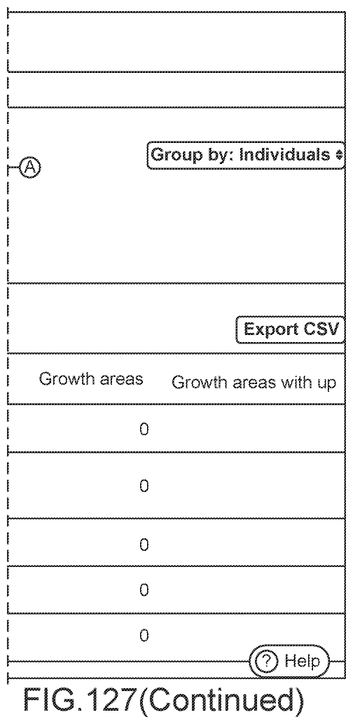

FIG. 127 is a schematic demonstrating how to navigate a user interface to access grow reporting.

Participation

The Participation page includes two metrics:
Growth area created: Measures the percent of employees who have created at least one growth area.
Growth area updated: Measures the percent of employees who have shared a progress update to at least one growth area.

Filtering Growth Areas

Near the top of the page, you'll see the ability to filter how you are viewing growth areas.

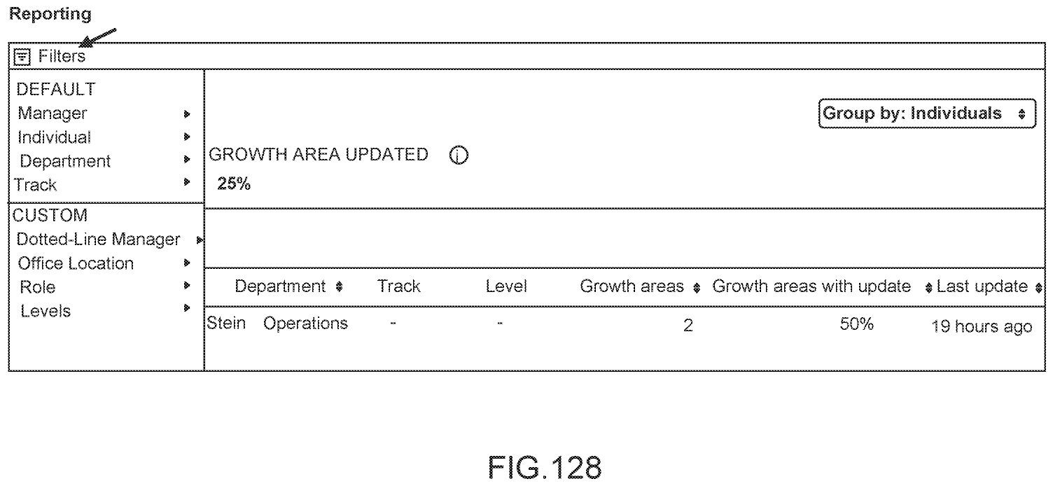

FIG. 128 is a schematic demonstrating how to navigate a user interface to filter growth areas in the participation page.

For example, you could choose a filter to view only the growth areas by a specific manager.

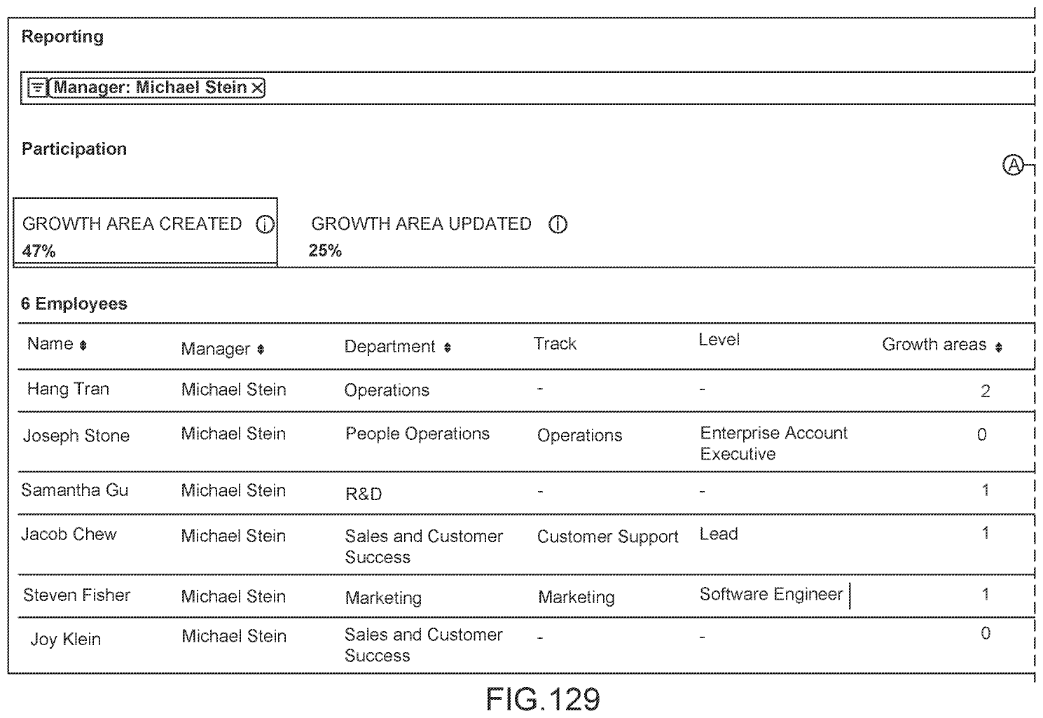

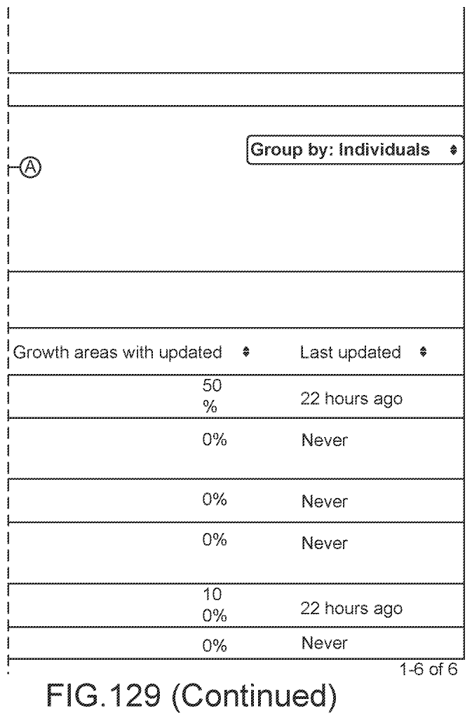

FIG. 129 is a schematic of a user interface displaying growth areas filtered by a specific manager on the participation page.

Grouping Growth Areas

To group growth areas by individuals, manager, department, or track:
1. Select the Group by dropdown in the top right corner.
2. Choose how you'd like the growth areas to be grouped (Individual, Manager, Department, or Track).

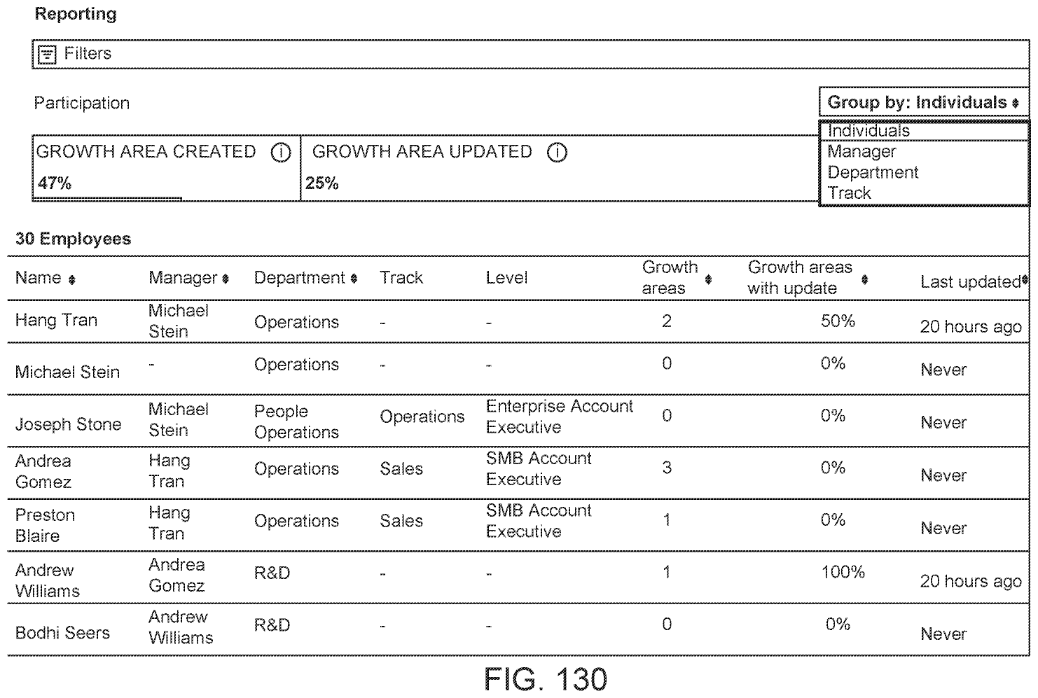

FIG. 130 is a schematic demonstrating how to navigate a user interface to group growth areas by individuals, manager, department, or track.

For example, when you select Group by: Manager, you'll see data for managers' direct reports who have created or have shared a progress update to at least one growth area. This way, you can see which parts of your business participate in growth areas.

Bar graph

Three groups can be seen in a graph view to better visualize the percentage of employees who have created or have shared a progress update to at least one growth area: manager, department, and track.

For example, if grouped by manager, you can view the percentage of direct reports which have created at least one growth area.

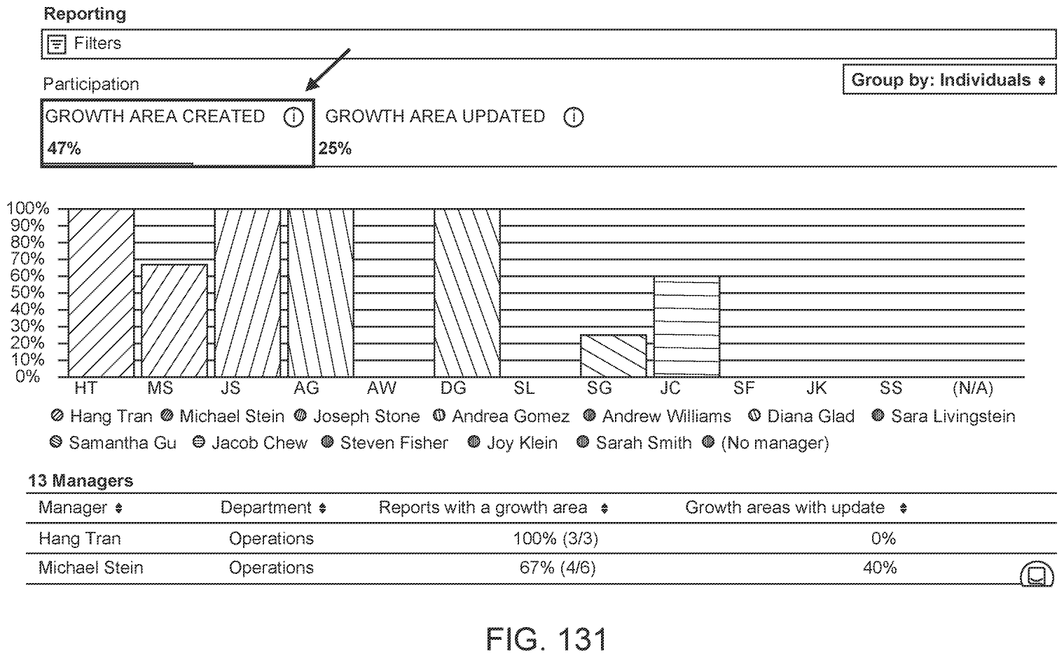

FIG. 131 is a schematic of a user interface displaying a bar graph depicting the percentage of direct reports which have created at least one growth area.

You can also view the percentage of direct reports who have shared a progress update to at least one growth area.

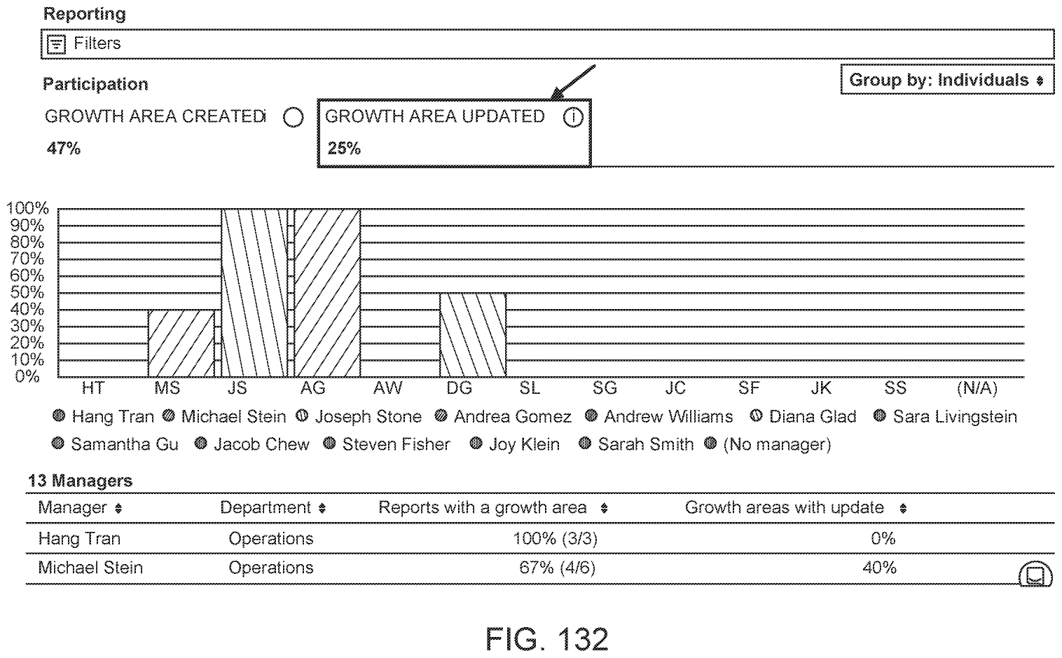

FIG. 132 is a schematic of a user interface displaying a bar graph depicting the percentage of direct reports who have shared a progress update to at least one growth area.

Please note: You may also hover over each bar for further details.

How to View When a Track Was Last Modified

Track auditing allows admins to view when a track was published or edited and by whom.

Auditing: Creating a track

Step 1: Navigate to Admin>Grow>Tracking.

Step 2: Hover over the Status badge to view track auditing for the desired track.
If the track is published, hover over the Publish badge to see who published the track and when.
If the track is in draft, hover over the Draft badge to see who created or unpublished the track and when.

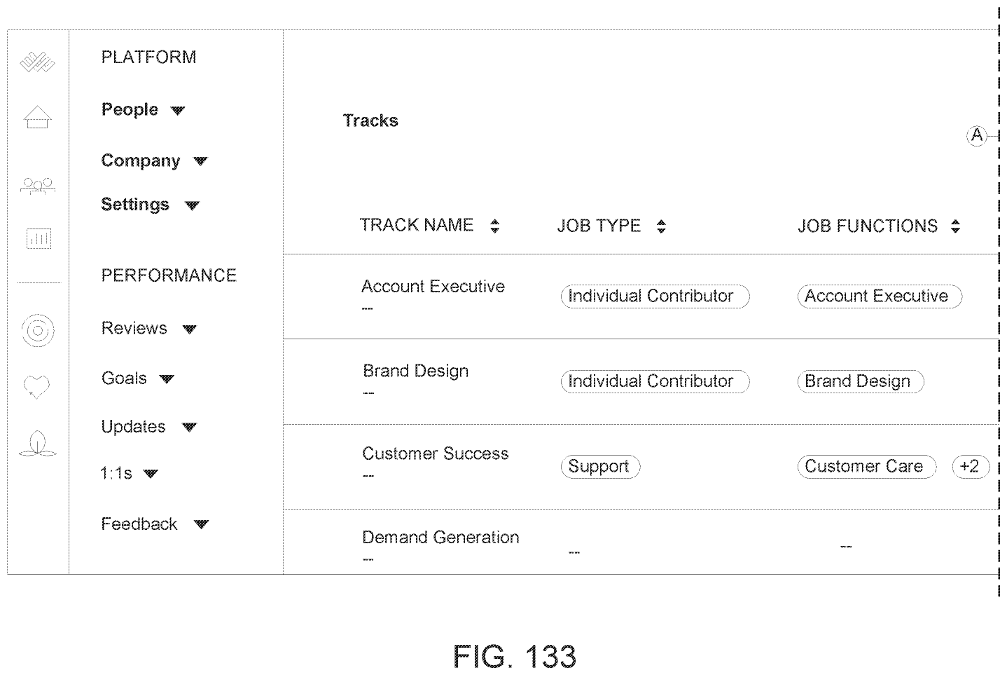

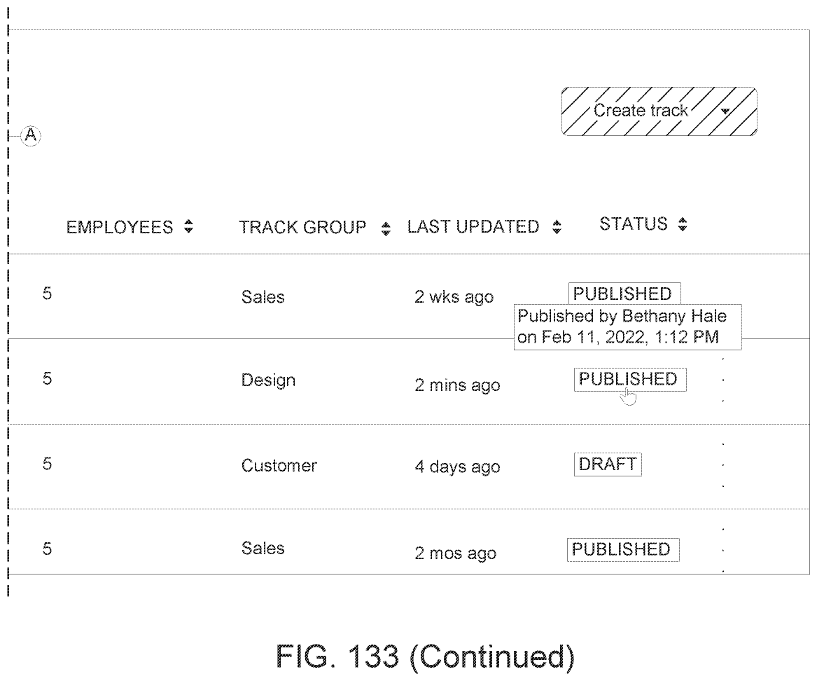

FIG. 133 is a schematic of a user interface displaying track auditing in the Status column.

Auditing: Editing a track

Step 1: Navigate to Admin>Grow>Tracking.

Step 2: Hover over the Last Updated badge to view track auditing for the desired track.

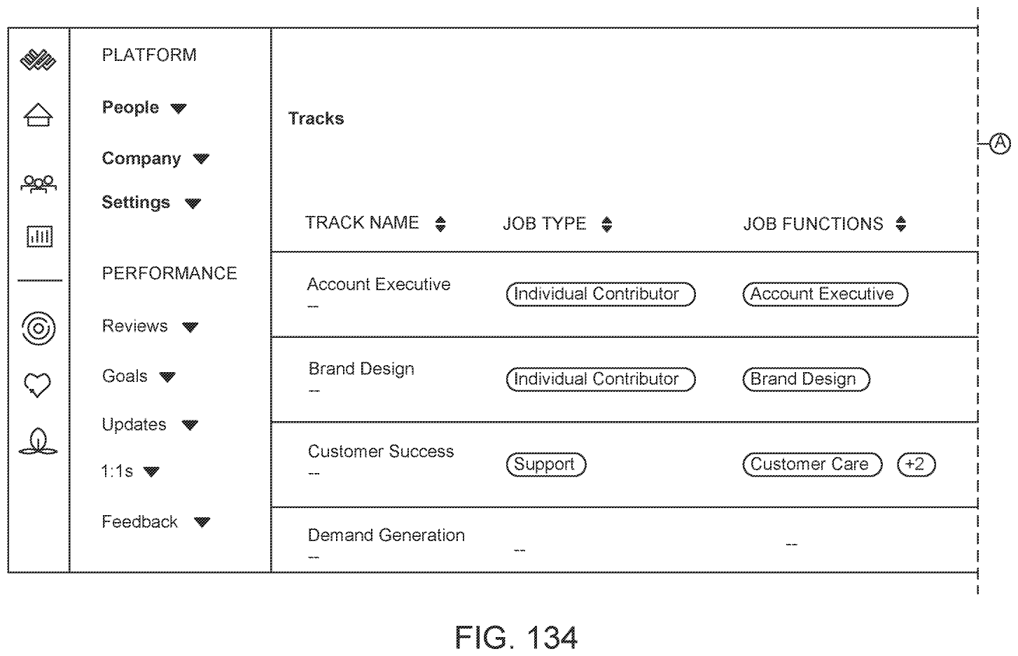

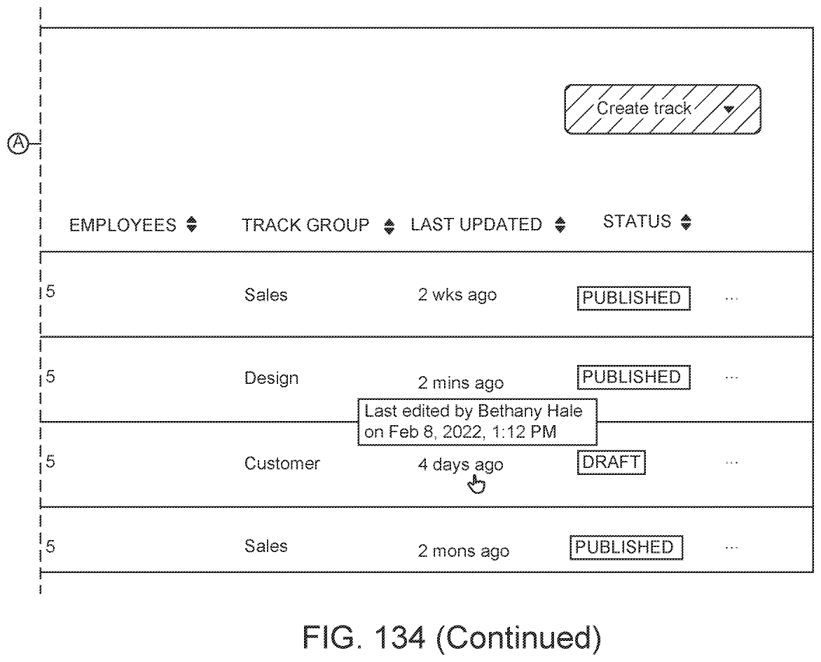

FIG. 134 is a schematic of a user interface displaying track auditing in the Last Updated column.

Lattice will track any time a change has been made to:
Competencies
Levels
Level descriptions
Expectations
Themes
Track name and details
Reordering levels
Regrouping competencies

How to Duplicate a Track

How Admins can Clone an Active or Drafted Track

Before you start

When duplicating a track, employee assignments are not carried over. Employees will still need to be assigned to the new track. For initial track assignments, see How to Assign Employees to Tracks.

Duplicate a track

Step 1: Navigate to Admin>Grow>Tracks>Auditing.

Step 2: Click on the ellipsis ( . . . ) to the right of the track you wish to duplicate and select Clone Track.

FIG. 135 is a schematic demonstrating how to navigate a user interface to duplicate a track.

Once cloned, you will see a new track with Copy of in the title.

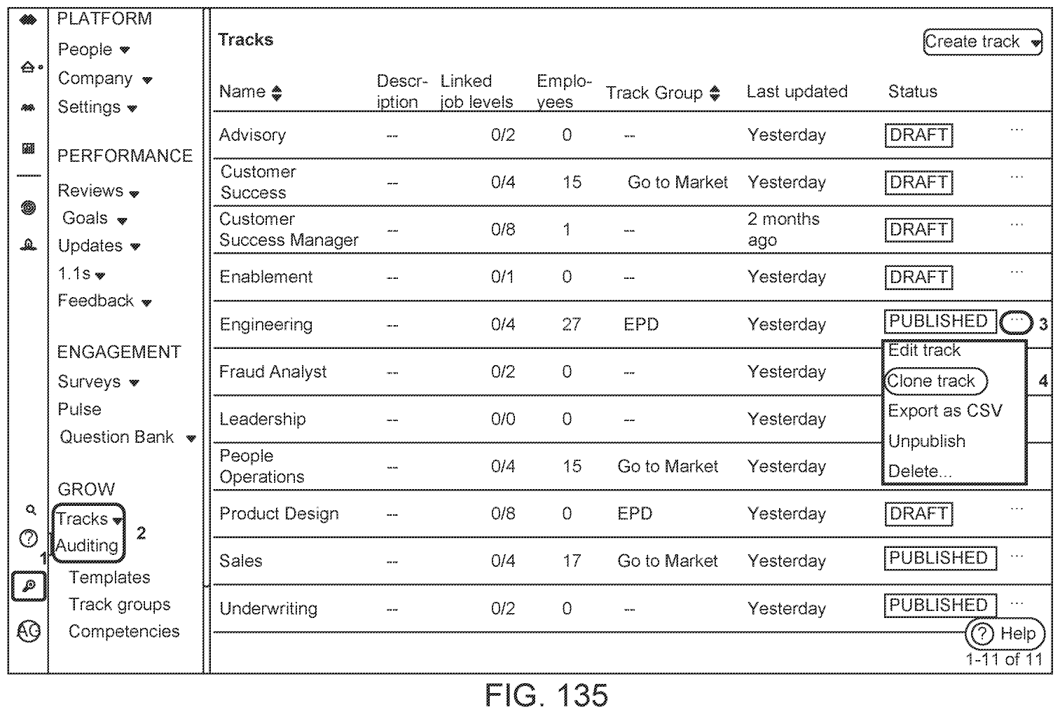

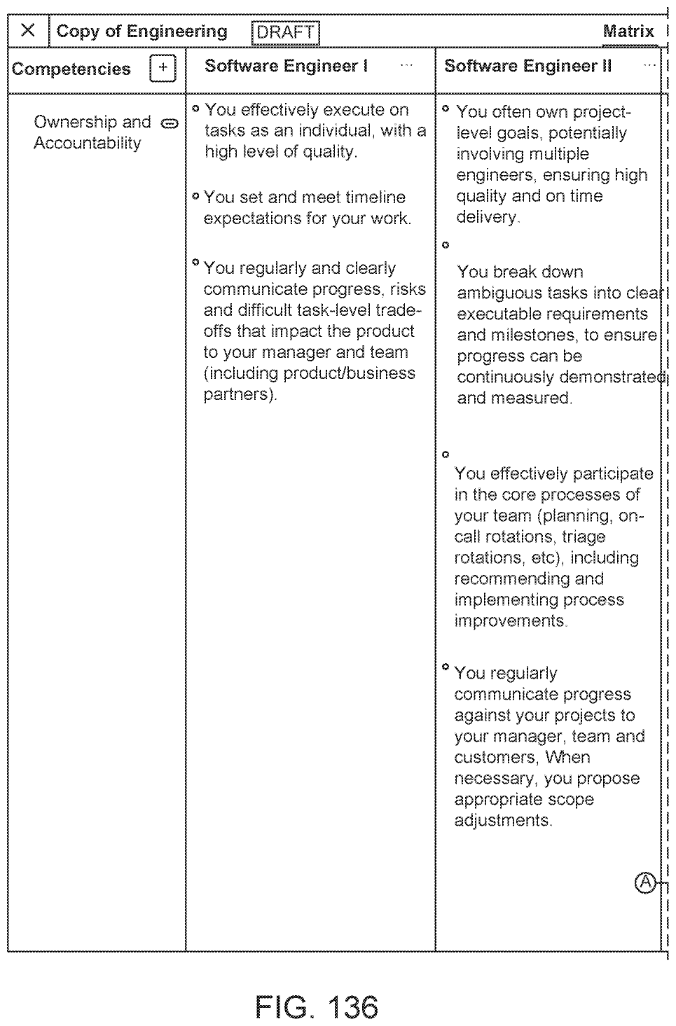

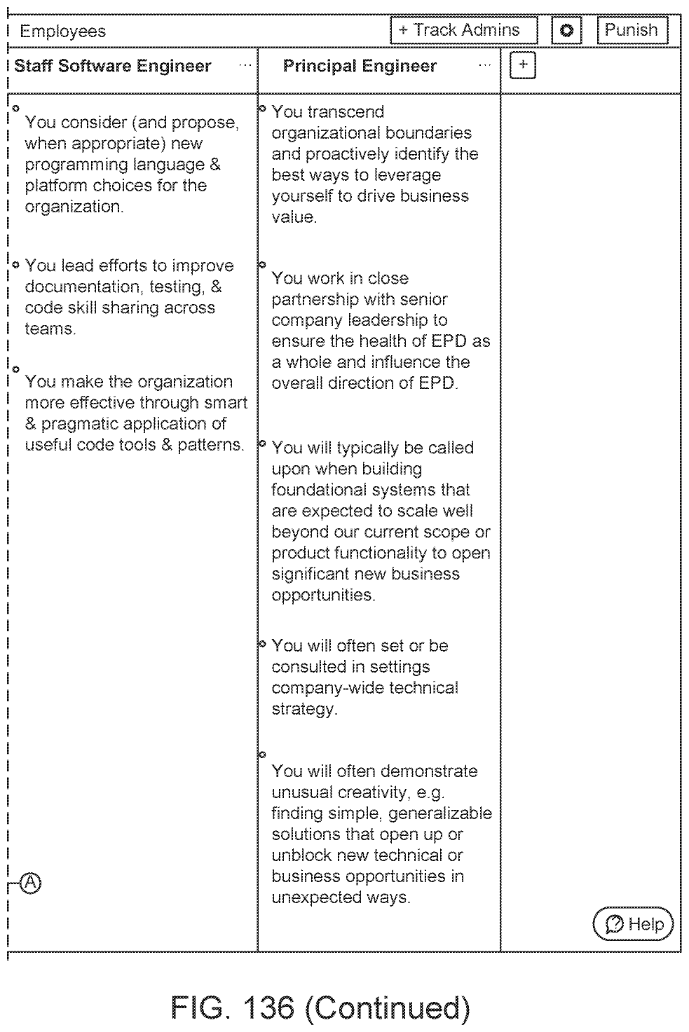

FIG. 136 is a schematic of a user interface displaying the duplicated track.

How to Delete a Competency

Before you start

Deleting a competency will delete related expectations and remove this information from all associated tracks and growth areas. For an alternative, see How to Replace a Competency in a Track.

Delete a Competency

Step 1: Navigate to Admin>Grow>Competencies>Auditing.

Step 2: Click on the ellipsis ( . . . ) next to the competency you'd like to delete.

Step 3: Click Delete.

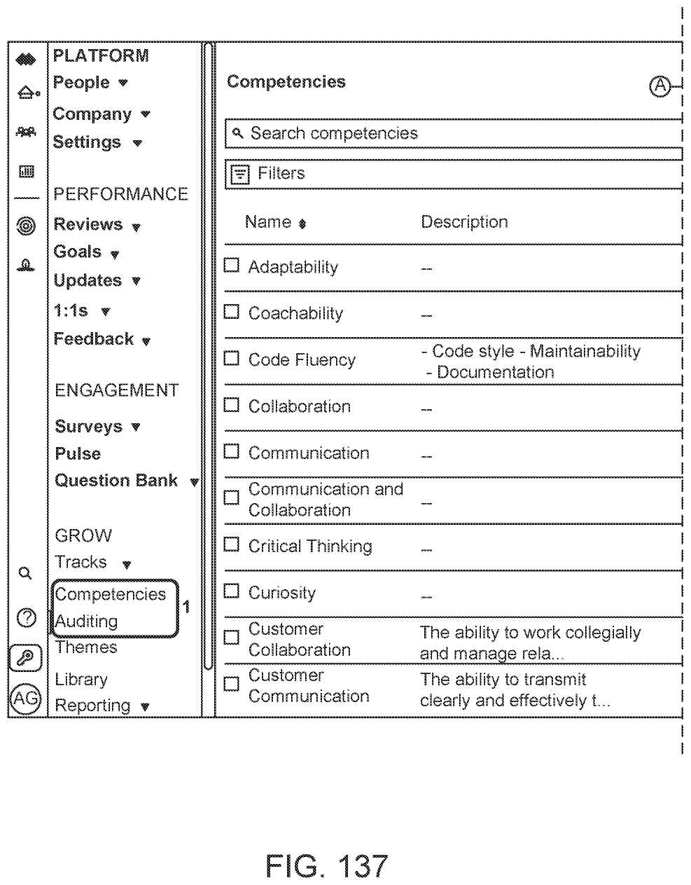

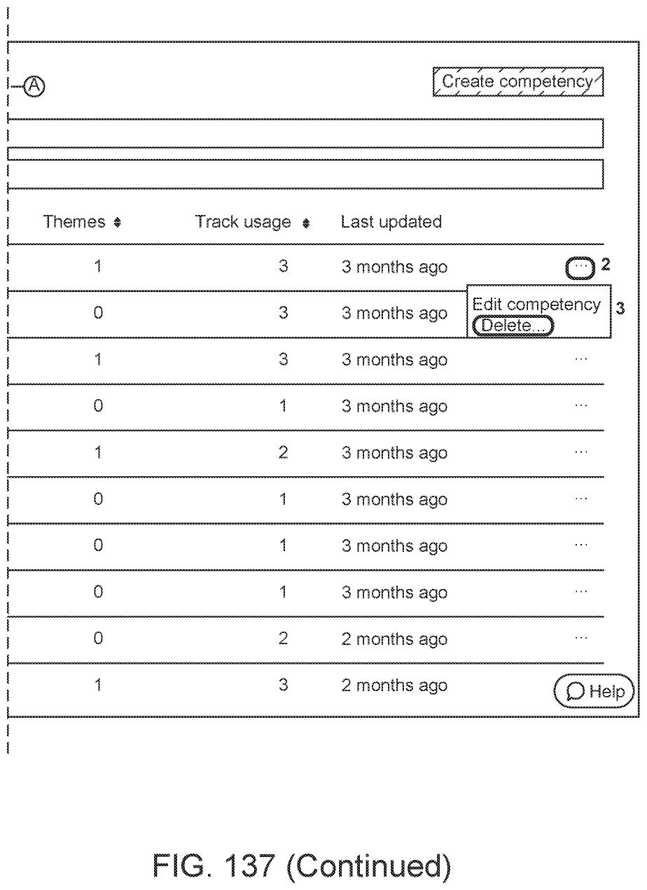

FIG. 137 is a schematic demonstrating how to navigate a user interface to delete a competency.

Step 4: You will be presented with a pop-up modal to confirm your selection.

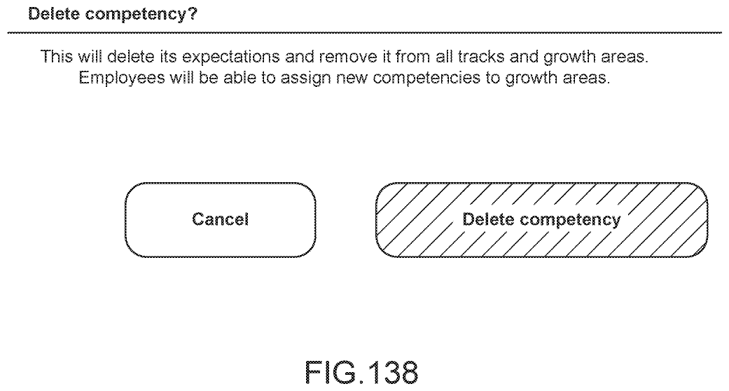

FIG. 138 is a schematic of a user interface displaying a pop-up window requesting confirmation of the selected competency to be deleted.

### How to Unpublish a Track

Before you start

Tracks can only be unpublished by a Lattice Admin. Track admins are not able to unpublish tracks. Tracks must be in draft to be edited. If your track is published, you will need to unpublish it before making any changes.

Unpublish a Track from the Auditing Page

Step 1: Navigate to Admin>Grow>Tracks>Auditing.

Step 2: Click on the ellipsis ( . . . ) next to the track you would like to unpublish

Step 3: Click Unpublish.

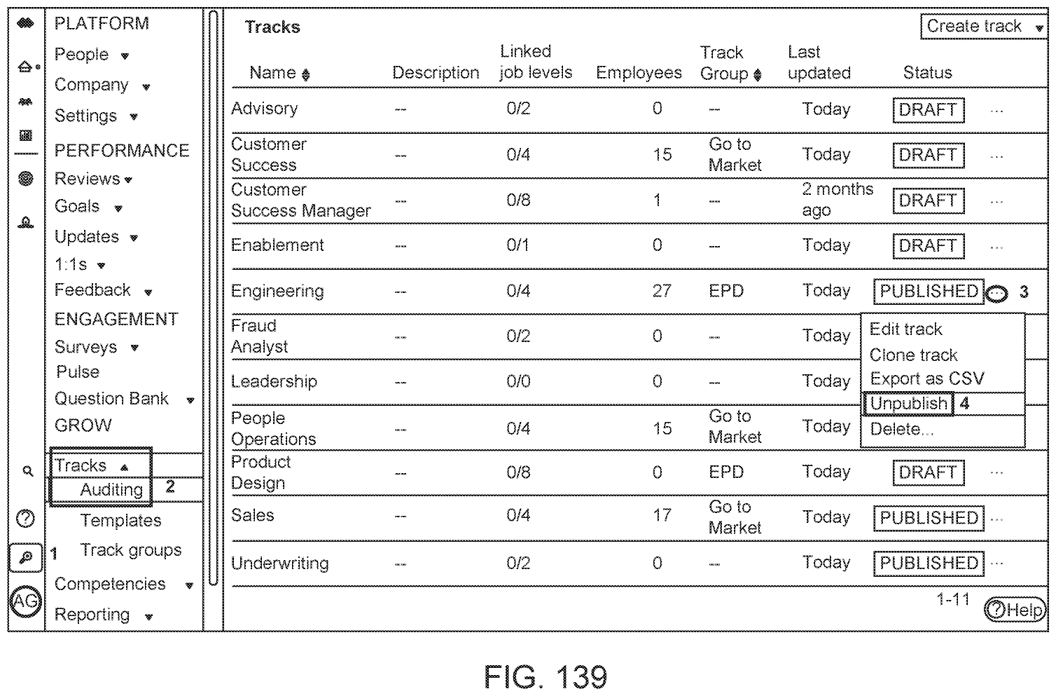

FIG. 139 is a schematic demonstrating how to navigate a user interface to unpublish a track from the auditing page.

Tracks can also be unpublished directly within the competency matrix view.

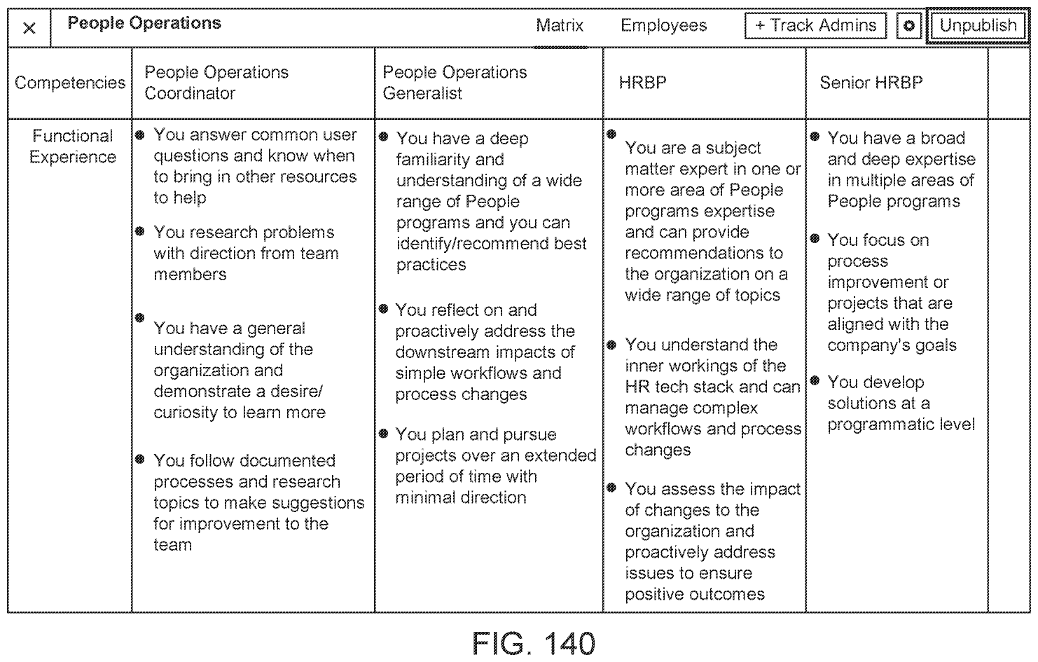

FIG. 140 is a schematic of a user interface displaying the competency matrix view.

### How to Delete a Track Group

Before you start

Track groups can only be deleted by a Lattice Admin. If you are an employee and would like to adjust track groups, please reach out to your HR team.

Please note, deleting a track group will remove the track group from Grow pages, but will not impact the tracks associated with it.

Delete a Track Group

Step 1: Navigate to Admin>Grow>Tracks>Track Groups.

FIG. 141 is a schematic demonstrating how to navigate a user interface to delete a track group.

Step 2: Click on the ellipsis ( . . . ) next to the track group you'd like to delete.

Step 3: Click Delete track group . . . You will be prompted to confirm your selection with a pop-up modal.

How to Rename a Track

Rename a Track

Step 1: Navigate to Admin>Grow>Tracks>Auditing.

Step 2: Click on the ellipsis ( . . . ) to the right of the track you wish to rename and select Edit Track.

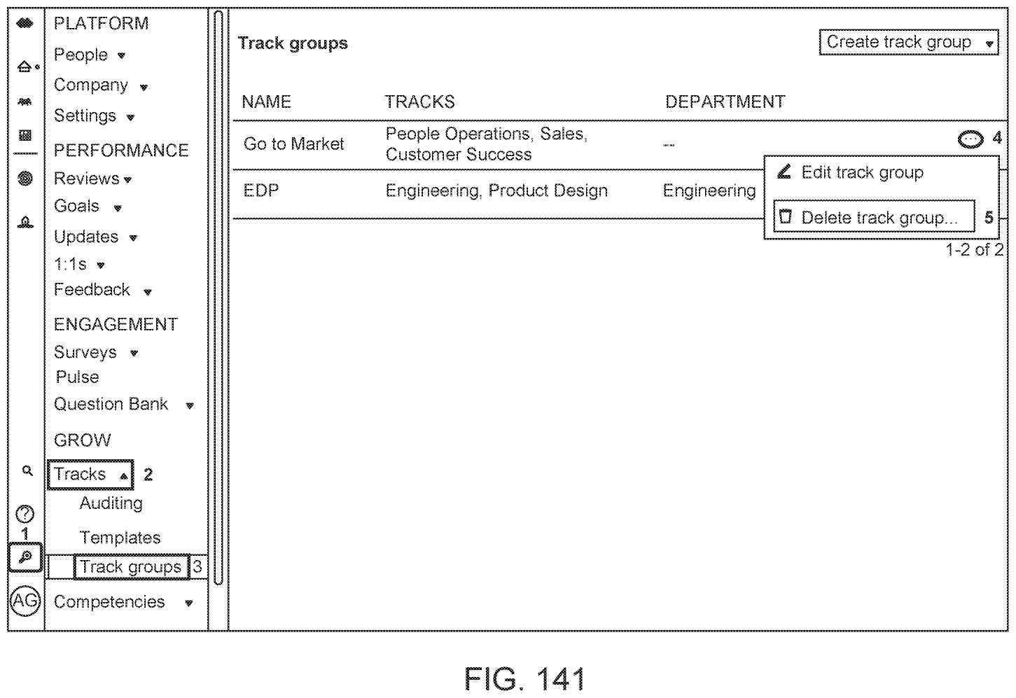

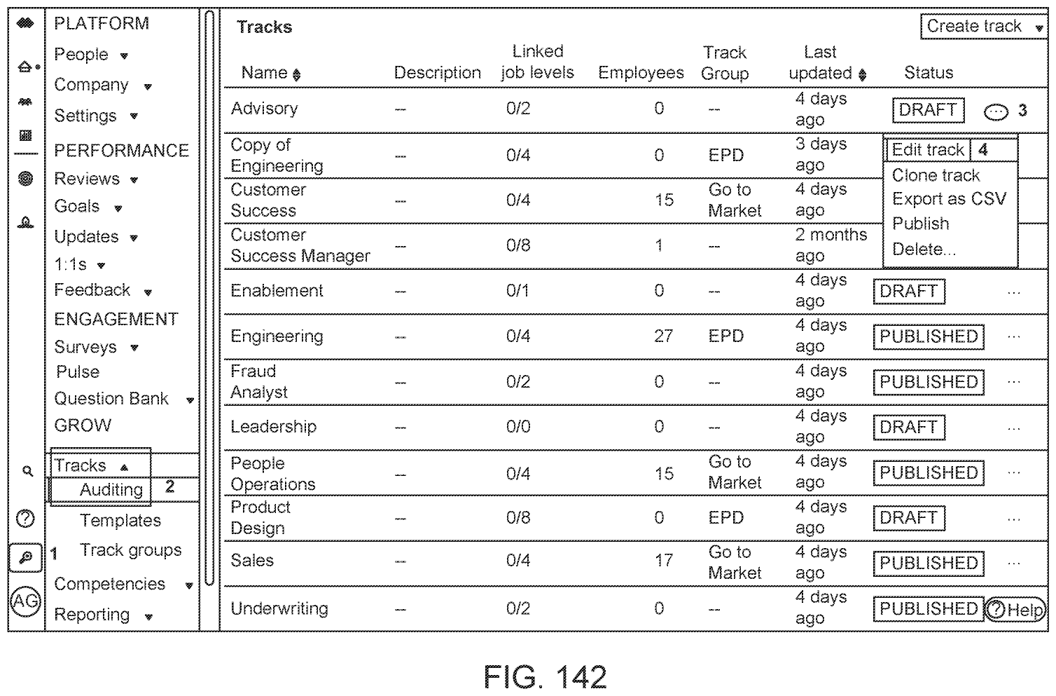

FIG. 142 is a schematic demonstrating how to navigate a user interface to rename a track.

Step 3: Apply edits and click save to apply changes.

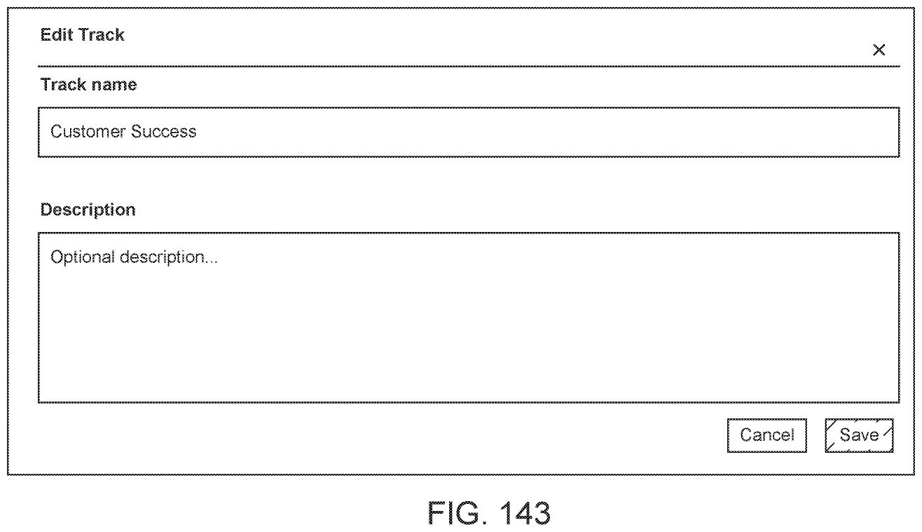

FIG. 143 is a schematic of a user interface displaying an edit track page containing text boxes to receive a track name and description.

### How to Edit and Remove Competencies in a Track

Before you start

Tracks must be in draft in order to edit the competencies within. If your track is published, you will need to unpublish it before making any changes.

Edit competencies in a track

Step 1: Navigate Admin>Grow>Tracks>Auditing.

Step 2: Enter the desired draft track.

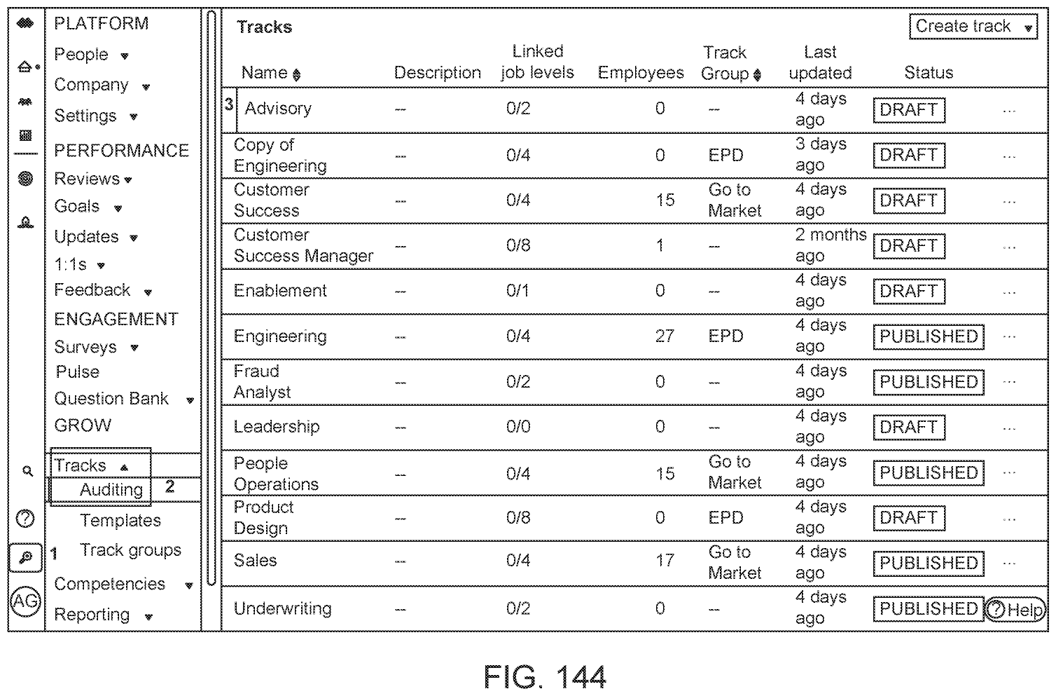

FIG. 144 is a schematic demonstrating how to navigate a user interface to edit competencies in a track.

Step 3: Click into the ellipsis ( . . . ) next to the competency you'd like to edit, then click edit competency.

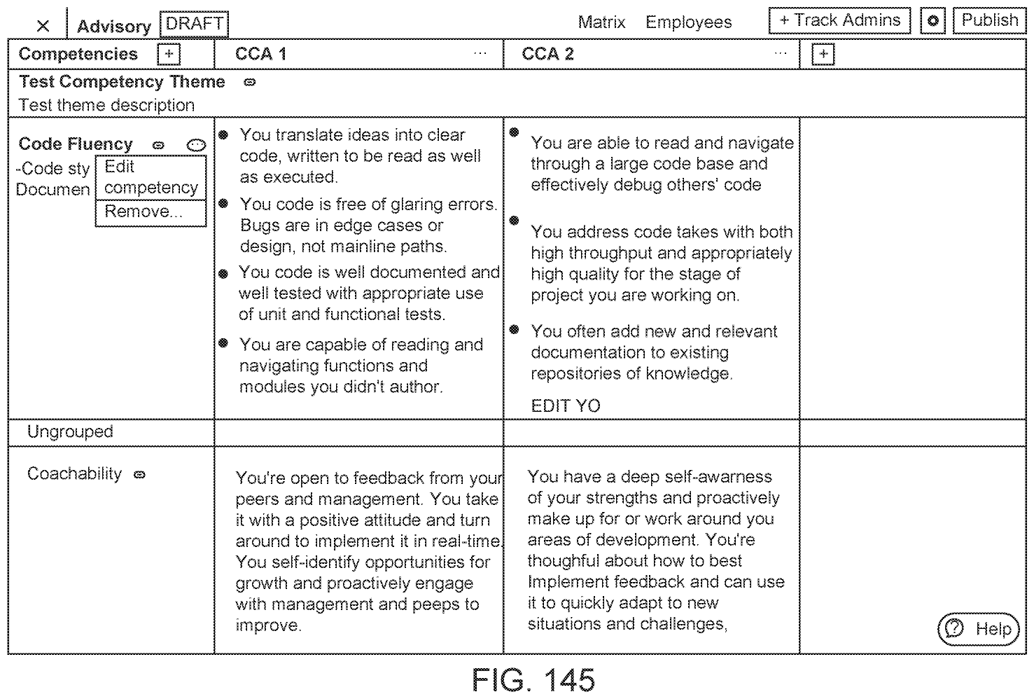

FIG. 145 is a schematic of a user interface displaying a matrix of competencies available to be edited.

Step 4: A pop-up modal will appear in which you're able to apply edits.

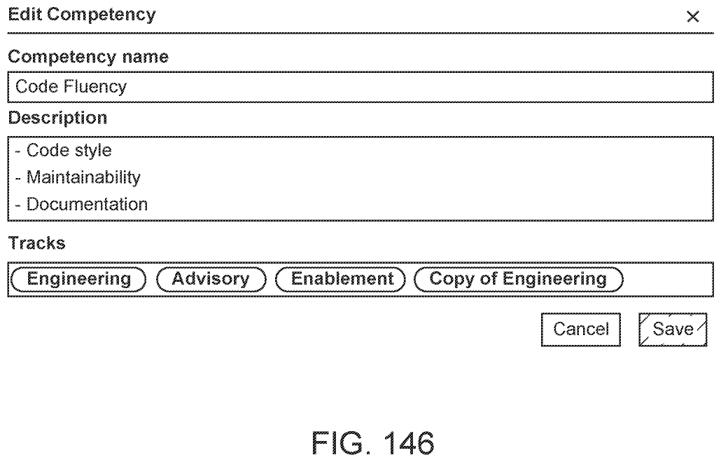

FIG. 146 is a schematic of a user interface displaying an edit competency page containing a list of linked tracks and text boxes to receive a competency name and description.

Note: Editing the competency from this page will impact all tracks this competency is linked to.

Remove Competencies in a Track

Step 1: From within a track, click on the ellipsis ( . . . ) to the right of the competency you wish to remove and select Remove.

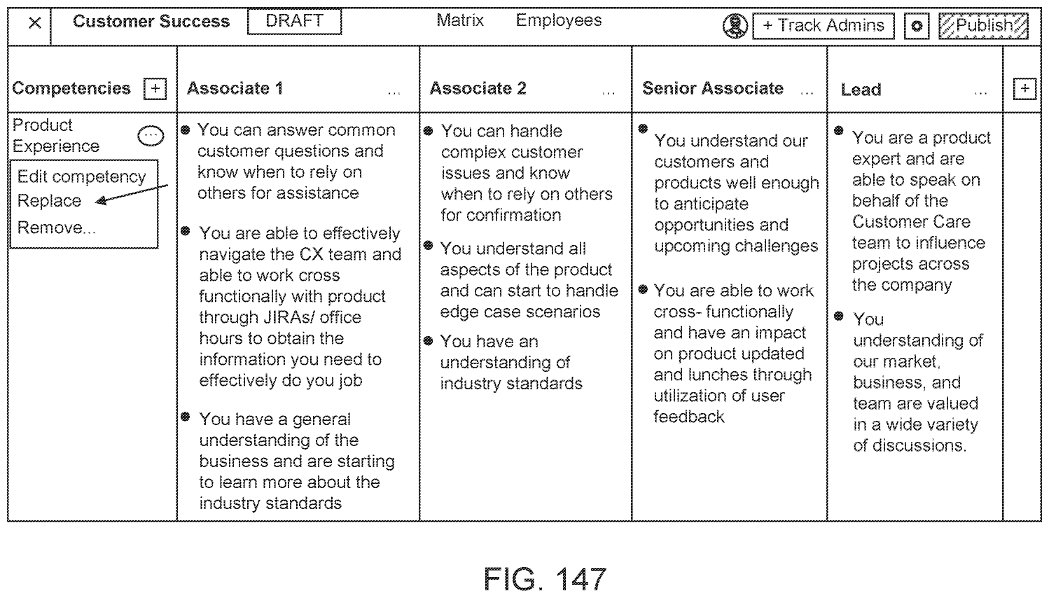

FIG. 147 is a schematic demonstrating how to navigate a user interface to remove a competency.

Step 2: A popup modal will prompt you to confirm removal. Clicking Remove Competency will automatically update and save the track.

(Optional): Once the track is ready, publish the track to make it visible to assigned employees.

### How to Edit Levels in a Track

Before You Start

Tracks must be in draft in order to edit, delete, or rename the associated levels. If your track is published, you will need to unpublish it before making any changes to its contents. To arrange levels in a track see How to Reorder Levels.

Edit and Delete Levels

Step 1: Navigate to Admin>Grow>Tracks>Auditing.

Step 2: Select the desired track and click on the ellipsis ( . . . ) to the right of the level you wish to edit and select Edit or Delete.

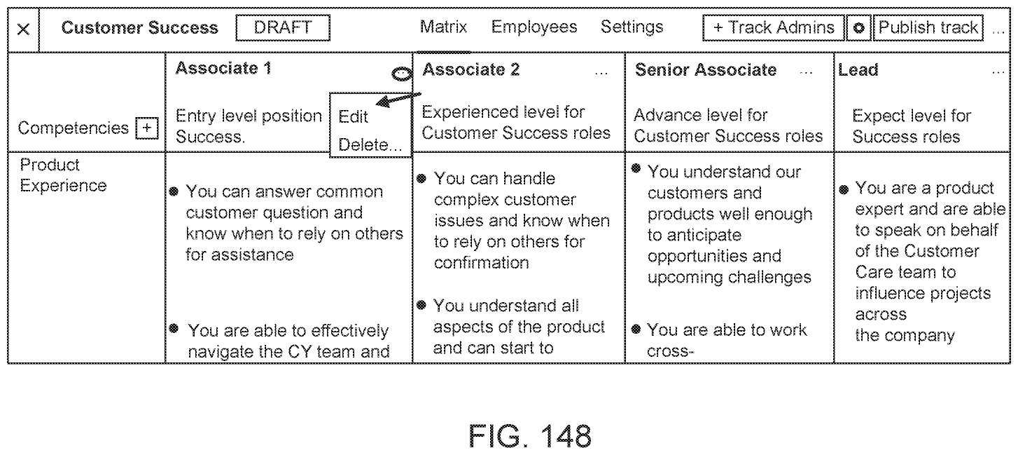

FIG. 148 is a schematic demonstrating how to navigate a user interface to edit a level in a track.

Step 3: A modal will appear where you can then rename the track and track level description, or in the case of deletion, a confirmation click will prompt you to save changes.

Add Additional Levels

Step 1: Select the desired track and click on the plus sign (+) to the right of the current levels in order to add additional columns. Changes are auto-saved.

(Optional): Once the track is ready, publish the track to make it visible to assigned employee.

Question

How can I deduplicate a competency?

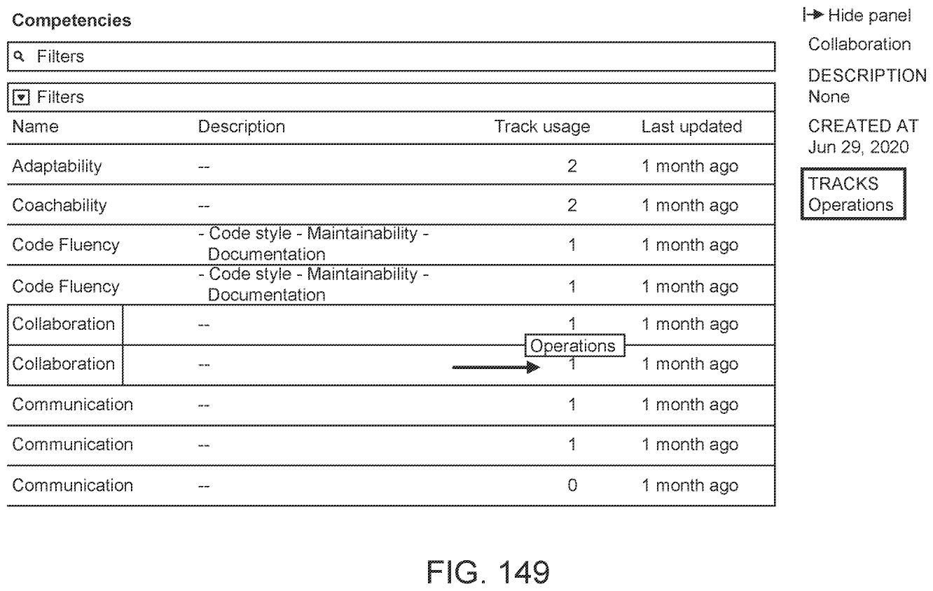

FIG. 149 is a schematic of a user interface displaying additional details for a particular competency in a list of competencies.

Answer

When uploading tracks and competencies by CSV, you may encounter tracks with the same competency. To deduplicate competencies:

Step 1: Replace the competency with the correct duplicate within your track.

Step 2: Delete the undesired duplicate.

Please note: You may click into the competency to view additional details or hover over the number of track usage to view which tracks are currently used for that competency.

### How to Reorder Levels

How Admins can Re-Order Levels in an Active or Drafted Track

Once a track has been created, admins can re-order levels to match a more appropriate placement within the track. Levels can be assigned and re-ordered in both a published and un-published track.

Step 1: Navigate Admin>Grow>Tracks>Auditing.

Step 2: Select the desired track and enter the Employees tab.

Step 3: Select the gear icon in the top right of the page and select Reorder job levels.

Please note: If your levels are linked to a user attribute, select Manage job levels.

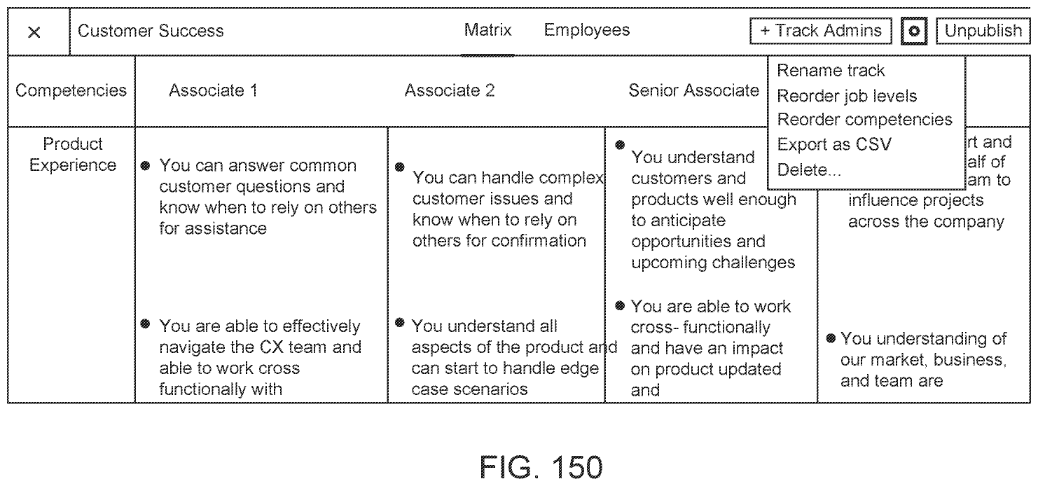

FIG. 150 is a schematic demonstrating how to navigate a user interface to reorder a level within a track.

Step 4: Select the dots next to the level title you would like to re organize, and drag and drop the level to the appropriate placement.

Step 5: Click Save.

FIG. 151 is a schematic of a user interface displaying a pop-up window containing a list of job levels that may be reordered by dragging and dropping.

### How to Replace a Competency in a Track

When creating a track, you may decide to swap out a competency with one more relevant within a track. Learn how to replace a competency in a track using the following steps.

Before you start

Tracks must be in draft in order to be edited. If your track is published, you will need to unpublish it before making any changes.

Step 1: Navigate Admin>Grow>Tracks>Auditing.

Step 2: Enter the desired draft track.

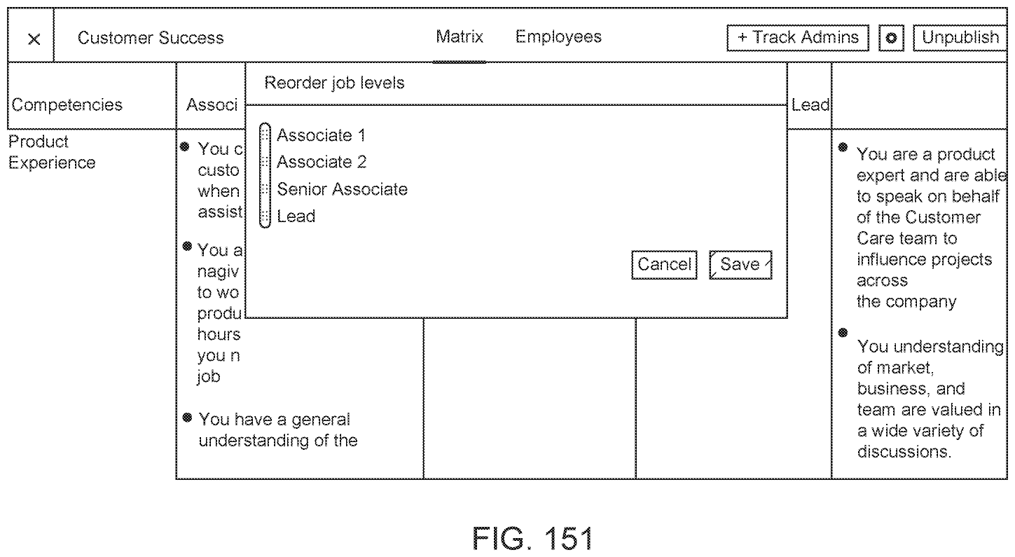

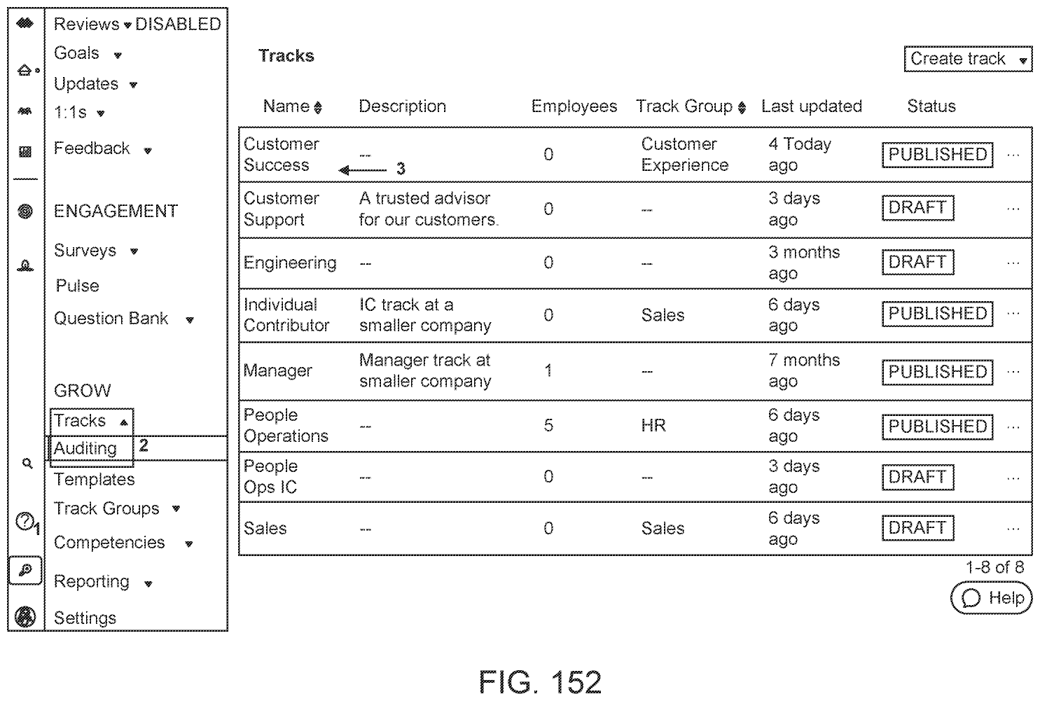

FIG. 152 is a schematic demonstrating how to navigate a user interface to replace competencies in a track.

Step 3: Click on the ellipsis ( . . . ) to the right of the competency you wish to replace and select Replace.

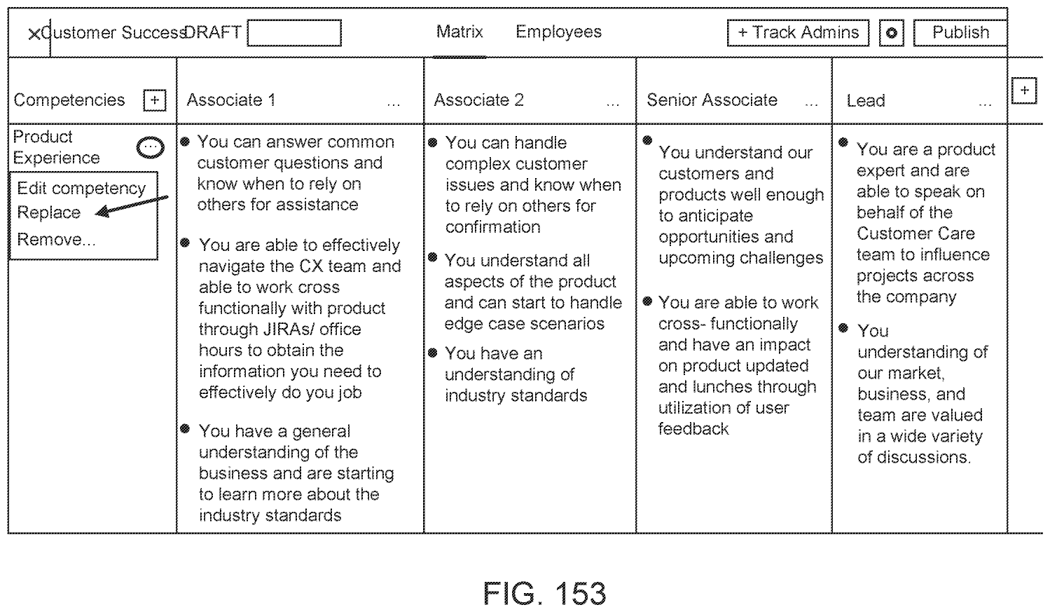

FIG. 153 is a schematic of a user interface displaying a matrix of competencies available to be replaced.

Step 4: A popup modal will appear. Search for the new competency in the search bar or click on the name of the competency from the list.

Step 5: Select Use competency.

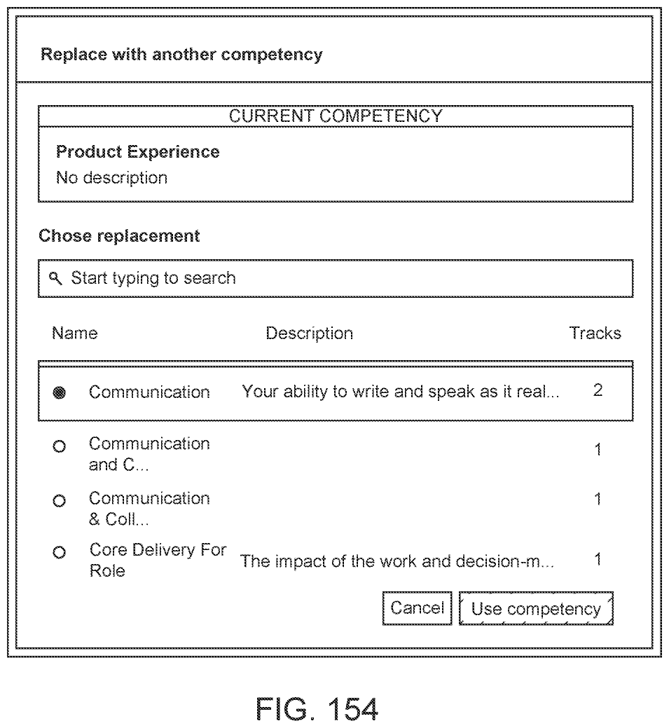

FIG. 154 is a schematic of a user interface displaying a pop-up window containing a list of replacement competencies to select from.

Step 6 (Optional): Once the track is ready, publish the track to make it visible to assigned employees.

How to Edit Track Groups

Step 1: Navigate to Admin>Grow>Tracks>Track Groups.

Step 2: Beside the groups, select the ellipses ( . . . ) and click Edit track group.

FIG. 155 is a schematic demonstrating how to navigate a user interface to edit track groups.

Step 3: A modal will appear with the current Track Group settings. Make the desired changes to the name, assigned tracks, or departments.

Step 4: Select Edit track group.

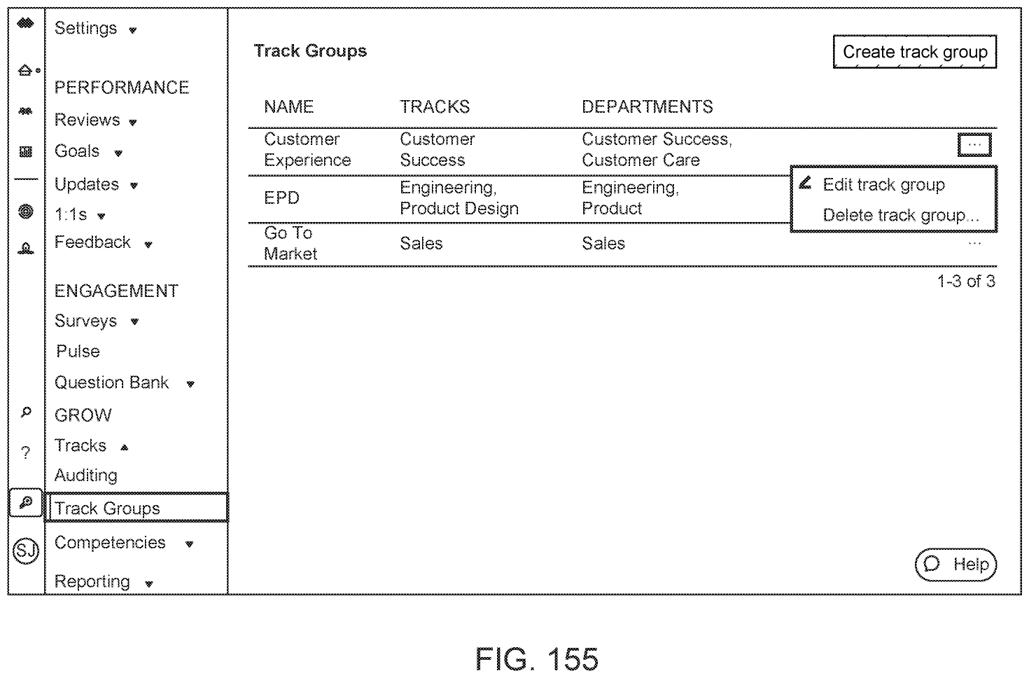

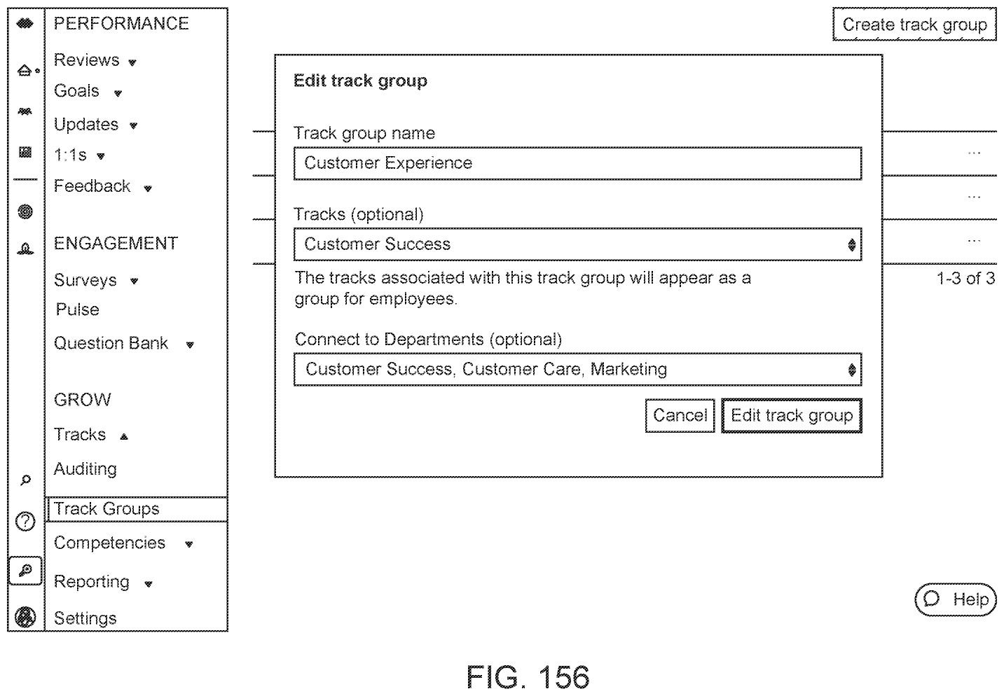

FIG. 156 is a schematic of a user interface displaying a pop-up window containing a text box and drop-down menus for receiving edits to a track group.

How to Export a Track into a CSV

After a track has been created, admins can export the track into a CSV file. The steps below walk through two ways to export an existing track from Lattice:
Export a track from the Track Auditing page
Export a track from within the track

Note: Admins can export both published and drafted tracks.

Export a track from the Track Auditing page

Step 1: Navigate to Admin>Grow>Tracks>Auditing.

Step 2: Click on the ellipses ( . . . ) next to the track you'd like to export and select Export as CSV.

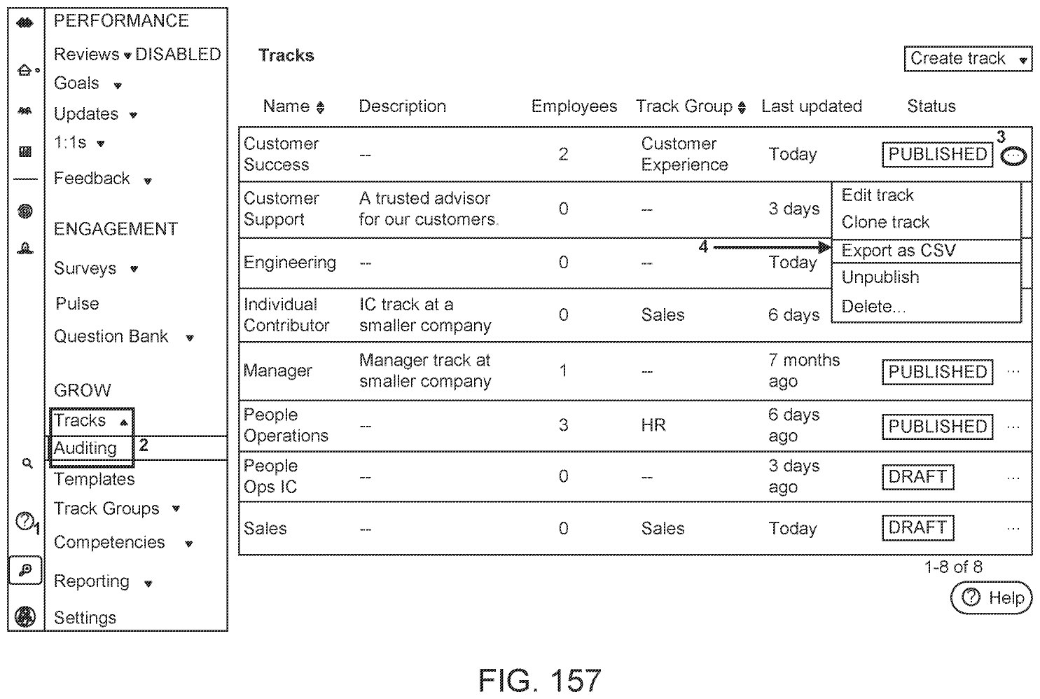

FIG. 157 is a schematic demonstrating how to navigate a user interface to export a track from the Track Auditing page.

Export a track from within the track

Step 1: Enter the desired track.

Step 2: Click on the gear icon in the top right corner and select Export as a CSV.

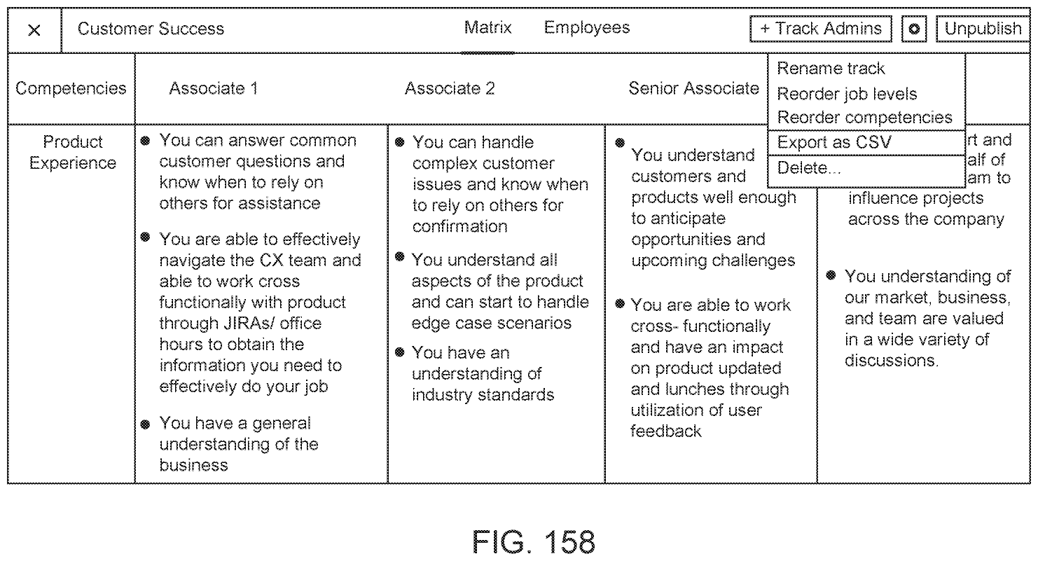

FIG. 158 is a schematic of a user interface displaying a track matrix available to be exported as a CSV.

Question

Can I update an existing track by re-uploading the CSV?

Answer

Tracks cannot be updated via CSV, only created. In this case, we'd recommend creating a new track (with the updated CSV) and putting your outdated track in a “draft” mode.

How to Customize Career Vision Templates for Your Organization

Career vision exercises help capture an employee's long-term career goals via exercise responses that they can share with their managers. The career vision template is customizable to admins to help fit their organization. Managers can also create team-specific exercises for further customization.

Learn more about Career visions in Individual Development Plans.

Before you start

Career vision exercises are automatically enabled in Grow. Only admins can customize the career vision template. However, managers can add a tip to each exercise for the direct report or create team-specific exercises in addition to the organization-wide template.

Note, managers of managers (MoMs) will not have visibility into their indirect report's career vision responses.

Customize the career vision template

Step 1: Navigate to Admin>Grow>Settings.

Step 2: Navigate to the Career vision template to complete one of the following actions:
Change the order within the template by dragging and dropping the exercises
Edit, disable, or enable an existing exercise
Create a new exercise

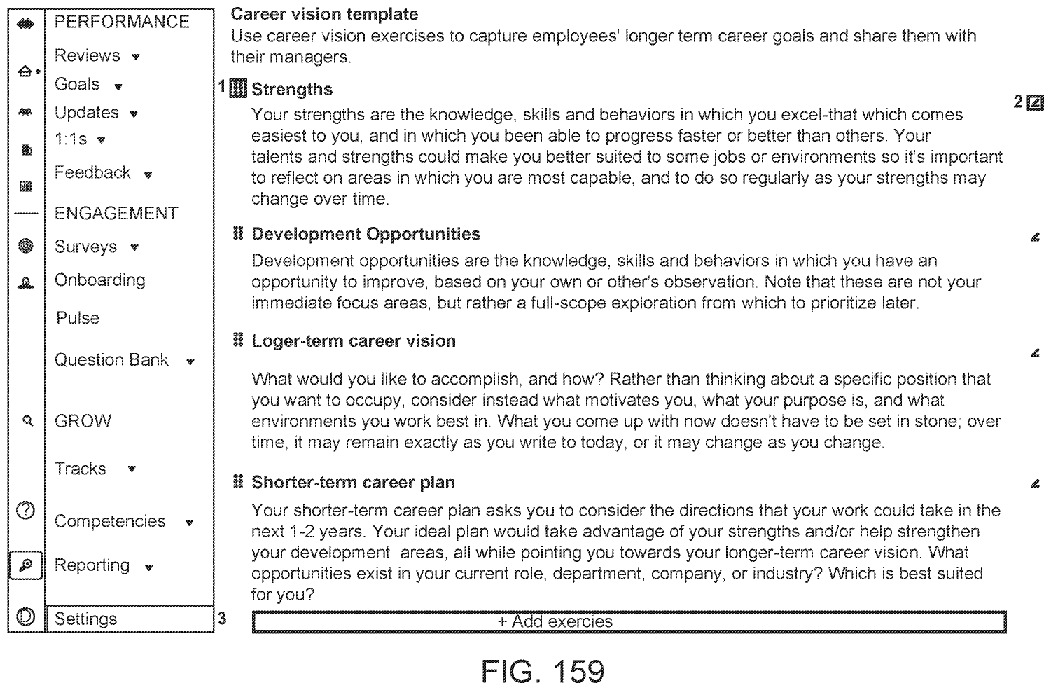

FIG. 159 is a schematic demonstrating how to navigate a user interface to customize a career vision template.

Step 3: Select Save within the modal. Confirm within the Settings page by selecting Save.

Next, learn how to create and send a career vision kickoff notification.

### How to Create a Career Vision Exercise for Your Organization

Career vision exercises help capture an employee's long-term career goals via exercise responses that they can share with their managers. The career vision template is customizable to admins to help fit their organization. Managers can also create team-specific exercises for further customization.

Before you start

Career vision exercises are automatically enabled in Grow. Only admins can create new exercises within the career vision template. However, managers can add a tip to each exercise for the direct report or create team-specific exercises in addition to the organization-wide template.

Note, managers of managers (MoMs) will not have visibility into their indirect report's career vision responses.

Create a Career Vision

Step 1: Navigate to Admin>Grow>Settings.

Step 2: Navigate to the Career vision template and select+Add exercise.

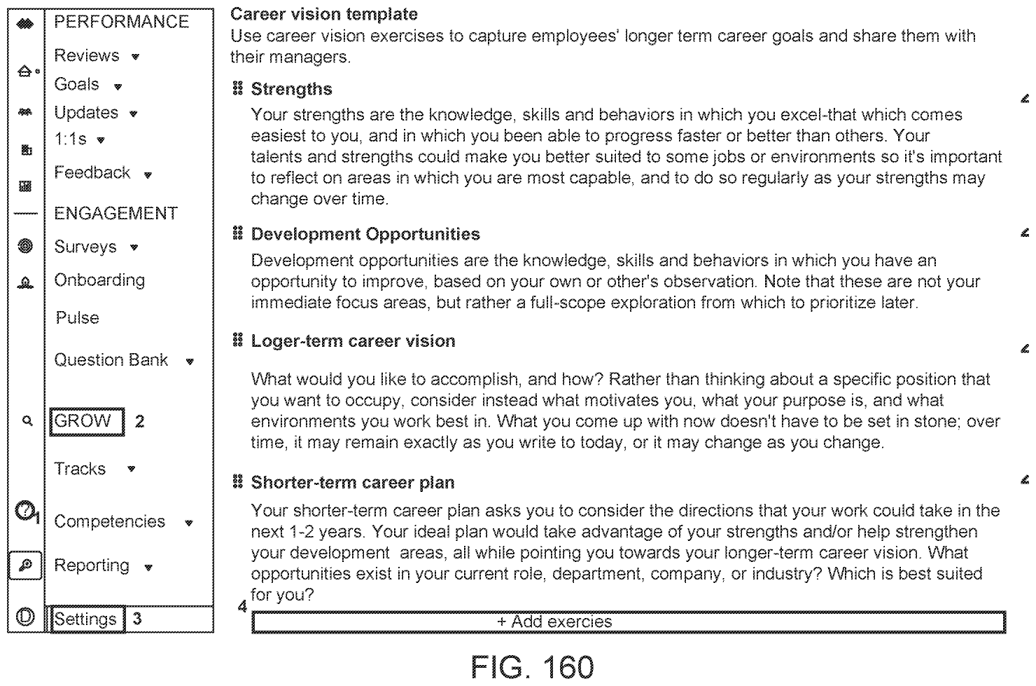

FIG. 160 is a schematic demonstrating how to navigate a user interface to add an exercise to a career vision template.

Step 3: Give the exercise a name and provide a description of what you're looking for. This will be visible to all employees.

Step 4: Toggle on Enabled to ensure the exercise is visible to managers and employees.

Step 5: Select Create. Confirm within the Settings page by selecting Save.

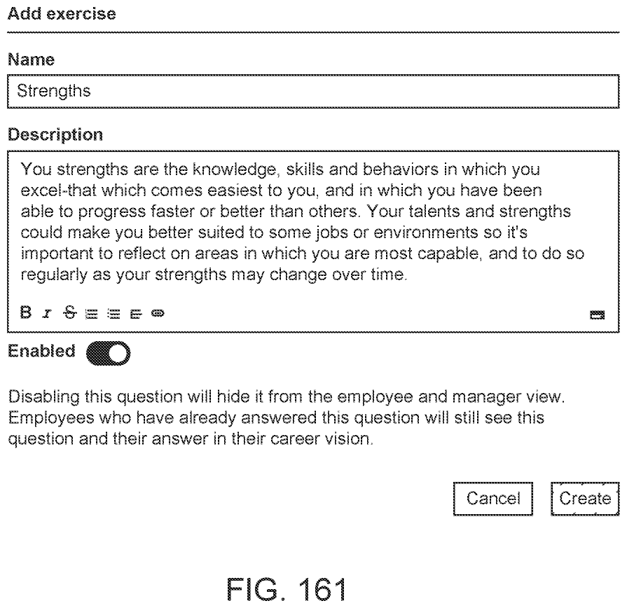

FIG. 161 is a schematic of a user interface displaying a pop-up window to receive edits to an exercise being added to a career vision template.

### How to Hide Career Vision Exercises for Your Organization

Career vision exercises help capture an employee's long-term career goals via exercise responses that they can share with their managers. The career vision template is customizable to admins to help fit their organization. Managers can also create team-specific exercises for further customization.

Before you start

Career vision exercises are automatically enabled in Grow. Only admins can hide exercises within the career vision template from the whole organization. Managers can hide team-specific exercises.

Once disabled, exercises are hidden for the entire organization, except for employees who have already submitted a response. In those cases, the employee can view the exercise and their response within the Inactive section of the Individual Development Plan.

How to hide a career vision exercise

Step 1: Navigate to Admin>Grow>Settings.

Step 2: Navigate to the Career vision template section and select the pencil icon next to the exercise you wish to hide.

Step 3: Toggle off Enabled.

Step 4: Select Save within the modal. Confirm within the Settings page by selecting Save.

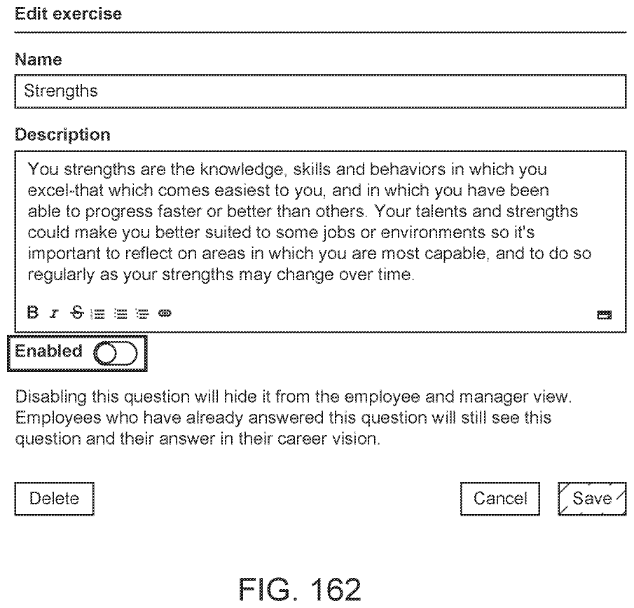

FIG. 162 is a schematic of a user interface displaying a pop-up window containing a toggle button for enabling a career vision exercise.

### How to Edit Career Vision Exercises for Your Organization

Career vision exercises help capture an employee's long-term career goals via exercise responses that they can share with their managers. The career vision template is customizable to admins to help fit their organization. Managers can also create team-specific exercises for further customization.

Before you start

Only admins can edit exercises within the career vision template. However, managers can add a tip to each exercise for the direct report or create team-specific exercises in addition to the organization-wide template.

Edits will update all exercises regardless of whether a response has been submitted.

How to edit a career vision exercise

Step 1: Navigate to Admin>Grow>Settings.

Step 2: Navigate to the Career vision template section and select the pencil icon next to the exercise you wish to edit.

Step 3: Update the exercise name, description, or enable/disable the exercise for employees.

Step 4: Select Save within the modal. Confirm within the Settings page by selecting Save.

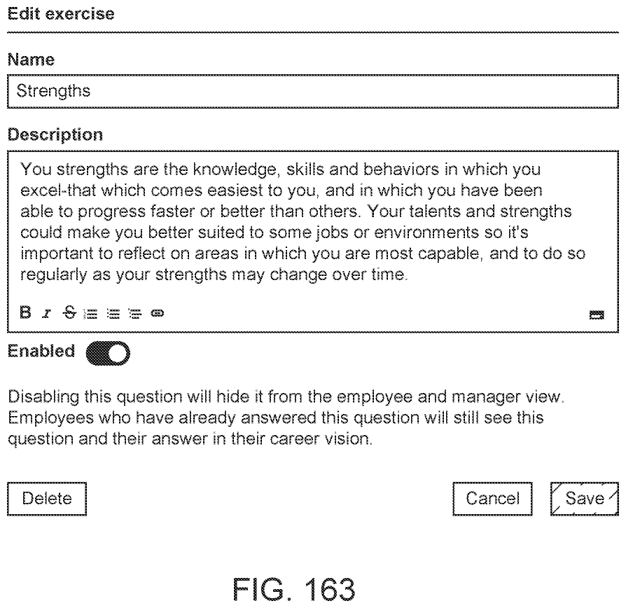

FIG. 163 is a schematic of a user interface displaying a pop-up window to receive edits to an exercise in a career vision template.

### How to Delete a Career Vision Exercise for Your Organization

Career vision exercises help capture an employee's long-term career goals via exercise responses that they can share with their managers. The career vision template is customizable to admins to help fit their organization. Managers can also create team-specific exercises for further customization.

Before you start

Only admins can delete exercises within the career vision template. However, managers can add a tip to each exercise for the direct report or create team-specific exercises in addition to the organization-wide template.

Deleting an exercise will prevent employees from answering the question and hide it from the admin settings panel. Employees who have already answered will still see the question and their answer in their career vision within their Inactive exercises.

How to delete a career vision exercise

Step 1: Navigate to Admin>Grow>Settings.

Step 2: Navigate to the Career vision template section and select the pencil icon next to the exercise you wish to edit.

Step 3: Select Delete. Confirm by selecting Delete . . . .

Step 4: Within the Settings page, select Save.

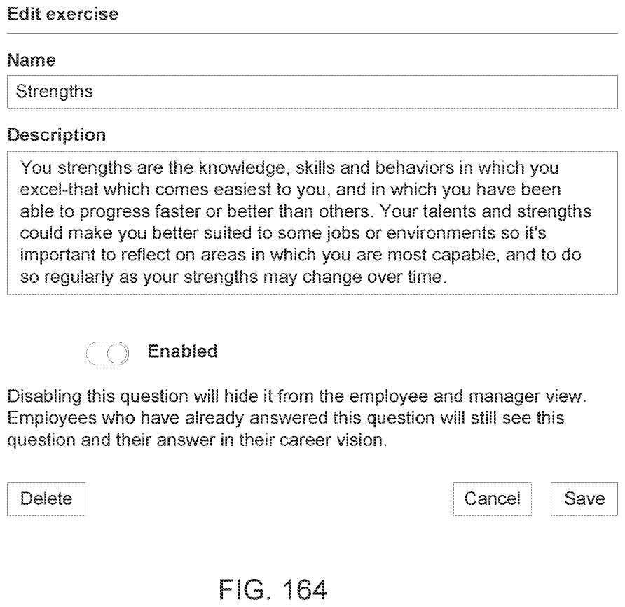

FIG. 164 is a schematic of a user interface displaying a pop-up window containing the option to delete an exercise from a career vision template.

### How to Create a Career Vision Exercise for Your Team

Career vision exercises help capture an employee's long-term career goals via exercise responses that they can share with their managers. While only an admin can customize the organization-wide template of career vision exercises, managers can create additional exercises for their teams for greater customization.

Before you start

Career vision exercises are automatically enabled in Grow. Managers can create team-wide exercises in addition to the organization-wide template, but they cannot edit, deactivate, or delete any admin-created exercises. Managers can add tips to admin-created exercises to provide additional clarity to their teams.

Exercises created by managers will appear to all their direct reports.

Note: Managers of managers (Molls) will not have visibility into their indirect reports career vision responses.

Create a career vision exercise
1. Navigate to My Team and select the Grow tab.
2. Under the Career Vision section, click Add Exercise.
3. Create the exercise or question and click Publish.

Edit a career vision exercise
1. Navigate to My Team and select the Grow tab.
2. Under the Career Vision section, locate the exercise you'd like to edit and click View.
3. Make any needed updates and click Publish.

Deactivate or reactivate a career vision exercise

To deactivate an exercise:
1. Navigate to My Team and select the Grow tab.
2. Under the Career Vision section, locate the exercise you'd like to edit and click View.
3. Click the Deactivate button.
4. When prompted, click Confirm.

When an exercise is deactivated, any responses that have been published will be preserved, but can't be edited. To view responses to deactivated exercises or reactivate them:
1. Click Add Exercise.
2. Select the deactivated exercises from the list of inactive exercises in the left navigation panel.

If the exercise has any prior responses they will appear here. To reactivate the exercise, click the Reactivate button.

Send an Individual Development Plan Kickoff Notification to Managers

Admins can create and schedule a kickoff notification to prompt managers to facilitate career conversations with their direct reports. Kickoff notifications will be sent across email, Slack, and Microsoft Teams.

Create an Individual Development Plan kickoff notification
1. Navigate to Admin>Grow>Settings.
2. Expand the Individual development plans section.
3. Under Individual development plan kickoff notification, select+Create notification.
4. Customize the subject, body, send date, time, and time zone.
5. (Optional) The Send reminder to managers notification is toggled on by default if a launch notification was enabled. If enabled a reminder notification will be sent to managers one week after the initial launch notification. Toggle off to disable.
6 (Optional): Send yourself a preview of the email to ensure accuracy.
7. Select Save.

Note: You can edit or cancel the kickoff notification at any time before sending.

### Edit an Individual Development Plan Kickoff Notification

Once an admin has created an individual development plan kickoff notification, the notification can be edited or canceled at any time before it sends.

Edit an individual development plan kickoff notification
1. Navigate to Admin>Grow>Settings.
2. Expand the Individual development plans section.
3. Under Individual development plan kickoff notification, select Manage notification.
4. Make desired edits and select Save.

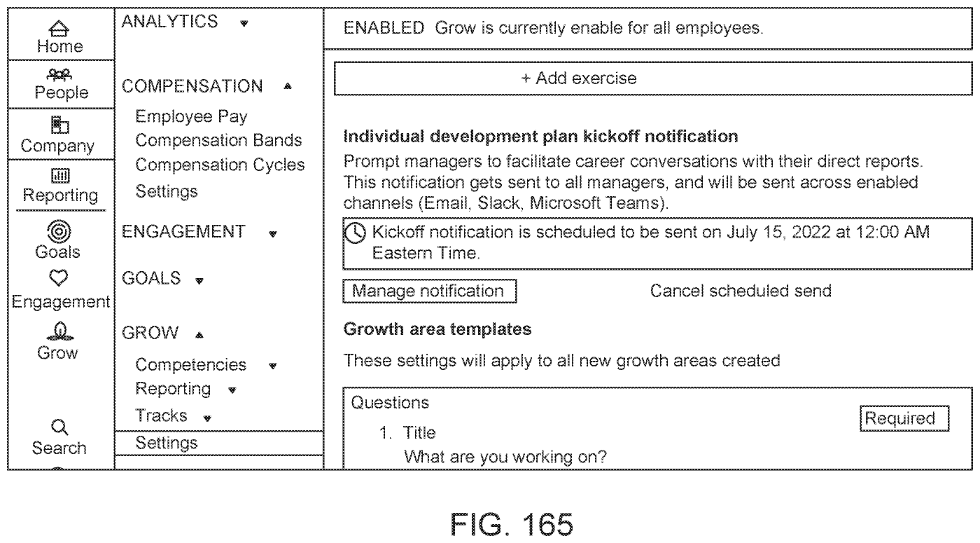

FIG. 165 is a schematic of a user interface displaying an individual development plan kickoff notification and a manage notification button.

### Cancel an Individual Development Plan Kickoff Notification Scheduled Send

Once an admin has created an individual development plan kickoff notification, the notification can be edited or deleted at any time before it sends.

Note: Canceling will permanently delete ally customizations made to your notification.

Cancel an individual development plan notification
1. Navigate to Admin>Grow>Settings.
2. Expand the Individual development plans section.
3. Under Individual development plan kickoff notification, select Cancel scheduled send.

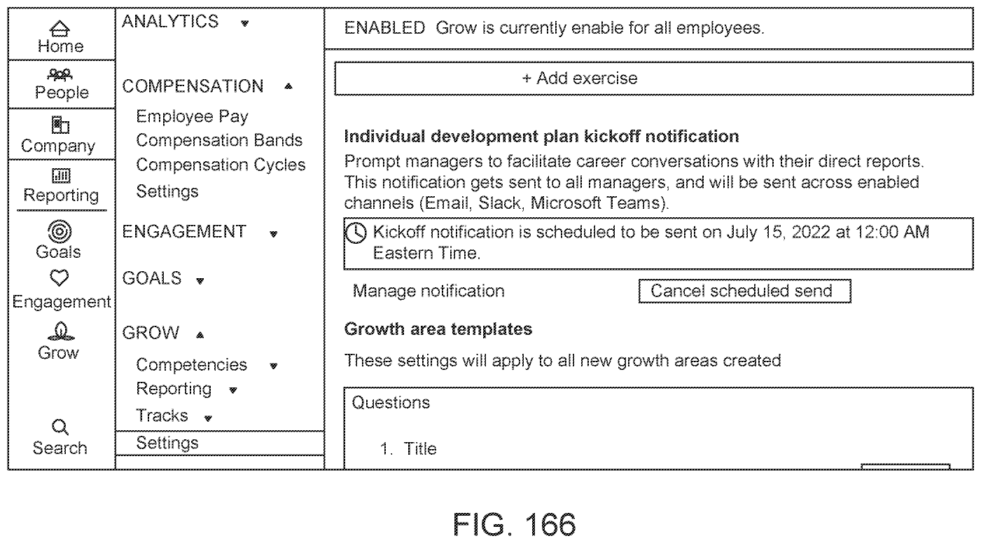

FIG. 166 is a schematic of a user interface displaying an individual development plan kickoff notification and a cancel scheduled send button.

### Customize Employee Growth Area Templates

Growth area templates help admins guide their employees and managers to create effective and actionable growth areas. We recognize that there are many schools of thought on development; therefore, we allow admins to customize growth area fields to fit their company's needs.

Before you start

Changes made to the template will only impact growth areas that are created after the change has been made.

Customize Growth Area Templates

Step 1: Navigate to Admin>Grow>Settings.

Step 2: Scroll down to the Growth area templates section of the Settings page.

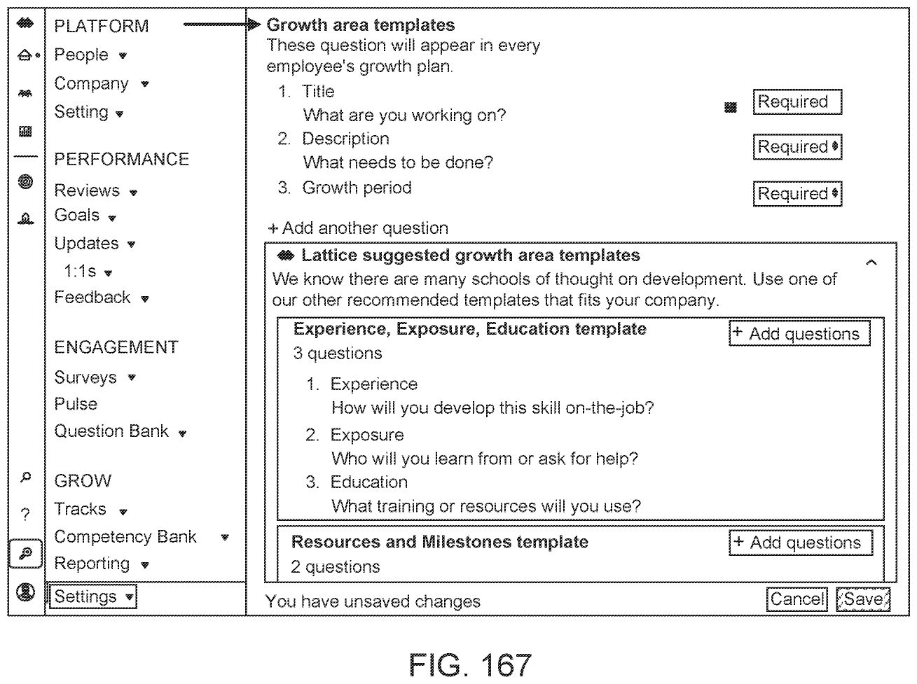

FIG. 167 is a schematic demonstrating how to navigate a user interface to customize growth area templates.

### Updating Optionality

Admins can make specific fields required or optional by selecting either option from the right-hand dropdown menu next to each field name. Please keep in mind that Title will always be a required field.

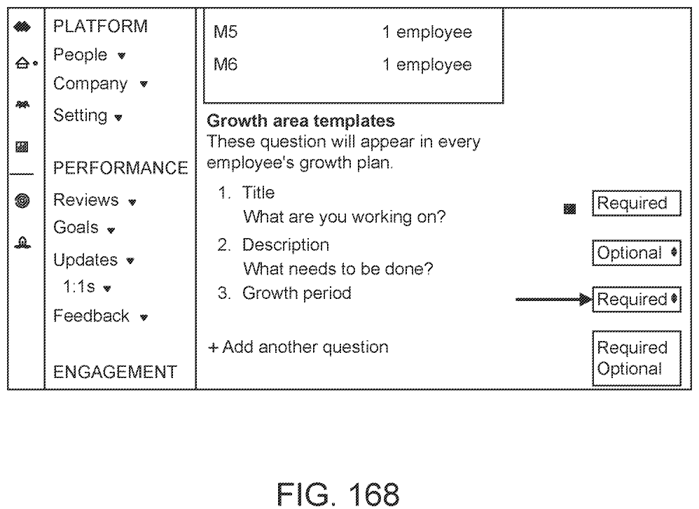

FIG. 168 is a schematic demonstrating how to navigate a user interface to update optionality of a specific field.

### Creating a New Question Field

Admins can create a new question field for their employees by selecting the +Add another question button found below the default fields.

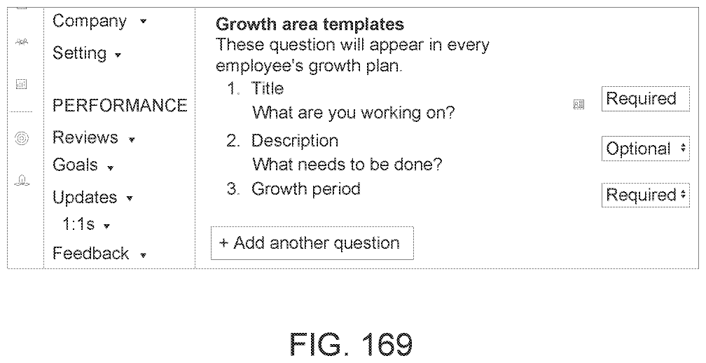

FIG. 169 is a schematic of a user interface displaying growth area template questions and an add another question button.

Once an admin clicks to create a new question, they will be prompted to add the question title, helper text, and choose whether the question will be required.

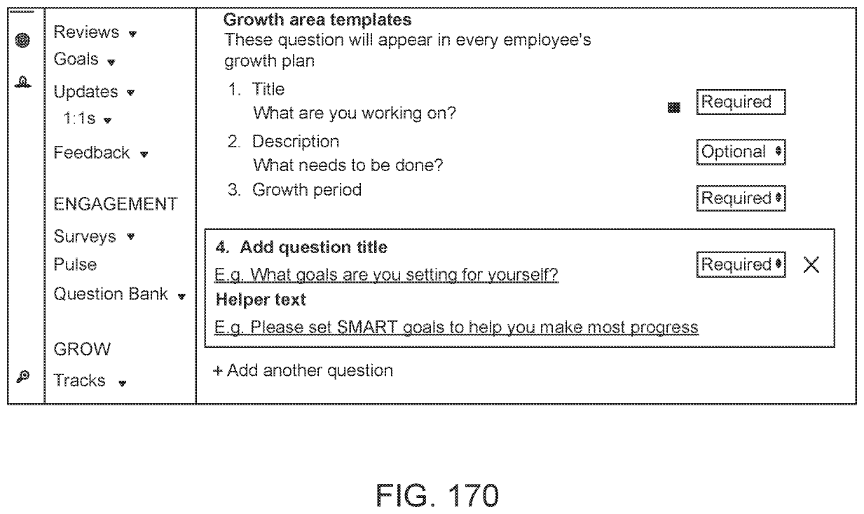

FIG. 170 is a schematic of a user interface displaying options to edit a new question in a growth area template.

### Allow Actions

Actions encourage employees to create discrete tasks and milestones they plan to complete as they develop. As an admin, you can hide action items or make them optional/required.

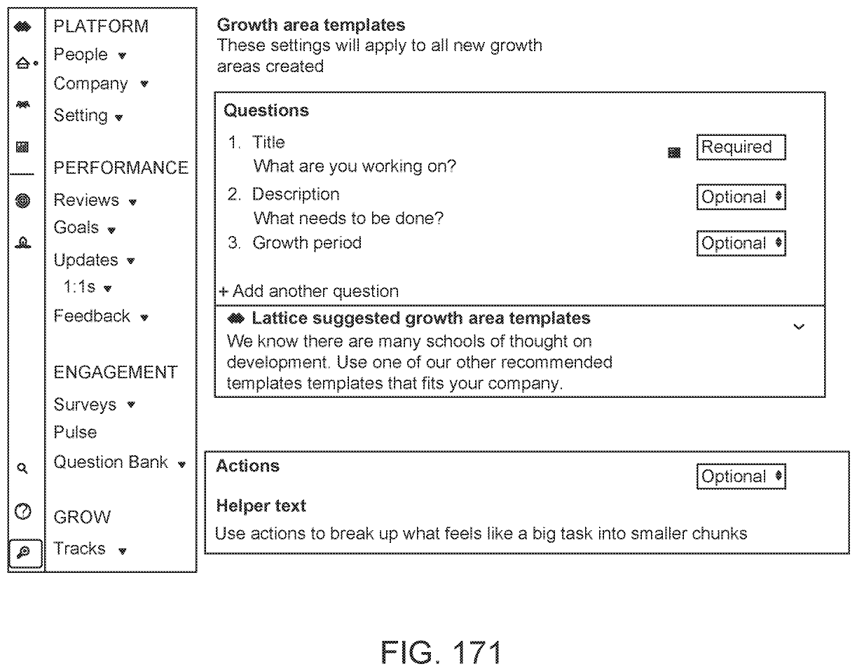

FIG. 171 is a schematic of a user interface displaying options to hide an action or make it optional/required.

### Using a Lattice-Approved Template

Lattice-approved templates have been designed to help admins pinpoint questions that will help guide their employees to dive deeper into their growth areas. Admins can use any of the following templates:

### Experience, Exposure, Education

1. Experience: How will you develop this skill on the job?

2. Exposure: Who will you learn from or ask for help?

3. Education: What training or resources will you use?

### Resources and Milestones

1. Resources: What support and resources do you need?

2. Milestones: What accomplishments will you use to track progress?

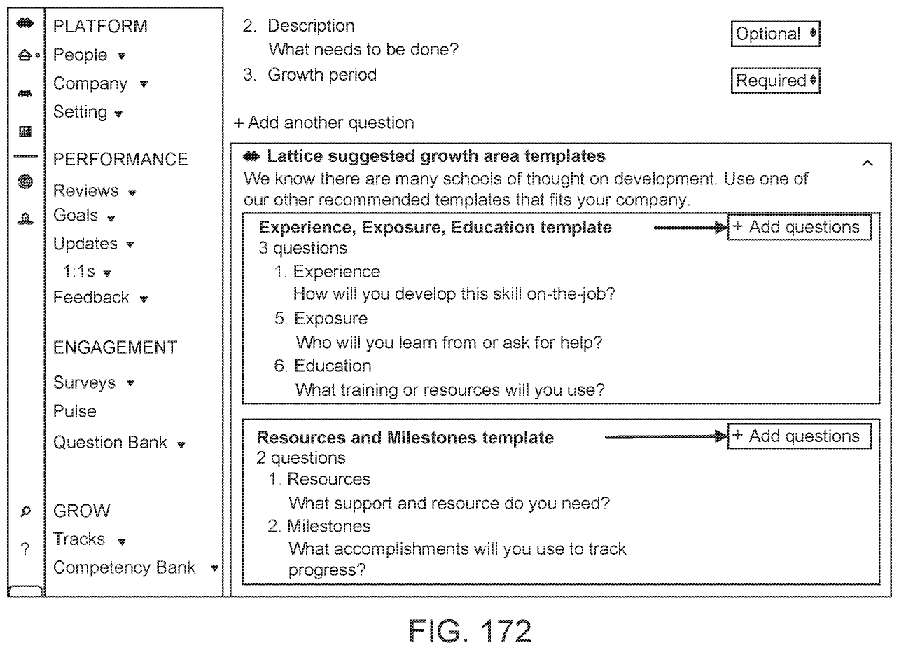

FIG. 172 is a schematic of a user interface displaying suggested growth area templates and the option to add questions to the templates.

To add the questions to the growth area template, simply click+Add questions. From here, admins can remove any questions and edit the optionality.

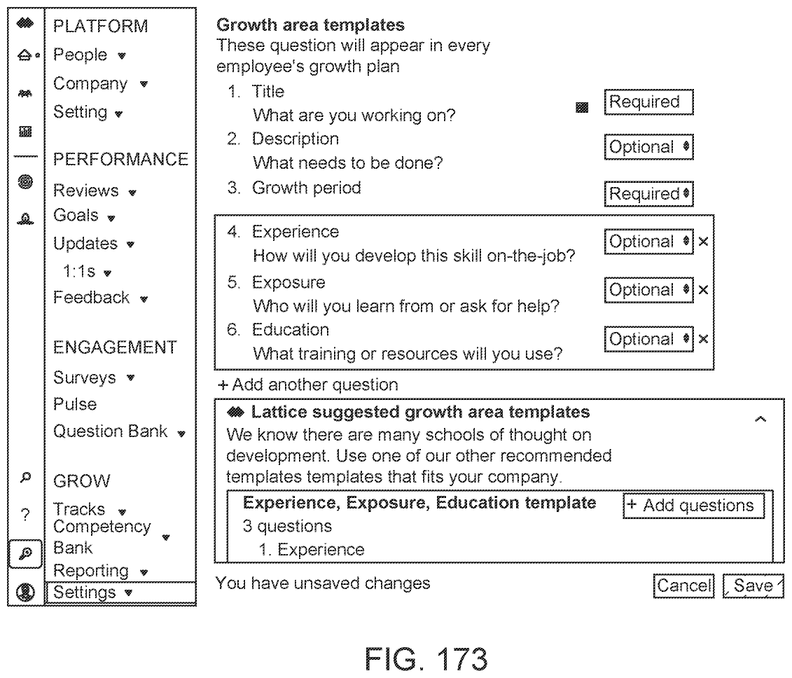

FIG. 173 is a schematic of a user interface displaying growth area template questions and the option to edit their optionality.

### Example Mobile Device

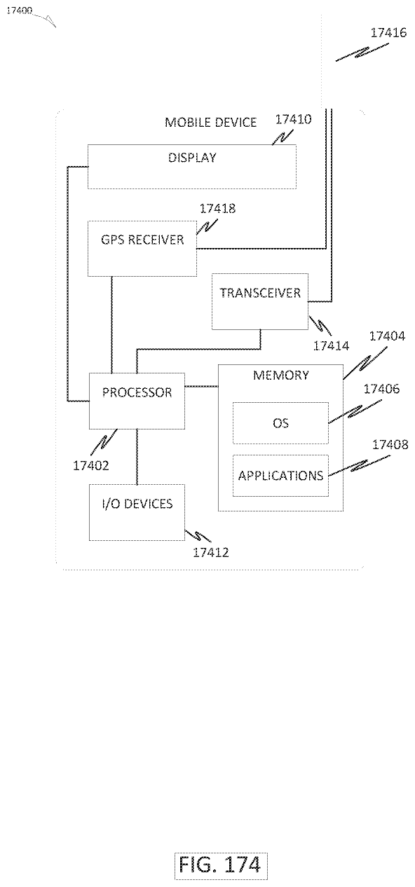

FIG. 174 is a block diagram illustrating a mobile device 17400, according to an example embodiment.

The mobile device 17400 can include a processor 17402. The processor 17402 can be any of a variety of different types of commercially available processors suitable for mobile devices 17400 (for example, an XScale architecture microprocessor, a Microprocessor without Interlocked Pipeline Stages (MIPS) architecture processor, or another type of processor). A memory 17404, such as a random access memory (RAM), a Flash memory, or other type of memory, is typically accessible to the processor 17402. The memory 17404 can be adapted to store an operating system (OS) 17406, as well as application programs 17408, such as a mobile location-enabled application that can provide location-based services (LBSs) to a user. The processor 17402 can be coupled, either directly or via appropriate intermediary hardware, to a display 17410 and to one or more input/output (I/O) devices 17412, such as a keypad, a touch panel sensor, a microphone, and the like. Similarly, in some embodiments, the processor 17402 can be coupled to a transceiver 17414 that interfaces with an antenna 17416. The transceiver 17414 can be configured to both transmit and receive cellular network signals, wireless data signals, or other types of signals via the antenna 17416, depending on the nature of the mobile device 17400. Further, in some configurations, a GPS receiver 17418 can also make use of the antenna 17416 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

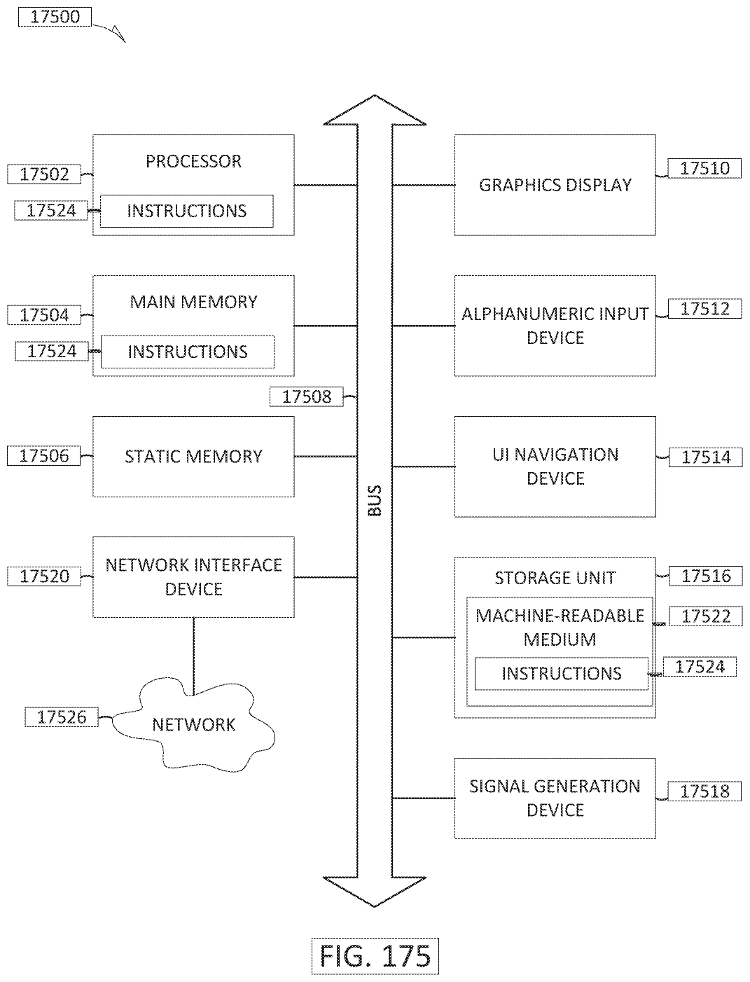

FIG. 175 is a block diagram of an example computer system 17500 on which methodologies and operations described herein may be executed, in accordance with an example embodiment.

In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 17500 includes a processor 17502 (e.g., a central processing unit (CPU), a graphics processing unit (GPU) or both), a main memory 17504, and a static memory 17506, which communicate with each other via a bus 17508. The computer system 17500 may further include a graphics display unit 17510 (e.g., a liquid crystal display (LCD) or a cathode ray tube (CRT)). The computer system 17500 also includes an alphanumeric input device 17512 (e.g., a keyboard or a touch-sensitive display screen), a user interface (UI) navigation device 17514 (e.g., a mouse), a storage unit 17516, a signal generation device 17518 (e.g., a speaker), and a network interface device 17520.

### Machine-Readable Medium

The storage unit 17516 includes a machine-readable medium 17522 on which is stored one or more sets of instructions and data structures (e.g., software) 17524 embodying or utilized by any one or more of the methodologies or functions described herein. The instructions 17524 may also reside, completely or at least partially, within the main memory 17504 and/or within the processor 17502 during execution thereof by the computer system 17500, the main memory 17504 and the processor 17502 also constituting machine-readable media.

While the machine-readable medium 17522 is shown in an example embodiment to be a single medium, the term “machine-readable medium” may include a single medium or multiple media (e.g., a centralized or distributed database, and/or associated caches and servers) that store the one or more instructions 17524 or data structures. The term “machine-readable medium” shall also be taken to include any tangible medium that is capable of storing, encoding or carrying instructions (e.g., instructions 17524) for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 17524 may further be transmitted or received over a communications network 17526 using a transmission medium. The instructions 17524 may be transmitted using the network interface device 17520 and any one of a number of well-known transfer protocols (e.g., HTTP). Examples of communication networks include a local area network (“LAN”), a wide area network (“WAN”), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
one or more computer processors;
one or more computer memories;
a set of instructions stored into the one or more computer memories, the set of instructions configuring the one or more computer processors to perform operations, the operations comprising:
creating a growth track;
associating the growth track with one or more competencies;
associating the growth track with one or more track levels;
aligning the growth track with a job architecture, the job architecture including a job function, a job type, and one or more job tracks;
mapping the one or more job levels to the one or more track levels;
creating a growth area, the growth area relating to the one or more competencies;
causing a presentation of a user interface on a device of a user based on the user being associated with the job function and the job type, the user interface allowing the user to share an update pertaining to a progress of the user within the growth area.

2. The system of claim 2, wherein the creating of the growth area is based on an input received from a manager of the user via an additional user interface.

3. The system of claim 1, wherein the growth area further includes one or more additional competences, the one or more additional competencies associated with an additional growth track.

4. The system of claim 1, wherein the one or more competencies include on or more characteristics or one or more skills corresponding to the growth track.

5. The system of claim 4, wherein the one or more competencies are selectable by a track administrator from a library of competencies via an additional user interface.

6. The system of claim 1, wherein the growth area includes one or more actions, the one or more actions associated with one or more due dates, and wherein the update pertaining to the progress of the user relates to a completion of the one or more actions before the one or more due dates.

7. The system of claim 1, further comprising, based on the sharing of the update, providing the update to a manager of the user via an additional user interface during a one-on-one meeting between the user and the manager.

8. A method comprising:
creating a growth track;
associating the growth track with one or more competencies;
associating the growth track with one or more track levels;
aligning the growth track with a job architecture, the job architecture including a job function, a job type, and one or more job tracks;
mapping the one or more job levels to the one or more track levels;
creating a growth area, the growth area relating to the one or more competencies;
causing a presentation of a user interface on a device of a user based on the user being associated with the job function and the job type, the user interface allowing the user to share an update pertaining a progress of the user within the growth area.

9. The system of claim 2, wherein the creating of the growth area is based on an input received from a manager of the user via an additional user interface.

10. The system of claim 1, wherein the growth area further includes one or more additional competences, the one or more additional competencies associated with an additional growth track.

11. The system of claim 1, wherein the one or more competencies include on or more characteristics or one or more skills corresponding to the growth track.

12. The system of claim 4, wherein the one or more competencies are selectable by a track administrator from a library of competencies via an additional user interface.

13. The system of claim 1, wherein the growth area includes one or more actions, the one or more actions associated with one or more due dates, and wherein the update pertaining to the progress of the user relates to a completion of the one or more actions before the one or more due dates.

14. The system of claim 1, further comprising, based on the sharing of the update, providing the update to a manager of the user via an additional user interface during a one-on-one meeting between the user and the manager.

15. A non-transitory computer-readable storage medium storing a set of instructions that, when executed by one or more computer processors, causes the one or more computer processors to perform operations, the operations comprising:
creating a growth track;
associating the growth track with one or more competencies;
associating the growth track with one or more track levels;
aligning the growth track with a job architecture, the job architecture including a job function, a job type, and one or more job tracks;
mapping the one or more job levels to the one or more track levels;
creating a growth area, the growth area relating to the one or more competencies;
causing a presentation of a user interface on a device of a user based on the user being associated with the job function and the job type, the user interface allowing the user to share an update pertaining a progress of the user within the growth area.

16. The system of claim 2, wherein the creating of the growth area is based on an input received from a manager of the user via an additional user interface.

17. The system of claim 1, wherein the growth area further includes one or more additional competences, the one or more additional competencies associated with an additional growth track.

18. The system of claim 1, wherein the one or more competencies include on or more characteristics or one or more skills corresponding to the growth track.

19. The system of claim 4, wherein the one or more competencies are selectable by a track administrator from a library of competencies via an additional user interface.

20. The system of claim 1, wherein the growth area includes one or more actions, the one or more actions associated with one or more due dates, and wherein the update pertaining to the progress of the user relates to a completion of the one or more actions before the one or more due dates.
